(19) United States
(12) Patent Application Publication
(10) Pub. No.: US 2016/0026754 A1
(43) Pub. Date: Jan. 28, 2016

(54) METHODS AND SYSTEMS FOR IDENTIFYING A PHYSIOLOGICAL STATE OF A TARGET CELL

(71) Applicant: PRESIDENT AND FELLOWS OF HARVARD COLLEGE, Cambridge, MA (US)

(72) Inventors: Isaac KOHANE, Newton, MA (US); Nathan PALMER, Somerville, MA (US)

(73) Assignee: PRESIDENT AND FELLOWS OF HARVARD COLLEGE, Cambridge, MA (US)

(21) Appl. No.: 14/776,047

(22) PCT Filed: Mar. 14, 2014
(86) PCT No.: PCT/US14/28328

§ 371 Date: Sep. 14, 2015

Related U.S. Application Data
(60) Provisional application No. 61/783,480, filed on Mar. 14, 2013.

(51) Int. Cl. G06F 19/18

(52) U.S. Cl. CPC G06F 19/18

(57) ABSTRACT

Embodiments of various aspects described herein are directed to methods, systems, and kits for identifying a functional or physiological state of a target cell. The inventions described herein are based on a novel approach that combines biochemical expression measurements of a sample (e.g., gene expression data) with mapping of the measurements onto a graphical representation of a plurality of reference points (loci). Each reference point corresponds to a reference sample with a known phenotype and reflects interrelationships between multi-dimensional biochemical expression measurements of the reference samples. By locating the sample relative to reference points on the graphical representation, the physiological or functional state of the sample can be identified. The methods, systems and kits described herein can be used for various applications, including, e.g., but not limited to, determining an effect of a perturbagen on a target cell, molecule screening, and diagnosis and/or treatment of a subject.

### CROSS-REFERENCE TO RELATED APPLICATIONS

This application claims benefit under 35 U.S.C. §119(e) of the U.S. Provisional Application No. 61/783,480 filed Mar. 14, 2013, the content of which is incorporated herein by reference in its entirety.

### TECHNICAL FIELD

Described herein relates generally to methods, systems and kits for identifying a functional or physiological state of a target cell. In some embodiments, the methods, systems and kits can be used in diagnosis and/or treatment of a subject. In some embodiments, the methods, systems and kits can be used for determining an effect of a perturbagen on a target cell, or for molecule screening.

### BACKGROUND

Although gene expression microarrays have been a standard, widely-utilized biological assay for many years, there is still a lack of comprehensive understanding of the transcriptional relationships between various tissues and disease states. Even with the hundreds of thousands of expression array data sets available through public repositories such as NCBI's Gene Expression Omnibus (GEO) (Barrett T et al. 2010 NAR D1005), the lack of standardized nomenclature and annotation methods has made large-scale, multi-phenotype analyses difficult. Thus, expression analyses have typically used the decade old approach of comparing expression levels across two states (e.g., case vs. control) or a limited number of phenotype classes. See, e.g., Tian Z. et al. (2009) PloS One 4:e5157; Dudley J T et al. (2009) Mol Syst Biol 5:307 and Golub T R et al. (1999) Science 286: 531. Even recent large-scale gene expression investigations, whether they have attempted to elucidate phenotypic signals (Rhodes D R et al (2007) NEO 9:166; Liu X et al. (2008) BMC Bioinformatics 9:271; and Ogasawara 0 et al. (2006) NAR 34: D628) or applied those signals for downstream analyses such as drug repurposing (Sirota M et al. (2001) Sci Transl Med 3:96ra77; and Lamb J (2007) Nat Rev Cancer 7:54)), involve comparisons between two states or classes. Comparative analyses, where transcriptional differences are directly measured between two phenotypes, inherently impose subjective decisions about what constitutes an appropriate control population Importantly, such analyses are fundamentally limited in scope and cannot differentiate between biological processes that are unique to a particular phenotype or part of a larger process that is common to multiple phenotypes (e.g. a generic “cancer pathway”). Moreover, the results of such comparative analyses can be limited in generalizability as they make assumptions about the phenotypes being compared (Ransohoff D R (2005) Nat Rev Cancer 5:142). Accordingly, there is a need for a more reliable and robust methods for determining cell phenotypes.

### SUMMARY

With the rapid growth of publicly available high throughput transcriptomic data, there is increasing recognition that large sets of such data can be analyzed to better understand disease states and mechanisms, e.g., for development of therapeutic intervention. However, typical expression analyses compare expression level based on a dichotomous nature, i.e., across two states (e.g., cases vs. controls), or a limited number of phenotypic classes. Such comparative analyses impose subjective decisions about what constitutes an appropriate control population, limiting the analysis to a specific phenotype and thus reducing generalizability. To this end, inventors have developed a scalable and robust statistical approach that can leverage a multi-dimensional biochemical expression (e.g., gene expression) space of a large diverse set of tissue and disease phenotypes to identify more accurate phenotypic-specific markers and/or to identify a functional or physiological state of a target cell, e.g., a cell derived from a biological sample of a subject.

In particular, the inventors have inter alfa developed a method (e.g., using a computer) that combines gene expression data determined from a sample (e.g., by a microarray) with mapping of the data onto a multi-coordinate (e.g., 2-coordinate) graphical representation of a plurality of reference points (loci), each of the reference points corresponding to a distinct reference sample with a known phenotype and reflecting interrelationships between multi-dimensional biochemical expression measurements of the reference samples. By locating the sample relative to reference points on the multi-coordinate (e.g., 2-coordinate) graphic representation of the reference points, the physiological state and/or functional state of the sample can be identified relative to a specific reference point accordingly. By way of example only, the inventors have demonstrated use of the method to accurately determine the tissue origin of cells from a tumor metastasis sample (e.g., a metastasis of a tumor of unknown origin) (Example 1, FIGS. 5A-5B). Additionally or alternatively, by following the trajectory of the loci of the same sample at different time points, the sample can have a diagnostic assignment to the class of samples with a similar trajectory. For example, by following the loci of a sample of differentiating stem cells, e.g., neuronal stem cells, over a series of time points, one can determine if the stem cells are on the trajectory to become neurons. In some embodiments, the effect of an agent that can reverse or alter the direction of the trajectory can be used to provide a therapeutic response. Accordingly, embodiments of various aspects provided herein relate to methods and systems for identifying a physiological state of a target cell, as well as applications thereof, e.g., for diagnosis of a condition, selection of a treatment regimen for the condition, and/or evaluation of the effects of a perturbagen on a target cell.

In one aspect, provided herein is a method of identifying a physiological state of a target cell comprising:
(a) providing a normalized expression atlas reflecting a plurality of reference loci, said plurality of reference loci corresponding to a set of reference phenotypes associated with reference samples, wherein each of the reference loci is determined based on a compendium of covariance measurements determined between different biochemical expression measurements across the reference samples;
(b) in a specifically-programmed computer, projecting onto the normalized expression atlas an expression vector reflecting at least a subset of biochemical expression measurements determined from a target cell to be identified, thereby locating the locus corresponding to the target cell on the normalized expression atlas; and
(c) in the specifically-programmed computer, determining deviation of the locus corresponding to the target cell from the reference loci corresponding to at least one selected reference phenotype, wherein the magnitude of the deviation indicates degree of similarity between the physiological state of the target cell and said at least one selected reference phenotype, thereby identifying the physiological state of the target cell relative to said at least one selected reference phenotype.

The normalized expression atlas used in the methods and systems of various aspects described herein is generally a graphical representation of covariances between different biochemical expression measurements across the reference samples, wherein the biochemical expression measurements of the references samples are normalized, e.g., to improve cross-data series comparability. In some embodiments, the normalized expression atlas is a 2-coordinate graphical representation, in which the location of each reference sample is defined by 2 coordinates on the graph, and the relative positions of the points (reference loci) to each other represent the similarities and differences in biochemical expression measurements between the reference samples.

In some embodiments, the method can further comprise assaying a test sample comprising the target cell to determine the biochemical expression measurements. Examples of biochemical expression measurements can include, but are not limited to, gene expression measurements, nucleic acid expression measurements, epigenetic marking measurements, RNA editing measurements, protein or peptide expression measurements, metabolite expression measurements, or any combinations thereof.

Depending on types of the biochemical expression measurements, the test sample can be assayed by any methods known in the art. Various methods to determine biochemical expression measurements can include, without limitations, polymerase chain reaction (PCR), real-time quantitative PCR, microarray, western blot, immunohistochemical analysis, enzyme linked absorbance assay (ELISA), mass spectrometry, nucleic acid sequencing, flow cytometry, gas chromatography, high performance liquid chromatography, nuclear magnetic resonance (NMR) spectroscopy, or any combinations thereof.

In embodiments of this aspect and other aspects described herein, a target cell can be of any cell type or any tissue type from any species (e.g., animal, mammal, plant, insects, and/or microbes). In some embodiments, the target cell can be of any cell type or of any tissue type from a mammalian subject. In some embodiments, a mammalian subject is a human subject.

In embodiments of this aspect and other aspects described herein, a target cell can be a cell from any source (e.g., in vitro, in vivo, ex vivo, environmental source). In some embodiments, the target cell can be collected or derived from a test sample. For example, in one embodiment, the target cell can be a cell collected from a test sample. In another embodiment, the target cell can be a cell reprogrammed or differentiated from a cell collected or derived from a test sample. For example, the target cell can be a stem cell that exists in a test sample, or a stem cell derived or reprogrammed from a somatic cell (e.g., but not limited to, a fibroblast) collected from a test sample. In some embodiments, the target cell can be an induced pluripotent stem cell (iPSC). In some embodiments, the target cell can be a mature cell. The mature cell can be collected from a test sample, or differentiated from a progenitor cell collected from a test sample.

In embodiments of this aspect and other aspects described herein, a target cell can be a cell at any state (e.g., normal healthy, diseased, malignant, differentiated, partially-differentiated, and/or undifferentiated). In some embodiments, the target cell can be a normal healthy cell. In some embodiments, the target cell can be a diseased cell. In some embodiments, the target cell can be a cancer cell or cancer stem cell.

In some embodiments of this aspect and other aspects described herein, a target cell can be an unknown cell or uncharacterized cell. For example, a cell of unknown tissue type, unknown species, unknown developmental stage and the like, can be subjected to the methods described herein so as to identify or characterize the cell.

In some embodiments of this aspect and other aspects described herein, a target cell can be a cell after a treatment. For example, in some embodiments, the target cell amenable to the methods described herein can be a cell that has been contacted with a perturbagen. A perturbagen can be an agent that can produce an effect (e.g., a beneficial/therapeutic effect or adverse/toxic effect) on a recipient cell, and includes, for example, but is not limited to, proteins, peptides, nucleic acids (e.g., RNA, DNA, siRNA, snRNA), aptamers, small molecules, toxins, therapeutic agents, nutraceuticals, environmental stimuli (e.g., pressure, hypoxia, humidity, light, temperature (e.g., extremes in high and low temperatures), radiation), microbes, and any combinations thereof. In these embodiments, a test sample comprising the target cell can be collected at a first time point after the target cell has been contacted with the perturbagen. In some embodiments, a test sample comprising the target cell can be collected at a second time point after the target cell has been contacted with the perturbagen, wherein the second time point is subsequent to the first time point.

In some embodiments where the target cell has been treated with a perturbagen, the method described herein to identify the physiological state of a target cell can indicate the effect of the perturbagen on the target cell. For example, based on the trajectory of the locus corresponding to a target cell, and/or the magnitude of the deviation of the locus corresponding to the target cell from the reference loci corresponding to a normal healthy state, and/or the magnitude of the deviation of the locus corresponding to the target cell from a locus corresponding to the target cell prior to the exposure to the perturbagen, the physiological state of the target cell can be identified.

In some embodiments where the perturbagen shows a therapeutic effect on the target cell, e.g., based on the locus corresponding to the target cell contacted with the perturbagen with a deviation from the reference loci corresponding to a normal healthy state being smaller than that of a locus corresponding to the target cell not contacted with the perturbagen, the method can further comprise selecting the perturbagen as a candidate for further therapeutic evaluation. In some embodiments, when the locus corresponding to the target cell contacted with the perturbagen deviates from the reference loci corresponding to a normal healthy state by no more or less than 30% (e.g., no more or less than 20%, no more or less than 10% or lower), the method can further comprise selecting the perturbagen as a candidate for further therapeutic evaluation.

The test sample comprising the target cell can be collected or derived from a cell culture, a subject and/or an environmental source. For example, the test sample can comprise a biological fluid sample (e.g., blood including whole blood, serum and/or plasma, urine, cerebrospinal fluid, amniotic fluid, or other bodily fluid sample), a biopsy sample, a cell culture sample, a homogenate, other biological samples, or a combination thereof.

In some embodiments, the test sample comprising the target cell can be collected or derived from a subject. In some embodiments, the subject can be a mammalian subject, e.g., a human subject. In some embodiments, the subject can be a normal healthy subject, or determined to have, or have a risk for, a condition (e.g., a disease or disorder). In some embodiments, a target cell collected or derived from a subject is an iPSC, where the subject is a normal subject, or determined to have, or be risk of having a disease or disorder.

In some embodiments where the subject is determined to have, or have a risk for, a condition (e.g., a disease or disorder), the method described herein to identify the physiological state of the subject's cell (target cell) can further provide a diagnosis of the condition (e.g., a disease or disorder) or a state of the condition (e.g., a disease or disorder) in the subject. For example, based on the trajectory of the locus/loci corresponding to the subject's cell(s), and/or the magnitude of the deviation of the locus/loci corresponding to the subject's cell(s) from reference loci (corresponding to a normal healthy state, a specific condition, and/or various states of the specific condition), the condition of the subject can be diagnosed relative to the reference loci. In some embodiments, the method can further comprise administering to the subject a treatment regimen after the diagnosis.

By way of example only, in some embodiments where the subject is diagnosed to have cancer, the method described herein to identify the physiological state of the subject's cancerous cell(s) (target cell(s)) can further identify the primary tissue origin of the cancerous cell(s) (e.g., to identify whether the tissue biopsy sample is of a primary tumor or a secondary tumor (metastasis)). For example, based on the vicinity of the locus/loci corresponding to the subject's cancerous cell(s) relative to reference loci (corresponding to various tissue phenotypes, e.g., but not limited to, bones, brain, and breast), the primary tissue origin and/or degree of malignancy of the subject's cancerous cell(s) can be identified.

In some embodiments where the subject is being administered with a treatment regimen, the method described herein to identify the physiological state of the subject's cell (target cell) can indicate or determine the efficacy effect of the treatment regimen. For example, based on the trajectory of the locus/loci corresponding to the subject's cell(s), and/or the magnitude of the deviation of the locus/loci corresponding to the subject's cell(s) from reference loci corresponding to a normal healthy state, and/or the magnitude of the deviation of the locus/loci corresponding to the subject's cell(s) from a locus/loci corresponding to the subject's cell(s) prior to the initiation of the therapeutic regime, the efficacy effect of the treatment regimen can be determined. In these embodiments, the method can further comprise selecting for, and optionally administering to, the subject an alternative treatment regimen, or adjusting the subject's treatment regimen, based on the identified physiological state of the subject′ cell relative to a normal healthy cell.

For construction of the normalized expression atlas, a non-parametric mathematical method that can (i) analyze a compendium of multivariate biochemical expression data sets, (ii) identify specific biochemical species (e.g., a subset of genes) that are relevant to distinguish the reference samples by phenotypes and (iii) express such information in a way as to highlight the similarities and difference among samples, can be used herein.

In some embodiments, the method described herein can further comprise constructing the normalized expression atlas. In some embodiments, the normalized expression atlas can be constructed by implementing, in a specifically-programmed computer, an algorithm comprising principal component analysis on a compilation of at least a subset of biochemical expression measurements determined from the reference samples. The principal component analysis is a mathematical technique known to a skilled artisan for use to compress a multi-dimensional data set by identifying a pattern among components in the data set, followed by transformation of the data to a normalized coordinate system such that a linear combination of the selected components (e.g., a subset of genes) contributing to the greatest variance of the data set becomes the first principal component (e.g., x-coordinate axis), while the subsequent principal component(s), e.g., the second principal component, can be selected to be orthogonal to the prior principal component (e.g., the first principal component). In some embodiments, the principal component analysis can comprise selecting at least the first two principal components of said at least the subset of biochemical expression measurements determined from the reference samples.

In some embodiments, said at least the subset of biochemical expression measurements used in construction of the normalized expression atlas can correspond to a set of biochemical expression signatures for a target phenotype. The biochemical expression signatures for a target phenotype can be identified by any statistical approaches known in the art. In some embodiments, the set of biochemical expression signatures for a target phenotype can be identified in silico based on distributions of biochemical expression intensities across the reference samples, e.g., but not limited to an in silico process comprising use of a finite impulse response filter.

In some embodiments, the method described herein can further comprise in the specifically-programmed computer, projecting the expression vector (corresponding to a target cell) onto a normalized time-course expression atlas reflecting a plurality of developmental reference loci, said plurality of the developmental reference loci corresponding to distinct developmental states of the reference samples. Similar to the normalized expression atlas described earlier, the normalized time-course expression atlas can be constructed by implementing, in the specifically-programmed computer, an algorithm comprising principal component analysis on a compilation of at least a subset of biochemical expression measurements determined from the reference samples, wherein said at least a subset of the biochemical expression measurements correspond to said distinct developmental states (e.g., but not limited to, differentiate state, stemness, and/or malignancy) of the reference samples.

The size of the data compendium comprising different biochemical expression measurements of the reference samples can vary with user′ preferences and/or applications of the normalized expression atlas. In some embodiments, the number of the biochemical expression measurements selected for construction of the normalized expression atlas can be at least about 10 for each of the reference samples (e.g., expression measurements of 10 genes, proteins, and/or metabolites for each reference sample). In some embodiments, the number of the biochemical expression measurements selected for construction of the normalized expression atlas can be about 1000 to about 50,000 for each of the reference samples.

In some embodiments, the number of reference samples presented in the normalized expression atlas can be at least about 100 or more, e.g., at least about 200, at least about 300, at least about 400, at least about 500 or more.

Depending on applications/purposes of the methods described herein (e.g., to monitor differentiation progress of a stem cell, and/or to identify a specific condition associated with a cell), the normalized expression atlas can include any number and/or any characteristics of phenotypes that are sufficient to identify the physiological state of the cell. In some embodiments, the set of the reference phenotypes selected for the normalized expression atlas can comprise at least about 5 phenotypes, at least about 10 phenotypes, at least about 20 phenotypes, at least about 30 phenotypes, at least about 40 phenotypes, at least about 50 reference phenotypes, or more.

In some embodiments, at least a subset of the reference phenotypes can be associated with cell or tissue types. In some embodiment, at least a subset of the reference phenotypes can be associated with a condition (e.g., disease or disorder) or a known state of the condition (e.g., disease or disorder). In some embodiments, at least a subset of the reference phenotypes can be associated with a normal healthy state. In some embodiments, at least a subset of the reference phenotypes can be associated with a known effect of a perturbagen in contact with the reference cells.

The compendium of biochemical expression datasets used to construct a normalized expression atlas can come from any publicly-available source, e.g., but not limited to, NCBI, and/or Concordia. In order to identify reference datasets that comprise relevant biochemical expression measurements of reference samples to construct a normalized expression atlas specific for a certain application, in some embodiments, a Concordia system comprising a database of biological samples (e.g., cell culture and/or primary cell samples) mapped to a structured ontology, e.g., the National Laboratory of Medicine's Unified Medical Language System (UMLS), e.g., of medical or biological concepts, such as “cancer,” can be used. Methods for constructing and searching in a Concordia database are described in U.S. Patent Appl. No. US 2011/0047169, the content of which is incorporated herein in its entirety by reference.

Another aspect provided herein is a system (e.g., a computer system), which can be, e.g., used to identify a physiological state of a target cell or a population of cells. The system comprises:
(a) at least one determination module configured to receive at least one test sample and perform at least one assay on at least one test sample comprising a target cell to determine biochemical expression measurements;
(b) at least one storage device configured to store the biochemical expression measurements of said at least one test sample determined from said determination module, and further configured to provide a normalized expression atlas reflecting a plurality of reference loci, said plurality of reference loci corresponding to a set of reference phenotypes associated with reference samples, wherein each of the reference loci is determined based on a compendium of covariance measurements determined between different biochemical expression measurements across the reference samples;
(c) at least one analysis module configured to perform the following:
   projecting onto the normalized expression atlas an expression vector reflecting at least a subset of the biochemical expression measurements determined from said at least one determination module, thereby locating the locus corresponding to the target cell on the normalized expression atlas;
   determining deviation of the locus corresponding to the target cell from the reference loci corresponding to at least one selected reference phenotype, wherein the magnitude of the deviation indicates degree of similarity between the physiological state of the target cell and said at least one selected reference phenotype, thereby identifying the physiological state of the target cell relative to said at least one selected reference phenotype.
(d) at least one display module for displaying a content based in part on the analysis output from said analysis module, wherein the content comprises a signal indicative of the presence of said at least one selected reference phenotype in the target cell, a signal indicative of the absence of said at least one selected reference phenotype in the target cell, a signal indicative of the deviation of the locus corresponding to the target cell from the reference loci, or any combinations thereof.

In some embodiments, at least one determination module can be configured to perform at least one assay selected for determination of biochemical expression measurements (e.g., but not limited to, nucleic acid expression measurements, gene expression measurements, protein or peptide expression measurements, epigenetic marking measurements, RNA editing measurements, metabolite expression measurements, or any combinations thereof). Various assays for determination of biochemical expression measurements are known in the art, and can include, e.g., but not limited to, polymerase chain reaction (PCR), real-time quantitative PCR, microarray, western blot, immunohistochemical analysis, enzyme linked absorbance assay (ELISA), mass spectrometry, nucleic acid sequencing (e.g., DNA sequencing and/or RNA sequencing), flow cytometry, gas chromatography, high performance liquid chromatography, nuclear magnetic resonance (NMR) spectroscopy, or any combinations thereof.

Depending on the nature of test samples and/or applications of the systems as desired by users, the display module can further display additional content. In some embodiments where the test sample is collected or derived from a subject for diagnostic assessment, the content displayed on the display module can further comprise a signal indicative of a diagnosis of a condition (e.g., disease or disorder) or a state of the condition (e.g., disease or disorder) in the subject. For example, in some embodiments where the subject is diagnosed with cancer, the content can further comprise a signal indicative of a primary tissue origin of the subject's cancerous cell.

In some embodiments wherein the test sample is collected or derived from a subject for selection and/or evaluation of a treatment regimen for a subject, the content can further comprise a signal indicative of a treatment regimen personalized to the subject, based on the magnitude of the deviation of the locus corresponding to the target cell from the reference loci corresponding to a normal healthy state.

In some embodiments, at least one analysis module can be configured to construct the normalized expression module as described herein, prior to projecting the expression vector onto the normalized expression atlas.

In some embodiments, at least one analysis module can be configured to determine trajectory of the locus corresponding to the target cell. For example, the trajectory of the locus of corresponding to a target cell can be determined by comparing the current locus corresponding to the target cell with its previously-determined locus. Thus, the progression of a condition (e.g., a disease or disorder), and/or the effectiveness of a treatment regimen administered to a subject with the condition can be determined.

In some embodiments, at least one storage device can be further configured to provide a normalized time-course expression atlas reflecting a plurality of developmental reference loci, said plurality of the developmental reference loci corresponding to distinct developmental states of the reference samples (e.g., but not limited to, differentiation states, stemness, and/or malignancy). In these embodiments, the analysis module can be further configured to project the expression vector corresponding to the target cell onto the normalized time-course expression atlas described herein. In some embodiments, the at least one analysis module can be further configured to construct the normalized time course expression module as described herein, prior to projecting the expression vector onto the normalized time-course expression atlas.

The methods of identifying a physiological state of a target cell and/or the systems described herein can be used in any application where a comparison of the physiological state of a target cell to one or more reference states (e.g., normal healthy cells, diseased cells, and/or cells treated with known agents, and/or tissue-specific cells) is desirable, e.g., diagnosis of a disease, treatment monitoring, drug or library screening, and cell differentiation. Accordingly, in a further aspect, a method for determining an effect of a perturbagen on a target cell is provided herein. The method comprises: (a) contacting a target cell with a perturbagen; (b) assaying the target cell to determine biochemical expression measurements; and (c) in a specifically-programmed computer, performing one or more embodiments of the methods and/or systems described herein to identify a physiological state of the target cell. By comparing the identified physiological state of the target cell to one or more reference states, e.g., the original state of the target cell prior to the contact with the perturbagen, and/or a desired state of the cell to be reached (e.g., normal healthy state), the effect of the perturbagen on the target cell can be determined.

In some embodiments, the target cell can be assayed to determine biochemical expression measurements comprising nucleic acid expression measurements, gene expression measurements, epigenetic marking measurements, RNA editing measurements, protein expression measurements, metabolite expression measurements, or any combinations thereof.

A perturbagen can be an agent that can produce an effect (e.g., a beneficial or therapeutic effect, or adverse or toxic effect) on a recipient cell, and includes, for example, but is not limited to, proteins, peptides, nucleic acids (e.g., RNA, DNA, siRNA, snRNA), aptamers, small molecules, toxins, therapeutic agents, nutraceuticals, environmental stimuli (e.g., pressure, hypoxia, humidity, light, temperature (e.g., extremes in high and low temperatures), radiation), microbes, and any combinations thereof.

For example, in some embodiments, to identify a perturbagen as a candidate for reprogramming a somatic cell to a stem cell, the method can further comprise identifying a perturbagen that can generate a locus (corresponding to the target cell) in closer proximity to a reference locus corresponding to a stem cell-like phenotype, or generate a trajectory of the locus (corresponding to the target cell) toward the reference locus corresponding to a stem-cell like phenotype.

In some embodiments, to identify a perturbagen as a candidate for therapeutic evaluation that can partially or completely restore a diseased target cell to a normal healthy state, the method can further comprise identifying a perturbagen that can generate a locus (corresponding to the target cell) in closer proximity to a reference locus corresponding to a normal healthy state, or generate a trajectory of the locus (corresponding to the target cell) toward the reference locus corresponding to a normal healthy state. In this embodiment, if the target cell is collected or derived from a subject determined to suffer from a condition, the identified perturbagen that shows therapeutic effect can be recommended for, or administered to, the subject.

Accordingly, provided herein are also methods for treating a subject with a condition using the methods and/or systems of identifying a physiological state of a target cell described herein. The treatment method comprises administering a selected therapeutic agent to a subject determined to have a condition, wherein the therapeutic agent is selected based on a process comprising: (a) contacting a population of cells with a plurality of perturbagens, wherein the population of cells are derived from a first test sample obtained from the subject; (b) assaying the population of cells to determine biochemical expression measurements (e.g., nucleic acid expression measurements, gene expression measurements, epigenetic marking measurements, RNA editing measurements, protein expression measurements, metabolite expression measurements), or any combinations thereof; and (c) in a specifically-programmed computer, performing one or more embodiments of the methods and/or systems described herein to identify the physiological state of the population of the cells, wherein at least one perturbagen that (i) can generate a locus corresponding to the population of cells in the closest proximity to a reference locus corresponding to normal healthy cells, or (ii) can generate a trajectory of the locus toward the reference locus, can be selected as the therapeutic agent for administration to the subject.

In some embodiments, the normalized expression atlas used in the methods and/or systems described herein to identify the physiological state of the population of the cells can comprise reference loci representing a normal healthy state. In some embodiments, the normalized expression atlas can comprise reference loci representing a known state of the condition.

In some embodiments, the method can further comprise selecting the therapeutic agent.

In some embodiments, the population of cells subjected to treatment with perturbagens can be collected or derived from the subject to be treated. In some embodiments, the population of the cells can comprise somatic cells of the subject, e.g., from a biopsy of target cells to be treated. In some embodiments, the population of cells subjected to treatment with perturbagens can comprise tissue-specific cells. The tissue-specific cells can be collected from a subject, or differentiated from stem cells collected or derived from the subject. In some embodiments, the stem cells can comprise naturally existing stem cells or derived stem cell (e.g., induced pluripotent stem cells) reprogrammed from the somatic cells (e.g., skin fibroblasts) of the subject. Since the cells for the methods and/or systems described herein are collected or derived from a subject, the results of the methods and/or systems can be used to make a decision for a personalized treatment.

In some embodiments, the method can further comprise determining or diagnosing the condition (e.g., a disease or disorder) or the state of the condition (e.g., a disease or disorder) in the subject, prior to administering the subject with the selected therapeutic agent. In addition to or alternative to using any known methods in the art for diagnosis, e.g., blood test, biopsy, and/or imaging methods (e.g., but not limited to, X-ray, MRI, ultrasound, PET scan, and/or CT scan), in some embodiments, the type and/or state of the condition of a subject can be determined by a diagnostic process comprising performing one or more embodiments of the methods and/or systems described herein to identify a physiological state of a target cell. For example, based on the vicinity of the locus corresponding to the subject's cell (target cell) from at least one subset of reference loci (e.g., corresponding to a normal healthy state and/or different states of the condition to be diagnosed, e.g., different stages of cancer), the type and/or state of the condition of the subject can be identified.

Accordingly, yet another aspect provided herein is a method of diagnosing a condition (e.g., a disease or disorder) or a state of the condition (e.g., a disease or disorder) in a subject. The method comprises (a) assaying at least a subset of cells from a test sample collected from a subject determined to have, or have a risk for, a condition, to determine biochemical expression measurements; (b) in a specifically-programmed computer, performing one or more embodiments of the methods and/or systems described herein to identify a physiological state of the subject's cells, wherein the magnitude of the deviation of the locus corresponding to the subject's cells from reference loci corresponding to the condition or different states of the condition, indicates degree of similarity between the physiological state of the subject's cells and the condition or different states of the condition, thereby determining the type of the condition (e.g., a disease or disorder) or the state of the condition (e.g., a disease or disorder) in the subject.

In some embodiments, at least a subset of the reference loci can represent a normal healthy state. In some embodiments, at least a subset of the reference loci can represent a known state of a condition to be diagnosed. For example, a subset of the reference loci can represent a specific stage of cancer.

In some embodiments, the method can further comprise administering the subject a therapeutic agent after diagnosing the condition.

Provided herein is also a method of monitoring a therapeutic treatment in a subject. The method comprises (a) assaying a test sample collected from a subject administered with a therapeutic treatment to determine biochemical expression measurements (e.g., nucleic acid expression measurements, gene expression measurements, epigenetic marking measurements, RNA editing measurements, protein/peptide expression measurements and/or metabolite measurements; and (b) in a specifically-programmed computer, performing one or more embodiments of the methods described herein to identify a physiological state of target cells in the test sample, thereby determining the effectiveness of the therapeutic treatment on the subject.

In some embodiments, the test sample can be collected at a first time point. The first time point can be taken prior to administration of the therapeutic treatment or after the subject has been treated with the therapeutic treatment.

In some embodiments, the test sample can be collected at a second time point. The second time point refers to a time point after the subject has been treated with the therapeutic treatment and is subsequent to the first time point.

In some embodiments, the method can comprise comparing the identified physiological state of the target cell(s) to at least one or more reference loci. For example, in some embodiments where the test sample is collected at a first time point after the subject has been treated with the therapeutic treatment, at least a subset of the reference loci can represent a physiological state of target cells in a test sample collected prior to the therapeutic treatment. In some embodiments, a subset of the reference loci can represent a normal healthy state of cells, e.g., from the same subject or different subjects. In some embodiments where the test sample is collected at a second time point after the subject has been treated with the therapeutic treatment (where the second time point is subsequent to the first time point), a subset of the reference loci can comprise the loci representing the physiological state of the subject's cells collected at the first time point. When the trajectory of the locus corresponding to the target cell(s) points toward the normal healthy state, and/or the locus corresponding to the target cells deviates from the normal healthy state by no more than 30% (e.g., no more than 20%, no more than 10% or less), the therapeutic treatment can be considered effective. Alternatively, when the trajectory of the locus corresponding to the target cell(s) moves away from the locus of the target cell(s) prior to the therapeutic treatment (e.g., along a trajectory toward reference loci corresponding to normal healthy states) by more than about 10%, or more than about 20%, or more than about 30%, or more than about 40%, or more than about 50% or more, then the therapeutic treatment can be considered effective.

The methods and/or systems of various aspects described herein can be applicable to various in vitro or in vivo applications. In some embodiments, the methods and/or systems of various aspects described herein can be applicable to treatment and/or diagnosis of any condition (e.g., disease or disorder). Examples of a condition (e.g., disease or disorder) can include, but are not limited to, neurodevelopmental disorders, neurodegenerative disorders, genetic disorders, metabolic disorders, cancer, and any combinations thereof.

### BRIEF DESCRIPTION OF THE DRAWINGS

FIG. 1 is a schematic representation of an exemplary process for transcriptomic evaluation of induced pluripotent stem cells development state in a multidisease and multitissue context for individualized therapeutic decision making. As depicted in FIG. 1, adult skin cells are obtained from patients and reprogrammed (a) into induced pluripotent stem cells (iPSCs) which are then differentiated (b) into a designated adult tissue corresponding to the most diseased target tissue that is to be assessed for therapy. The transcriptome of the patient's differentiated cells can then be measured by a hybridizing microarray or by RNA sequence (c), which provides a multi-dimensional vector (“individual transcriptomic vector”). The individual transcriptomic vector can then be projected into two different normalized multidimensional reference spaces (“expression atlases”). The first expression atlas (“multi-tissue multi-disease expression atlas”) is a compilation of over 50,000 expression microarray experiments covering over 100 disease states and over 30 tissue types. The projection of the individual transcriptome to the multi-tissue multi-disease expression atlas (d) can provide two multidimensional vectors: one reports the position of the individual's transcriptome in tissue space and the other in disease space. Together these vectors provide accurate positioning of the individual's disease state for a given tissue. The second expression atlas into which the individual transcriptomic vector can be projected (e) is constructed from the transcriptomic time-series (i.e. full transcriptome measurement to each time point in development) of the developing tissue (e.g., developing murine tissue) corresponding to the adult human tissue into which the iPSC were differentiated (b). The resulting vector represents the developmental staging of the individual's transcriptome. The vectors obtained from the two expression atlases can then be combined (f) to provide a multi-dimensional integrated disease, tissue, and developmental state locus corresponding to the individual's transcriptome. The distance in this integrated state from reference healthy individual samples to the patient's individual transcriptome provides a multidimensional quantified measure of disease (“Individualized Disease Vector”) and thereby defines its inverse, the “therapeutic vector” (g).

FIGS. 2A-2C show a comprehensive view of gene expression analysis. FIG. 2A is a schematic representation showing that comprehensive perspective on expression analysis can enable the elucidation of biological signals that are thematically coherent but provide an alternative view to traditional dichotomous approaches. For example, the gene-signature for “breast cancer” is enriched for breast specific development and carbohydrate and lipid metabolism in our comprehensive approach, as opposed to being dominated by a more general “cancer” signal. FIG. 2B is a gene expression landscape, as represented by the first two principal components of the expression values of 20252 genes from 3030 microarray samples separates into three distinct clusters: blood, brain, and soft tissue. The shading of the regions corresponds to the amount of data located in that particular region of the landscape such that the darker the color, the more data exists at that location. Interestingly, the area where the soft tissue intersects the blood tissue corresponds to bone marrow samples, and where it intersects the brain tissue, mostly corresponds to spinal cord tissue samples. FIG. 2C is an enlarged view of a portion of FIG. 2B showing that there is a clear separation of reproductive and gastrointestinal tissue samples in the soft tissue cluster.

FIG. 3 shows a tissue correlation network, which recapitulates gene expression landscape. A tissue network constructed from the correlations that averaged greater than 0.8 across 100 random subsamplings runs between the various tissues mirrors the structure of the larger expression continuum while simultaneously showing more fine-grained relationships between various phenotypes. The thickness of the line indicates the strength of the correlation, whereas the color of the nodes corresponds to the higher-level biological groupings of brain, blood, gastrointestinal, and reproductive. The gray nodes indicate tissues that do not belong to the aforementioned types. Similar to the view provided by the analysis of the transcriptomic landscape (FIGS. 2A-2C), this figure also shows the distinct grouping of brain, blood, and soft tissues. In addition, strong intrarelationships between the gastrointestinal tissues and the reproductive tissues are also found.

FIGS. 4A-4B is a schematic representation of construction and querying Concordia, which comprises a database of gene expression samples mapped to UMLS concepts that is used to classify new input microarray samples. FIG. 4A shows construction of database. The free-text associated with each sample is processed using the National Library of Medicine's MetaMap program to map each sample to a set of UMLS concepts. These concepts are then mapped up the ontology so that all ancestor concepts of the ones deemed relevant by MetaMap are also included as correct annotations for each respective sample. The gene expression values for these samples are then normalized and inserted into the Concordia database. Unlike previous or existing tools, new data can be added to this system continually, without causing any interruption to the classification engine. FIG. 4B shows exemplary methods for querying the Concordia database. A user submits a gene expression profile to the database that then computes the similarity to all other samples in the database. Based on the similarity, an enrichment score is computed for each UMLS concept for which data exists in the database and the concepts are returned to the user in order of statistical significance.

FIGS. 5A-5B are sample- and gene-centric expression analyses showing that metastasized samples more closely resemble their primary sites than their biopsy site. FIG. 5A shows that breast tumors that metastasized to the lung, brain, and bone (GSE14107) still appear to be more closely related to other breast samples than to their metastasis sites when placed in the transcriptomic landscape of 3030 other expression samples. FIG. 5B is an expression analysis obtained by recomputing the PCs using only the 164 genes of the breast gene set, as opposed to all 20252 genes, which recapitulates the proximity of the metastasized breast cancer samples to breast tissue samples, and shows that they lie within the confines of the other breast cancer samples in the database.

FIGS. 6A-6B are line graphs showing improvement of accuracy of the enrichment statistic with the increase of data in the database. FIG. 6A is a plot of density estimate of the performance of the method over various amounts of data. The average AUC values over all concepts when varying the amount of data used to compute the enrichment scores. For example, when using only 50% of the data for a given concept, the average AUC drops down to 42%. FIG. 6B is a plot of density estimates of the accuracies of the concepts that are associated with at least 50 samples. Although this includes only 544 of the 1,489 concepts, it provides a more robust view of the change in accuracy.

FIG. 7 is a graph showing distribution of DBC1 expression intensities across the entire database: The distributions of rank-normalized gene expression intensities for gene DBC1 are shown for the stem cell samples as well as the non-stem cell samples. The non-stem cell samples clearly exhibit expression both higher and lower than the stem cell samples, while the stem cell samples are relatively specific in their range of expression.

FIG. 8 is a Venn diagram showing the number of genes in common and distinct to each of the gene sets indicated in Sperger et al., 2003 Proc Natl Acad Sci U.S.A, 100:13350-13355; Skotheim et al., 2005 Cancer Res., 65:5588-5598; and Almstrup et al., 2004 Cancer Res., 64:4736-4743. The Venn diagram indicates that the stem cell gene set (SCGS) overlaps with previously-identified stem cell genes.

FIGS. 9A-9D are normalized expression atlas reflecting loci corresponding to various stem cell-like transcriptional states, including, e.g., precursor cells, immortalized cells, malignant cells, mesenchymal stem cell, pluripotent stem cells, and normal cells (control). In FIGS. 9A-9D, the stem cell signature genes stratify a phenotypically diverse database according to pluripotentiality. Each panel shows the entire expression database plotted on the principal coordinates defined by the stem cell signature genes. PC 1 is represented on the x-axis of each plot, while PC2 is on the y-axis. In each plot, the pluripotent stem cells (IPS and ES) are clustered on the extreme right-hand side (magenta), followed by mesenchymal stem cells (cyan) and immortalized cell lines (blue). Taken together, the panels demonstrate that, across tissue types, this stem cell signature draws a coherent picture of pluripotentiality and differentiation. While the distinction between the pluripotent stem cells and normal tissues represents the predominant signal (PC1) in the data, the contrast in the expression profiles of hematopoietic and neural tissues apparently defines the second strongest signal (PC2). Even so, both tissues' respective malignancies show a common tendency to exhibit greater stem-like activity, as demonstrated by their closer proximity to the pluripotent stem cell cluster. Blood (FIG. 9A), breast (FIG. 9B), neural (FIG. 9C) and colon (FIG. 9D) all demonstrate the same enhanced stem-like expression activity among their respective malignancies.

FIG. 10 is a graph showing distribution of differentiating mouse ES cells over stemness index. Each curve represents the distribution of stemness index values for a particular time point. This signature collocates the four time points' samples and clearly separates the early and late stages of differentiation.

FIG. 11 is a set of panels each showing the distribution, within the space of the stem cell genes, of graded tumor samples for one particular tissue type. Stem cell-like activity correlates with tumor grade in various solid malignancies. The stemness index consistently separates high-grade tumors from low grade ones. Based on this transcriptional index, the mid-grade tumors are less well defined.

FIG. 12 is a heat map showing expression modules in the SCGS across pluripotent and partially committed stem cells, as well as malignant and normal breast samples. Four distinct expression modules (row clusters) are apparent within the stem cell genes. To demonstrate the transcriptome-wide implications of these profiles, this figure displays a series of cell types, ranging from fully differentiated (normal breast), through the associated malignancy, partially committed stem cells, and pluripotent stem cells. Each gene (row) has been independently z-score normalized to improve readability and highlight cluster-specific trends. Biological significance of each cluster was determined by GO analysis (see Tables s5-s8 of Appendix 5). The individual genes represented in each cluster can be found in Tables s1-s4 of Appendix 5.

FIG. 13 is a set of distribution curves showing inter-gene SCGS correlation across various sample types. The distribution of SCGS gene-gene correlations are shown in the top panel independently for the non-malignant, malignant and stem cell samples contained in the database. The distribution of gene-gene correlations for 1,000 random sets of genes equal in size to the SCGS is shown in the bottom panel.

FIG. 14 is a screen snapshot of an animation demonstrating the effect of varying the FIR score threshold for including genes in the SCGS. For each possible number of top-scoring stem genes from 3-502 (displayed at the top of the animation frame), all of the samples in the database are projected into the first two principal components (PCs) of gene space (panel on top right), and six relevant phenotypes are highlighted (as in FIGS. 9A-9D): embryonic/induced pluripotent stem cells; mesenchymal stem cells; immortalized cell line samples; blood precursor cells; leukemia samples; and normal blood cells. The panel below the principal component analysis (PCA) scatter plot shows the distribution of stemness index values (PC1 projection coordinates) for each highlighted phenotype. The plot on the left of the frame shows the analysis of variance (ANOVA) score (including all highlighted phenotypes) for the clustering defined by the current stemness index highlighted by a magenta dot on the curve showing all ANOVA scores for all of the depicted FIR thresholds. Higher ANOVA scores indicate better multi-way separation of the individual phenotypes along the stemness index. ANOVA was calculated and all plots were generated in the R statistical environment as described in Gentleman et al., 2004 Genome Biol 5:R80; and Kohane et al., “Microarrays for an Integrative Genomics” Cambridge, Mass., USA: MIT Press; 2002.

FIG. 15 is a plot based on principal component analysis of whole-genome gene expression profiles for blood, lymphoblast cell lines, brain tissue, fibroblasts, induced pluripotent stem cells (iPSCs), embryonic stem cells (ESCs), and derived neurons showing clustering of cell types based on the first two principal components (PC1 and PC2). This database is comprised of 1,204 gene expression samples belonging to 37 series performed on the Illumina HumanRef-8 v3.0 expression beadchips that were obtained from NCBI's GEO (Allison et al., Nat Rev Genet 2006, 7(1) 55). Notably, the gene expression signature of primary neuronal cultures (NPCs at 0, 2, 4 and 8 weeks) is consistently shifting towards the brain tissue as a function of days in culture and neural differentiation.

FIGS. 16A-16B show that genes exhibiting transcriptional disregulation in primary brain tissue from individuals with neurodevelopmental disorders also exhibit altered expression in iPSC-derived neuronal lines from diseased individuals. Genes were identified in primary cerebella samples that exhibited altered expression in diseased individuals with respect to neurotypics. FIG. 16A is a plot based on principal component analysis of the autistic and control cerebella (Voineagu et al., Nature 2011, 474 (7351) 380) over this set of transcripts demonstrates the ability of this set of marker genes to cluster the samples by disease state. FIG. 16B is a plot based on principal component analysis of Timothy syndrome and neurotypic iPSC-derived neuronal lines (Pasca et al., Nature Medicine 2011, 17(12) 1657), over this same set of genes, demonstrates the altered regulation of these same genes in iPSC-derived cell lines.

FIGS. 17A-17B show that the first two principal components clustered murine (Fmr1KO and WT) brain tissue and primary neuronal cultures in four categories as identified by gene expression. In FIG. 17A, as indicated by the scatter, the murine gene expression profile of cortical neuronal cultures is distinct from hippocampal neuronal cultures profile; and hippocampal brain tissue is distinct from cortical brain tissue. In FIG. 17B, the same plot was used to differentiate between the genotypes in each one of the tissues and cultures: Group A is Fmr1KO and Group B is WT. The clustering of genotypes could be observed in each one of the categories. The units for PC1 and PC2 are normalized Affymetrix signal intensity.

FIGS. 18A-18B are block diagrams showing exemplary systems for use in the methods described herein, e.g., for selecting or identifying a physiological state of a target cell.

FIG. 19 is an exemplary set of instructions on a computer readable storage medium for use with the systems described herein.

### DETAILED DESCRIPTION OF THE INVENTION

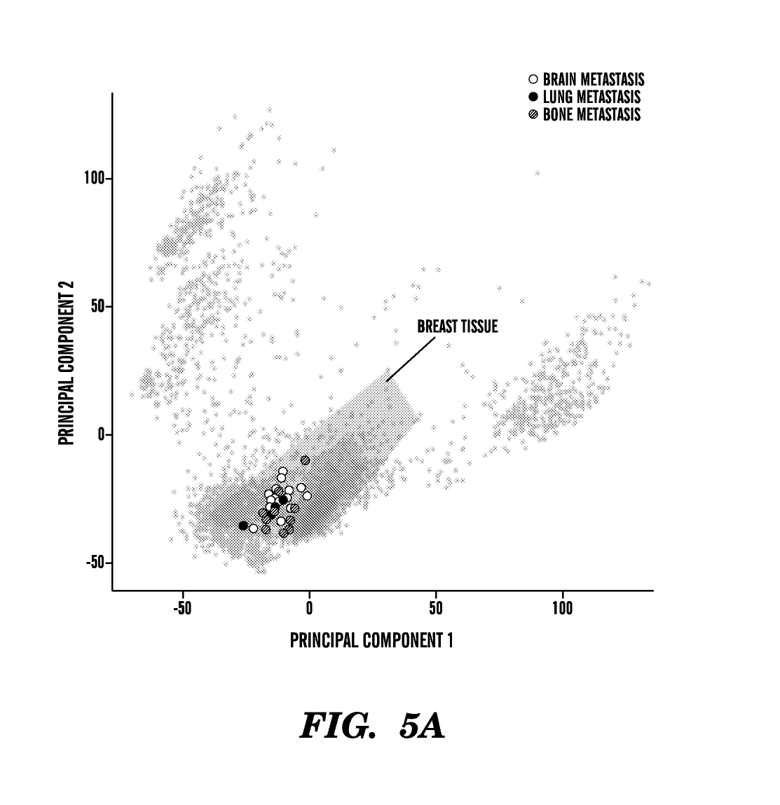

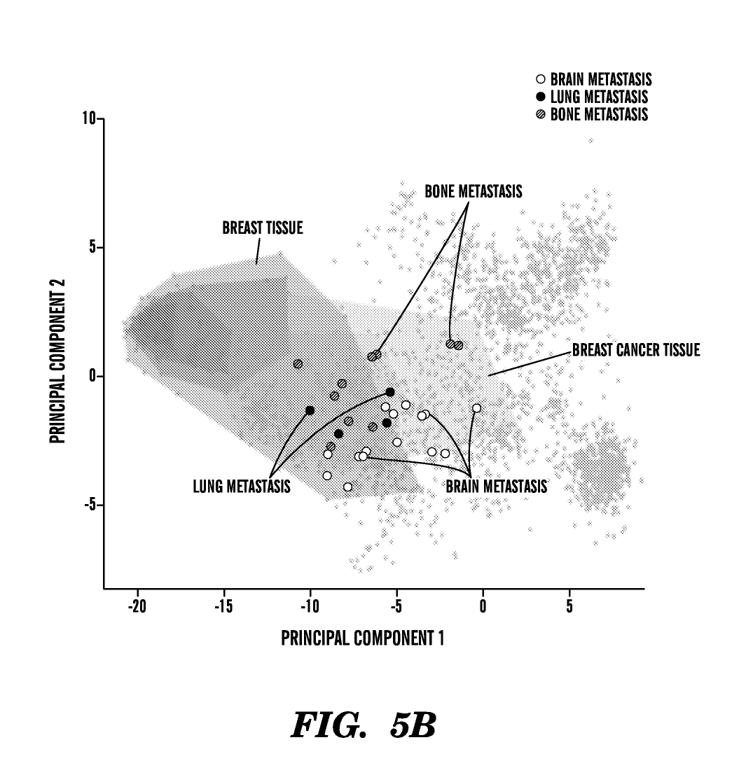

While large sets of transcriptomic data can be analyzed to better understand disease states and mechanisms, e.g., for development of therapeutic intervention, typical expression analyses generally compare expression level based on a dichotomous nature, i.e., across two states (e.g., cases vs. controls), or a limited number of phenotypic classes. Such comparative analyses impose subjective decisions about what constitutes an appropriate control population, limiting the analysis to a specific phenotype and thus reducing generalizability. To this end, the inventors have inter alfa developed a method (e.g., using a computer) that combines gene expression data determined from a sample (e.g., by a microarray) with mapping of the data onto a 2-coordinate graphical representation of a plurality of reference points (loci), each of the reference points corresponding to a distinct reference sample with a known phenotype and reflecting interrelationships between multi-dimensional biochemical expression measurements of the reference samples. By locating the sample relative to reference points on the 2-coordinate or higher-coordinate graphic representation of the reference points, the physiological state and/or functional state of the sample can be identified relative to a specific reference point accordingly. By way example only, the inventors have demonstrated use of the method to accurately determine the tissue origin of cells from a tumor metastasis sample (e.g., a metastasis of a tumor of unknown origin) (Example 1, FIGS. 5A-5B). Additionally or alternatively, by following the trajectory of the loci of the same sample at different time points, the sample can have a diagnostic assignment to the class of samples with a similar trajectory. For example, by following the loci of a sample of differentiating stem cells, e.g., neuronal stem cells, over a series of time points, one can determine if the stem cells are on the trajectory to become neurons. In some embodiments, the effect of an agent that can reverse or alter the direction of the trajectory can provide a therapeutic response.

Accordingly, the inventors have developed a scalable and robust statistical approach that can leverage a multi-dimensional biochemical expression (e.g., gene expression) space of a large diverse set of tissue and disease phenotypes to identify more accurate phenotypic-specific markers and/or to identify a functional or physiological state of a target cell, e.g., a cell derived from a biological sample of a subject. Thus, embodiments of various aspects provided herein relate to methods and systems for identifying a physiological state of a target cell, as well as applications thereof, e.g., for diagnosis of a condition, selection of a treatment regimen for the condition, and/or evaluation of the effects of a perturbagen on a target cell.

### Methods of Identifying a Physiological State of a Target Cell

In one aspect, provided herein is a method or a computer implemented method of identifying a physiological state of a target cell comprising:
(a) providing a normalized expression atlas reflecting a plurality of reference loci, said plurality of reference loci corresponding to a set of reference phenotypes associated with reference samples, wherein each of the reference loci is determined based on a compendium of covariance measurements determined between different biochemical expression measurements across the reference samples;
(b) in a specifically-programmed computer, projecting onto the normalized expression atlas an expression vector reflecting at least a subset of biochemical expression measurements determined from a target cell to be identified, thereby locating the locus corresponding to the target cell on the normalized expression atlas; and
(c) in the specifically-programmed computer, determining deviation of the locus corresponding to the target cell from the reference loci corresponding to at least one selected reference phenotype, wherein the magnitude of the deviation indicates degree of similarity between the physiological state of the target cell and said at least one selected reference phenotype, thereby identifying the physiological state of the target cell relative to said at least one selected reference phenotype.

The term “locus” or “loci” as used herein refers to representation(s) of data associated with biochemical expression measurements of a target cell or a reference cell. The data can be reduced by mathematical manipulation or transformation, which is explained in detail below, such that it can be represented by 2 or more coordinates, e.g., coordinates determined by principal component analysis as described herein, on a normalized expression atlas. By way of example only, as shown in FIGS. 5A-5B, each locus (shown as a point) on the normalized expression atlas represents a sample.

As used herein, the term “covariance” generally refers to the correlation between the pairs of variables. In embodiments of various aspects described herein, the term “covariance” refers to correlation between the pairs of biochemical expression measurements across the reference samples. The covariance measurements can be expressed in a covariance matrix, and methods for calculating the covariance matrix from a multi-dimensional data matrix is known in the art.

As used herein, the term “specifically-programmed computer” refers to a computer system comprising one or more processors; and memory to store one or more programs, which comprise instructions for performing one or more functions described herein. These programs or sets of instructions need not be implemented as separate software programs, procedures or modules, and thus various subsets of these modules may be combined or otherwise re-arranged in various embodiments. In some embodiments, memory may store a subset of the modules and data structures described herein. Further, memory may store additional modules and data structures not described herein.

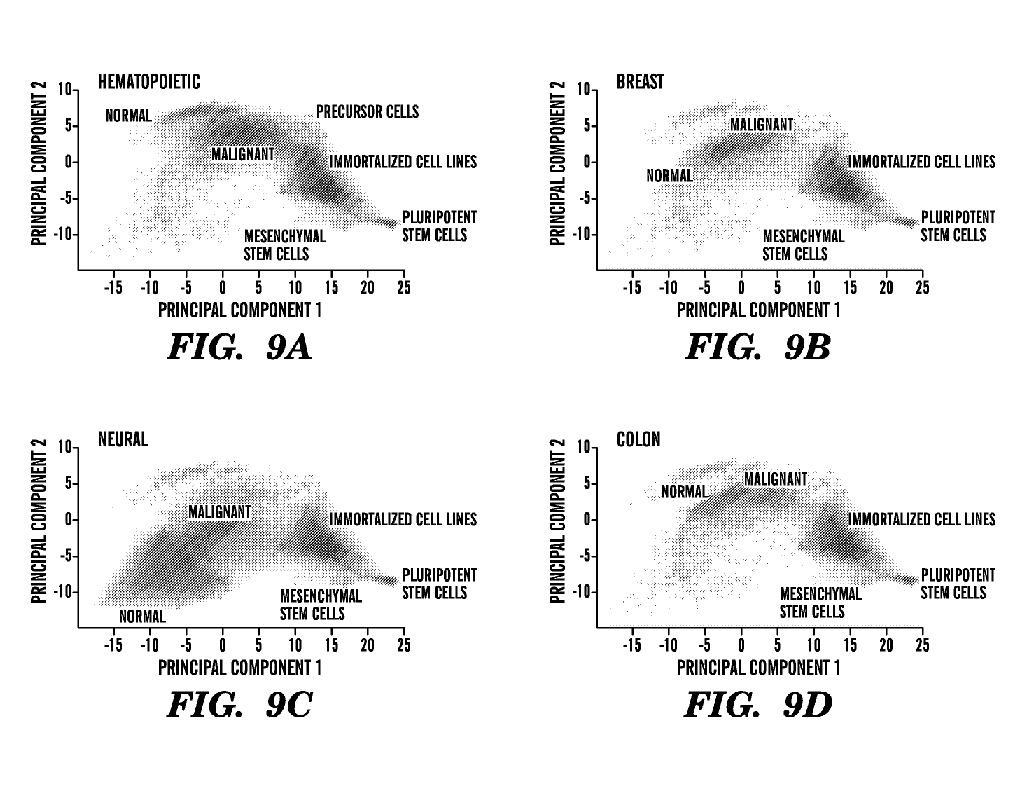

As used herein, the term “projecting” generally refers to an expression vector comprising biochemical expression measurements of a target cell being transformed from an original data matrix, by a mathematical operative, e.g., a projection matrix or a transformation matrix, into a score value, an array of values, or another multi-dimensional matrix in accordance with the new coordinates of the normalized expression atlas. By way of example only, when the multidimensional biochemical expression measurements (e.g., expression data sets) are transformed into a 2-coordinate normalized expression atlas by principal component analysis comprising use of a projection matrix P containing eigenvectors, wherein each coordinate axis represents a linear combination of relevant biochemical expression measurements that can distinguish phenotypes (e.g., by tissue types vs. stemness of the cells as shown in FIGS. 9A-9D), an expression vector comprising biochemical expression measurements can be transformed by the same projection matrix P to determine the projection of the expression vector onto the principal components. See, e.g., Abdi H. and Williams L. J. “Principal Component Analysis” Wiley Interdisciplinary Reviews: Computational Statistics. Vol. 2. Issue 4. Page 433-459 (2010) and Lay, David (2000) Linear Algebra and Its Applications. Addision-Wesley, New York, for information on principal component analysis and how to determine projections of original data matrix onto principal components.

As used herein, the term “expression vector” refers to a mathematical expression of data associated with a plurality of biochemical expression measurements. The biochemical expression measurements can be determined from a target cell or a population of target cells. In some embodiments, an expression vector is an array of data associated with a plurality of biochemical expression measurements.

In some embodiments, the method described herein can further comprise in the specifically-programmed computer, projecting the expression vector (corresponding to a target cell) onto a normalized time-course expression atlas reflecting a plurality of developmental reference loci, said plurality of the developmental reference loci corresponding to distinct developmental states of the reference samples. Similar to the normalized expression atlas described earlier, the normalized time-course expression atlas can be constructed by implementing, in the specifically-programmed computer, an algorithm comprising principal component analysis on a compilation of at least a subset of biochemical expression measurements determined from the reference samples, wherein said at least a subset of the biochemical expression measurements correspond to said distinct developmental states (e.g., but not limited to, differentiate state, stemness, and/or malignancy) of the reference samples.

In some embodiments, the method can further comprise assaying a test sample comprising the target cell to determine the biochemical expression measurements. Examples of biochemical expression measurements can include, but are not limited to, gene expression measurements, nucleic acid expression measurements, protein or peptide expression measurements, metabolite expression measurements, epigenetic marking measurements, RNA editing measurements, or any combinations thereof.

As used herein, the term “RNA editing” generally refers to a molecular process through which some cells can make discrete changes to specific nucleotide sequences within a RNA molecule after it has been generated by RNA polymerase. In some embodiments, common forms of RNA processing (e.g. splicing, 5′-capping and 3′-polyadenylation) are not included as editing. Editing events can include the insertion, deletion, and substitution of nucleotides within the edited RNA molecule.

Depending on types of the biochemical expression measurements, the test sample can be assayed by any methods known in the art. Various methods to determine biochemical expression measurements include, without limitations, polymerase chain reaction (PCR), real-time quantitative PCR, microarray, western blot, immunohistochemical analysis, enzyme linked absorbance assay (ELISA), mass spectrometry, nucleic acid sequencing, flow cytometry, gas chromatography, high performance liquid chromatography, nuclear magnetic resonance (NMR) spectroscopy, or any combinations thereof. Techniques for nucleic acid sequencing are known in the art and can be used to assay the test sample to determine nucleic acid or gene expression measurements, for example, but not limited to, DNA sequencing, RNA sequencing, de novo sequencing, next-generation sequencing such as massively parallel signature sequencing (MPSS), polony sequencing, pyrosequencing, Illumina (Solexa) sequencing, SOLiD sequencing, ion semiconductor sequencing, DNA nanoball sequencing, Heliscope single molecule sequencing, single molecule real time (SMRT) sequencing), nanopore DNA sequencing, sequencing by hybridization, sequencing with mass spectrometry, microfluidic Sanger sequencing, microscopy-based sequencing techniques, RNA polymerase (RNAP) sequencing, or any combinations thereof.

Target cells: In embodiments of various aspects described herein, the target cells can include a biological cell selected from the group consisting of living or dead cells (prokaryotic and eukaryotic, including mammalian), viruses, bacteria, fungi, yeast, protozoan, plant cells, insect cells, microbes, and parasites. The biological cell can be a normal cell, a mutant cell, or a diseased cell. For example, a diseased cell can be a cancer cell Mammalian cells include, without limitation; primate, human and a cell from any animal of interest, including without limitation; mouse, hamster, rabbit, dog, cat, domestic animals, such as equine, bovine, murine, ovine, canine, and feline. In some embodiments, the cells can be derived from a human subject. In other embodiments, the cells are derived from a domesticated animal, e g, a dog or a cat. Exemplary mammalian cells include, but are not limited to, stem cells (e.g., naturally existing stem cells or derived stem cells), cancer cells, progenitor cells, immune cells, blood cells, fetal cells, and any combinations thereof. The cells can be derived from a wide variety of tissue types without limitation such as; hematopoietic, neural, mesenchymal, cutaneous, mucosal, stromal, muscle, spleen, reticuloendothelial, epithelial, endothelial, hepatic, kidney, gastrointestinal, pulmonary, cardiovascular, T-cells, and fetus. Stem cells, embryonic stem (ES) cells, ES− derived cells, induced pluripotent stem cells, and stem cell progenitors are also included, including without limitation, hematopoietic, neural, stromal, muscle, cardiovascular, hepatic, pulmonary, and gastrointestinal stem cells. Yeast cells may also be used as cells in some embodiments described herein. In some embodiments, the cells can be ex vivo or cultured cells, e.g. in vitro. For example, for ex vivo cells, cells can be obtained from a subject, where the subject is healthy and/or affected with a disease. While cells can be obtained from a fluid sample, e.g., a blood sample, cells can also be obtained, as a non-limiting example, by biopsy or other surgical means know to those skilled in the art.

Exemplary fungi and yeast include, but are not limited to, Cryptococcus neoformans, Candida albicans, Candida tropicalis, Candida stellatoidea, Candida glabrata, Candida krusei, Candida parapsilosis, Candida guilliermondii, Candida viswanathii, Candida lusitaniae, Rhodotorula mucilaginosa, Aspergillus fumigatus, Aspergillus flavus, Aspergillus clavatus, Cryptococcus neoformans, Cryptococcus laurentii, Cryptococcus albidus, Cryptococcus gattii, Histoplasma capsulatum, Pneumocystis jirovecii (or Pneumocystis carinii), Stachybotrys chartarum, and any combination thereof.

Exemplary bacteria include, but are not limited to: anthrax, campylobacter, cholera, diphtheria, enterotoxigenic E. coli, giardia, gonococcus, Helicobacter pylori, Hemophilus influenza B, Hemophilus influenza non-typable, meningococcus, pertussis, pneumococcus, salmonella, shigella, Streptococcus B, group A Streptococcus, tetanus, Vibrio cholerae, yersinia, Staphylococcus, Pseudomonas species, Clostridia species, Myocobacterium tuberculosis, Mycobacterium leprae, Listeria monocytogenes, Salmonella typhi, Shigella dysenteriae, Yersinia pestis, Brucella species, Legionella pneumophila, Rickettsiae, Chlamydia, Clostridium perfringens, Clostridium botulinum, Staphylococcus aureus, Treponema pallidum, Haemophilus influenzae, Treponema pallidum, Klebsiella pneumoniae, Pseudomonas aeruginosa, Cryptosporidium parvum, Streptococcus pneumoniae, Bordetella pertussis, Neisseria meningitides, and any combination thereof.

Exemplary parasites include, but are not limited to: Entamoeba histolytica; Plasmodium species, Leishmania species, Toxoplasmosis, Helminths, and any combination thereof.

Exemplary viruses include, but are not limited to, HIV-1, HIV-2, hepatitis viruses (including hepatitis B and C), Ebola virus, West Nile virus, and herpes virus such as HSV-2, adenovirus, dengue serotypes 1 to 4, ebola, enterovirus, herpes simplex virus 1 or 2, influenza, Japanese equine encephalitis, Norwalk, papilloma virus, parvovirus B 19, rubella, rubeola, vaccinia, varicella, Cytomegalovirus, Epstein-Barr virus, Human herpes virus 6, Human herpes virus 7, Human herpes virus 8, Variola virus, Vesicular stomatitis virus, Hepatitis A virus, Hepatitis B virus, Hepatitis C virus, Hepatitis D virus, Hepatitis E virus, poliovirus, Rhinovirus, Coronavirus, Influenza virus A, Influenza virus B, Measles virus, Polyomavirus, Human Papilomavirus, Respiratory syncytial virus, Adenovirus, Coxsackie virus, Dengue virus, Mumps virus, Rabies virus, Rous sarcoma virus, Yellow fever virus, Ebola virus, Marburg virus, Lassa fever virus, Eastern Equine Encephalitis virus, Japanese Encephalitis virus, St. Louis Encephalitis virus, Murray Valley fever virus, West Nile virus, Rift Valley fever virus, Rotavirus A, Rotavirus B, Rotavirus C, Sindbis virus, Human T-cell Leukemia virus type-1, Hantavirus, Rubella virus, Simian Immunodeficiency viruses, and any combination thereof.

In embodiments of this aspect and other aspects described herein, a target cell can be of any cell type or any tissue type from any species (e.g., animal, mammal, plant, insect, and/or microbes). In some embodiments, the target cell can be of any cell type (e.g., but not limited to, somatic cells, stem cells (e.g., naturally existing stem cells or derived stem cells such as iPSCs), germ cells, bone marrow cells, adipose cells, dermal cells, epidermal cells, epithelial cells, connective tissue cells, fibroblasts, muscle cells, cartilage cells, chondrocytes, ocular cells, follicle cells, buccal cells, neuronal cells, reproductive cells, and/or blood cells), or of any tissue type (e.g., but not limited to, lung, liver, colon, heart, skin, brain, gastrointestinal, bone, and/or breast) from a mammalian subject. For example, a mammalian subject can be a human subject.

In embodiments of this aspect and other aspects described herein, a target cell can be a cell from any source (e.g., in vitro, in vivo, ex vivo, environmental source). In some embodiments, the target cell can be collected or derived from a test sample. For example, in one embodiment, the target cell can be a cell collected from a test sample. In another embodiment, the target cell can be a cell reprogrammed or differentiated from a cell collected or derived from a test sample. For example, the target cell can be a stem cell that exists in a test sample, or a stem cell derived or reprogrammed from a somatic cell (e.g., but not limited to, a fibroblast) collected from a test sample. In some embodiments, the target cell can be an induced pluripotent stem cell (iPSC). In some embodiments, the target cell can be a mature cell. The mature cell can be collected from a test sample, or differentiated from a progenitor cell collected from a test sample.

Various types of pluripotent stem cells and precursor cells (e.g., ES cell, somatic stem cells, hematopoietic stem cells, leukemic stem cells, skin stem cells, intestinal stem cells, gonadal stem cells, brain stem cells, muscle stem cells (muscle myoblasts, etc), mammary stem cells, neural stem cells (e.g., cerebellar granule neuron progenitors, etc.), and various stem cell or precursor cells (e.g., those described in Table 1 of Sparmann & Lohuizen, Nature 6, 2006 (Nature Reviews Cancer, November 2006), incorporated herein by reference), as well as in vitro and in vivo derived stem cells, such as induced pluripotent stem cells (iPSC) as well as terminally differentiated cells) can be used in the methods, systems and/or kits described herein.

In embodiments of this aspect and other aspects described herein, a target cell can be a cell from any state (e.g., normal healthy, mutant, diseased, malignant, differentiated, partially-differentiated, and/or undifferentiated). In some embodiments, the target cell can be a normal healthy cell. In some embodiments, the target cell can be a diseased cell. In some embodiments, the target cell can be a cancer cell or cancer stem cell.

In some embodiments of this aspect and other aspects described herein, a target cell can be an unknown cell or uncharacterized cell. For example, a cell of unknown tissue type, unknown species, unknown developmental stage and the like, can be subjected to the methods described herein so as to identify or characterize the cell.

In some embodiments of this aspect and other aspects described herein, a target cell can be a cell after a treatment. In some embodiments, the target cell amenable to the methods described herein can be a cell that has been contacted with a perturbagen. A perturbagen can be an agent that can produce an effect (e.g., a beneficial/therapeutic effect or adverse/toxic effect) on a recipient cell, and includes, for example, but is not limited to, proteins, peptides, nucleic acids (e.g., RNA, DNA, siRNA, snRNA), aptamers, small molecules, toxins, therapeutic agents, nutraceuticals, environmental stimuli (e.g., pressure, hypoxia, humidity, light, temperature (e.g., extremes in high and low temperatures), radiation), microbes, and any combinations thereof. In these embodiments, a test sample comprising a target cell can be collected at a first time point prior to treatment with a perturbagen or after the target cell has been contacted with the perturbagen. In some embodiments, a test sample comprising the target cell can be collected at a second time point after the target cell has been contacted with the perturbagen, wherein the second time point is subsequent to the first time point.

In some embodiments where the target cell has been treated with a perturbagen, the method described herein to identify the physiological state of the target cell can indicate or determine the effect of the perturbagen on the target cell. For example, based on the trajectory of the locus corresponding to a target cell, and/or the magnitude of the deviation of the locus corresponding to the target cell from the reference loci corresponding to a normal healthy state, and/or the magnitude of the deviation of the locus corresponding to the target cell from a locus corresponding to the target cell prior to the exposure to the perturbagen, the resulting physiological state of the target cell after the treatment can determine the effect of the perturbagen on the target cell.

In some embodiments where the perturbagen shows a therapeutic effect on the target cell, e.g., based on the locus corresponding to the target cell contacted with the perturbagen with a deviation from the reference loci corresponding to a normal healthy state being smaller than that of a locus corresponding to the target cell not contacted with the perturbagen, the method can further comprise selecting the perturbagen as a candidate for further therapeutic evaluation. In some embodiments, when the locus corresponding to the target cell contacted with the perturbagen deviates from the reference loci corresponding to a normal healthy state by no more or less than 30% (e.g., no more or less than 20%, no more or less than 10%, no more or less than 5% or lower), the method can further comprise selecting the perturbagen as a candidate for further therapeutic evaluation.

The test sample comprising the target cell can be collected or derived from a cell culture, a subject and/or an environmental source. In some embodiments, the test sample comprising the target cell can be collected or derived from a subject. In some embodiments, the subject can be a mammalian subject such as a human subject. In some embodiments, the subject can be a normal healthy subject, or a subject determined to have, or have a risk for, a condition (e.g., a disease or disorder). In some embodiments, a target cell collected or derived from a subject is an iPSC, where the subject is a normal subject, or a subject determined to have, or be risk of having a disease or disorder.

In some embodiments where the subject is determined to have, or have a risk for, a condition (e.g., a disease or disorder), the method described herein to identify the physiological state of the subject's cell (target cell) can further provide a diagnosis of the condition (e.g., a disease or disorder) or a state of the condition (e.g., a disease or disorder) in the subject. For example, based on the trajectory of the locus corresponding to the subject's cell, and/or the magnitude of the deviation of the locus corresponding to the subject's cell from reference loci corresponding to a normal healthy state, a specific condition, and/or various states of the specific condition, the type and/or state of the condition of the subject can be diagnosed, e.g., relative to the reference loci.

In some embodiments, the method can further comprise administering to the subject a treatment regimen after the diagnosis. For example, if a subject is diagnosed to have cancer, an anti-cancer agent (including, e.g., but not limited to, chemotherapeutics, surgery to remove the tumor, radiation, and/or cancer immunotherapy) can be administered to the subject.

By way of example only, in some embodiments where the subject is diagnosed to have cancer, the method described herein to identify the physiological state of the subject's cancerous cell (target cell) can further identify the primary tissue origin of the cancerous cell (e.g., to identify whether the tissue biopsy sample is of a primary tumor or a secondary tumor (metastasis)). For example, based on the vicinity of the locus corresponding to the subject's cancerous cell relative to reference loci corresponding to various tissue phenotypes (e.g., but not limited to, bones, brain, and breast), the primary tissue origin and/or degree of malignancy of the subject's tumor can be identified. For example, if the cancer cells isolated from the bone of a subject display a locus on an expression atlas in closer vicinity to reference loci corresponding to a breast tissue than to a bone tissue, this indicates that the cancer cells isolated from the bone are more likely to be of a breast tissue origin than a bone tissue origin. This further indicates that the cancer cells isolated from the bone are not from a primary tumor, but are metastasized from the breast tissue. On the other hand, if the cancer cells isolated from the bone of a subject display a locus on an expression atlas in closer vicinity to reference loci corresponding to a bone tissue than to any other tissue, this indicates that the cancer cells isolated from the bone are from a primary tumor.

In some embodiments where the subject is being administered with a treatment regimen, the method described herein to identify the physiological state of the subject's cell (target cell) can determine the efficacy effect of the treatment regimen. For example, based on the trajectory of the locus corresponding to the subject's cell, and/or the magnitude of the deviation of the locus corresponding to the subject's cell from reference loci corresponding to a normal healthy state, and/or the magnitude of the deviation of the locus corresponding to the subject's cell from a locus corresponding to the subject's cell prior to the initiation of the therapeutic regime, the efficacy effect of the treatment regimen can be determined By way of example only, if the trajectory of the locus corresponding to the subject's cells' physiological state change over the course of the treatment regimen points toward a normal healthy state, this indicates that the treatment regimen is effective. Similarly, if the locus corresponding to the subject after treatment moves away from the locus corresponding to the subject prior to treatment and also toward a normal healthy state, this indicates that the treatment regimen is effective. On the other hand, if the locus corresponding to the subject after treatment does not tend to move toward reference loci corresponding to a normal healthy state, this indicates that the treatment regimen is not effective. In these embodiments, the method can further comprise selecting for, and optionally administering to, the subject an alternative treatment regimen, or adjusting the subject's treatment regimen, e.g., by increasing the administration frequency and/or dosage, based on the identified physiological state of the subject′ cell relative to a normal healthy cell.

### Normalized Expression Atlases and Methods of Construction

The normalized expression atlas used in the methods and systems of various aspects described herein is generally a graphical representation of covariances between different biochemical expression measurements across the reference samples. The biochemical expression measurements of the references samples are normalized, e.g., to improve cross-data series comparability. In some embodiments, the normalized expression atlas is a 2-coordinate graphical representation, in which the location of each reference sample is defined by 2 coordinates on the graph, and the relative positions of the points (reference loci) to each other represent the similarities and differences in biochemical expression measurements between the reference samples. See, e.g., FIGS. 5A-5B, or FIGS. 9A-9D for examples of normalized expression atlas. For example, the closer the two points (each corresponding to a sample) on a normalized expression atlas, the more similarities are shared by the two samples.

Reference samples and reference phenotypes: Biochemical expression measurements of reference samples can be obtained from expression array datasets that are electronically or digitally recorded and publicly available through public repositories such as National Center for Biotechnology Information (NCBI's) Gene Expression Omnibus (GEO), scientific publications, and/or the Concordia database, which contains 3,209 Affymetrix human tissue or cultured human cell lines) extracted from NCBI's GEO. A full description of the techniques used to assemble the Concordia database can be found, e.g., in Example 1 and Schmid P R et al. 2012 PNAS 109: 5594, and U.S. Patent App. No. 2011/0047169, the contents of which are incorporated herein in its entirety by reference, and the curated phenotype data are available for public download at the Concordia database website (accessible at http://concordia.csail.mit.edu). Additionally or alternatively, biochemical expression measurements of reference samples can be obtained from experimentation (e.g., but not limited to, microarrays or sequencing). In some embodiments, the expression array datasets can include biochemical expression measurements, and text descriptions relating to each sample (including, e.g., title, description such as phenotypes, and source fields).

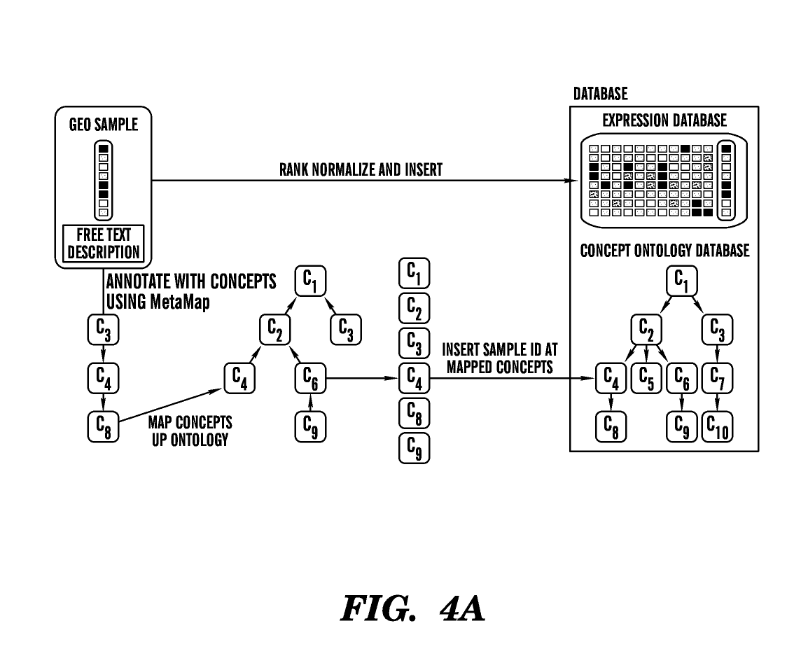

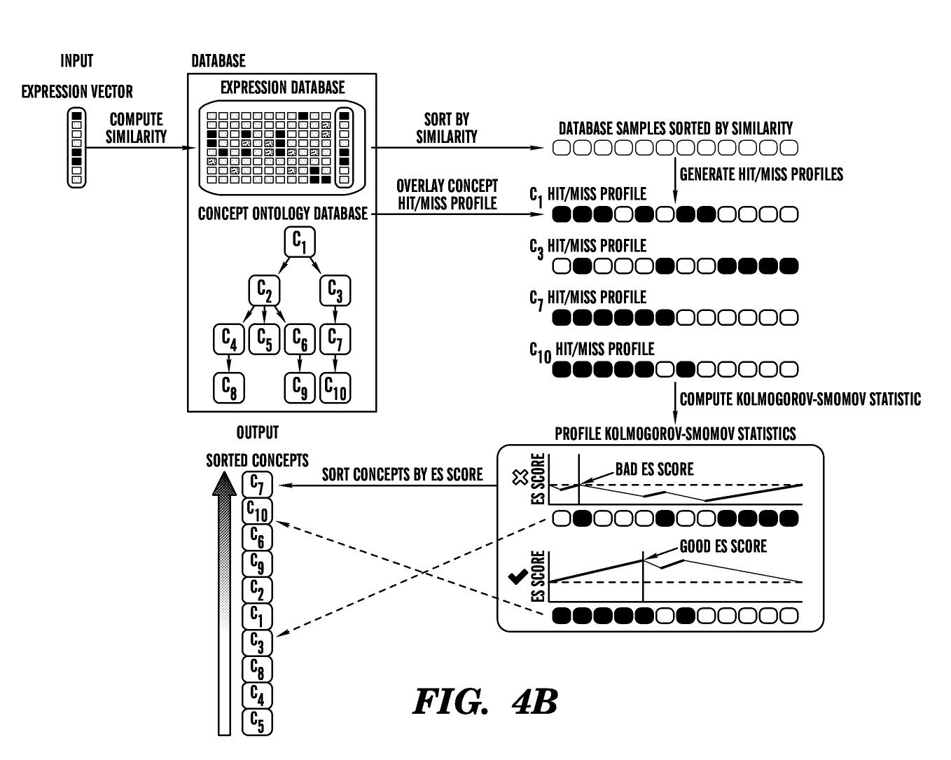

In order to identify reference datasets or samples that comprise relevant biochemical expression measurements to construct a normalized expression atlas specific for a certain application, in some embodiments, a Concordia system comprising a database of biological samples (e.g., cell culture and/or primary cell samples) mapped to a structured ontology can be used. In some embodiments, the National Laboratory of Medicine's Unified Medical Language System (UMLS) can be used to develop a database of biological samples mapped to various medical or biological concepts, such as diseases or disorders, e.g., “cancer.” Methods for constructing and searching in a Concordia database are described in Example 1 (FIGS. 4A-4B) and U.S. Patent Appl. No. US 2011/0047169, the content of which is incorporated herein in its entirety by reference.

The size of the data compendium comprising different biochemical expression measurements can vary with data availability, user′ preferences and/or applications of the normalized expression atlas. In some embodiments, the number of the biochemical expression measurements selected for construction of the normalized expression atlas can be at least about 10 for each of the reference samples (e.g., expression measurements of 10 genes, proteins, and/or metabolites for each reference sample), including, e.g., at least about 20, at least about 30, at least about 40, at least about 50, at least about 60, at least about 70, at least about 80, at least about 90, at least about 100, at least about 250, at least about 500, at least about 1000, at least about 1500, at least about 2000, at least about 2500, at least about 5000, at least about 10,000 or more, for each reference sample. In some embodiments, the number of the biochemical expression measurements selected for construction of the normalized expression atlas can be about 1000 to about 100,000 for each of the reference samples, or about 2500 to about 75,000 for each of the reference samples, or about 5000 to about 50,000 for each of the reference samples. Thus, the position of each reference loci on the normalized expression atlas represents the state of each reference sample relative to others based on a set of biochemical expression measurements selected to characterize the reference sample.

In some embodiments, the number of reference samples used to construct the normalized expression atlas can be at least about 50 or more, e.g., at least about 100, at least about 200, at least about 300, at least about 400, at least about 500, at least about 1000, at least about 2000, at least about 3000, at least about 4000, at least about 5000, or more.

Each subject has a distinct biochemical expression profile, e.g., due to their different genetic and environmental backgrounds. Thus, there are usually variations in biochemical expression measurements even between two reference samples with similar phenotypes. Such inter-subject variability can be accounted for by including in a normalized expression atlas a large number of reference loci corresponding to a population of subjects with the same phenotype of interest. The reference loci form a cluster on the normalized expression atlas and define the boundary and/or spread for the phenotype of the interest. For example, as shown in FIG. 9A, each cluster of reference loci represent a different cell type.

Depending on applications/purposes of the methods described herein (e.g., to monitor differentiation progress of a stem cell, and/or to identify a specific condition associated with a cell), the normalized expression atlas can include any number and/or any characteristics of phenotypes that are sufficient to identify the physiological state of the cell. In some embodiments, the set of the reference phenotypes selected for the normalized expression atlas can comprise at least about 5 phenotypes, at least about 10 phenotypes, at least about 20 phenotypes, at least about 30 phenotypes, at least about 40 phenotypes, at least about 50 phenotypes, at least about 60 phenotypes, at least about 70 phenotypes, at least about 80 phenotypes, at least about 90 phenotypes, at least about 100 phenotypes, at least about 150 phenotypes, at least about 200 phenotypes, at least about 300 phenotypes, at least about 400 phenotypes or more.

In some embodiments, at least a subset of the reference phenotypes can be associated with cell or tissue types. Examples of cell types can include, but are not limited to, somatic cells, stem cells (e.g., naturally existing stem cells and/or derived stem cells such as iPSCs), germ cells, bone marrow cells, adipose cells, dermal cells, epidermal cells, epithelial cells, connective tissue cells, fibroblasts, muscle cells, cartilage cells, chondrocytes, ocular cells, follicle cells, buccal cells, neuronal cells, reproductive cells, blood cells, or any combinations thereof. The cells can be cultured cells and/or primary cells. Examples of tissue types can include, but are not limited to, lung, liver, kidney, colon, heart, skin, brain, gastrointestinal, bone, blood, breast and/or any combinations thereof. By way of example only, as shown in FIGS. 9A-9D, the normalized expression has subsets of reference phenotypes associated with various cell types, e.g., but not limited to, normal cells, precursor cells, immortalized cell, malignant cells, mesenchymal cell, pluripotent stem cells. In addition, the normalized expression in FIGS. 9A-9D has subsets of references phenotypes associated with various tissue types, e.g., but not limited to, hematopoietic, neural, breast, and colon.

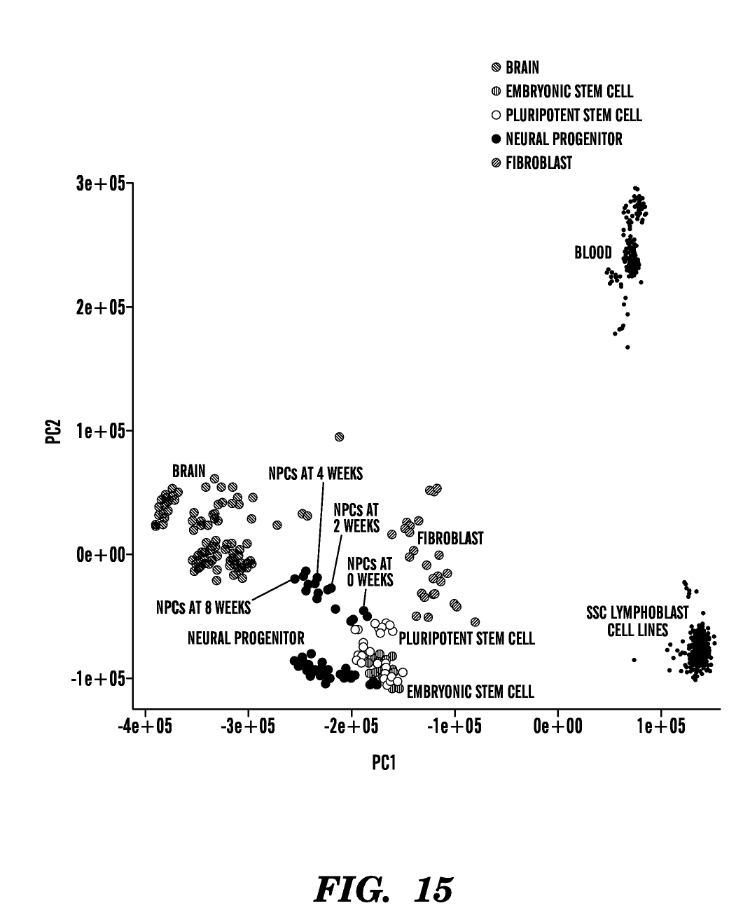

In some embodiments, at least a subset of the reference phenotypes can be associated with developmental states of a cell type or tissue types. For example, FIG. 15 shows a time-course normalized expression atlas comprising subsets of the reference phenotypes associated with primary neuronal cultures (e.g., neural progenitor cells (NPC)) as a function of culture duration (NPCs at 0, 2, 4, and 8 weeks). Notably, the gene expression signature of NPs is consistently shifting towards the brain tissue as a function of days in culture and neural differentiation.

In some embodiments, at least the subset of the reference phenotypes can be associated with a condition (e.g., disease or disorder) or a known state of the condition (e.g., disease or disorder). For example, in one embodiment, at least a subset of the reference phenotypes can be associated with cancer in different tissues (e.g., but not limited to, breast cancer, lung cancer, colon cancer, brain cancer, head and neck cancer, prostate cancer, skin cancer, pancreatic cancer, bone cancer, and/or blood-related cancer, e.g., leukemia). In some embodiments, at least a subset of the reference phenotypes can be associated with stages of cancer. For example, for breast cancer, at least a subset of the reference phenotypes can be associated with DCIS (ductal carcinoma in situ), invasive breast cancer, metastatic breast cancer, or more specifically breast tumors from stages 0-IV.

In some embodiments, at least the subset of the reference phenotypes can be associated with a normal healthy state. The term “normal healthy state” refers to a state without any symptoms of any diseases or disorders, or not identified with any diseases or disorders, or not on any medication treatment, or a state that is identified as healthy by skilled practitioners based on examinations, e.g., microscopic examination on cells from a biopsy.

In some embodiments, at least the subset of the reference phenotypes can be associated with a known effect of a perturbagen in contact with the reference cells. By way of example only, at least a subset of the reference phenotypes can be associated with cancer cells treated with various therapeutic agents (e.g., but not limited to, chemotherapeutics, cancer immunotherapy, and/or X-ray).

The reference samples can be obtained from cell cultures or a biological sample from animal models (e.g., but not limited to, mice, rat, pigs, rabbits, and the like) or human subjects (of any age or race), e.g., a biopsy from patients diagnosed with a specific condition. In some embodiments, the reference samples can be obtained from a tissue bank.

Construction of a Normalized Expression Atlas (Including a Time-Course Expression Atlas):

The expression array datasets, e.g., from GEO or Concordia, can be used to construct a normalized expression atlas that reflects a plurality of reference loci corresponding to a set of reference phenotypes associated with reference samples, wherein each of the reference loci is determined based on a compendium of covariance measurements determined between different biochemical expression measurements across the reference samples.

In some embodiments, normalization of expression data obtained from public repositories such GEO and/or scientific publications can be performed to improve cross-data comparability. Different software and algorithms for data normalization are known in the art. For example, in one embodiment, the expression data can be normalized via R's BioConductor package. The resulting probe set intensities are averaged into unique values, e.g., gene-centric values, and then rank normalized to improve cross-data series comparability. The calculations can be performed in the R statistical environment, employing the BioConductors suite. See, e.g., R Development Core Team “R: A language and environment for statistical computing.” Vienna, Austria 2007; and Gentleman R C et al. “Bioconductor: open software development for computational biology and bioinformatics.” Genome Biol 2004, 5: R80, the content of which is incorporated herein by reference, for exemplary methods of data normalization.

To construct a normalized expression atlas as described herein, a non-parametric mathematical method that can (i) analyze a compendium of datasets comprising multivariate biochemical expression measurements, (ii) identify specific biochemical species (e.g., a subset of genes) that are relevant to distinguish the reference samples by phenotypes and (iii) express such information in a way as to highlight the similarities and difference among samples, can be used herein.

In some embodiments, the method described herein can further comprise constructing a normalized expression atlas. In some embodiments, the normalized expression atlas can be constructed by implementing, in a specifically-programmed computer, an algorithm comprising principal component analysis on a compilation of at least a subset of biochemical expression measurements determined from the reference samples. The principal component analysis is a mathematical technique known to a skilled artisan for use to compress a multi-dimensional data set by identifying a pattern among components in the data set, followed by transformation of the data to a normalized coordinate system, such that a linear combination of the selected components (e.g., a subset of genes) contributing to the greatest variance of the data set becomes the first principal component (e.g., x-coordinate axis), while the subsequent principal component(s), e.g., the second principal component, can be selected to be orthogonal to the prior principal component (e.g., the first principal component). In some embodiments, the principal component analysis can comprise selecting at least the first two principal components of at least the subset of biochemical expression measurements determined from the reference samples. See, e.g., Abdi H. and Williams L. J. “Principal Component Analysis” Wiley Interdisciplinary Reviews: Computational Statistics. Vol. 2. Issue 4. Page 433-459 (2010) and Lay, David (2000) Linear Algebra and Its Applications. Addision-Wesley, New York; and Kohane I S et al “Microarrays for an Integrative Genomics” Cambridge, Mass., USA: MIT Press (2002), the contents of which are incorporated herein by reference, for information on principal component analysis and how to construct a normalized expression atlas using principal component analysis as well as projection of new data onto the principal components.

In some embodiments, at least the subset of biochemical expression measurements used in construction of the normalized expression atlas can correspond to a set of biochemical expression signatures for a target phenotype. As used herein, the term “biochemical expression signature” generally means a biochemical species present in a sample that can be used to indicate a target phenotype. The biochemical expression signatures for a target phenotype can be identified by any statistical approaches known in the art. In some embodiments, a subset of biochemical expression signatures that characterize a target phenotype can be identified in the context of broad biochemical expression landscapes (e.g., broad transcriptomic landscapes), and not in the context of dichotomous classes. For example, instead of defining a biochemical expression signature as one that is over- or underexpressed in a case vs. control study using methods akin to t-tests, a biochemical expression signature can be defined as a biochemical species (e.g., gene, molecule) that has a “localized” expression signature for a phenotype, i.e., how grouped together are all of the samples corresponding to that phenotype for that biochemical species (e.g., gene). If all of the samples for a phenotype have a very similar expression level (all high, all low, etc., e.g., expression levels within 50% of each other), the biochemical species (e.g., gene, molecule) can be considered as a biochemical expression signature for that phenotype.

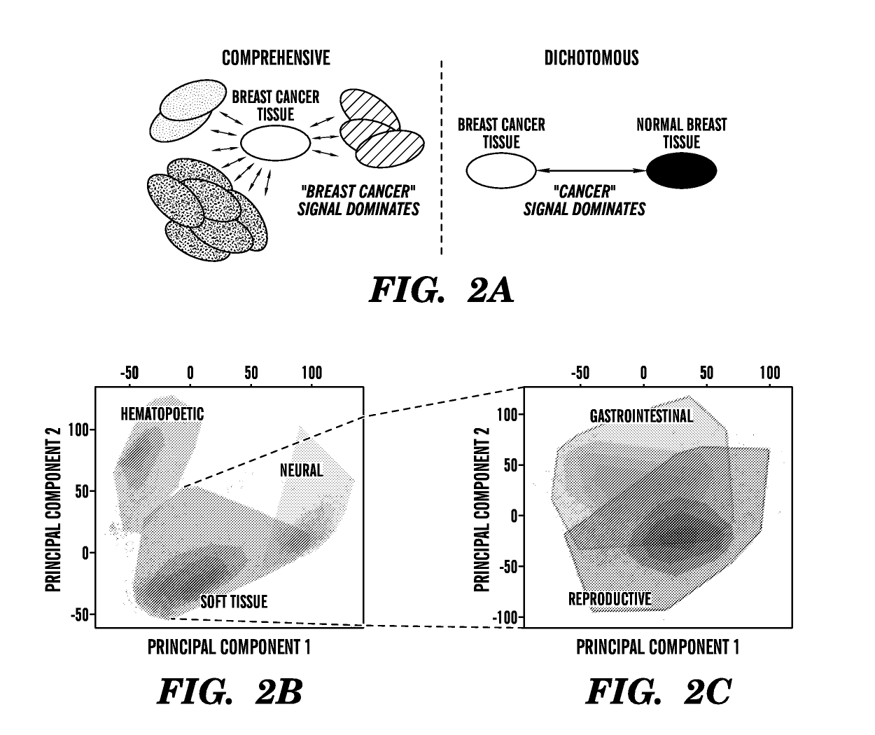

For example, FIG. 2A is a schematic representation showing that comprehensive perspective on expression analysis can permit the elucidation of biological signals (biochemical expression signatures) that are thematically coherent but provide an alternative view to traditional dichotomous approaches. For example, the gene-signature (an example of biochemical expression signature) for “breast cancer” is enriched for breast specific development and carbohydrate and lipid metabolism in the comprehensive approach, as opposed to being dominated by a more general “cancer” signal. By analyzing a given phenotype in the context of this comprehensive transcriptomic landscape, the need for predefined control groups and presupposed relationships between phenotypes can be circumvented.

Accordingly, in some embodiments, the set of biochemical expression signatures for a target phenotype can be identified in silico based on distributions of biochemical expression intensities across the reference samples. In some embodiments, the set of biochemical expression signatures for the target phenotype can be determined by an in silico process comprising employing a finite impulse response filter (FIRF) on each biochemical expression measurements across the database of diverse expression samples to quantify the degree of expression level localization for a given phenotype. To generate the set of biochemical expression signatures relevant to a phenotype, the localization scores for biochemical species can be used to rank all biochemical species (e.g., gene) and then the cutoff for the number of biochemical species (e.g., gene) to include can be identified by balancing the set's ability to accurately classify samples of its own phenotype while minimizing the presence of non-phenotype specific signal. See, e.g., Examples 1 and 2 herein as well as McClellan J H et al. “DSP First: a multimedia approach” Prentice Hall, Englewood Cliffs, N.J. (1998), contents of which are incorporated herein by reference, for details on finite impulse response filter and methods of using the same to identify biochemical expression signatures from a database of diverse expression samples that represent a target phenotype. In some embodiments, the identified biochemical expression signatures can then used to identify relevant biochemical expression measurement datasets for construction of the normalized expression atlas.

The finite impulse response filter is a signal-processing tool. For each biochemical species s (e.g., a gene, or molecule), phenotype p pair, all of the expression samples can be sorted by their expression intensities for s. Using a “sliding window” of size equal to the number of samples corresponding to p, the fraction of samples in that window that are associated with p was computed. The value is 1 if all samples in the window are associated with p, and 0 if none of them are. This window is iteratively moved across the sorted list of samples to obtain a value for all positions. The score of a biochemical expression signature for a particular gene-phenotype pair is the maximum value that is achieved in any of the windows. A p-value is computed for each score using a binomial distribution.

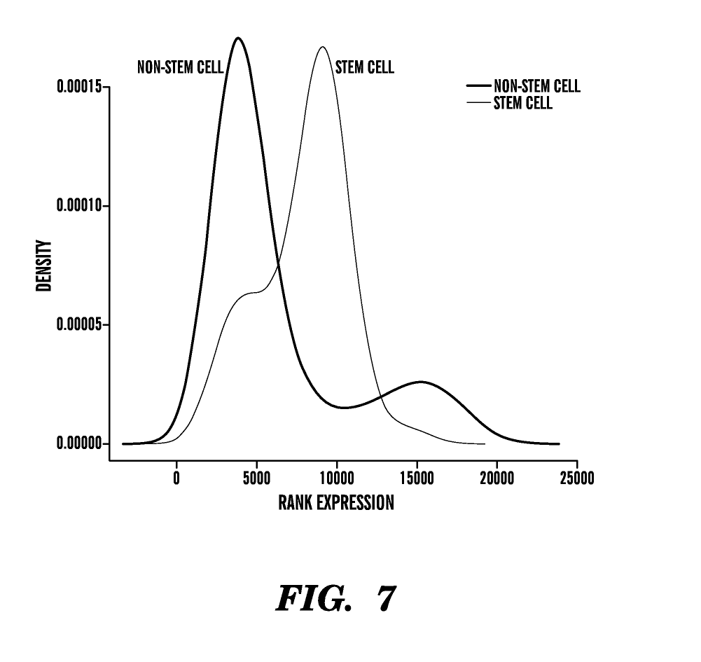

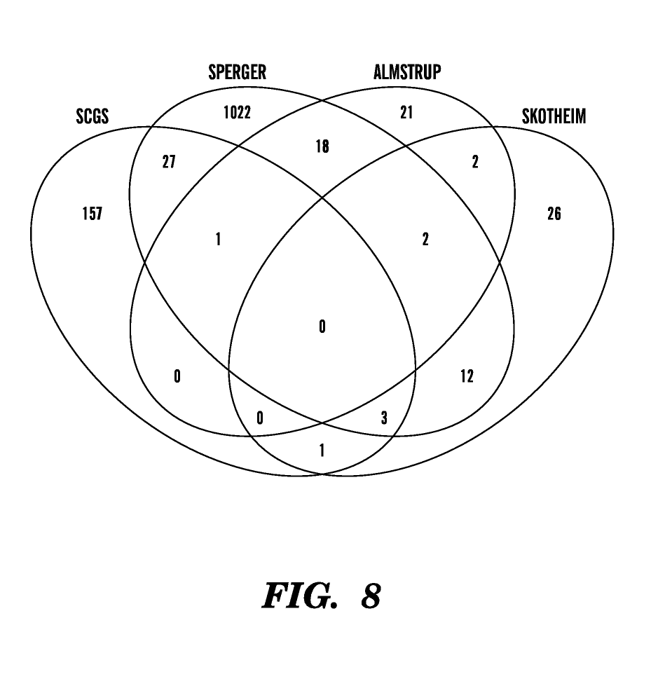

In contrast to a standard t-test, this approach does not require defining a specific “control” phenotype against which is tested for separation. Moreover, the FIRF method described herein can identify biochemical species (e.g., genes) with expression levels that are highly specific for a target phenotype in the samples, allowing for the diverse population of samples without the target phenotype to express these biochemical species at simultaneously higher and lower levels (something for which a t-test cannot directly account). For example, as shown in FIG. 7, the gene DBC1 exhibits a highly specific range of expression across the stem cell samples, and ranked highly (among the top 0.5% of all genes) in its ability to localize the stem cell samples by the described method. However, the non-stem cell samples demonstrate both higher and lower expression levels of this gene, causing a standard Student's t-test (treating all non-stem cell samples as the control group) to rank this gene at only the 24.6% strongest among all genes.

### Test Sample

In accordance with various embodiments described herein, a test sample, including any fluid or specimen (processed or unprocessed) or other biological sample, can be subjected to an assay or method, kit and system described herein. The test sample or fluid can be liquid, supercritical fluid, solutions, suspensions, gases, gels, slurries, and combinations thereof. The test sample or fluid can be aqueous or non-aqueous.

In some embodiments, the test sample can include a biological fluid obtained from a subject. Exemplary biological fluids obtained from a subject can include, but are not limited to, blood (including whole blood, plasma, cord blood and serum), lactation products (e.g., milk), amniotic fluids (e.g., a sample collected during amniocentesis), sputum, saliva, urine, semen, cerebrospinal fluid, bronchial aspirate, perspiration, mucus, liquefied feces, synovial fluid, lymphatic fluid, tears, tracheal aspirate, and fractions thereof. In some embodiments, a biological fluid can include a homogenate of a tissue specimen (e.g., biopsy) from a subject. In one embodiment, a test sample can comprises a suspension obtained from homogenization of a solid sample obtained from a solid organ or a fragment thereof.

In some embodiments, a test sample can be obtained from a normal healthy subject. In other embodiments, a test sample can be obtained from a subject who has or is suspected of having a disease or disorder, e.g., a condition afflicting a tissue, or who is suspected of having a risk of developing a disease or disorder, e.g., a condition afflicting a tissue. Various examples of diseases or disorders are described herein. In some embodiments, the test sample can be obtained from a subject who has or is suspected of having cancer, or who is suspected of having a risk of developing cancer. In some embodiments, the test sample can be obtained from a subject who has or is suspected of having a neurodegenerative disorder, or who is suspected of having a risk of developing neurodegenerative disorder.

In some embodiments, a test sample can be obtained from a subject who is being treated for the disease or disorder. In other embodiments, the test sample can be obtained from a subject whose previously-treated disease or disorder is in remission. In other embodiments, the test sample can be obtained from a subject who has a recurrence of a previously-treated disease or disorder. For example, in the case of cancer such as breast cancer or pancreatic cancer, a test sample can be obtained from a subject who is undergoing a cancer treatment, or whose cancer was treated and is in remission, or who has cancer recurrence.

As used herein, a “subject” can mean a human or an animal Examples of subjects include primates (e.g., humans, and monkeys). Usually the animal is a vertebrate such as a primate, rodent, domestic animal or game animal Primates include chimpanzees, cynomologous monkeys, spider monkeys, and macaques, e.g., Rhesus. Rodents include mice, rats, woodchucks, ferrets, rabbits and hamsters. Domestic and game animals include cows, horses, pigs, deer, bison, buffalo, feline species, e.g., domestic cat, canine species, e.g., dog, fox, wolf, and avian species, e.g., chicken, emu, ostrich. A patient or a subject includes any subset of the foregoing, e.g., all of the above, or includes one or more groups or species such as humans, primates or rodents. In certain embodiments of the aspects described herein, the subject is a mammal, e.g., a primate, e.g., a human. The terms, “patient” and “subject” are used interchangeably herein. A subject can be male or female. The term “patient” and “subject” does not denote a particular age. Thus, any mammalian subjects from adult to newborn subjects, as well as fetuses, are intended to be covered.

In one embodiment, the subject or patient is a mammal. The mammal can be a human, non-human primate, mouse, rat, dog, cat, horse, or cow, but are not limited to these examples. In one embodiment, the subject is a human being. In another embodiment, the subject can be a domesticated animal and/or pet.

In some embodiments, the test sample can include a fluid or specimen obtained from an environmental source, e.g., but not limited to, food products or industrial food products, food produce, poultry, meat, fish, beverages, dairy products, water supplies (including wastewater), surfaces, ponds, rivers, reservoirs, swimming pools, soils, food processing and/or packaging plants, agricultural places, hydrocultures (including hydroponic food farms), pharmaceutical manufacturing plants, animal colony facilities, and any combinations thereof.

In some embodiments, the test sample can include a fluid (e.g., culture medium) from a biological culture. Examples of a fluid (e.g., culture medium) obtained from a biological culture includes the one obtained from culturing or fermentation, for example, of single- or multi-cell organisms, including prokaryotes (e.g., bacteria) and eukaryotes (e.g., animal cells, plant cells, insect cells, yeasts, fungi), and including fractions thereof. In some embodiments, the test sample can include a fluid from a blood culture. In some embodiments, the culture medium can be obtained from any source, e.g., without limitations, research laboratories, pharmaceutical manufacturing plants, hydrocultures (e.g., hydroponic food farms), diagnostic testing facilities, clinical settings, and any combinations thereof.

In some embodiments, the test sample can include a media or reagent solution used in a laboratory or clinical setting, such as for biomedical and molecular biology applications. As used herein, the term “media” refers to a medium for maintaining a tissue, an organism, or a cell population, or refers to a medium for culturing a tissue, an organism, or a cell population, which contains nutrients that maintain viability of the tissue, organism, or cell population, and support proliferation and growth.

As used herein, the term “reagent” refers to any solution used in a laboratory or clinical setting for biomedical and molecular biology applications. Reagents include, but are not limited to, saline solutions, PBS solutions, buffered solutions, such as phosphate buffers, EDTA, Tris solutions, and any combinations thereof. Reagent solutions can be used to create other reagent solutions. For example, Tris solutions and EDTA solutions are combined in specific ratios to create “TE” reagents for use in molecular biology applications.

### Systems, e.g., for Identifying a Physiological State of a Target Cell

Embodiments of a further aspect also provide for systems (and non-transitory computer readable media for causing computer systems) to, e.g., identify a physiological state of a target cell, and/or to perform the methods of various aspects described herein.

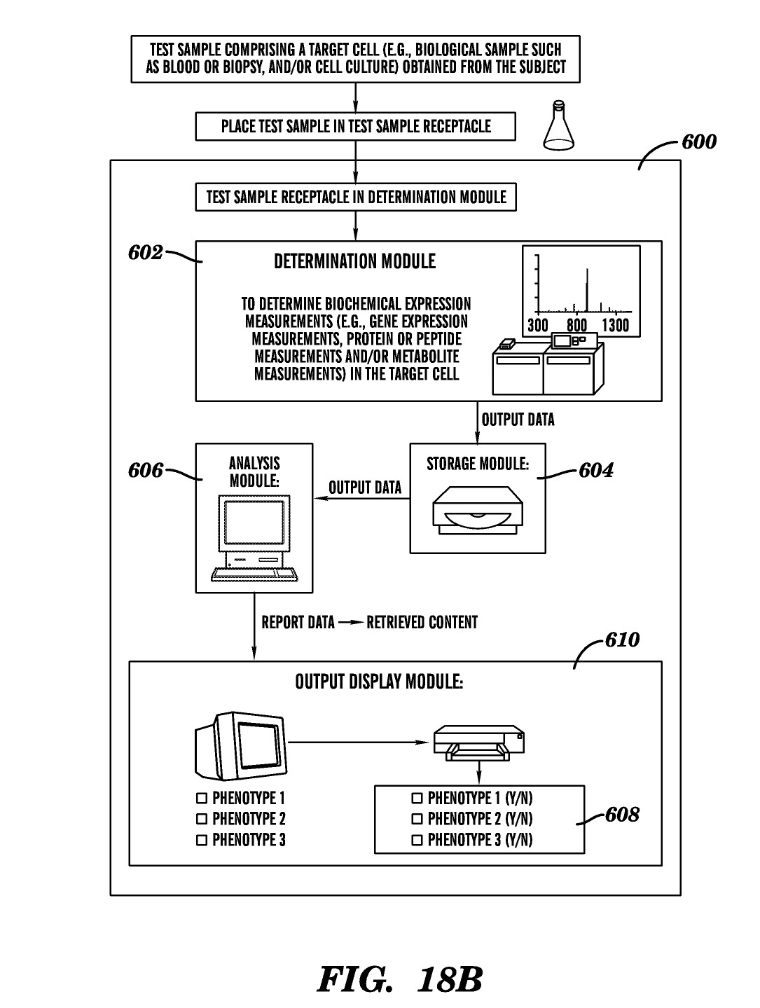

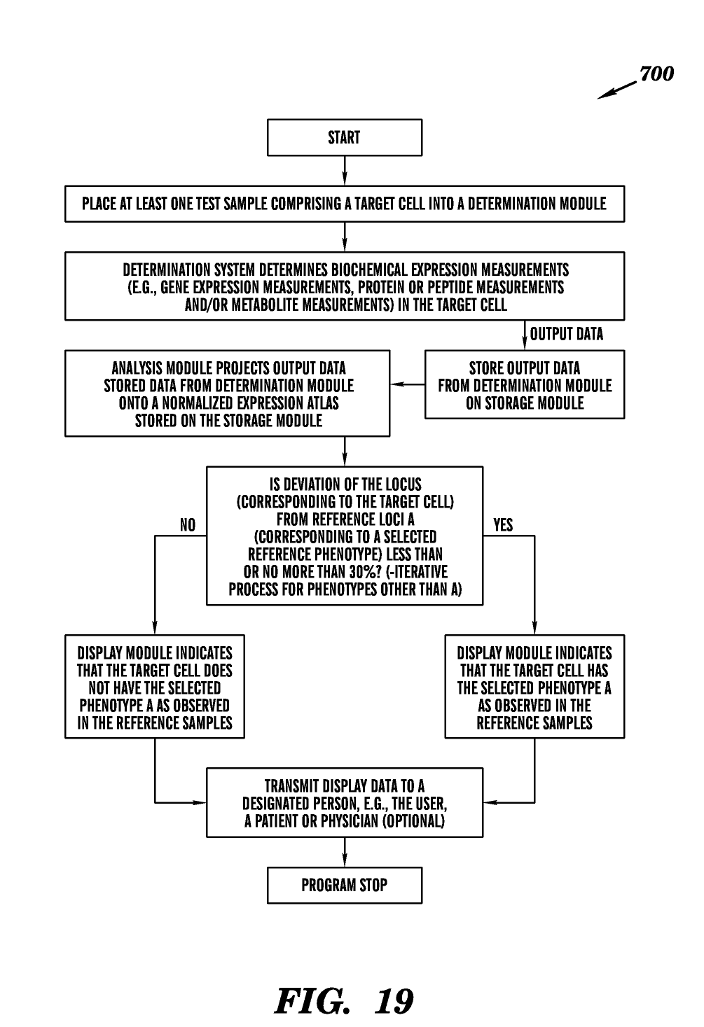

FIG. 18A depicts a device or a computer system 600 comprising one or more processors 630 and a memory 650 storing one or more programs 620 for execution by the one or more processors 630.

In some embodiments, the device or computer system 600 can further comprise a non-transitory computer-readable storage medium 700 storing the one or more programs 620 for execution by the one or more processors 630 of the device or computer system 600.

In some embodiments, the device or computer system 600 can further comprise one or more input devices 640, which can be configured to send or receive information to or from any one from the group consisting of: an external device (not shown), the one or more processors 630, the memory 650, the non-transitory computer-readable storage medium 700, and one or more output devices 660.

In some embodiments, the device or computer system 600 can further comprise one or more output devices 660, which can be configured to send or receive information to or from any one from the group consisting of: an external device (not shown), the one or more processors 630, the memory 650, and the non-transitory computer-readable storage medium 700.

In some embodiments, the device or computer system 600 for identifying a physiological state of a target cell or a population of cells comprises:
one or more processors; and
memory to store one or more programs, the one or more programs comprising instructions for:
(i) projecting onto a normalized expression atlas an expression vector reflecting at least a subset of the biochemical expression measurements, e.g., stored on a storage device, thereby locating the locus corresponding to a target cell (or loci corresponding to a population of cells) on the normalized expression atlas; wherein the normalized expression atlas reflects a plurality of reference loci, said plurality of reference loci corresponding to a set of reference phenotypes associated with reference samples, wherein each of the reference loci is determined based on a compendium of covariance measurements determined between different biochemical expression measurements across the reference samples; and
(ii) determining deviation of the locus corresponding to the target cell (or loci corresponding to the population of cells) from the reference loci corresponding to at least one selected reference phenotype, wherein the magnitude of the deviation indicates degree of similarity between the physiological state of the target cell and said at least one selected reference phenotype, thereby identifying the physiological state of the target cell relative to said at least one selected reference phenotype; and
(iii) displaying a content based in part on the data output from (ii), wherein the content comprises a signal indicative of the presence of at least one selected reference phenotype in the target cell or population of cells, a signal indicative of the absence of said at least one selected reference phenotype in the target cell or population of cells, a signal indicative of the deviation of the locus corresponding to the target cell (or loci corresponding to the population of cells) from the reference loci, or any combinations thereof.

FIG. 18B depicts a device or a system 600 (e.g., a computer system) for obtaining data from at least one test sample obtained from at least one subject is provided. The system can be used for identifying a physiological state of a target cell or a population of cells. The system comprises:
(a) at least one determination module 602 configured to receive said at least one test sample and perform at least one assay on said at least one test sample comprising a target cell to determine biochemical expression measurements;
(b) at least one storage device 604 configured to store the biochemical expression measurements of said at least one test sample determined from said determination module, and further configured to provide a normalized expression atlas reflecting a plurality of reference loci, said plurality of reference loci corresponding to a set of reference phenotypes associated with reference samples, wherein each of the reference loci is determined based on a compendium of covariance measurements determined between different biochemical expression measurements across the reference samples;
(c) at least one analysis module 606 configured to perform the following:
   projecting onto the normalized expression atlas an expression vector reflecting at least a subset of the biochemical expression measurements determined from said at least one determination module, thereby locating the locus corresponding to the target cell on the normalized expression atlas;
   determining deviation of the locus corresponding to the target cell from the reference loci corresponding to at least one selected reference phenotype, wherein the magnitude of the deviation indicates degree of similarity between the physiological state of the target cell and said at least one selected reference phenotype, thereby identifying the physiological state of the target cell relative to said at least one selected reference phenotype.
(d) at least one display module 610 for displaying a content based in part on the analysis output from said analysis module, wherein the content comprises a signal indicative of the presence of said at least one selected reference phenotype in the target cell, a signal indicative of the absence of said at least one selected reference phenotype in the target cell, a signal indicative of the deviation of the locus corresponding to the target cell from the reference loci, or any combinations thereof.

In some embodiments, said at least one determination module 602 can be configured to perform at least one assay selected for determination of biochemical expression measurements (e.g., but not limited to, nucleic acid expression measurements, gene expression measurements, protein or peptide expression measurements, epigenetic marking measurements, RNA editing measurements, metabolite expression measurements, or any combinations thereof). Various assays for determination of biochemical expression measurements are known in the art, and can include, e.g., but not limited to, polymerase chain reaction (PCR), real-time quantitative PCR, microarray, western blot, immunohistochemical analysis, enzyme linked absorbance assay (ELISA), mass spectrometry, nucleic acid sequencing, flow cytometry, gas chromatography, high performance liquid chromatography, nuclear magnetic resonance (NMR) spectroscopy, or any combinations thereof. Techniques for nucleic acid sequencing are known in the art and can be used to assay the test sample to determine nucleic acid or gene expression measurements, for example, but not limited to, DNA sequencing, RNA sequencing, de novo sequencing, next-generation sequencing such as massively parallel signature sequencing (MPSS), polony sequencing, pyrosequencing, Illumina (Solexa) sequencing, SOLiD sequencing, ion semiconductor sequencing, DNA nanoball sequencing, Heliscope single molecule sequencing, single molecule real time (SNRT) sequencing), nanopore DNA sequencing, sequencing by hybridization, sequencing with mass spectrometry, microfluidic Sanger sequencing, microscopy-based sequencing techniques, RNA polymerase (RNAP) sequencing, or any combinations thereof.

Depending on the nature of test samples and/or applications of the systems as desired by users, the display module 610 can further display additional content. In some embodiments where the test sample is collected or derived from a subject for diagnostic assessment, the content displayed on the display module 610 can further comprise a signal indicative of a diagnosis of a condition (e.g., disease or disorder) or a state of the condition (e.g., disease or disorder) in the subject. For example, in some embodiments where the subject is diagnosed with cancer, the content can further comprise a signal indicative of a primary tissue origin of the subject's cancerous cell.

In some embodiments wherein the test sample is collected or derived from a subject for selection and/or evaluation of a treatment regimen for a subject, the content can further comprise a signal indicative of a treatment regimen personalized to the subject, based on the magnitude of the deviation of the locus corresponding to the target cell from the reference loci corresponding to a normal healthy state.

In some embodiments, the at least one analysis module 606 can be configured to construct the normalized expression module as described herein, prior to projecting the expression vector onto the normalized expression atlas.

In some embodiments, the at least one analysis module 606 can be configured to determine trajectory of the locus corresponding to the target cell, e.g., by comparing the current locus corresponding to the target cell with its previously-determined locus. Thus, the progression of a condition (e.g., a disease or disorder), and/or the effectiveness of a treatment regimen administered to a subject with the condition can be determined.

In some embodiments, the at least one storage device 604 can be further configured to provide a normalized time-course expression atlas reflecting a plurality of developmental reference loci, said plurality of the developmental reference loci corresponding to distinct developmental states of the reference samples. As used herein, the term “developmental state” refers to the developmental stage of cells in a sample. Examples of developmental states include, but are not limited to, differentiation states, stemness (e.g., how close a cell to have a phenotype as a stem cell), and/or malignancy (e.g., degree of malignancy of a tumor). In these embodiments, the analysis module can be further configured to project the expression vector corresponding to the target cell onto the normalized time-course expression atlas described herein. In some embodiments, the at least one analysis module can be further configured to construct the normalized time course expression module as described herein, prior to projecting the expression vector onto the normalized time-course expression atlas.

A tangible and non-transitory (e.g., no transitory forms of signal transmission) computer readable medium 700 having computer readable instructions recorded thereon to define software modules for implementing a method on a computer is also provided herein. In some embodiments, the computer readable medium 700 stores one or more programs for identifying a physiological of a target cell or a population of cells. The one or more programs for execution by one or more processors of a computer system comprises (a) instructions for analyzing the data (e.g., biochemical expression measurements of at least one test sample comprising a target cell) stored on a storage device based on a normalized expression atlas, the normalized expression atlas reflecting a plurality of reference loci, said plurality of reference loci corresponding to a set of reference phenotypes associated with reference samples, wherein each of the reference loci is determined based on a compendium of covariance measurements determined between different biochemical expression measurements across the reference samples, wherein the analyzing comprises the following: (i) projecting onto the normalized expression atlas an expression vector reflecting at least a subset of the biochemical expression measurements stored on the storage device, thereby locating the locus corresponding to the target cell on the normalized expression atlas; and (ii) determining deviation of the locus corresponding to the target cell from the reference loci corresponding to at least one selected reference phenotype, wherein the magnitude of the deviation indicates degree of similarity between the physiological state of the target cell and said at least one selected reference phenotype, thereby identifying the physiological state of the target cell relative to said at least one selected reference phenotype; and (b) instructions for displaying a content based in part on the data output from the analysis module, wherein the content comprises a signal indicative of the presence of at least one selected reference phenotype in the target cell, a signal indicative of the absence of said at least one selected reference phenotype in the target cell, a signal indicative of the deviation of the locus corresponding to the target cell from the reference loci, or any combinations thereof.

Depending on the nature of test samples and/or applications of the systems as desired by users, the computer readable storage medium 700 can further comprise instructions for displaying additional content. In some embodiments where the test sample is collected or derived from a subject for diagnostic assessment, the content displayed on the display module can further comprise a signal indicative of a diagnosis of a condition (e.g., disease or disorder) or a state of the condition (e.g., disease or disorder) in the subject. For example, in some embodiments where the subject is diagnosed with cancer, the content can further comprise a signal indicative of a primary tissue origin of the subject's cancerous cell. In some embodiments wherein the test sample is collected or derived from a subject for selection and/or evaluation of a treatment regimen for a subject, the content can further comprise a signal indicative of a treatment regimen personalized to the subject, based on the magnitude of the deviation of the locus corresponding to the target cell from the reference loci corresponding to a normal healthy state.

In some embodiments, the instructions for the analyzing can further comprise determining trajectory of the locus corresponding to the target cell, e.g., by comparing the current locus corresponding to the target cell with its previously-determined locus. Thus, the progression of a condition (e.g., a disease or disorder), and/or the effectiveness of a treatment regimen administered to a subject with the condition can be determined.

In some embodiments, the computer readable storage medium 700 can further comprise instructions to construct the normalized expression module as described herein, prior to the analyzing step.

In some embodiments, the computer readable storage medium 700 can further comprise instructions to construct a normalized time-course expression atlas reflecting a plurality of developmental reference loci, said plurality of the developmental reference loci corresponding to distinct developmental states of the reference samples (e.g., but not limited to, differentiation states, stemness, and/or malignancy). In these embodiments, the instructions for the analyzing can further comprise projecting the expression vector corresponding to the target cell onto the normalized time-course expression atlas described herein.

Embodiments of the systems described herein have been described through functional modules, which are defined by computer executable instructions recorded on computer readable media and which cause a computer to perform method steps when executed. The modules have been segregated by function for the sake of clarity. However, it should be understood that the modules need not correspond to discrete blocks of code and the described functions can be carried out by the execution of various code portions stored on various media and executed at various times. Furthermore, it should be appreciated that the modules may perform other functions, thus the modules are not limited to having any particular functions or set of functions.

Computing devices typically include a variety of media, which can include computer-readable storage media and/or communications media, in which these two terms are used herein differently from one another as follows. Computer-readable storage media or computer readable media (e.g., 700) can be any available tangible media (e.g., tangible storage media) that can be accessed by the computer, is typically of a non-transitory nature, and can include both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM (random access memory), ROM (read only memory), EEPROM (erasable programmable read only memory), flash memory or other memory technology, CD-ROM (compact disc read only memory), DVD (digital versatile disk) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal that can be transitory such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

In some embodiments, the computer readable storage media 700 can include the “cloud” system, in which a user can store data on a remote server, and later access the data or perform further analysis of the data from the remote server.

Computer-readable data embodied on one or more computer-readable media, or computer readable medium 700, may define instructions, for example, as part of one or more programs, that, as a result of being executed by a computer, instruct the computer to perform one or more of the functions described herein (e.g., in relation to system 600, or computer readable medium 700), and/or various embodiments, variations and combinations thereof. Such instructions may be written in any of a plurality of programming languages, for example, Java, J#, Visual Basic, C, C#, C++, Fortran, Pascal, Eiffel, Basic, COBOL assembly language, and the like, or any of a variety of combinations thereof. The computer-readable media on which such instructions are embodied may reside on one or more of the components of either of system 600, or computer readable medium 700 described herein, may be distributed across one or more of such components, and may be in transition there between.

The computer-readable media can be transportable such that the instructions stored thereon can be loaded onto any computer resource to implement the assays and/or methods described herein. In addition, it should be appreciated that the instructions stored on the computer readable media, or computer-readable medium 700, described above, are not limited to instructions embodied as part of an application program running on a host computer. Rather, the instructions may be embodied as any type of computer code (e.g., software or microcode) that can be employed to program a computer to implement the assays and/or methods described herein. The computer executable instructions may be written in a suitable computer language or combination of several languages. Basic computational biology methods are known to those of ordinary skill in the art and are described in, for example, Setubal and Meidanis et al., Introduction to Computational Biology Methods (PWS Publishing Company, Boston, 1997); Salzberg, Searles, Kasif, (Ed.), Computational Methods in Molecular Biology, (Elsevier, Amsterdam, 1998); Rashidi and Buehler, Bioinformatics Basics: Application in Biological Science and Medicine (CRC Press, London, 2000) and Ouelette and Bzevanis Bioinformatics: A Practical Guide for Analysis of Gene and Proteins (Wiley & Sons, Inc., 2nd ed., 2001).

The functional modules of certain embodiments of the system or computer system described herein can include a determination module, a storage device, an analysis module and a display module. The functional modules can be executed on one, or multiple, computers, or by using one, or multiple, computer networks. The determination module 602 can have computer executable instructions to perform at least one assay selected for determination of biochemical expression measurements (e.g., but not limited to, nucleic acid expression measurements, gene expression measurements, protein or peptide expression measurements, epigenetic marking measurements, RNA editing measurements, metabolite expression measurements, or any combinations thereof) as described earlier.

In some embodiments, the determination module 602 can have computer executable instructions to provide sequence information in computer readable form, e.g., for RNA sequencing. As used herein, “sequence information” refers to any nucleotide and/or amino acid sequence, including but not limited to full-length nucleotide and/or amino acid sequences, partial nucleotide and/or amino acid sequences, or mutated sequences. Moreover, information “related to” the sequence information includes detection of the presence or absence of a sequence (e.g., detection of a mutation or deletion), determination of the concentration of a sequence in the sample (e.g., amino acid sequence expression levels, or nucleotide (RNA or DNA) expression levels), and the like. The term “sequence information” is intended to include the presence or absence of post-translational modifications (e.g. phosphorylation, glycosylation, summylation, farnesylation, and the like).

As an example, determination modules 602 for determining sequence information may include known systems for automated sequence analysis including but not limited to Hitachi FMBIO® and Hitachi FMBIO® II Fluorescent Scanners (available from Hitachi Genetic Systems, Alameda, Calif.); Spectrumedix® SCE 9610 Fully Automated 96-Capillary Electrophoresis Genetic Analysis Systems (available from SpectruMedix LLC, State College, Pa.); ABI PRISM® 377 DNA Sequencer, ABI® 373 DNA Sequencer, ABI PRISM® 310 Genetic Analyzer, ABI PRISM® 3100 Genetic Analyzer, and ABI PRISM® 3700 DNA Analyzer (available from Applied Biosystems, Foster City, Calif.); Molecular Dynamics Fluorlmager™ 575, SI Fluorescent Scanners, and Molecular Dynamics Fluorlmager™ 595 Fluorescent Scanners (available from Amersham Biosciences UK Limited, Little Chalfont, Buckinghamshire, England); GenomyxSC™ DNA Sequencing System (available from Genomyx Corporation (Foster City, Calif.); and Pharmacia ALF™ DNA Sequencer and Pharmacia ALFexpress™ (available from Amersham Biosciences UK Limited, Little Chalfont, Buckinghamshire, England).

Alternative methods for determining sequence information, i.e. determination modules 602, include systems for protein and DNA analysis. For example, mass spectrometry systems including Matrix Assisted Laser Desorption Ionization—Time of Flight (MALDI-TOF) systems and SELDI-TOF-MS ProteinChip array profiling systems; systems for analyzing gene expression data (see, for example, published U.S. Patent Application Pub. No. U.S. 2003/0194711); systems for array based expression analysis: e.g., HT array systems and cartridge array systems such as GeneChip® AutoLoader, Complete GeneChip® Instrument System, GeneChip® Fluidics Station 450, GeneChip® Hybridization Oven 645, GeneChip® QC Toolbox Software Kit, GeneChip® Scanner 3000 7G plus Targeted Genotyping System, GeneChip® Scanner 3000 7G Whole-Genome Association System, GeneTitan™ Instrument, and GeneChip® Array Station (each available from Affymetrix, Santa Clara, Calif.); automated ELISA systems (e.g., DSX® or D52® (available from Dynax, Chantilly, Va.) or the Triturus® (available from Grifols USA, Los Angeles, Calif.), The Mago® Plus (available from Diamedix Corporation, Miami, Fla.); Densitometers (e.g. X-Rite-508-Spectro Densitometer® (available from RP Imaging™, Tucson, Ariz.), The HYRYS™ 2 HIT densitometer (available from Sebia Electrophoresis, Norcross, Ga.); automated Fluorescence in situ hybridization systems (see for example, U.S. Pat. No. 6,136,540); 2D gel imaging systems coupled with 2-D imaging software; microplate readers; Fluorescence activated cell sorters (FACS) (e.g. Flow Cytometer FACSVantage SE, (available from Becton Dickinson, Franklin Lakes, N.J.); and radio isotope analyzers (e.g. scintillation counters).

The sequence information determined from the determination module can be used to determine biochemical expression measurements.

The biochemical expression measurements (e.g., gene expression measurements, protein/peptide expression measurements, epigenetic marking measurements, RNA editing measurements, metabolite expression measurements, or any combinations thereof) determined in the determination module can be read by the storage device 604. As used herein the “storage device” 604 is intended to include any suitable computing or processing apparatus or other device configured or adapted for storing data or information. Examples of electronic apparatus suitable for use with the system described herein can include stand-alone computing apparatus, data telecommunications networks, including local area networks (LAN), wide area networks (WAN), Internet, Intranet, and Extranet, and local and distributed computer processing systems. Storage devices 604 also include, but are not limited to: magnetic storage media, such as floppy discs, hard disc storage media, magnetic tape, optical storage media such as CD-ROM, DVD, electronic storage media such as RAM, ROM, EPROM, EEPROM and the like, general hard disks and hybrids of these categories such as magnetic/optical storage media. The storage device 604 is adapted or configured for having recorded thereon sequence information or expression level information. Such information may be provided in digital form that can be transmitted and read electronically, e.g., via the Internet, on diskette, via USB (universal serial bus) or via any other suitable mode of communication, e.g., the “cloud”.

As used herein, “expression level information” refers to any nucleic acid (e.g., RNA/DNA), gene, protein or peptide, and/or metabolite expression measurements. In some embodiments, the expression level information can be determined from the sequence information determined from the determination module. In some embodiments, the expression level information can be determined from a hybridization-based microarray.

As used herein, “stored” refers to a process for encoding information on the storage device 604. Those skilled in the art can readily adopt any of the presently known methods for recording information on known media to generate manufactures comprising the sequence information or expression level information.

A variety of software programs and formats can be used to store the sequence information or expression level information on the storage device. Any number of data processor structuring formats (e.g., text file or database) can be employed to obtain or create a medium having recorded thereon the sequence information or expression level information.

By providing sequence information and/or expression level information (or biochemical expression measurements) in computer-readable form, one can use the sequence information and/or expression level information (or biochemical expression measurements) in readable form (e.g., as a multi-dimensional expression vector) in the analysis module 606 to perform projection of the expression vector onto a normalized expression atlas stored within the storage device 604 and determination of deviation of the locus (represented by the expression vector) from reference loci (corresponding to at least one selected reference phenotype) displayed in the normalized expression atlas. The analysis made in computer-readable form provides a computer readable analysis result which can be processed by a variety of means. Content 608 based on the analysis result can be retrieved from the analysis module 606 to indicate the presence or absence of at least one selected reference phenotype in the target cell.

In one embodiment, the storage device 604 to be read by the analysis module 606 can comprise expression array datasets that are electronically or digitally recorded and publicly available through public repositories such as National Center for Biotechnology Information (NCBI's) Gene Expression Omnibus (GEO), and/or the Concordia database, which contains 3,209 Affymetrix human tissue or cultured human cell lines) extracted from NCBI's GEO. A full description of the techniques used to assemble the Concordia database can be found, e.g., in Example 1 and Schmid P R et al. 2012 PNAS 109: 5594, and U.S. Patent App. No. 2011/0047169, the contents of which are incorporated herein in its entirety by reference, and the curated phenotype data are available for public download at the Concordia database website (accessible at http://concordia.csail.mit.edu). The expression array datasets can include biochemical expression measurements, and text descriptions relating to each sample (including title, description such as phenotypes, and source fields). These expression array datasets can then ready by an analysis module 606 to construct a normalized expression atlas that reflects a plurality of reference loci corresponding to a set of reference phenotypes associated with reference samples, wherein each of the reference loci is determined based on a compendium of covariance measurements determined between different biochemical expression measurements across the reference samples.

The “analysis module” 606 can use a variety of available software programs and formats for construction of the normalized expression atlas (including normalized time-course expression atlas) described herein and/or projection operative to map the locus (based on the biochemical expression measurements determined in the determination module 602) to the normalized expression atlas. In one embodiment, the analysis module 606 can be configured to project the expression vector (corresponding to a target cell) onto the principle components (e.g., PC1 and PC2) of the normalized expression atlas, which is constructed based on principal component analysis. See, e.g., Abdi H. and Williams L. J. “Principal Component Analysis” Wiley Interdisciplinary Reviews: Computational Statistics. Vol. 2. Issue 4. Page 433-459 (2010) and Lay, David (2000) Linear Algebra and Its Applications. Addision-Wesley, New York; and Kohane I S et al “Microarrays for an Integrative Genomics” Cambridge, Mass., USA: MIT Press (2002), for information on principal component analysis and how to construct a normalized expression atlas using principal component analysis as well as projection of new data onto the principal components. The analysis module 606 may be configured using existing commercially-available or freely-available software for performing principal component analysis.

In some embodiments, the analysis module 606 can further comprise software programs and/or algorithms (e.g., vector analysis) to determine trajectory of the locus corresponding to the target cell, e.g., by comparing the current locus corresponding to the target cell with its previously-determined locus.

In some embodiments, the analysis module 606 can be configured to perform normalization of expression data obtained from public repositories such GEO and/or scientific publications, as well as biochemical expression measurements determined from the determination module 602. Different software and algorithms for data normalization are known in the art. For example, in one embodiment, the analysis module 606 can be configured to normalize the expression data via R's BioConductor package. The resulting probe set intensities are averaged into unique, e.g., gene-centric values, and then rank normalized to improve cross-data series comparability. The calculations can be performed in the R statistical environment, employing the BioConductors suite. See, e.g., R Development Core Team “R: A language and environment for statistical computing.” Vienna, Austria 2007; and Gentleman R C et al. “Bioconductor: open software development for computational biology and bioinformatics.” Genome Biol 2004, 5: R80, for exemplary methods of data normalization.

Various algorithms are available which are useful for comparing multi-dimensional data (e.g., microarray data analysis) and/or identifying the predictive gene signatures. For example, algorithms such as those identified in Babu M. M. “Introduction to microarray data analysis” in Computational Genomics (Ed: R. Grant), Horizon Press, U. K.; Komura et al. “Multidimensional support vector machines for visualization of gene expression data” Bioinformatics Vol. 21 (2005) 439; Montaner D. and Dopazo J. “Multidimensional gene set analysis of genomic data” PLoS One, April 2010 (Vol. 5, Issue 4) e10348; Piro R. M. “An atlas of tissue specific conserved coexpression for functional annotation and disease gene prediction” European Journal of Human Genetics (2011) 19, 1173-1180; Zhang S. et al. “Discovery of multi-dimensional modules by integrative analysis of cancer genomic data” Nucleic acids research 2012 (1-13); Breitling R. et al. “Vector analysis as a fast and easy method to compare gene expression responses between different experimental backgrounds” BMC Bioinformatics 2005, 6: 181; Guo W et al. “Controlling false discoveries in multidimensional directional decisions, with applications to gene expression data on ordered categories.” Biometrics. 2010 June; 66(2):485-92; van Deun K. et al. “Joint mapping of genes and conditions via multidimensional unfolding analysis.” BMC bioinformatics 2007, 8: 181; and Hutz J. E. et al. “The multidimensional perturbation value: A single metric to measure similarity and activity of treatments in high-throughput multidimensional screens.” Journal of Biomolecule screening (published online 20 Nov. 2012), or any combinations thereof can also be used in the analysis module 606.

In some embodiments, the analysis module 606 can be configured to identify a subset of biochemical expression signatures that characterize a target phenotype in the context of broad biochemical expression landscapes (e.g., broad transcriptomic landscapes), and not in the context of dichotomous classes. Instead of defining a biochemical expression signature as one that is over- or underexpressed in a case vs. control study using methods akin to t-tests, a biochemical expression signature can be defined as a biochemical species (e.g., gene) that has a “localized” expression signature for a phenotype; i.e., how grouped together are all of the samples corresponding to that phenotype for that biochemical species (e.g., gene). If all of the samples for a phenotype have a very similar expression level (all high, all low, etc.), the biochemical species (e.g., gene) can be considered as a biochemical expression signature for that phenotype. In some embodiments, the analysis module 606 can be configured to employ a finite impulse response filter (FIRF) on each biochemical expression measurements across the database of diverse expression samples to quantify the degree of expression level localization for a given phenotype. To generate the set of biochemical expression signatures relevant to a phenotype, the localization scores for biochemical species can be used to rank all biochemical species (e.g., gene) and then the cutoff for the number of biochemical species (e.g., gene) to include can be identified by balancing the set's ability to accurately classify samples of its own phenotype while minimizing the presence of non-phenotype specific signal. See, e.g., Examples 1 and 2 as well as McClellan J H et al. “DSP First: a multimedia approach” Prentice Hall, Englewood Cliffs, N.J. (1998), for details on finite impulse response filter and methods of using the same to identify biochemical expression signatures from a database of diverse expression samples that represent a target phenotype. In some embodiments, the identified biochemical expression signatures can then used to identify relevant biochemical expression measurement datasets for construction of the normalized expression atlas.

In some embodiments, the analysis module 606 can compare protein expression profiles. Any available comparison software can be used, including but not limited to, the Ciphergen Express (CE) and Biomarker Patterns Software (BPS) package (available from Ciphergen Biosystems, Inc., Freemont, Calif.). Comparative analysis can be done with protein chip system software (e.g., The Protein chip Suite (available from Bio-Rad Laboratories, Hercules, Calif.). Algorithms for identifying expression profiles can include the use of optimization algorithms such as the mean variance algorithm (e.g. JMP Genomics algorithm available from JMP Software Cary, N.C.).

The analysis module 606, or any other module of the system described herein, may include an operating system (e.g., UNIX) on which runs a relational database management system, a World Wide Web application, and a World Wide Web server. World Wide Web application includes the executable code necessary for generation of database language statements (e.g., Structured Query Language (SQL) statements). Generally, the executables will include embedded SQL statements. In addition, the World Wide Web application may include a configuration file which contains pointers and addresses to the various software entities that comprise the server as well as the various external and internal databases which must be accessed to service user requests. The Configuration file also directs requests for server resources to the appropriate hardware—as may be necessary should the server be distributed over two or more separate computers. In one embodiment, the World Wide Web server supports a TCP/IP protocol. Local networks such as this are sometimes referred to as “Intranets.” An advantage of such Intranets is that they allow easy communication with public domain databases residing on the World Wide Web (e.g., the GenBank or Swiss Pro World Wide Web site). Thus, in a particular embodiment, users can directly access data (via Hypertext links for example) residing on Internet databases using a HTML interface provided by Web browsers and Web servers. In another embodiment, users can directly access data residing on the “cloud” provided by the cloud computing service providers.

The analysis module 606 provides computer readable analysis result that can be processed in computer readable form by predefined criteria, or criteria defined by a user, to provide a content based in part on the analysis result that may be stored and output as requested by a user using a display module 610. The display module 610 enables display of a content 608 based in part on the comparison result for the user, wherein the content 608 is a signal indicative of the presence of said at least one selected reference phenotype in the target cell, a signal indicative of the absence of said at least one selected reference phenotype in the target cell, a signal indicative of the deviation of the locus corresponding to the target cell from the reference loci, or any combinations thereof. Such signal, can be for example, a display of content 608 indicative of the presence or absence of the selected reference phenotype in the target cell on a computer monitor, a printed page of content 608 indicating the presence or absence of the selected reference phenotype in the target cell from a printer, or a light or sound indicative of the absence of the selected reference phenotype in the target cell.

In various embodiments of the computer system described herein, the analysis module 606 can be integrated into the determination module 602.

Depending on the nature of test samples and/or applications of the systems as desired by users, the content 608 based on the analysis result can also include a signal indicative of a diagnosis of a condition (e.g., disease or disorder) or a state of the condition (e.g., disease or disorder) in the subject. For example, in some embodiments where the subject is diagnosed with cancer, the content 608 can further comprise a signal indicative of a primary tissue origin of the subject's cancerous cell. In some embodiments, the content 608 based on the analysis result can further comprise a signal indicative of a treatment regimen personalized to the subject.

In some embodiments, the content 608 based on the analysis result can include a graphical representation reflecting the locus (corresponding to the target cell) relative to a plurality of reference loci (corresponding to a set of reference phenotypes associated with reference samples) on a normalized expression atlas. See, e.g., FIGS. 5A-5B or FIGS. 9A-9D for examples of the graphical representations.

In one embodiment, the content 608 based on the analysis result is displayed a on a computer monitor. In one embodiment, the content 608 based on the analysis result is displayed through printable media. The display module 610 can be any suitable device configured to receive from a computer and display computer readable information to a user. Non-limiting examples include, for example, general-purpose computers such as those based on Intel PENTIUM-type processor, Motorola PowerPC, Sun UltraSPARC, Hewlett-Packard PA-RISC processors, any of a variety of processors available from Advanced Micro Devices (AMD) of Sunnyvale, Calif., or any other type of processor, visual display devices such as flat panel displays, cathode ray tubes and the like, as well as computer printers of various types.

In one embodiment, a World Wide Web browser is used for providing a user interface for display of the content 608 based on the analysis result. It should be understood that other modules of the system described herein can be adapted to have a web browser interface. Through the Web browser, a user may construct requests for retrieving data from the analysis module. Thus, the user will typically point and click to user interface elements such as buttons, pull down menus, scroll bars and the like conventionally employed in graphical user interfaces. The requests so formulated with the user's Web browser are transmitted to a Web application which formats them to produce a query that can be employed to extract the pertinent information related to the physiological state of a target cell in a test sample, e.g., display of an indication of the presence or absence of the selected reference phenotype in a target cell, or display of information based thereon. In one embodiment, the information of the reference sample data is also displayed.

In any embodiments, the analysis module can be executed by a computer implemented software as discussed earlier. In such embodiments, a result from the analysis module can be displayed on an electronic display. The result can be displayed by graphs, numbers, characters or words. In additional embodiments, the results from the analysis module can be transmitted from one location to at least one other location. For example, the comparison results can be transmitted via any electronic media, e.g., internet, fax, phone, a “cloud” system, and any combinations thereof. Using the “cloud” system, users can store and access personal files and data or perform further analysis on a remote server rather than physically carrying around a storage medium such as a DVD or thumb drive.

Each of the above identified modules or programs corresponds to a set of instructions for performing a function described above. These modules and programs (i.e., sets of instructions) need not be implemented as separate software programs, procedures or modules, and thus various subsets of these modules may be combined or otherwise re-arranged in various embodiments. In some embodiments, memory may store a subset of the modules and data structures identified above. Furthermore, memory may store additional modules and data structures not described above.

The illustrated aspects of the disclosure may also be practiced in distributed computing environments where certain tasks are performed by remote processing devices that are linked through a communications network. In a distributed computing environment, program modules can be located in both local and remote memory storage devices.

Moreover, it is to be appreciated that various components described herein can include electrical circuit(s) that can include components and circuitry elements of suitable value in order to implement the embodiments of the subject innovation(s). Furthermore, it can be appreciated that many of the various components can be implemented on one or more integrated circuit (IC) chips. For example, in one embodiment, a set of components can be implemented in a single IC chip. In other embodiments, one or more of respective components are fabricated or implemented on separate IC chips.

What has been described above includes examples of the embodiments of the present invention. It is, of course, not possible to describe every conceivable combination of components or methodologies for purposes of describing the claimed subject matter, but it is to be appreciated that many further combinations and permutations of the subject innovation are possible. Accordingly, the claimed subject matter is intended to embrace all such alterations, modifications, and variations that fall within the spirit and scope of the appended claims. Moreover, the above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable storage medium having computer-executable instructions for performing the acts and/or events of the various methods of the claimed subject matter.

The aforementioned systems/circuits/modules have been described with respect to interaction between several components/blocks. It can be appreciated that such systems/circuits and components/blocks can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function; software stored on a computer-readable medium; or a combination thereof.

In view of the exemplary systems described above, methodologies that may be implemented in accordance with the described subject matter will be better appreciated with reference to the flowcharts of the various figures. For simplicity of explanation, the methodologies are depicted and described as a series of acts. However, acts in accordance with this disclosure can occur in various orders and/or concurrently, and with other acts not presented and described herein. Furthermore, not all illustrated acts may be required to implement the methodologies in accordance with the disclosed subject matter. In addition, those skilled in the art will understand and appreciate that the methodologies could alternatively be represented as a series of interrelated states via a state diagram or events. Additionally, it should be appreciated that the methodologies disclosed in this specification are capable of being stored on an article of manufacture to facilitate transporting and transferring such methodologies to computing devices. The term article of manufacture, as used herein, is intended to encompass a computer program accessible from any computer-readable device or storage media.

The system 600, and computer readable medium 700, are merely illustrative embodiments, e.g., for identifying a physiological state of a target cell and/or for use in the methods of various aspects described herein and is not intended to limit the scope of the inventions described herein. Variations of system 600, and computer readable medium 700, are possible and are intended to fall within the scope of the inventions described herein.

The modules of the machine, or used in the computer readable medium, may assume numerous configurations. For example, function may be provided on a single machine or distributed over multiple machines.

Applications of the Methods and/or Systems Described Herein

The methods of identifying a physiological state of a target cell and/or the systems described herein can be used in any application where a comparison of the physiological state of a target cell to one or more reference states (e.g., normal healthy cells, diseased cells, developmental status of the cells, and/or cells treated with known agents, and/or tissue-specific cells) is desirable, e.g., diagnosis of a disease, treatment monitoring, drug or library screening. Accordingly, in a further aspect, a method for determining an effect of a perturbagen on a target cell is provided herein. The method comprises: (a) contacting a target cell with a perturbagen; (b) assaying the target cell to determine biochemical expression measurements; and (c) in a specifically-programmed computer, performing one or more embodiments of the methods and/or systems described herein to identify a physiological state of the target cell. By comparing the identified physiological state of the target cell to one or more reference state, e.g., the original state of the target cell prior to the contact with the perturbagen, and/or a desired state of the cell to be reached (e.g., normal healthy state), the effect of the perturbagen on the target cell can be determined.

In some embodiments, the target cell can be assayed to determine biochemical expression measurements comprising nucleic acid expression measurements, gene expression measurements, protein expression measurements, epigenetic marking measurements, RNA editing measurements, metabolite expression measurements, or any combinations thereof.

A perturbagen is an agent that can produce an effect (e.g., a beneficial or therapeutic effect, or adverse or toxic effect) on a recipient cell, and includes, for example, but is not limited to, proteins, peptides, nucleic acids (e.g., RNA, DNA, siRNA, snRNA), aptamers, small molecules, toxins, therapeutic agents, nutraceuticals, environmental stimuli (e.g., pressure, hypoxia, humidity, light, temperature (e.g., extremes in high and low temperatures), radiation), microbes, and any combinations thereof.

For example, in some embodiments, to identify a perturbagen as a candidate for reprogramming a somatic cell to a stem cell, the method can further comprise identifying a perturbagen that can generate a locus (corresponding to the target cell) in closer proximity to a reference locus corresponding to a stem cell-like phenotype, or generate a trajectory of the locus (corresponding to the target cell) toward the reference locus corresponding to a stem-cell like phenotype.

As used herein, the term “proximity” or “vicinity” refers to the closeness of a point (e.g., a reference locus or a sample locus) relative to other points (e.g., reference loci or clusters of reference loci) on a normalized expression atlas. In some embodiments, the closeness between any two points can be represented by the distance between the two points on a normalized expression atlas. When comparing the closeness of a point or a cluster of points to other point(s) or cluster(s), the cluster center or the boundary defined by the points involved in the cluster can be used to determine the closeness. Any other methods known in the art to determine closeness of a point to a cluster or between two clusters can also be used. As used herein, the term “closer proximity” refers to a comparison of the closeness of at least two points/clusters (e.g., sample locus A and sample locus B) to a certain point or a cluster of points (e.g., a cluster of reference loci) on a normalized expression atlas. For illustration purposes only, if the distance between the sample locus A and a cluster of reference loci is shorter (e.g., by at least about 5%, including, e.g., at least about 10%, at least about 20%, at least about 30 or more) than that of the sample locus B to the cluster of the reference loci, the sample locus A is in closer proximity to the cluster of reference loci than the sample locus B. As used herein, the term “closest proximity” refers to the minimum distance between a point/cluster to another point or cluster.

In some embodiments, to identify a perturbagen as a candidate for therapeutic evaluation that can partially or completely restore a diseased target cell to a normal healthy state, the method can further comprise identifying a perturbagen that can generate a locus (corresponding to the target cell) in closer proximity to a reference locus corresponding to a normal healthy state, or generate a trajectory of the locus (corresponding to the target cell) toward the reference locus corresponding to a normal healthy state. In this embodiment, if the target cell is collected or derived from a subject determined to suffer from a condition, the identified perturbagen that shows therapeutic effect can be recommended for, or administered to, the subject.

In some embodiments, the methods, systems, and/or kits of various aspects described herein can provide a method for drug screening and/or reporting of drug effects in preclinical and/or clinical trials. For example, in some embodiments, the methods, systems, and/or kits described herein can be used to identify lead therapeutic agents from a library of candidate agents, e.g., but not limited to, a small-molecule library, and/or siRNA library, alone or in combination with other therapeutic agents or adjuvants. In one embodiment, by treating cells with candidate agents, alone or in combination with other therapeutic agents or adjuvants, and then comparing the biochemical expression measurements of the cells to reference samples (e.g., normal healthy cells, diseased cells and/or developmental states of the cells) using the methods, systems and/or kits of identifying a physiological state of the cells described herein, one or more lead therapeutic agents can be identified when the loci of the cells treated with the candidate agents indicate a trajectory toward reference loci corresponding to normal healthy state. The methods, systems and/or kits of various aspects described herein can be adapted for high-throughput screening.

Provided herein are also methods for treating a subject with a condition using the methods and/or systems of identifying a physiological state of a target cell described herein. The treatment method comprises administering a selected therapeutic agent to a subject determined to have a condition, wherein the therapeutic agent is selected based on a process comprising: (a) contacting a population of cells with a plurality of perturbagens, wherein the population of cells are derived from a first test sample obtained from the subject; (b) assaying the population of cells to determine biochemical expression measurements (e.g., nucleic acid expression measurements, gene expression measurements, protein expression measurements, epigenetic marking measurements, RNA editing measurements, metabolite expression measurements), or any combinations thereof; and (c) in a specifically-programmed computer, performing one or more embodiments of the methods and/or systems described herein to identify the physiological state of the population of the cells, wherein at least one perturbagen that (i) can generate a locus corresponding to the population of cells in the closest proximity to a reference locus corresponding to normal healthy cells, or (ii) can generate a trajectory of the locus toward the reference locus, can be selected as the therapeutic agent for administration to the subject.

The terms “treatment” and “treating” as used herein, with respect to treatment of a disease or disorder, means preventing the progression of the disease or disorder, or altering the course of the disorder (for example, but are not limited to, slowing the progression of the disorder), or partially reversing a symptom of the disorder or reducing one or more symptoms and/or one or more biochemical markers in a subject, preventing one or more symptoms from worsening or progressing, promoting recovery or improving prognosis. For example, in the case of cancer, therapeutic treatment refers to clinically relevant alleviation of at least one symptom associated with cancer. Measurable lessening includes any clinically significant decline in a measurable marker or symptom, such as measuring markers for cancer in the blood, or measuring tumor size, e.g., by imaging. In one embodiment, at least one symptom associated with cancer can be alleviated by a “clinically relevant amount” as evaluated by a physician or a skilled practitioner, as compared to a control (e.g., a normal healthy subject or a subject diagnosed with the same cancer but not administered with the treatment, or the condition of the same subject being treated at the previous time point). For example, in some embodiments, at least one cancer biomarker and/or tumor size or growth can be reduced by at least about 10%, at least about 15%, at least about 20%, at least about 30%, at least about 40%, or at least about 50%. In another embodiment, at least one cancer biomarker and/or tumor size or growth by more than 50%, e.g., at least about 60%, or at least about 70%. In one embodiment, at least one cancer biomarker and/or tumor size or growth by at least about 80%, at least about 90% or greater, as compared to a control (e.g., a normal healthy subject or a subject diagnosed with the same cancer but not administered with the treatment, or the condition of the same subject being treated at the previous time point.) In some embodiments, at least one cancer biomarker and/or tumor size or growth can be alleviated by a clinically relevant amount as evaluated by a physician within a treatment period of at least about 10 days, including, e.g., at least about 20 days, at least about 30 days, at least about 40 days, or longer. In some embodiments, at least one cancer biomarker and/or tumor size or growth can be reduced by at least about 10%, at least about 15%, at least about 20%, at least about 30%, at least about 40%, or at least about 50% or higher within a treatment period of at least about 10 days, including, e.g., at least about 20 days, at least about 30 days, at least about 40 days, or longer.

In some embodiments, the normalized expression atlas used in the methods and/or systems described herein to identify the physiological state of a population of the cells can comprise at least a subset of the reference loci representing a normal healthy state. In some embodiments, the normalized expression atlas can comprise a second subset of the reference loci representing a known state of the condition.

In some embodiments, the method can further comprise selecting the therapeutic agent.

In some embodiments, the population of cells subjected to treatment with perturbagens can be collected or derived from the subject to be treated. In some embodiments, the population of the cells can comprise somatic cells of the subject, e.g., from a biopsy of target cells to be treated. In some embodiments, the population of cells subjected to treatment with perturbagens can comprise tissue-specific cells. The tissue-specific cells can be collected from a subject, or differentiated from stem cells collected or derived from the subject. In some embodiments, the stem cells can comprise naturally existing stem cells or derived stem cell (e.g., induced pluripotent stem cells) reprogrammed from the somatic cells (e.g., skin fibroblasts) of the subject. Since the cells for the methods and/or systems described herein are collected or derived from a subject, the results of the methods and/or systems can be used to make a decision for a personalized treatment.

An exemplary embodiment of a method for individualized therapeutic decision marking is shown below. The method combines gene expression assays in induced pluripotent stem cells (iPSC5) with projections of these measurements into annotated expression atlases that capture a continuum of development, disease and tissue. These projections provide a vector of disease perturbation in a specific tissue of the individual from which the iPSCs were obtained which allows for a precise diagnostic assignment to the class of individuals with similar such vectors. This inverse of this vector can be used as measure of therapeutic response to interventions as measured by the change in expression profile of the iPSC in response to therapy whether it in a small molecule screen, dsRNA or antibody.

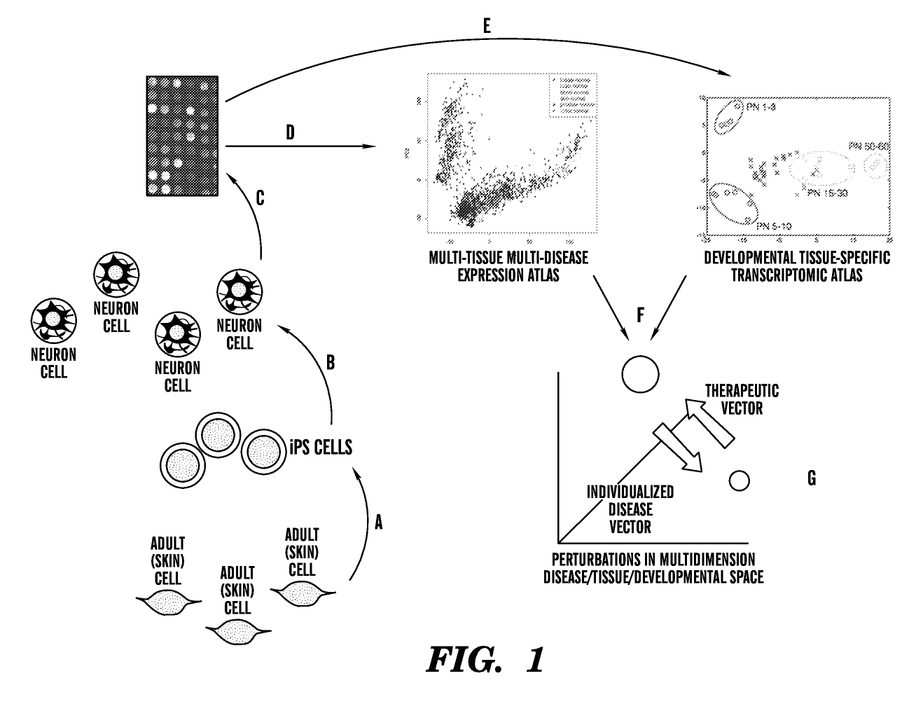

As depicted in FIG. 1, any adult somatic cells (e.g., adult skin cells) can be obtained from patients and reprogrammed (a) into pluripotent stem cells (e.g., iPSC5) which can then be differentiated (b) into a designated adult tissue corresponding to the most diseased target tissue that is to be assessed for therapy. Various types of pluripotent stem cells that can be used in the methods, systems and/or kits described herein and methods of making the pluripotent stem cells are described in the section “Pluripotent stem cells for use in the methods, systems, and/or kits described herein” in detail later below.

The transcriptome (the expression of approximately 30,000 genes) is a stable multidimensional measure of the regulatory state of a cell and can be quantified (c) by a hybridizing microarray or by RNA sequence. This provides a 30,000 dimensional vector (“individual transcriptomic vector”) describing the transcriptomic state of the IPSC derived diseased tissue from an individual.

The individual transcriptomic vector can then be projected into two different normalized multidimensional reference spaces (“expression atlases”). The first (“multi-tissue multi-disease expression atlas”) is a compilation of over 50,000 expression microarray experiments covering over 100 disease states and over 30 tissue types. The projection of the individual transcriptome to the multi-tissue multi-disease expression atlas (d) provides two multidimensional vectors: one reports the position of the individual's transcriptome in tissue space and the other in disease space. Together these vectors provide accurate positioning of the individual's disease state for a given tissue. The second expression atlas into which the individual transcriptomic vector is projected (e) is constructed from the transcriptomic time-series (i.e. full transcriptome measurement to each time point in development) of the developing murine tissue corresponding to the adult human tissue into which the iPSC were differentiated (b). In some embodiments, this projection can be restricted to the individual transcriptomic vector elements which correspond to their homologues of an animal model (e.g., mouse) as per reference databases (e.g. HomoloGene). The resulting vector represents the developmental staging of the individual's transcriptome. The developmental regression of tissues measured in this way allows a separate whole-transcriptome measurement of disease.

The vectors obtained from the two expression atlases can then be combined (f) to provide a multi-dimensional integrated disease, tissue, and developmental state locus corresponding to the individual's transcriptome. The distance in this integrated state from reference healthy individual samples to the patient's individual transcriptome provides a multidimensional quantified measure of disease (“Individualized Disease Vector”) and thereby defines its inverse, the “therapeutic vector”.

The therapeutic vector is a weighted vector of genes which can be then used in a screening process for therapeutic compounds. The vector can be analyzed to determine what fraction of the transcriptome has to be measured in the screen to account for sufficient variance to allow the screen to be cost-effective. Those therapeutics that generate the largest vectors aligned with the therapeutic vector (i.e. most co-linear in multidimensional space) are high yield candidates for therapeutic evaluation.

In some embodiments, the method can further comprise determining or diagnosing the condition (e.g., a disease or disorder) or the state of the condition (e.g., a disease or disorder) in the subject, prior to administering the subject with the selected therapeutic agent. In addition to or alternative to using any known methods in the art for diagnosis, e.g., blood test, biopsy, and/or imaging methods (e.g., but not limited to, X-ray, MRI, ultrasound, PET scan, and/or CT scan), in some embodiments, the condition or the state of the condition in a subject can be determined by a diagnostic process comprising performing one or more embodiments of the methods and/or systems described herein to identify a physiological state of a target cell. For example, based on the vicinity of the locus corresponding to the subject's cell (target cell) from at least one reference loci (e.g., corresponding to a normal healthy state and/or different states of the condition to be diagnosed, e.g., different stages of cancer), the type and/or state of the condition of the subject can be identified.

By way of example only, where a patient is suspected of having a tumor in her lung (yet it is not clear whether it is a primary or secondary tumor), a test sample from the patient can be assayed for various biochemical expression measurements as described herein (e.g., biochemical expression signatures for cancer), which determine the locus of the patient sample relative to reference loci on a normalized expression atlas described herein. The reference loci can represent normal and corresponding cancerous tissues from primary tumors (e.g., but not limited to, breast, lung, liver, and brain) and metastases (e.g., brain metastases, lung metastases, bone metastases). If the patient locus is closer to the cluster of reference loci corresponding to breast tumors, rather than lung tumors, this indicates that the patient is likely to have a lung metastasis originated from a breast primary tumor.

Accordingly, yet another aspect provided herein is a method of diagnosing a condition (e.g., a disease or disorder) or a state of the condition (e.g., a disease or disorder) in a subject. The method comprises (a) assaying at least a subset of cells from a test sample collected from a subject determined to have, or have a risk for, a condition, to determine biochemical expression measurements; (b) in a specifically-programmed computer, performing one or more embodiments of the methods and/or systems described herein to identify a physiological state of the subject's cells, wherein the magnitude of the deviation of the locus corresponding to the subject's cells from reference loci corresponding to the condition or different states of the condition, indicates degree of similarity between the physiological state of the subject's cells and the condition or different states of the condition, thereby determining the condition (e.g., a disease or disorder) or the state of the condition (e.g., a disease or disorder) in the subject.

In some embodiments, at least a subset of the reference loci can represent a normal healthy state. In some embodiments, a second subset of the reference loci can represent a known state of the condition to be diagnosed. For example, a subset of the reference loci can represent a specific stage of cancer.

In some embodiments, the method can further comprise administering the subject a therapeutic agent after diagnosing the condition.

Provided herein is also a method of monitoring a therapeutic treatment in a subject. The method comprises (a) assaying a test sample collected from a subject administered with a therapeutic treatment to determine biochemical expression measurements (e.g., nucleic acid expression measurements, gene expression measurements, protein/peptide expression measurements epigenetic marking measurements, RNA editing measurements, and/or metabolite measurements; and (b) in a specifically-programmed computer, performing one or more embodiments of the methods described herein to identify a physiological state of target cells in the test sample, thereby determining the effectiveness of the therapeutic treatment on the subject.

In some embodiments, the test sample can be collected at a first time point. The first time point can be taken prior to administration of the therapeutic treatment or after the subject has been treated with the therapeutic treatment.

In some embodiments, the test sample can be collected at a second time point. The second time point refers to a time point after the subject has been treated with the therapeutic treatment and is subsequent to the first time point.

In some embodiments, the method can comprise comparing the identified physiological state of the target cells to at least one or more reference loci (e.g., one or more clusters). For example, in some embodiments where the test sample is collected at a first time point after the subject has been treated with the therapeutic treatment, at least a subset of the reference loci can represent a physiological state of target cells in a test sample collected prior to the therapeutic treatment. In some embodiments, a second subset of the reference loci can represent a normal healthy state. In some embodiments where the test sample is collected at a second time point after the subject has been treated with the therapeutic treatment (where the second time point is subsequent to the first time point), a subset of the reference loci can comprise the loci representing the physiological state of the subject's cells collected at the first time point. When the trajectory of the locus corresponding to the target cells points toward the normal healthy state and/or the locus corresponding to the target cells deviates from the normal healthy state by no more than 30% (e.g., no more than 20%, no more than 10%, no more than 5% or less), the therapeutic treatment can be considered effective. Alternatively, when the trajectory of the locus corresponding to the target locus moves away from the locus of the target cell prior to the therapeutic treatment (e.g., along a trajectory toward reference loci corresponding to normal healthy states) by more than 10%, or more than 20%, or more than 30%, or more than 40%, or more than 50% or more, then the therapeutic treatment can be considered effective.

The methods, systems and/or kits of various aspects described herein can be applicable to various in vitro or in vivo applications. In some embodiments, the methods and/or systems of various aspects described herein can be applicable to treatment and/or diagnosis of any condition (e.g., disease or disorder). Examples of a condition (e.g., disease or disorder) can include, but are not limited to, neurodevelopmental disorder, neurodegenerative disorder, a genetic disorder, metabolic disorder, cancer, or any combinations thereof.

In some embodiments, the methods, systems, and/or kits described herein can be used to provide a method to identify which subjects are more likely to be responsive to a drug being evaluated, assess the effectiveness of the drug in a population of subjects alone or in combination with other therapeutic agents, improve the quality and reduce costs of clinical trials, discover the subset of positive responders to a particular class of the drug (i.e. stratifying patient populations), improve therapeutic success rates, and/or reduce sample sizes, trial duration and costs of clinical trials. In one embodiment, by identifying a subset of loci corresponding to treated subjects (e.g., subjects treated with a drug being evaluated during clinical trials) that indicate a trajectory toward reference loci corresponding to normal healthy state, a subset of patients (e.g., with particular characteristics such as presence of certain gene markers) that can effectively benefit from the drug can be identified, thus improving the therapeutic success rates in the subset of patients.

In some embodiments, the methods, systems, and/or kits described herein can provide a service to physicians that will enable the physicians to tailor optimal personalized patient therapies. Stated another way, in some embodiments, the methods, systems, and/or kits described herein can be performed by one or more service providers, e.g., a diagnostic laboratory to assay a biological sample taken from a subject and perform the assay analysis, or a diagnostic laboratory to assay a biological sample taken from a subject and then provide the assay results to a third-party for the assay analysis. For example, a biological sample (e.g., a biological fluid sample or a biopsy) taken from a subject, e.g., by a skilled practitioner, can be sent to a laboratory facility (e.g., a clinical laboratory improvement amendments (CLIA)-certified laboratory), for example, one such lab is operated by Quest Diagnostics. The laboratory may assay the biological sample to determine any types of biochemical expression measurements described herein (e.g., but not limited to, gene expression measurements) and then analyze the assay results with respect to a normalized expression atlas described herein (e.g., a multi-disease, multi-tissue-related expression atlas, or a single-disease, multi-tissue-related expression atlas, or a time-course disease-related expression atlas) in accordance with one or more embodiments of the methods described herein. In some embodiments, the laboratory can assay the biological sample and then send the assay results to a third-party for the analysis. By way of example only, when the subject is diagnosed with cancer (e.g., based on detection of circulating tumor cells in a blood sample, and/or a biopsy of a metastasis) where the location of the primary tumor is not known, the laboratory and/or the third party can analyze the assay results with respect to a normalized expression atlas reflecting reference samples associated with various types and/or stages of cancer in different tissues, in order to identify the primary origin of the tumor and provide a report to the physician or health care provider, who can make an appropriate decision on a treatment regimen. The laboratory may provide the physician or health care provider a report indicating the primary tissue origin of the sample.

In some embodiments, instead of providing a diagnosis of a subject's disease or disorder, the laboratory can assay the biological sample to determine the subject from which the biological sample was taken is responsive or unresponsive to a selected treatment regimen and optionally provide an alternative which can be used should the subject be identified to be unresponsive to the selected treatment regimen. This may enable a physician to tailor therapy to the individual subject's disease or other disorder, prescribe the right therapy to the right patient at right time, provide a higher treatment success rate, spare the patient unnecessary toxicity and side effects, reduce the cost to patients and insurers of unnecessary or dangerous ineffective medication, and improve patient quality of life, eventually making cancer a managed disease, with follow up assays as appropriate. Physicians can use the reported information to tailor optimal personalized patient therapies instead of the current “trial and error” or one size fits all methods used to prescribe a drug under current systems. The inventive methods described herein may establish a system of personalized medicine.

In some embodiments, the methods, systems, and/or kits described herein can be used for cell quality control, e.g., but not limited to, assessment of healthiness of blood cells before transfusion to a subject, or evaluation of stem cell differentiation process prior to transplantation of the stem cells to a subject, e.g., for cell therapies or gene therapies. By way of example only, the methods, systems, and/or kits described herein can be used to assess the quality of pluripotent stem cells prior to use for a cell transplantation therapy or gene therapy. In one embodiment, by assaying a subset of pluripotent cells for biochemical expression measurements described herein (e.g., biochemical expression signatures for stem cells at various differentiation stages and/or differentiated mature tissues) and analyzing the assay results with respect to a time-course normalized expression atlas (e.g., as shown in FIG. 15) reflecting, e.g., various differentiation states of pluripotent stems cells and a mature differentiated state corresponding to a tissue of interest (e.g., a brain tissue), the quality of the pluripotent stem cells, e.g., whether the stem cells will appropriately differentiate into a tissue of interest, can be assessed, e.g., by determining whether the assayed pluripotent cells follow a trajectory toward a mature state corresponding to the tissue of interest as reflected in the time-course normalized expression atlas, prior to use for cell transplantation therapies or gene therapy. See below the section “Pluripotent stem cells for use in the methods, systems, and/or kits described herein” for examples of pluripotent stem cells that can be assessed using the methods, systems and/or kits described herein for quality control prior to cell transplantation or gene therapy.

Conditions (e.g., Diseases or Disorders) Amenable to Diagnosis, Prognosis/Monitoring, and/or Treatment Using Methods, Systems or Various Aspects Described Herein

Different embodiments of the methods, systems and/or kits described herein can be used for diagnosis and/or treatment of a disease or disorder, and/or the state of the disease or disorder in a subject, e.g., a condition afflicting a certain tissue in a subject. For example, the disease or disorder in a subject can be associated with breast, pancreas, blood, prostate, colon, lung, skin, brain, ovary, kidney, oral cavity, throat, cerebrospinal fluid, liver, or other tissues, and any combination thereof.

In some embodiments, the condition (e.g., disease or disorder) amenable to diagnosis and/or treatment using any aspects described herein can include a condition that is not terminal but can cause an interruption, disturbance, or cessation of a bodily function, system, or organ. Such examples of disorders can include, e.g., but not limited to, developmental disorders (e.g., autism), brain disorders (e.g., epilepsy), mental disorders (e.g., depression), endocrine disorders (e.g., diabetes), or skin disorders (e.g., skin inflammation).

In some embodiments, the condition (e.g., disease or disorder) amenable to diagnosis and/or treatment using any aspects described herein can include a breast disease or disorder. Exemplary breast disease or disorder includes breast cancer.

In some embodiments, the condition (e.g., disease or disorder) amenable to diagnosis and/or treatment using any aspects described herein can include a pancreatic disease or disorder. Nonlimiting examples of pancreatic diseases or disorders include acute pancreatitis, chronic pancreatitis, hereditary pancreatitis, pancreatic cancer (e.g., endocrine or exocrine tumors), etc., and any combinations thereof.

In some embodiments, the condition (e.g., disease or disorder) amenable to diagnosis and/or treatment using any aspects described herein can include a blood disease or disorder. Examples of blood disease or disorder include, but are not limited to, platelet disorders, von Willebrand diseases, deep vein thrombosis, pulmonary embolism, sickle cell anemia, thalassemia, anemia, aplastic anemia, fanconi anemia, hemochromatosis, hemolytic anemia, hemophilia, idiopathic thrombocytopenic purpura, iron deficiency anemia, pernicious anemia, polycythemia vera, thrombocythemia and thrombocytosis, thrombocytopenia, and any combinations thereof.

In some embodiments, the condition (e.g., disease or disorder) amenable to diagnosis and/or treatment using any aspects described herein can include a prostate disease or disorder. Non-limiting examples of a prostate disease or disorder can include prostatis, prostatic hyperplasia, prostate cancer, and any combinations thereof.

In some embodiments, the condition (e.g., disease or disorder) amenable to diagnosis and/or treatment using any aspects described herein can include a colon disease or disorder. Exemplary colon diseases or disorders can include, but are not limited to, colorectal cancer, colonic polyps, ulcerative colitis, diverticulitis, and any combinations thereof.

In some embodiments, the condition (e.g., disease or disorder) amenable to diagnosis and/or treatment using any aspects described herein can include a lung disease or disorder. Examples of lung diseases or disorders can include, but are not limited to, asthma, chronic obstructive pulmonary disease, infections, e.g., influenza, pneumonia and tuberculosis, and lung cancer.

In some embodiments, the condition (e.g., disease or disorder) amenable to diagnosis and/or treatment using any aspects described herein can include a skin disease or disorder, or a skin condition. An exemplary skin disease or disorder can include skin cancer.

In some embodiments, the condition (e.g., disease or disorder) amenable to diagnosis and/or treatment using any aspects described herein can include a brain or mental disease or disorder (or neural disease or disorder). Examples of brain diseases or disorders (or neural disease or disorder) can include, but are not limited to, brain infections (e.g., meningitis, encephalitis, brain abscess), brain tumor, glioblastoma, stroke, ischemic stroke, multiple sclerosis (MS), vasculitis, and neurodegenerative disorders (e.g., Parkinson's disease, Huntington's disease, Pick's disease, amyotrophic lateral sclerosis (ALS), dementia, and Alzheimer's disease), Timothy symdrome, Rett symdrome, Fragile X, autism, schizophrenia, spinal muscular atrophy, frontotemporal dementia, any combinations thereof.

In some embodiments, the condition (e.g., disease or disorder) amenable to diagnosis and/or treatment using any aspects described herein can include a liver disease or disorder. Examples of liver diseases or disorders can include, but are not limited to, hepatitis, cirrhosis, liver cancer, billary cirrhosis, primary sclerosing cholangitis, Budd-Chiari syndrome, hemochromatosis, transthyretin-related hereditary amyloidosis, Gilbert's syndrome, and any combinations thereof.

In other embodiments, the condition (e.g., disease or disorder) amenable to diagnosis and/or treatment using any aspects described herein can include cancer. Examples of cancers can include, but are not limited to, bladder cancer; breast cancer; brain cancer including glioblastomas and medulloblastomas; cervical cancer; choriocarcinoma; colon cancer including colorectal carcinomas; endometrial cancer; esophageal cancer; gastric cancer; head and neck cancer; hematological neoplasms including acute lymphocytic and myelogenous leukemia, multiple myeloma, AIDS associated leukemias and adult T-cell leukemia lymphoma; intraepithelial neoplasms including Bowen's disease and Paget's disease, liver cancer; lung cancer including small cell lung cancer and non-small cell lung cancer; lymphomas including Hodgkin's disease and lymphocytic lymphomas; neuroblastomas; oral cancer including squamous cell carcinoma; osteosarcomas; ovarian cancer including those arising from epithelial cells, stromal cells, germ cells and mesenchymal cells; pancreatic cancer; prostate cancer; rectal cancer; sarcomas including leiomyosarcoma, rhabdomyosarcoma, liposarcoma, fibrosarcoma, synovial sarcoma and osteosarcoma; skin cancer including melanomas, Kaposi's sarcoma, basocellular cancer, and squamous cell cancer; testicular cancer including germinal tumors such as seminoma, non-seminoma (teratomas, choriocarcinomas), stromal tumors, and germ cell tumors; thyroid cancer including thyroid adenocarcinoma and medullar carcinoma; transitional cancer and renal cancer including adenocarcinoma and Wilm's tumor.

In some embodiments, the methods and systems described herein can be used for determining in a subject a given stage of cancer. The stage of a cancer generally describes the extent the cancer has progressed and/or spread. The stage usually takes into account the size of a tumor, how deeply the tumor has penetrated, whether the tumor has invaded adjacent organs, how many lymph nodes the tumor has metastasized to (if any), and whether the tumor has spread to distant organs. Staging of cancer is generally used to assess prognosis of cancer as a predictor of survival, and cancer treatment is primarily determined by staging. Thus, methods and systems for determining in a subject a given stage of cancer are also provided herein. For example, such methods and systems can comprise detecting in a biological sample (e.g., a biopsy) the physiological state of a subject's cancerous cells relative to tumors of different stages.

In some embodiments, the cancer to be diagnosed or treated or monitored can be breast carcinoma. In such embodiments, the methods and systems described herein can be used to distinguish a cancerous breast tissue from a normal breast tissue, or identify a given stage of a cancerous breast tissue, e.g., ductal carcinoma in situ, lobular carcinoma in situ, invasive ductal carcinoma or a subtype, invasive lobular carcinoma, etc. In some embodiments where the cancer has been metastasized to a different organ (e.g., bone metastasis), determining the physiological state of the cells obtained from a secondary tumor with the methods and systems described herein can also determine the primary origin of the metastatic cells, without prior knowledge of the existence of the primary tumor.

Pluripotent Stem Cells for Use in the Methods, Systems, and/or Kits Described Herein

In some embodiments, as described earlier, the methods, systems, and/or kits described herein can be used to assess the quality of pluripotent stem cells prior to use for cell transplantation therapies or gene therapy. Generally, a pluripotent stem cell for use in the methods, systems, and/or kits described herein can be obtained or derived from any available source. Accordingly, a pluripotent cell can be obtained or derived from a vertebrate or invertebrate. In some embodiments, the pluripotent stem cell is mammalian pluripotent stem cell. In all aspects as disclosed herein, pluripotent stem cells for use in the methods, systems and/or kits described herein can be any pluripotent stem cell. For example, a pluripotent stem cell can be obtained or derived from a vertebrate or an invertebrate. In some embodiments of various aspects described herein, the pluripotent stem cell is mammalian pluripotent stem cell.

In some embodiments of various aspects described herein, the pluripotent stem cell is primate or rodent pluripotent stem cell. In some embodiments of various aspects described herein, the pluripotent stem cell is selected from the group consisting of chimpanzee, cynomologous monkey, spider monkey, macaques (e.g. Rhesus monkey), mouse, rat, woodchuck, ferret, rabbit, hamster, cow, horse, pig, deer, bison, buffalo, feline (e.g., domestic cat), canine (e.g. dog, fox and wolf), avian (e.g. chicken, emu, and ostrich), and fish (e.g., trout, catfish and salmon) pluripotent stem cell.

In some embodiments of various aspects described herein, the pluripotent stem cell is a human pluripotent stem cell. In some embodiments, the pluripotent stem cell is a human stem cell line known to one of ordinary skill in the art. In some embodiments, the pluripotent stem cell is an induced pluripotent stem (iPS) cell, or a stably reprogrammed cell which is an intermediate pluripotent stem cell and can be further reprogrammed into an iPS cell, e.g., partial induced pluripotent stem cells (also referred to as “piPS cells”). In some embodiments, the pluripotent stem cell, iPSC or piPSC is a genetically modified pluripotent stem cell.

In some embodiments, the pluripotent state of a pluripotent stem cell used in the methods, systems and/or kits described herein can be confirmed by various methods. For example, the cells can be tested for the presence or absence of characteristic ES cell markers. In the case of human ES cells, examples of such markers are identified supra, and include SSEA-4, SSEA-3, TRA-1-60, TRA-1-81 and OCT 4, and are known in the art.

Also, pluripotency can be confirmed by injecting the cells into a suitable animal, e.g., a SCID mouse, and observing the production of differentiated cells and tissues. Still another method of confirming pluripotency is using the subject pluripotent cells to generate chimeric animals and observing the contribution of the introduced cells to different cell types. Methods for producing chimeric animals are well known in the art and are described in U.S. Pat. No. 6,642,433, which is incorporated by reference herein.

Yet another method of confirming pluripotency is to observe ES cell differentiation into embryoid bodies and other differentiated cell types when cultured under conditions that favor differentiation (e.g., removal of fibroblast feeder layers). This method has been utilized and it has been confirmed that the subject pluripotent cells give rise to embryoid bodies and different differentiated cell types in tissue culture.

The resultant pluripotent cells and cell lines, preferably human pluripotent cells and cell lines, which are derived from DNA of entirely female original, have numerous therapeutic and diagnostic applications. Such pluripotent cells may be used for cell transplantation therapies or gene therapy (if genetically modified) in the treatment of numerous disease conditions.

In this regard, it is known that some mouse embryonic stem (ES) cells have a propensity of differentiating into some cell types at a greater efficiency as compared to other cell types. Similarly, human pluripotent (ES) cells possess similar selective differentiation capacity. Accordingly, in some embodiments, the methods, systems, and/or kits described herein can be used to assess the quality of pluripotent stem cells prior to use for cell transplantation therapies or gene therapy as described earlier.

For example, a human pluripotent stem cell, e.g., a ES cell or iPS cell can be induced to differentiate into hematopoietic stem cells, muscle cells, cardiac muscle cells, liver cells, islet cells, retinal cells, cartilage cells, epithelial cells, urinary tract cells, etc., by culturing such cells in differentiation medium and under conditions which provide for cell differentiation, according to methods known to persons of ordinary skill in the art. Medium and methods which result in the differentiation of ES cells are known in the art as are suitable culturing conditions.

In some embodiments, a pluripotent stem cell is an induced pluripotent stem cell (e.g., an iPS cell) or a stable partially reprogrammed cell, e.g., piPSC. In some embodiments, the stable reprogrammed cells can be produced from the incomplete reprogramming of a somatic cell. In some embodiments, the somatic cell is a human cell, and can be a diseased somatic cell, e.g., obtained from a subject with a pathology, or from a subject with a genetic predisposition to have, or be at risk of a disease or disorder.

One can use any method for reprogramming a somatic cell to an iPS cell or an piPS cell, for example, as disclosed in International patent applications; WO2007/069666; WO2008/118820; WO2008/124133; WO2008/151058; WO2009/006997; and U.S. Patent Applications US2010/0062533; US2009/0227032; US2009/0068742; US2009/0047263; US2010/0015705; US2009/0081784; US2008/0233610; U.S. Pat. No. 7,615,374; U.S. patent application Ser. No. 12/595,041, EP2145000, CA2683056, AU8236629, 12/602,184, EP2164951, CA2688539, US2010/0105100; US2009/0324559, US2009/0304646, US2009/0299763, US2009/0191159, the contents of which are incorporated herein in their entirety by reference. In some embodiments, an iPS cell for use in the methods, systems and/or kits described herein can be produced by any method known in the art for reprogramming a cell, for example virally-induced or chemically induced generation of reprogrammed cells, as disclosed in EP1970446, US2009/0047263, US2009/0068742, and 2009/0227032, which are incorporated herein in their entirety by reference.

In some embodiments, an iPS cell for use in the methods, systems and/or kits described herein can be produced from the incomplete reprogramming of a somatic cell by chemical reprogramming, such as by the methods as disclosed in WO2010/033906, the contents of which is incorporated herein in its entirety by reference. In alternative embodiments, the stable reprogrammed cells disclosed herein can be produced from the incomplete reprogramming of a somatic cell by non-viral means, such as by the methods as disclose in WO2010/048567 the contents of which is incorporated herein in its entirety by reference.

Other pluripotent stem cells for use in the methods, systems, and/or kits described herein can be any pluripotent stem cell known to persons of ordinary skill in the art. Exemplary stem cells include embryonic stem cells, adult stem cells, pluripotent stem cells, neural stem cells, liver stem cells, muscle stem cells, muscle precursor stem cells, endothelial progenitor cells, bone marrow stem cells, chondrogenic stem cells, lymphoid stem cells, mesenchymal stem cells, hematopoietic stem cells, central nervous system stem cells, peripheral nervous system stem cells, and the like. Descriptions of stem cells, including method for isolating and culturing them, may be found in, among other places, Embryonic Stem Cells, Methods and Protocols, Turksen, ed., Humana Press, 2002; Weisman et al., Annu. Rev. Cell. Dev. Biol. 17:387 403; Pittinger et al., Science, 284:143 47, 1999; Animal Cell Culture, Masters, ed., Oxford University Press, 2000; Jackson et al., PNAS 96(25):14482 86, 1999; Zuk et al., Tissue Engineering, 7:211 228, 2001 (“Zuk et al.”); Atala et al., particularly Chapters 33 41; and U.S. Pat. Nos. 5,559,022, 5,672,346 and 5,827,735. Descriptions of stromal cells, including methods for isolating them, may be found in, among other places, Prockop, Science, 276:71 74, 1997; Theise et al., Hepatology, 31:235 40, 2000; Current Protocols in Cell Biology, Bonifacino et al., eds., John Wiley & Sons, 2000 (including updates through March, 2002); and U.S. Pat. No. 4,963,489. The skilled artisan will understand that the stem cells and/or stromal cells selected for inclusion in a transplant with mixed SVF cells or SVF-matrix construct (e.g. for encapsulating a tissue or cell transplant according to the constructs and methods as disclosed herein) are typically appropriate for the intended use of that construct.

Additional pluripotent stem cells for use in the methods, systems and/or kits described herein can be any cells derived from any kind of tissue (for example embryonic tissue such as fetal or pre-fetal tissue, or adult tissue), which stem cells have the characteristic of being capable under appropriate conditions of producing progeny of different cell types that are derivatives of all of the 3 germinal layers (endoderm, mesoderm, and ectoderm). These cell types may be provided in the form of an established cell line, or they may be obtained directly from primary embryonic tissue and used immediately for differentiation. Included are cells listed in the NIH Human Embryonic Stem Cell Registry, e.g. hESBGN-01, hESBGN-02, hESBGN-03, hESBGN-04 (BresaGen, Inc.); HES-1, HES-2, HES-3, HES-4, HES-5, HES-6 (ES Cell International); Miz-hES1 (MizMedi Hospital-Seoul National University); HSF-1, HSF-6 (University of California at San Francisco); and H1, H7, H9, H13, H14 (Wisconsin Alumni Research Foundation (WiCell Research Institute)). In some embodiments, an embryo has not been destroyed in obtaining a pluripotent stem cell for use in the methods, systems and/or kits described herein.

In another embodiment, the stem cells, e.g., adult or embryonic stem cells can be isolated from tissue including solid tissues (the exception to solid tissue is whole blood, including blood, plasma and bone marrow) which were previously unidentified in the literature as sources of stem cells. In some embodiments, the tissue is heart or cardiac tissue. In other embodiments, the tissue is for example but not limited to, umbilical cord blood, placenta, bone marrow, or chondral villi.

Stem cells of interest for use in the methods, systems and/or kits described herein also include embryonic cells of various types, exemplified by human embryonic stem (hES) cells, described by Thomson et al. (1998) Science 282:1145; embryonic stem cells from other primates, such as Rhesus stem cells (Thomson et al. (1995) Proc. Natl. Acad. Sci USA 92:7844); marmoset stem cells (Thomson et al. (1996) Biol. Reprod. 55:254); and human embryonic germ (hEG) cells (Shambloft et al., Proc. Natl. Acad. Sci. USA 95:13726, 1998). Also of interest are lineage committed stem cells, such as mesodermal stem cells and other early cardiogenic cells (see Reyes et al. (2001) Blood 98:2615-2625; Eisenberg & Bader (1996) Circ Res. 78(2):205-16; etc.). In some embodiments, the pluripotent stem cells may be obtained from any mammalian species, e.g. human, equine, bovine, porcine, canine, feline, rodent, e.g. mice, rats, hamster, primate, etc. In some embodiments, where the pluripotent stem cell is a human pluripotent stem cell, an embryo has not been destroyed in obtaining a pluripotent stem cell for use in the methods, systems and/or kits described herein.

In some embodiments, a pluripotent stem cell for use in the methods, systems and/or kits described herein is a human umbilical cord blood cell. Human umbilical cord blood cells (HUCBC) have recently been recognized as a rich source of hematopoietic and mesenchymal progenitor cells (Broxmeyer et al., 1992 Proc. Natl. Acad. Sci. USA 89:4109-4113). Previously, umbilical cord and placental blood were considered a waste product normally discarded at the birth of an infant. Cord blood cells are used as a source of transplantable stem and progenitor cells and as a source of marrow repopulating cells for the treatment of malignant diseases (i.e. acute lymphoid leukemia, acute myeloid leukemia, chronic myeloid leukemia, myelodysplastic syndrome, and neuroblastoma) and non-malignant diseases such as Fanconi's anemia and aplastic anemia (Kohli-Kumar et al., 1993 Br. J. Haematol. 85:419-422; Wagner et al., 1992 Blood 79; 1874-1881; Lu et al., 1996 Crit. Rev. Oncol. Hematol 22:61-78; Lu et al., 1995 Cell Transplantation 4:493-503). A distinct advantage of HUCBC is the immature immunity of these cells that is very similar to fetal cells, which significantly reduces the risk for rejection by the host (Taylor & Bryson, 1985 J. Immunol. 134:1493-1497).

Human umbilical cord blood contains mesenchymal and hematopoietic progenitor cells, and endothelial cell precursors that can be expanded in tissue culture (Broxmeyer et al., 1992 Proc. Natl. Acad. Sci. USA 89:4109-4113; Kohli-Kumar et al., 1993 Br. J. Haematol. 85:419-422; Wagner et al., 1992 Blood 79; 1874-1881; Lu et al., 1996 Crit. Rev. Oncol. Hematol 22:61-78; Lu et al., 1995 Cell Transplantation 4:493-503; Taylor & Bryson, 1985 J. Immunol. 134:1493-1497 Broxmeyer, 1995 Transfusion 35:694-702; Chen et al., 2001 Stroke 32:2682-2688; Nieda et al., 1997 Br. J. Haematology 98:775-777; Erices et al., 2000 Br. J. Haematology 109:235-242). The total content of hematopoietic progenitor cells in umbilical cord blood equals or exceeds bone marrow, and in addition, the highly proliferative hematopoietic cells are eightfold higher in HUCBC than in bone marrow and express hematopoietic markers such as CD14, CD34, and CD45 (Sanchez-Ramos et al., 2001 Exp. Neur. 171:109-115; Bicknese et al., 2002 Cell Transplantation 11:261-264; Lu et al., 1993 J. Exp Med. 178:2089-2096). One source of cells is the hematopoietic micro-environment, such as the circulating peripheral blood, preferably from the mononuclear fraction of peripheral blood, umbilical cord blood, bone marrow, fetal liver, or yolk sac of a mammal. In some embodiments, pluripotent stem cells, especially neural stem cells, may also be derived from the central nervous system, including the meninges.

### Kits

Kits, which can be used in combination with the methods and/or systems of various aspects described herein, are also provided. For example, a kit can comprise (a) at least one agent for assaying at least one test sample to determine biochemical gene expression measurements; and (b) a computer readable medium containing instructions to identify a physiological state of a target cell as described herein.

The reagent provided in the kit can be tailored to suit different types of assays to determine biochemical expression measurements. By way of example only, a microarray and/or amplification agents can be included in the kit to determine gene expression measurements of said at least one test sample. Alternatively, reagents for an antibody-based assay can be provided in the kit determine protein or peptide expression measurements of said at least one test sample. Methods for determining different biochemical expression measurements are known in the art. Accordingly, a skilled artisan can determine appropriate agents required for performing assays specific for different types of biochemical expression measurements.

The computer readable medium provided in the kit can comprise a normalized expression atlas specific for different applications. For example, in some embodiments where the kit is used for assessing stem cell quality, e.g., prior to cell transplantation or gene therapy, the normalized expression atlas provided in the computer readable medium can primarily contain reference data directed to various types of stem cells at different differentiation states, and mature tissue-specific cells. In some embodiments where the kit is used for diagnosis and/or treatment of cancer, the normalized expression atlas provided in the computer readable medium can primarily contain reference data directed to various types of cancer and/or related treatments.

In some embodiments, the kit can further comprise a control sample (e.g., a vial of control cells). For example, a control sample can comprise any kind of cells provided that it is characterized and its biochemical expression measurements are reflected as part of the normalized expression atlas. In some embodiments, a control sample can be assayed along with said at least one test sample, e.g., as a means to monitor the performance of the assay, and/or to account for assay-to-assay variations. If the determined locus of the control sample falls within an acceptable range on the normalized expression atlas, the assay results of the test sample can be considered valid. Alternatively or additionally, the determined locus of the control sample can also be used to guide normalization of the test sample data such that the determined locus of the control sample falls within the acceptable range on the normalized expression atlas.

Embodiments of various aspects described herein can be defined in any of the following numbered paragraphs:
1. A method of identifying a physiological state of a target cell comprising:
   providing a normalized expression atlas reflecting a plurality of reference loci, said plurality of reference loci corresponding to a set of reference phenotypes associated with reference samples, wherein each of the reference loci is determined based on a compendium of covariance measurements determined between different biochemical expression measurements across the reference samples;
   in a specifically-programmed computer, projecting onto the normalized expression atlas an expression vector reflecting at least a subset of biochemical expression measurements determined from a target cell to be identified, thereby locating the locus corresponding to the target cell on the normalized expression atlas;
   in the specifically-programmed computer, determining deviation of the locus corresponding to the target cell from the reference loci corresponding to at least one selected reference phenotype, wherein the magnitude of the deviation indicates degree of similarity between the physiological state of the target cell and said at least one selected reference phenotype, thereby identifying the physiological state of the target cell relative to said at least one selected reference phenotype.
2. The method of paragraph 1, further comprising assaying a test sample comprising the target cell to determine the biochemical expression measurements.
3. The method of paragraph 2, wherein the test sample is assayed by a method comprising polymerase chain reaction (PCR), real-time quantitative PCR, microarray, nucleic acid sequencing, western blot, immunohistochemical analysis, enzyme linked absorbance assay (ELISA), mass spectrometry, flow cytometry, gas chromatography, high performance liquid chromatography, nuclear magnetic resonance (NMR) spectroscopy, or any combinations thereof.
4. The method of any of paragraphs 1-3, wherein the target cell has been contacted with a perturbagen.
5. The method of any of paragraphs 1-4, wherein the target cell is derived from a test sample.
6. The method of any of paragraphs 2-5, wherein the test sample is collected at a first time point after the target cell has been contacted with the perturbagen.
7. The method of paragraph 6, wherein the test sample is collected at a second time point after the target cell has been contacted with the perturbagen, wherein the second time point is subsequent to the first time point.
8. The method of any of paragraphs 4-7, wherein the perturbagen is selected from the group consisting of proteins, peptides, nucleic acids (e.g., RNA, DNA, siRNA, snRNA), aptamers, small molecules, toxins, therapeutic agents, nutraceuticals, environmental stimuli (e.g., pressure, hypoxia, humidity, light, temperature (e.g., extremes in high and low temperatures), radiation), microbes, and any combinations thereof.
9. The method of any of paragraphs 4-8, further comprising selecting the perturbagen as a candidate for therapeutic evaluation, if the locus corresponding to the target cell contacted with the perturbagen has a smaller deviation from the reference loci (corresponding to a normal healthy state) than does a locus corresponding to the target cell not contacted with the perturbagen.
10. The method of any of paragraphs 2-9, wherein the test sample is derived from a cell culture.
11. The method of any of paragraphs 2-9, wherein the test sample is derived from a subject.
12. The method of any of paragraphs 2-11, wherein the test sample comprises a biological fluid sample (e.g., blood including whole blood, serum and/or plasma, urine, cerebrospinal fluid, amniotic fluid, or other bodily fluid sample), a biopsy sample, cell culture media, a homogenate, or a combination thereof.
13. The method of any of paragraphs 11-12, wherein the subject is determined to have, or have a risk for, a condition.
14. The method of paragraph 13, wherein said identifying the physiological state of the target cell further provides a diagnosis of the condition or a state of the condition in the subject.
15. The method of any of paragraphs 8-14, wherein the perturbagen comprises a therapeutic agent for treatment of the condition in the subject.
16. The method of paragraph 15, further comprising selecting for, and optionally administering to the subject, an alternative treatment regimen or adjusting a treatment regimen comprising the therapeutic agent, based on the magnitude of the deviation of the locus corresponding to the target cell from the reference loci corresponding to a normal healthy state, after the target cell has been contacted with the therapeutic agent.
17. The method of any of paragraphs 11-16, wherein the subject is a mammalian subject.
18. The method of paragraph 17, wherein the mammalian subject is a human subject.
19. The method of any of paragraphs 1-18, wherein the target cell is a somatic cell or a stem cell (e.g., a naturally existing or derived stem cell such as iPSC).
20. The method of any of paragraphs 1-19, wherein the target cell is a normal cell.
21. The method of any of paragraphs 1-19, wherein the target cell is a diseased cell.
22. The method of paragraph 21, wherein the diseased cell is a cancer cell.
23. The method of paragraph 22, wherein the cancer cell is a metastasis.
24. The method of paragraph 23, wherein said identifying the physiological state of the cancer cell further comprises identifying a tissue origin of the metastasis.
25. The method of paragraph 24, further comprising administering to the subject a treatment regimen
26. The method of any of paragraphs 1-25, wherein the number of the biochemical expression measurements is at least about 10 for each of the reference samples.
27. The method of any of paragraphs 1-26, wherein the number of the biochemical expression measurements is about 1000 to about 50,000 for each of the reference samples.
28. The method of any of paragraphs 1-27, wherein the number of reference samples is at least about 500.
29. The method of any of paragraphs 1-28, wherein the set of the reference phenotypes comprises at least about 50 reference phenotypes.
30. The method of any of paragraphs 1-29, wherein at least a subset of the reference phenotypes are associated with cell or tissue types.
31. The method of paragraph 30, wherein said at least the subset of the reference phenotypes are associated with a condition or a known state of the condition.
32. The method of any of paragraphs 30-31, wherein said at least the subset of the reference phenotypes are associated with a normal healthy state.
33. The method of any of paragraphs 30-32, wherein said at least the subset of the reference phenotypes are associated with a known effect of a perturbagen in contact with the reference cells.
34. The method of any of paragraphs 1-33, wherein the biochemical expression measurements comprise gene expression measurements, epigenetic marking measurements, RNA editing measurements, protein expression measurements, metabolite expression measurements, or any combinations thereof.
35. The method of any of paragraphs 1-34, further comprising constructing the normalized expression atlas.
36. The method of paragraph 35, wherein the normalized expression atlas is constructed by implementing, in the specifically-programmed computer, an algorithm comprising principal component analysis on a compilation of at least a subset of biochemical expression measurements determined from the reference samples.
37. The method of paragraph 36, wherein the principal component analysis comprises selecting at least first two principal components of said at least the subset of biochemical expression measurements determined from the reference samples.
38. The method of any of paragraphs 36-37, wherein said at least the subset of biochemical expression measurements correspond to a set of biochemical expression signatures for a target phenotype.
39. The method of paragraph 38, wherein the set of biochemical expression signatures for the target phenotype is identified in silico based on distributions of biochemical expression intensities across the reference samples.
40. The method of paragraph 39, wherein the set of biochemical expression signatures for the target phenotype is determined by an in silico process comprising use of a finite impulse response filter.
41. The method of any of paragraphs 1-40, further comprising in the specifically-programmed computer, projecting the expression vector onto a normalized time-course expression atlas reflecting a plurality of developmental reference loci, said plurality of the developmental reference loci corresponding to distinct developmental states of the reference samples.
42. The method of paragraph 41, wherein the normalized time-course expression atlas is constructed by implementing, in the specifically-programmed computer, an algorithm comprising principal component analysis on a compilation of at least a subset of biochemical expression measurements determined from the reference samples, wherein said at least a subset of the biochemical expression measurements correspond to said distinct developmental states of the reference samples.
43. The method of paragraph 41 or 42, wherein said distinct developmental states correspond to stemness, differentiation state, or malignancy.
44. A system comprising:
   (a) at least one determination module configured to receive said at least one test sample and perform at least one assay on said at least one test sample comprising a target cell to determine biochemical expression measurements;
   (b) at least one storage device configured to store the biochemical expression measurements of said at least one test sample determined from said determination module, and further configured to provide a normalized expression atlas reflecting a plurality of reference loci, said plurality of reference loci corresponding to a set of reference phenotypes associated with reference samples, wherein each of the reference loci is determined based on a compendium of covariance measurements determined between different biochemical expression measurements across the reference samples;
   (c) at least one analysis module configured to perform the following:
      projecting onto the normalized expression atlas an expression vector reflecting at least a subset of the biochemical expression measurements determined from said at least one determination module, thereby locating the locus corresponding to the target cell on the normalized expression atlas;
      determining deviation of the locus corresponding to the target cell from the reference loci corresponding to at least one selected reference phenotype, wherein the magnitude of the deviation indicates degree of similarity between the physiological state of the target cell and said at least one selected reference phenotype, thereby identifying the physiological state of the target cell relative to said at least one selected reference phenotype.
   (d) at least one display module for displaying a content based in part on the analysis output from said analysis module, wherein the content comprises a signal indicative of the presence of said at least one selected reference phenotype in the target cell, a signal indicative of the absence of said at least one selected reference phenotype in the target cell, a signal indicative of the deviation of the locus corresponding to the target cell from the reference loci, or any combinations thereof.
45. The system of paragraph 44, wherein said at least one assay comprises polymerase chain reaction (PCR), real-time quantitative PCR, microarray, nucleic acid sequencing, western blot, immunohistochemical analysis, enzyme linked absorbance assay (ELISA), mass spectrometry, flow cytometry, gas chromatography, high performance liquid chromatography, nuclear magnetic resonance (NMR) spectroscopy, or any combinations thereof.
46. The system of paragraph 44 or 45, wherein the target cell has been contacted with a perturbagen.
47. The system of paragraph 46, wherein the perturbagen is selected from the group consisting of proteins, peptides, nucleic acids (e.g., RNA, DNA, siRNA, snRNA), aptamers, small molecules, toxins, therapeutic agents, nutraceuticals, environmental stimuli (e.g., pressure, hypoxia, humidity, light, temperature (e.g., extremes in high and low temperatures), radiation), microbes, and any combinations thereof.
48. The system of any of paragraphs 44-47, wherein the test sample is derived from a cell culture.
49. The system of any of paragraphs 44-47, wherein the test sample is derived from a subject.
50. The system of paragraph 49, wherein the subject is a mammalian subject.
51. The system of paragraph 50, wherein the mammalian subject is a human subject.
52. The system of any of paragraphs 44-51, wherein the test sample comprises a biological fluid sample (e.g., blood including whole blood, serum and/or plasma, urine, cerebrospinal fluid, amniotic fluid, or other bodily fluid sample), a biopsy sample, cell culture media, a homogenate, or a combination thereof.
53. The system of any of paragraphs 44-52, wherein the content further comprises a signal indicative of a diagnosis of a condition or a state of the condition in the subject.
54. The system of any of paragraphs 44-53, wherein the content further comprises a signal indicative of a treatment regimen personalized to the subject, based on the magnitude of the deviation of the locus corresponding to the target cell from the reference loci corresponding to a normal healthy state.
55. The system of any of paragraphs 44-54, wherein the target cell is a somatic cell or a stem cell (e.g., a naturally existing or derived stem cell such as iPSC).
56. The system of any of paragraphs 44-55, wherein the target cell is a normal cell.
57. The system of any of paragraphs 44-55, wherein the target cell is a diseased cell.
58. The system of paragraph 57, wherein the diseased cell is a cancer cell.
59. The system of paragraph 58, wherein the cancer cell is a metastasis.
60. The system of paragraph 59, wherein the content further comprises a signal indicative of a tissue origin of the metastasis.
61. The system of any of paragraphs 44-60, wherein the number of the biochemical expression measurements is at least about 10 for each of the reference samples.
62. The system of any of paragraphs 44-61, wherein the number of the biochemical expression measurements is about 1000 to about 50,000 for each of the reference samples.
63. The system of any of paragraphs 44-62, wherein the number of reference samples is at least about 500.
64. The system of any of paragraphs 44-63, wherein the set of the reference phenotypes comprises at least about 50 reference phenotypes.
65. The system of any of paragraphs 44-64, wherein at least a subset of the reference phenotypes are associated with cell or tissue types.
66. The system of any of paragraphs 44-65, wherein said at least the subset of the reference phenotypes are associated with a condition or a known state of the condition.
67. The system of any of paragraphs 44-66, wherein said at least the subset of the reference phenotypes are associated with a normal healthy state.
68. The system of any of paragraphs 44-67, wherein said at least the subset of the reference phenotypes are associated with a known effect of a perturbagen in contact with the reference cells.
69. The system of any of paragraphs 44-68, wherein the biochemical expression measurements comprise gene expression measurements, epigenetic marking measurements, RNA editing measurements, protein expression measurements, metabolite expression measurements, or any combinations thereof.
70. The system of any of paragraphs 44-69, wherein the normalized expression atlas is constructed by implementing an algorithm comprising principal component analysis on a compilation of at least a subset of biochemical expression measurements determined from the reference samples.
71. The system of paragraph 70, wherein the principal component analysis comprises selecting at least first two principal components of said at least the subset of biochemical expression measurements determined from the reference samples.
72. The system of paragraph 70 or 71, wherein said at least the subset of biochemical expression measurements correspond to a set of biochemical expression signatures for a target phenotype.
73. The system of paragraph 72, wherein the set of biochemical expression signatures for the target phenotype is identified in silico based on distributions of biochemical expression intensities across the reference samples.
74. The system of paragraph 73, wherein the set of biochemical expression signatures for the target phenotype is determined by an in silico process comprising use of a finite impulse response filter.
75. The system of any of paragraphs 44-74, wherein said at least one storage device further comprises a normalized time-course expression atlas reflecting a plurality of developmental reference loci, said plurality of the developmental reference loci corresponding to distinct developmental states of the reference samples.
76. The system of paragraph 75, wherein the normalized time-course expression atlas is constructed by implementing an algorithm comprising principal component analysis on a compilation of at least a subset of biochemical expression measurements determined from the reference samples, wherein said at least a subset of the biochemical expression measurements correspond to said distinct developmental states of the reference samples.
77. The system of paragraph 75 or 76, wherein said distinct developmental states correspond to stemness, differentiation state, or malignancy.
78. The system of any of paragraphs 44-77, wherein the analysis module is further configured to project the expression vector onto the normalized time-course expression atlas.
79. A method for determining an effect of a perturbagen on a target cell comprising:
   a. contacting a target cell with a perturbagen;
   b. assaying the target cell to determine biochemical expression measurements;
   c. in a specifically-programmed computer, identifying a physiological state of the target cell comprising performing the method of any of paragraphs 1-43;
thereby determining an effect of the perturbagen on the target cell.
80. The method of paragraph 79, wherein the biochemical expression measurements comprise gene expression measurements, epigenetic marking measurements, RNA editing measurements, protein expression measurements, metabolite expression measurements, or any combinations thereof.
81. The method of paragraph 79 or 80, wherein the perturbagen is selected from the group consisting of proteins, peptides, nucleic acids (e.g., RNA, DNA, siRNA, snRNA), aptamers, small molecules, toxins, therapeutic agents, nutraceuticals, environmental stimuli (e.g., pressure, hypoxia, humidity, light, temperature (e.g., extremes in high and low temperatures), radiation), microbes, and any combinations thereof.
82. The method of any of paragraphs 79-81, wherein the perturbagen that generates a locus corresponding to the target cells in close proximity to a reference locus corresponding to a normal healthy state is a candidate for therapeutic evaluation.
83. A method of treating a subject with a condition comprising:
   administering a selected therapeutic agent to a subject determined to have a condition, wherein the therapeutic agent is selected based on a process comprising:
   a. contacting a population of cells with a plurality of perturbagens, wherein the population of cells are derived from a first test sample obtained from the subject;
   b. assaying the population of cells to determine biochemical expression measurements;
   c. in a specifically-programmed computer, identifying a physiological state of the population of the cells comprising performing the method of any of paragraphs 1-43, wherein at least one perturbagen that generates a locus corresponding to the population of cells in the closest proximity to a reference locus corresponding to normal healthy cells is selected as the therapeutic agent for administration to the subject.
84. The method of paragraph 83, further comprising selecting the therapeutic agent.
85. The method of any of paragraphs 83-84, wherein the population of cells comprise somatic cells of the subject.
86. The method of any of paragraphs 83-85, wherein the population of cells comprise tissue-specific cells differentiated from stem cells.
87. The method of paragraph 86, wherein the stem cells comprise naturally existing stem cells or derived stem cells (e.g., induced pluripotent stem cells) reprogrammed from the somatic cells.
88. The method of any of paragraphs 85-87, wherein the somatic cells or the tissue-specific cells comprise neurons.
89. The method of any of paragraphs 83-88, wherein the condition comprises a neurodevelopmental disorder, neurodegenerative disorder, a genetic disorder, metabolic disorder, cancer, or any combinations thereof.
90. The method of any of paragraphs 83-89, wherein the biochemical expression measurements comprise gene expression measurements, epigenetic marking measurements, RNA editing measurements, protein expression measurements, metabolite expression measurements, or any combinations thereof.
91. The method of any of paragraphs 83-90, wherein said at least one perturbagen is selected from the group consisting of proteins, peptides, nucleic acids (e.g., RNA, DNA, siRNA, snRNA), aptamers, small molecules, therapeutic agents, nutraceuticals, environmental stimuli (e.g., pressure, hypoxia, humidity, light, temperature (e.g., extremes in high and low temperatures), radiation), microbes, and any combinations thereof.
92. The method of any of paragraphs 83-91, wherein at least a subset of the reference loci represent a normal healthy state.
93. The method of paragraph 92, wherein a second subset of the reference loci represent a known state of the condition.
94. The method of any of paragraphs 83-93, further comprising administering to the subject a therapeutic agent selected for the condition.
95. The method of any of paragraphs 83-94, further comprising determining the condition or the state of the condition in the subject.
96. The method of paragraph 95, wherein the condition or the state of the condition is determined by a diagnostic process comprising
   a. assaying a second test sample collected from the subject to determine biochemical expression measurements;
   b. in a specifically-programmed computer, identifying a physiological state of target cells present in the second test sample comprising performing the method of any of paragraphs 1-43, wherein the magnitude of the deviation of the locus corresponding to the target cells from reference loci corresponding to the condition or different states of the condition, indicates degree of similarity between the physiological state of the target cells and the condition or different states of the condition, thereby determining the condition or the state of the condition in the subject.
97. A method of monitoring a therapeutic treatment in a subject comprising:
   a. assaying a test sample collected from a subject administered with a therapeutic treatment to determine biochemical expression measurements;
   b. in a specifically-programmed computer, identifying a physiological state of target cells in the test sample comprising performing the method of any of paragraphs 1-43,
thereby determining the effectiveness of the therapeutic treatment on the subject.
98. The method of paragraph 97, wherein the test sample is collected at a first time point after the subject has been treated with the therapeutic treatment.
99. The method of paragraph 97 or 98, wherein the test sample is collected at a second time point after the subject has been treated with the therapeutic treatment.
100. The method of any of paragraphs 97-99, further comprising comparing the physiological state of the target cells to at least one reference locus.
101. The method of any of paragraphs 97-100, wherein the reference locus represents a physiological state of target cells in a test sample collected prior to the therapeutic treatment.
102. The method of any of paragraphs 97-101, wherein the reference locus represents a physiological state of target cells in a test sample collected at the first time point after the subject has been treated with the therapeutic treatment.
103. The method of any of paragraphs 97-102, wherein the reference locus represents a normal healthy state.
104. The method of any of paragraphs 97-103, wherein the locus corresponding to the target cells approaching to the reference locus indicates effectiveness of the therapeutic treatment on the subject.
105. A method of diagnosing a condition or a state of the condition in a subject;
   a. assaying a test sample collected from a subject determined to have, or have a risk for, a condition;
   b. in a specifically-programmed computer, identifying a physiological state of target cells in the test sample comprising performing the method of any of paragraphs 1-43,
wherein the magnitude of the deviation of the locus corresponding to the target cells from the reference loci corresponding to at least one selected reference phenotype, indicates degree of similarity between the physiological state of the target cell and said at least one selected reference phenotype, thereby diagnosing the condition or the state of the condition in the subject.
106. The method of paragraph 105, wherein the reference locus represents a normal healthy state.
107. The method of paragraph 105 or 106, wherein the reference locus represents a known state of the condition.
108. The method of paragraph 107, further comprising administering the subject a therapeutic agent after diagnosing the condition.
109. A computer implemented method for identifying a physiological state of a target cell comprising: on a device having one or more processors and a memory storing one or more programs for execution by one or more processors, the one or more programs including instructions for:
   projecting onto a normalized expression atlas an expression vector reflecting at least a subset of biochemical expression measurements determined from a target cell to be identified, wherein the normalized expression atlas comprises a plurality of reference loci, said plurality of reference loci corresponding to a set of reference phenotypes associated with reference samples, wherein each of the reference loci is determined based on a compendium of covariance measurements determined between different biochemical expression measurements across the reference samples;
   locating the locus corresponding to the target cell on the normalized expression atlas;
   determining deviation of the locus corresponding to the target cell from the reference loci corresponding to at least one selected reference phenotype, wherein the magnitude of the deviation indicates degree of similarity between the physiological state of the target cell and said at least one selected reference phenotype, thereby identifying the physiological state of the target cell relative to said at least one selected reference phenotype; and
   displaying a content comprising a signal indicative of the presence of said at least one selected reference phenotype in the target cell, a signal indicative of the absence of said at least one selected reference phenotype in the target cell, a signal indicative of the deviation of the locus corresponding to the target cell from the reference loci, or any combinations thereof.
110. The computer implemented method of paragraph 109, wherein the one or more programs further comprise instructions for assaying a test sample comprising the target cell to determine the biochemical expression measurements.
111. The computer implemented method of paragraph 110, wherein the test sample is assayed by a method comprising polymerase chain reaction (PCR), real-time quantitative PCR, microarray, nucleic acid sequencing, western blot, immunohistochemical analysis, enzyme linked absorbance assay (ELISA), mass spectrometry, flow cytometry, gas chromatography, high performance liquid chromatography, nuclear magnetic resonance (NMR) spectroscopy, or any combinations thereof.
112. The computer implemented method of any of paragraphs 109-111, wherein the one or more programs further comprise instructions for constructing the normalized expression atlas.
113. The computer implemented method of paragraph 112, wherein the constructing comprises implementing an algorithm comprising principal component analysis on a compilation of at least a subset of biochemical expression measurements determined from the reference samples.
114. The computer implemented method of paragraph 113, wherein the principal component analysis comprises selecting at least first two principal components of said at least the subset of biochemical expression measurements determined from the reference samples.
115. The computer implemented method of any of paragraphs 113-114, wherein said at least the subset of biochemical expression measurements correspond to a set of biochemical expression signatures for a target phenotype.
116. The computer implemented method of paragraph 115, wherein the one or more programs further comprise instructions for identifying the set of biochemical expression signatures for the target phenotype based on distributions of biochemical expression intensities across the reference samples.
117. The computer implemented method of paragraph 116, wherein the determining comprises use of a finite impulse response filter.
118. The computer implemented method of any of paragraphs 109-117, wherein the one or more programs further comprise instructions for projecting the expression vector onto a normalized time-course expression atlas reflecting a plurality of developmental reference loci, said plurality of the developmental reference loci corresponding to distinct developmental states of the reference samples.
119. The computer implemented method of paragraph 118, wherein the one or more programs further comprise instructions for constructing the normalized time-course expression atlas by implementing an algorithm comprising principal component analysis on a compilation of at least a subset of biochemical expression measurements determined from the reference samples, wherein said at least a subset of the biochemical expression measurements correspond to said distinct developmental states of the reference samples.
120. The computer implemented method of any of paragraphs 109-119, wherein the content is displayed on a computer display, a screen, a monitor, an email, a text message, a website, a physical printout (e.g., paper) or provided as stored information in a storage device.
121. A computer system for identifying a physiological state of a target cell comprising: one or more processors; and memory to store one or more programs, the one or more programs comprising instructions for:
   (a) receiving at least one test sample and performing at least one assay on said at least one test sample comprising a target cell to determine biochemical expression measurements;
   (b) projecting onto a normalized expression atlas an expression vector comprising at least a subset of the biochemical expression measurements determined from (a), wherein the normalized expression atlas comprises a plurality of reference loci, said plurality of reference loci corresponding to a set of reference phenotypes associated with reference samples, wherein each of the reference loci is determined based on a compendium of covariance measurements determined between different biochemical expression measurements across the reference samples;
   (c) locating locus corresponding to the target cell on the normalized expression atlas;
   (d) determining deviation of the locus corresponding to the target cell from the reference loci corresponding to at least one selected reference phenotype, wherein the magnitude of the deviation indicates degree of similarity between the physiological state of the target cell and said at least one selected reference phenotype, thereby identifying the physiological state of the target cell relative to said at least one selected reference phenotype; and
   (d) displaying a content comprising a signal indicative of the presence of said at least one selected reference phenotype in the target cell, a signal indicative of the absence of said at least one selected reference phenotype in the target cell, a signal indicative of the deviation of the locus corresponding to the target cell from the reference loci, or any combinations thereof.
122. The computer system of paragraph 121, wherein said at least one assay comprises polymerase chain reaction (PCR), real-time quantitative PCR, microarray, nucleic acid sequencing, western blot, immunohistochemical analysis, enzyme linked absorbance assay (ELISA), mass spectrometry, flow cytometry, gas chromatography, high performance liquid chromatography, nuclear magnetic resonance (NMR) spectroscopy, or any combinations thereof.
123. The computer system of paragraph 121 or 122, wherein the content is displayed on a computer display, a screen, a monitor, an email, a text message, a website, a physical printout (e.g., paper) or provided as stored information in a storage device.
124. The computer system of any of paragraphs 121-123, wherein the content further comprises a signal indicative of a diagnosis of a condition or a state of the condition in the subject.
125. The computer system of any of paragraphs 121-124, wherein the content further comprises a signal indicative of a treatment regimen personalized to the subject, based on the magnitude of the deviation of the locus corresponding to the target cell from the reference loci corresponding to a normal healthy state.
126. The computer system of any of paragraphs 121-125, wherein the content further comprises a signal indicative of a tissue origin of the metastasis.
127. The computer system of any of paragraphs 121-126, wherein the number of the biochemical expression measurements is at least about 10 for each of the reference samples.
128. The computer system of any of paragraphs 121-127, wherein the number of the biochemical expression measurements is about 1000 to about 50,000 for each of the reference samples.
129. The computer system of any of paragraphs 121-128, wherein the number of reference samples is at least about 500.
130. The computer system of any of paragraphs 121-129, wherein the set of the reference phenotypes comprises at least about 50 reference phenotypes.
131. The computer system of any of paragraphs 121-130, wherein at least a subset of the reference phenotypes are associated with the groups consisting of cell or tissue types; conditions (e.g., diseases or disorders) or known states of the conditions; a normal healthy state; known effects of perturbagens on cells; and any combinations thereof.
132. The computer system of any of paragraphs 121-131, wherein the one or more programs further comprise instructions for constructing the normalized expression atlas.
133. The computer system of paragraph 132, wherein the normalized expression atlas is constructed by implementing an algorithm comprising principal component analysis on a compilation of at least a subset of biochemical expression measurements determined from the reference samples.
134. The computer system of paragraph 133, wherein the principal component analysis comprises selecting at least first two principal components of said at least the subset of biochemical expression measurements determined from the reference samples.
135. The computer system of paragraph 133 or 134, wherein said at least the subset of biochemical expression measurements correspond to a set of biochemical expression signatures for a target phenotype.
136. The computer system of paragraph 135, wherein the one or more programs further comprise instructions for identifying the set of biochemical expression signatures for the target phenotype based on distributions of biochemical expression intensities across the reference samples.
137. The computer system of paragraph 136, wherein the determining comprises use of a finite impulse response filter.
138. The computer system of any of paragraphs 121-137, wherein the one or more programs further comprise instructions for constructing a normalized time-course expression atlas comprising a plurality of developmental reference loci, said plurality of the developmental reference loci corresponding to distinct developmental states of the reference samples.
139. The computer system of paragraph 138, wherein the normalized time-course expression atlas is constructed by implementing an algorithm comprising principal component analysis on a compilation of at least a subset of biochemical expression measurements determined from the reference samples, wherein said at least a subset of the biochemical expression measurements correspond to said distinct developmental states of the reference samples.
140. The computer system of any of paragraphs 138-139, wherein the one or more programs further comprise instructions for projecting the expression vector onto the normalized time-course expression atlas.
141. A non-transitory computer-readable storage medium storing one or more programs for identifying a physiological state of a target cell, the one or more programs for execution by one or more processors of a computer system, the one or more programs comprising instructions for:
   projecting onto a normalized expression atlas an expression vector reflecting at least a subset of biochemical expression measurements determined from a target cell to be identified, wherein the normalized expression atlas comprises a plurality of reference loci, said plurality of reference loci corresponding to a set of reference phenotypes associated with reference samples, wherein each of the reference loci is determined based on a compendium of covariance measurements determined between different biochemical expression measurements across the reference samples;
   locating the locus corresponding to the target cell on the normalized expression atlas;
   determining deviation of the locus corresponding to the target cell from the reference loci corresponding to at least one selected reference phenotype, wherein the magnitude of the deviation indicates degree of similarity between the physiological state of the target cell and said at least one selected reference phenotype, thereby identifying the physiological state of the target cell relative to said at least one selected reference phenotype; and
   displaying a content comprising a signal indicative of the presence of said at least one selected reference phenotype in the target cell, a signal indicative of the absence of said at least one selected reference phenotype in the target cell, a signal indicative of the deviation of the locus corresponding to the target cell from the reference loci, or any combinations thereof.
142. The non-transitory computer-readable storage medium of paragraph 141, wherein the one or more programs further comprise instructions for assaying a test sample comprising the target cell to determine the biochemical expression measurements.
143. The non-transitory computer-readable storage medium of paragraph 142, wherein said at least one assay comprises polymerase chain reaction (PCR), real-time quantitative PCR, microarray, nucleic acid sequencing, western blot, immunohistochemical analysis, enzyme linked absorbance assay (ELISA), mass spectrometry, flow cytometry, gas chromatography, high performance liquid chromatography, nuclear magnetic resonance (NMR) spectroscopy, or any combinations thereof.
144. The non-transitory computer-readable storage medium of any of paragraphs 141-143, wherein the content further comprises a signal indicative of a diagnosis of a condition or a state of the condition in the subject.
145. The non-transitory computer-readable storage medium of any of paragraphs 141-144, wherein the content further comprises a signal indicative of a treatment regimen personalized to the subject, based on the magnitude of the deviation of the locus corresponding to the target cell from the reference loci corresponding to a normal healthy state.
146. The non-transitory computer-readable storage medium of any of paragraphs 141-145, wherein the content further comprises a signal indicative of a tissue origin of the metastasis.
147. The non-transitory computer-readable storage medium of any of paragraphs 141-146, wherein the number of the biochemical expression measurements is at least about 10 for each of the reference samples.
148. The non-transitory computer-readable storage medium of any of paragraphs 141-147, wherein the number of the biochemical expression measurements is about 1000 to about 50,000 for each of the reference samples.
149. The non-transitory computer-readable storage medium of any of paragraphs 141-148, wherein the number of reference samples is at least about 500.
150. The non-transitory computer-readable storage medium of any of paragraphs 141-149, wherein the set of the reference phenotypes comprises at least about 50 reference phenotypes.
151. The computer system of any of paragraphs 141-150, wherein at least a subset of the reference phenotypes are associated with the groups consisting of cell or tissue types; conditions (e.g., diseases or disorders) or known states of the conditions; a normal healthy state; known effects of perturbagens on cells; and any combinations thereof.
152. The non-transitory computer-readable storage medium of any of paragraphs 141-151, wherein the one or more programs further comprise instructions for constructing the normalized expression atlas.
153. The non-transitory computer-readable storage medium of paragraph 152, wherein the normalized expression atlas is constructed by implementing an algorithm comprising principal component analysis on a compilation of at least a subset of biochemical expression measurements determined from the reference samples.
154. The non-transitory computer-readable storage medium of paragraph 153, wherein the principal component analysis comprises selecting at least first two principal components of said at least the subset of biochemical expression measurements determined from the reference samples.
155. The non-transitory computer-readable storage medium of paragraph 153 or 154, wherein said at least the subset of biochemical expression measurements correspond to a set of biochemical expression signatures for a target phenotype.
156. The non-transitory computer-readable storage medium of paragraph 155, wherein the one or more programs further comprise instructions for identifying the set of biochemical expression signatures for the target phenotype based on distributions of biochemical expression intensities across the reference samples.
157. The non-transitory computer-readable storage medium of paragraph 156, wherein the determining comprises use of a finite impulse response filter.
158. The non-transitory computer-readable storage medium of any of paragraphs 141-157, wherein the one or more programs further comprise instructions for constructing a normalized time-course expression atlas comprising a plurality of developmental reference loci, said plurality of the developmental reference loci corresponding to distinct developmental states of the reference samples.
159. The non-transitory computer-readable storage medium of paragraph 158, wherein the normalized time-course expression atlas is constructed by implementing an algorithm comprising principal component analysis on a compilation of at least a subset of biochemical expression measurements determined from the reference samples, wherein said at least a subset of the biochemical expression measurements correspond to said distinct developmental states of the reference samples.
160. The non-transitory computer-readable storage medium of any of paragraphs 158-159, wherein the one or more programs further comprise instructions for projecting the expression vector onto the normalized time-course expression atlas.
161. The non-transitory computer-readable storage medium of any of paragraphs 141-160, wherein the content is displayed on a computer display, a screen, a monitor, an email, a text message, a website, a physical printout (e.g., paper) or provided as stored information in a storage device.

### SOME SELECTED DEFINITIONS

For convenience, certain terms employed in the entire application (including the specification, examples, and appended claims) are collected here. Unless defined otherwise, all technical and scientific terms used herein have the same meaning as commonly understood by one of ordinary skill in the art to which this invention belongs.

It should be understood that this invention is not limited to the particular methodology, protocols, and reagents, etc., described herein and as such may vary. The terminology used herein is for the purpose of describing particular embodiments only, and is not intended to limit the scope of the present invention, which is defined solely by the claims.

Other than in the operating examples, or where otherwise indicated, all numbers expressing quantities of ingredients or reaction conditions used herein should be understood as modified in all instances by the term “about.” The term “about” when used to described the present invention, in connection with numeric values means±5%.

In one aspect, the present invention relates to the herein described compositions, methods, and respective component(s) thereof, as essential to the invention, yet open to the inclusion of unspecified elements, essential or not (“comprising”). In some embodiments, other elements to be included in the description of the composition, method or respective component thereof are limited to those that do not materially affect the basic and novel characteristic(s) of the invention (“consisting essentially of”). This applies equally to steps within a described method as well as compositions and components therein. In other embodiments, the inventions, compositions, methods, and respective components thereof, described herein are intended to be exclusive of any element not deemed an essential element to the component, composition or method (“consisting of”).

The words “example” or “exemplary” or “e.g.,” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term or is intended to mean an inclusive or rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and an as used in this application and the appended claims should generally be construed to mean one or more unless specified otherwise or clear from context to be directed to a singular form.

As used herein, the term “a plurality of” refers to at least 2 or more, including, e.g., at least 3, at least 4, at least 5, at least 10, at least 15, at least 20, at least 25, at least 50, at least 75, at least 100 or more. In some embodiments, the term “a plurality of” refers to at least 100 or more, including, e.g., at least 250, at least 500, at least 750, at least 1000, or more. In some embodiments, the term “a plurality of” refers to at least 1000 or more, including, e.g., at least 1500, at least 2000, at least 3000, at least 4000, at least 5000, at least 7500, at least 10,000 or more.

The term “normal healthy subject” refers to a subject who has no symptoms of any diseases or disorders, or who is not identified with any diseases or disorders, or who is not on any medication treatment, or a subject who is identified as healthy by physicians based on medical examinations.

As used herein, the term “administer” refers to the placement of a composition into a subject by a method or route which results in at least partial localization of the composition at a desired site such that desired effect is produced. Routes of administration suitable for the methods described herein can include both local and systemic administration. Generally, local administration results in a higher amount of a therapeutic agent being delivered to a specific location (e.g., a target site to be treated) as compared to the entire body of the subject, whereas, systemic administration results in delivery of a therapeutic agent to essentially the entire body of the subject.

The term “induced pluripotent stem cell” or “iPSC” or “iPS cell” refers to a cell derived from a complete reversion or reprogramming of the differentiation state of a differentiated cell (e.g. a somatic cell). As used herein, an iPSC is fully reprogrammed and is a cell which has undergone complete epigenetic reprogramming. As used herein, an iPSC is a cell which cannot be further reprogrammed (e.g., an iPSC cell is terminally reprogrammed).

As used herein, the term “somatic cell” refers to any cell other than a germ cell, a cell present in or obtained from a pre-implantation embryo, or a cell resulting from proliferation of such a cell in vitro. Stated another way, a somatic cell refers to any cells forming the body of an organism, as opposed to germline cells. In mammals, germline cells (also known as “gametes”) are the spermatozoa and ova which fuse during fertilization to produce a cell called a zygote, from which the entire mammalian embryo develops. Every other cell type in the mammalian body-apart from the sperm and ova, the cells from which they are made (gametocytes) and undifferentiated stem cells—is a somatic cell: internal organs, skin, bones, blood, and connective tissue are all made up of somatic cells. In some embodiments the somatic cell is a “non-embryonic somatic cell”, by which is meant a somatic cell that is not present in or obtained from an embryo and does not result from proliferation of such a cell in vitro. In some embodiments the somatic cell is an “adult somatic cell”, by which is meant a cell that is present in or obtained from an organism other than an embryo or a fetus or results from proliferation of such a cell in vitro. Unless otherwise indicated the methods for reprogramming a differentiated cell can be performed both in vivo and in vitro (where in vivo is practiced when a differentiated cell is present within a subject, and where in vitro is practiced using isolated differentiated cell maintained in culture). In some embodiments, where a differentiated cell or population of differentiated cells are cultured in vitro, the differentiated cell can be cultured in an organotypic slice culture, such as described in, e.g., meneghel-Rozzo et al., (2004), Cell Tissue Res, 316(3); 295-303, which is incorporated herein in its entirety by reference.

As used herein, the term “adult cell” refers to a cell found throughout the body after embryonic development.

In the context of cell ontogeny, the term “differentiate”, or “differentiating” is a relative term meaning a “differentiated cell” is a cell that has progressed further down the developmental pathway than its precursor cell. Thus in some embodiments, a reprogrammed cell as this term is defined herein, can differentiate to lineage-restricted precursor cells (such as a mesodermal stem cell), which in turn can differentiate into other types of precursor cells further down the pathway (such as an tissue specific precursor, for example, a neural precursor cell), and then to an end-stage differentiated cell, which plays a characteristic role in a certain tissue type, and may or may not retain the capacity to proliferate further.

The term “embryonic stem cell” is used to refer to the pluripotent stem cells of the inner cell mass of the embryonic blastocyst (see U.S. Pat. Nos. 5,843,780, 6,200,806, which are incorporated herein by reference). Such cells can similarly be obtained from the inner cell mass of blastocysts derived from somatic cell nuclear transfer (see, for example, U.S. Pat. Nos. 5,945,577, 5,994,619, 6,235,970, which are incorporated herein by reference). The distinguishing characteristics of an embryonic stem cell define an embryonic stem cell phenotype. Accordingly, a cell has the phenotype of an embryonic stem cell if it possesses one or more of the unique characteristics of an embryonic stem cell such that that cell can be distinguished from other cells. Exemplary distinguishing embryonic stem cell characteristics include, without limitation, gene expression profile, proliferative capacity, differentiation capacity, karyotype, responsiveness to particular culture conditions, and the like.

By way of background only, an ES cell is considered to be undifferentiated when they have not committed to a specific differentiation lineage. Such cells display morphological characteristics that distinguish them from differentiated cells of embryo or adult origin. Undifferentiated ES cells are easily recognized by those skilled in the art, and typically appear in the two dimensions of a microscopic view in colonies of cells with high nuclear/cytoplasmic ratios and prominent nucleoli. Undifferentiated ES cells express genes that may be used as markers to detect the presence of undifferentiated cells, and whose polypeptide products may be used as markers for negative selection. For example, see U.S. application Ser. No. 2003/0224411 A1; Bhattacharya (2004) Blood 103(8):2956-64; and Thomson (1998), supra., each herein incorporated by reference. Human ES cell lines express cell surface markers that characterize undifferentiated nonhuman primate ES and human EC cells, including stage-specific embryonic antigen (SSEA)-3, SSEA-4, TRA-I-60, TRA-1-81, and alkaline phosphatase. The globo-series glycolipid GL7, which carries the SSEA-4 epitope, is formed by the addition of sialic acid to the globo-series glycolipid GbS, which carries the SSEA-3 epitope. Thus, GL7 reacts with antibodies to both SSEA-3 and SSEA-4. The undifferentiated human ES cell lines did not stain for SSEA-1, but differentiated cells stained strongly for SSEA-I. Methods for proliferating hES cells in the undifferentiated form are described in WO 99/20741, WO 01/51616, and WO 03/020920, which are incorporated herein in their entirety by reference.

All patents, patent applications, and publications identified herein are expressly incorporated herein by reference for the purpose of describing and disclosing, for example, the methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

### Examples

The following examples illustrate some embodiments and aspects of the invention. It will be apparent to those skilled in the relevant art that various modifications, additions, substitutions, and the like can be performed without altering the spirit or scope of the invention, and such modifications and variations are encompassed within the scope of the invention as defined in the claims which follow. The following examples do not in any way limit the invention.

### Example 1

### Use of Concordia Method in Analysis of Tumor Metastases Samples

Prior gene expression analyses, both large and small, have been dichotomous in nature, in which phenotypes are compared using clearly defined controls. Such approaches may require arbitrary decisions about what are considered “normal” phenotypes, and what each phenotype should be compared to. Instead, the inventors developed a holistic approach in which phenotypes were characterized in the context of a myriad of tissues and diseases. Scalable methods were used to associate expression patterns to phenotypes in order both to assign phenotype labels to new expression samples and to select phenotypically meaningful gene signatures. By using a nonparametric statistical approach, the inventors identified signatures that are more precise than those from existing approaches and accurately revealed biological processes that are hidden in case vs. control studies. In this Example, employing a comprehensive perspective on expression, the inventors showed how metastasized tumor samples localize in the vicinity of the primary site counterparts and are over-enriched for those phenotype labels. The novel approach provides insights into the biological processes that underlie differences between tissues and diseases beyond those identified by traditional differential expression analyses.

Although gene expression microarrays have been a standard, widely-utilized biological assay for many years, there is still a lack of comprehensive understanding of the transcriptional relationships between various tissues and disease states. Even with the hundreds of thousands of expression array data sets available through public repositories such as NCBI's Gene Expression Omnibus (1) (GEO), the lack of standardized nomenclature and annotation methods has made large-scale, multi-phenotype analyses difficult. Thus, expression analyses have typically used the decade old approach of comparing expression levels across two states (e.g., case vs. control) or a limited number of phenotype classes (2-4). Even recent large-scale gene expression investigations, whether they have attempted to elucidate phenotypic signals (5-7) or applied those signals for downstream analyses such as drug repurposing (8, 9), involve comparisons between two states or classes. Comparative analyses, where transcriptional differences are directly measured between two phenotypes, inherently impose subjective decisions about what constitutes an appropriate control population Importantly, such analyses are fundamentally limited in scope and cannot differentiate between biological processes that are unique to a particular phenotype or part of a larger process that is common to multiple phenotypes (e.g. a generic “cancer pathway”). Moreover, the results of such comparative analyses can be limited in generalizability as they make assumptions about the phenotypes being compared (10).

Presented herein is a novel, scalable and robust approach that leverage the full expression space of a large diverse set of tissue and disease phenotypes to accurately perform and glean biological insights from both sample- and gene-centric analyses. By analyzing a given phenotype in the context of this comprehensive transcriptomic landscape, the need for predefined control groups and presupposed relationships between phenotypes (FIG. 2A) can be circumvented. The accuracy of an enrichment statistic that provides detailed phenotypic information for new samples when they are mapped onto and compared with the transcriptomic landscape (which is accessible online at http://concordia.csail.mit.edu) was devised, implemented and validated.

A new perspective on interpreting gene expression space helps uncover phenotype-specific marker genes beyond those discovered by traditional dichotomous views of gene expression. Presented herein a method comprising identifying a set of gene expression signatures for a target phenotype based on an in silico process comprising use of a finite impulse response filter (11) in signal processing to reveal, for instance, marker genes involved in carbohydrate and lipid metabolism as key processes in breast cancer. Such findings are in contrast to those of traditional over- and under-expression based analyses, which focus on generic cancer processes not specific to breast cancer such as cell-cycle and cell adhesion (12). Based on the hierarchical nature of the phenotypic labels associated with samples, e.g., constructed using an apparatus or framework described in the U.S. App. No. US 2011/0047169, the content of which is incorporated herein in its entirety by reference, it was discovered that genes previously linked to specific types of carcinomas may actually be part of a broader “carcinoma” process. In addition, this Example shows how one or more embodiments of the methods described herein can be used to identify how metastasized tumor samples are transcriptomically more proximal to other cancer samples from their respective primary sites, as opposed to cancerous tissue from the metastasis sites from which the samples were resected.

### Results

Transcriptomic Landscape:

As an initial step towards a holistic approach to gene expression analysis, the substructure of the global transcriptomic landscape was constructed. For example, a curated gene expression database of 3030 diverse samples (from 192 series) obtained from NCBI's Gene Expression Omnibus (1) (GEO) was constructed. These samples were annotated with their phenotypes (tissue of origin, disease state, etc.) using the anatomical and disease concepts in a custom subset of the Unified Medical Language System (13) (UMLS) concept ontology via both natural language processing and manual validation (see, Exemplary Methods below and US 2011/0047169, the content of which is incorporated herein in its entirety by reference, for methods of annotating samples with their phenotypes).

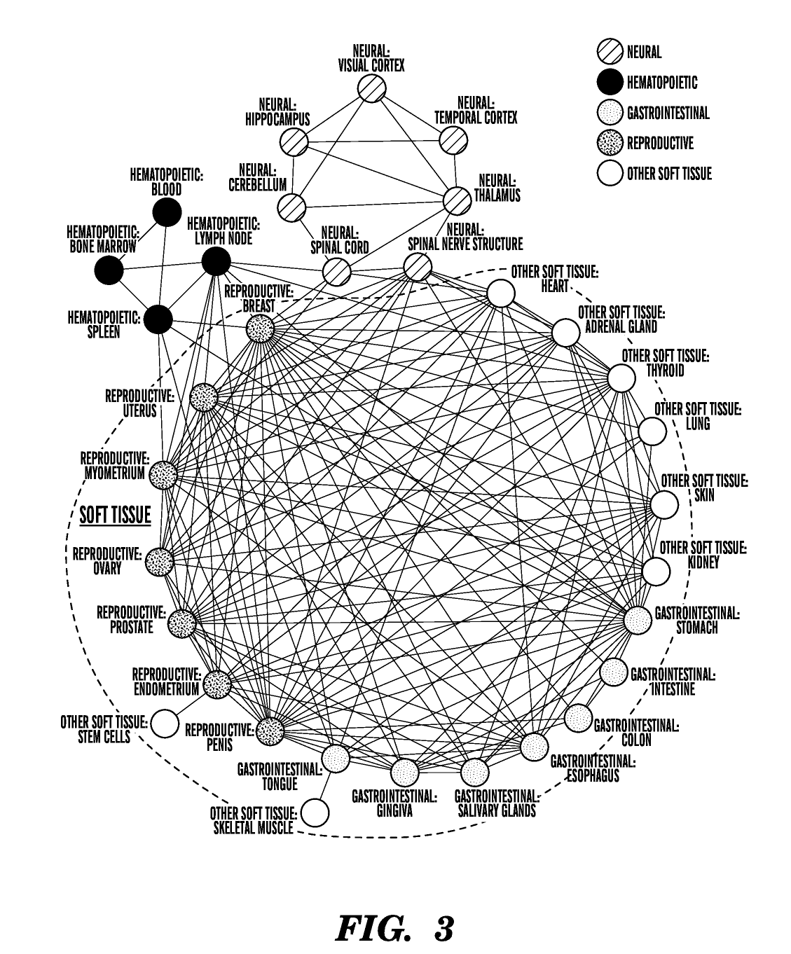

Instead of analyzing the full transcriptomic landscape encompassing all genes, the first two principal components (PCs) of the expression level of 20252 genes across the database provide a representation of the phenotypic relationships that captures roughly 20% of the variance in the data (see, e.g., Exemplary Methods below). Although it has been suggested that the primary factors driving the organization of the global transcriptomic landscape can largely be attributed to hematopoietic and malignant programming (14), the inventors have discovered that the cell and tissue specific signatures of blood, brain, and soft tissue are dominant (FIG. 2B). Furthermore, these PCs recapitulate the phenotypic relationships captured in a tissue network (FIG. 3) derived from a de-novo tissue correlation analysis (see, e.g., Exemplary Methods below). Indeed, when analyzing the tissue specific characteristics of these clusters, the over-expression of fibrillar and epithelial genes such as COL3A1, COL6A3, KRT19, KRT14, and CADH1 in the soft tissue cluster and neural genes such as GFAP, APLP1, GRIA2, PLP1, and SLC1A2 in the brain cluster was determined Gene ontology (GO) enrichment analysis of the top 250 tissue specific genes for each cluster further points to over-enrichment for terms related to each of the three tissue types (Appendix 1). Several recent reports have stated that data from different datasets are not comparable as the dataset signal is dominant (10, 15); however, as the methods described herein are based on an expression space of a large diverse set of tissue and disease phenotypes, the tissue signal becomes dominant in this macroscopic view, which is further discussed below.

Quantification of the “Batch” Effect.

There have been several reports that data from different datasets are not comparable as the dataset (batch) signal is dominant (10, 15). Whereas the localization of phenotypes as seen in the expression landscape (FIGS. 2A-2C), regardless of series of origin, depicts the lack of a dataset effect in principal component space, the cross-validation performance shows that this phenomenon holds true when all gene expression data is considered. Although the AUC and ROC curves are generally used to quantify the performance of a classifier, they can also be used as a proxy to quantify the significance of a batch effect. As high AUC values can only be attained through accurate identification of phenotypes in cross-validation, it is a necessary precondition for samples associated with a given phenotype to be more closely related to each other than those associated with another phenotype.

In addition, by associating the series of origin for each sample used to generate the ROC plot, one can examine the degree of the batch effect by the clustering of the samples from these series. The analysis shows that: 1) samples with the phenotype, regardless of dataset, are closer to the other samples with the same phenotype, and 2) samples from various datasets are intermingled. Leukemia samples, for example, were more closely related to other leukemia samples with a mean intraphenotype, interseries correlation of 0.1 higher compared to other samples within their own dataset that were nonleukemia samples (interphenotype, intraseries). This trend is found to be evident in the ROC curves across all types of phenotypes. If this were not the case, not only would the AUC values for concepts that have samples from multiple series have to be substantially lower than those with fewer series, but also the phenotypic localization evident in the transcriptome landscape would have been overshadowed by dataset localization.

In an effort to quantify the dataset effect (DE) from the correlation structure of the gene expression samples used in the construction of the transcriptome landscape, the mean difference in correlation between all samples in a series with the phenotype to all other samples in other series with that phenotype was compared to the mean difference in correlation of samples with a given phenotype in a series against all other samples in that series without the phenotype. In the event that the signal from the data series is greater than that of the phenotype, one would expect that the intraseries correlation between differing phenotypes is greater than the interseries correlation between samples corresponding to identical phenotypes. The p-values were computed by randomly shuffling the phenotype labels on the samples and computing the dataset effect 100 times for each tissue type. The empirical p-value was determined by finding the position in the sorted list of sampled dataset effect values. The majority of the tissues for which sufficient data was available (at least two series with the phenotype and at least one series containing both the phenotype of interest and at least one other phenotype), do not exhibit the existence of a batch effect. For example, across six series with normal prostate tissue, the correlation of prostate samples to other prostate samples in other series is on average 0.17 higher than the correlation of those samples to other samples within their own series. In the few instances where the correlation within the dataset is higher, it generally is due to the highly similar nature of the samples and that the tissue signal dominates the disease signal. In the case for the blood series, for instance, normal blood is being compared to diseased blood. Appendix 4 provides these numbers for all tissues that are represented in the tissue relationship network such that a negative batch effect implies that the phenotypic signal dominated the dataset signal.

By additionally performing principal component analysis on soft tissue samples (all non-cancerous samples that are also not blood or brain), it was determined that phenotypic grouping occurs on multiple levels of phenotypic granularity. Not only are individual tissue samples in confined regions, they are also organized by functionality. Tissues sensitive to reproductive hormones (e.g., ovary, uterus, myometrium, endometrium, prostate, penis, and breast) group together to form a distinct sub-region in the smooth landscape (FIG. 2C). Juxtaposed to them are primarily gastrointestinal tract samples from tissues such as colon, stomach, intestine, liver, and esophagus.

Concordia: Phenotypic concept enrichment. Although correlation analyses and the representation of the transcriptomic landscape provide insight into the broad relationships between various phenotypes, the ability to harness these expression signals to map new, previously unseen samples into a database of expression samples is compelling. Beginning with customized UMLS concept annotation of the 3030 samples, the set of UMLS concepts was restricted to the 1489 anatomy and disease concepts that mapped to at least three expression samples (FIGS. 4A-4B). A sample-centric method was developed based on the Kolmogorov-Smirnov statistic to label new samples with UMLS concepts that are over-represented in their local expression neighborhoods (See, e.g., Exemplary Methods below). No hard boundaries are drawn when a new input sample is labeled, but rather the concepts pertinent to the transcriptomic neighborhood for the input sample are reported. Importantly, as it is often difficult to define an appropriate control, this approach has the advantage that it does not require case-control type input but, rather, just a single microarray sample. Concordia (a web-based analysis tool accessible at http://concordia.csail.mit.edu) allows users to submit their own microarray samples performed on the Affymetrix HG-U133 Plus 2.0 array and obtain their over-enriched tissue and disease concepts.

Leave-one-sample-out cross-validation was performed to validate the accuracy of the method for assigning an unknown sample to the correct phenotype. The receiver operating characteristic (ROC) curve was computed for each of the 1489 UMLS concepts, and the standard measure of area under the curve (AUC) that summarizes both the true-positive and false-positive rates was used as a measure of accuracy. An average accuracy of 92.8% was observed after restricting the set of UMLS concepts to the 1209 that have samples from two or more expression series in GEO to ensure that a diverse set of data is used. Even when the concepts were restricted to the 450 that have at least 50 samples originating from at least five different data series, the average accuracy is approximately 89.8%. Table 1 contains the performance of a selection of UMLS concepts, along with the number of samples and series that were associated with that concept. “Broader” concepts have poorer performance compared to the more specific concepts, as the former encompass a much more diverse expression signal. As many of these concepts are similar and have samples in common; consequently, many of the concepts have similarly high (low) AUC values (See Table S2 of Schmid P. R. et al. (2012) PNAS 109: 5594-5599).

TABLE 1
Concordia cross-validation performance on selected
UMLS concepts

| Concept | AUC | No. series | No. samples |
|---|---|---|---|
| Malignant neoplasms | 0.82 | 74 | 855 |
| Malignant neoplasm of breast | 0.97 | 9 | 69 |
| Malignant neoplasm of ovary | 0.99 | 4 | 51 |
| Malignant neoplasm of lung | 0.97 | 4 | 98 |
| Leukemia | 0.99 | 13 | 151 |
| Soft tissue | 0.69 | 98 | 1,513 |
| Breast | 0.93 | 13 | 195 |
| Ovary | 0.95 | 8 | 103 |
| Lung | 0.95 | 9 | 131 |
| Inflammatory disorder | 0.79 | 13 | 91 |
| Rheumatoid arthritis | 0.93 | 7 | 31 |
| Inflammatory bowel diseases | 0.99 | 2 | 24 |

Scalability.

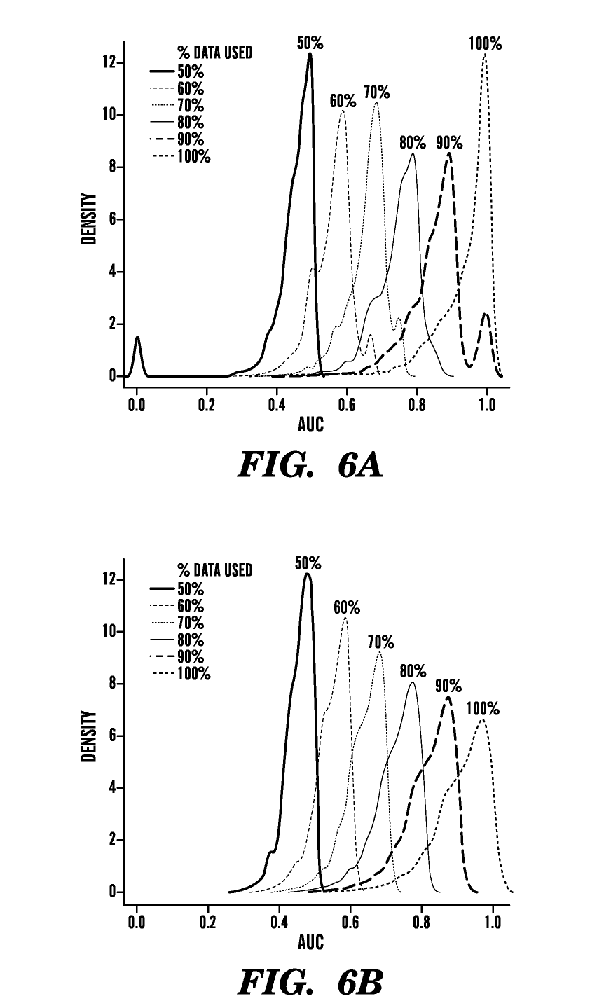

Due to the nonparametric data-driven nature of the method, the method described herein can accommodate any size of data corresponding gene expression samples that are present in the database. In order to determine whether or not adding more samples to the smooth continuum of the transcriptomic landscape provides a higher resolution picture, or if it merely muddles the picture, the classification accuracy of each concept was calculated when the number of samples that were used to compute the enrichment score for that given concept was set to 50%, 60%, 70%, 80%, and 90%. For example, using all 69 samples for “malignant neoplasm of breast” yields an accuracy of 96.5%. Then, keeping all else constant, half of the “malignant neoplasm of breast” samples were removed and the enrichment score was re-computed. This random recomputation was performed five times for each concept at each threshold. In the case of “malignant neoplasm of breast,” for instance, the average accuracy across the five runs using only 34 samples is a mere 37%. Thus, the average accuracy across all concepts drastically increases from 44% to roughly 93% when increasing the amount of data used (FIGS. 6A-6B). It is also noteworthy that the concepts that are the most susceptible to change are specific concepts (e.g., “pluripotent stem cells” and “myeloid leukemia”), whereas the classification accuracy of the broad topics (e.g., “soft tissue” and “disorders”) are unaffected by the quantity of data as the underlying gene expression values are so vastly different. Furthermore, when the set of concepts was restricted to only the 544 that were associated with at least 50 samples (FIG. 6B), there is still a substantial increase in performance Although not providing a summary result for all concepts, this restricted view shows a more robust view of the accuracies as only the concepts that had “sufficient” data (many samples, multiple datasets) are included.

Accordingly, a significant increase in accuracy was observed as more data is added to the underlying database. For example, as noted above, when half of the samples associated with each concept are removed, the global performance is a mere 44%, compared to the aforementioned 93%. This implies that the phenotypic signal becomes stronger and the power of this type of macroscopic analysis increases with the amount of underlying data. As the methods described herein generally employ a non-parametric enrichment statistic that only requires the concept annotation of the samples in the original gene expression database, it can be updated in real-time without having to “retrain” the database. A system such as this could thus be deployed in a research or clinical setting where new samples are continually being added and analyzed, with minimal alteration of normal protocols.

Concept Enrichment for Gene Expression Omnibus (GEO).

With a database primed with the 3,030 labeled samples ranging from normal breast to blood from children with septic shock, Concordia was applied to 15,904 other GEO (43) samples performed on the Affymetrix HG-U133 Plus 2.0 array and each sample was mapped onto the transcriptomic landscape. In this manner, the concept enrichment scores for 1,489 anatomy and disease-related concepts for other samples can be provided based on the current biological “knowledge-base” of Concordia. These concept enrichment scores can thus be used as an additional source of biological information when performing future large-scale gene expression analyses. For example, if one is looking for expression samples relating to breast tissue, he/she could both examine the text that is associated with each sample, and determine the expression similarity of that particular sample and the concept for “breast.” The full matrix of concept enrichment scores can be publicly obtained from the downloads section of the Concordia website at http://concordia.csail.mit.edu.

Phenotypic-Specific Marker Genes.

A method to identify marker genes that characterize a specific phenotype in the context of broad transcriptomic landscapes, and not in the context of dichotomous classes, was developed. Instead of defining a marker gene as one that is over- or under-expressed in a case vs. control study using methods akin to t-tests, a marker gene was defined herein as a gene that has a “localized” expression signature for a phenotype; i.e., how grouped together are all of the samples corresponding to that phenotype for that gene. If all of the samples for a phenotype have a very similar expression level (all high, all low, etc.), the gene may be considered as a marker gene for that phenotype. To do so, for example, a finite impulse response filter (11) (FIRF) was employed on each gene's expression values across the entire database of 3030 diverse expression samples to quantify the degree of expression level localization for a given phenotype. To generate the set of genes most relevant to a phenotype, the marker gene localization scores were used to rank all genes and then the cutoff for the number of genes to include was identified by balancing the set's ability to accurately classify samples of its own phenotype while minimizing the presence of non-phenotype specific signal (See, e.g., Exemplary Methods below). Not only does this method sidestep the requirement of defining appropriate “control” phenotype(s), it can also facilitate the identification of thematically coherent gene signatures that reveal very different aspects of biology from traditional ones.

As an example, the breast cancer gene set was derived from a landscape of 673 samples representing 17 different cancerous tissues. The 74 genes that comprise this set are functionally enriched for processes related to breast specific development, and carbohydrate and lipid metabolism (Appendices 2 and 3). These pathways, revealed through gene expression, are consistent with independent clinical and genetic data indicating an important role for carbohydrate and lipid metabolism in breast cancer. For example, women with type 2 diabetes may have higher susceptibility to breast cancer (16). Three genes specifically indicated in this analysis, ENPP1, ADIPOQ and PPARA, are of particular interest. ADIPOQ is expressed in adipose tissue exclusively. Variants in the ADIPOQ gene and protein levels are implicated in prostate cancer (17) and breast cancer (18). Similarly, ENPP1 levels have been correlated to progression-free survival in tamoxifen-treated patients with breast cancer (19). PPARA is one of a family of nuclear transcription factors that has been found to stimulate both adipocyte (fat cell) differentiation and fatty acid oxidation (20). Moreover, the PPARA signaling pathway has been implicated in breast cancer progression (21), and in a case-control study a polymorphism of PPARA was identified to be associated with a two-fold increase in breast cancer (22).

Notably missing from this list of enriched pathways are processes commonly associated with cancer, such as cell-cycle and cell-adhesion (12). This conventional perspective can be recreated by selecting the set of candidate marker genes using a traditional permutation t-test based method (See, e.g., Exemplary Methods below). However, this reveals enrichment for processes that are associated with cancer in general, but not specific to breast cancer, such as “cellular response to tumor necrosis factor,” “induction of apoptosis,” and other tumor related processes (Appendices 2 and 3). Furthermore, according to the permutation t-test method, PPARA is less significant than nearly 17% of the other genes (ADIPOQ is in the top 2% and ENPP1 is in the top 0.5%). In comparison, using the FIRF, the tumor necrosis related genes, such as RIPK1, TRADD, and TNFRSF25, do not appear until, respectively, 18%, 54%, and 97% of the other more breast cancer-specific genes appear first.

To ascertain the “cancer” gene set using the FIRF based method, the transcriptomic landscape was expanded to include not only 17 cancers, but also 2187 samples across 30 non-cancerous tissue types. By comparing all cancers against all non-cancers, it was unsurprisingly found that the most significant genes are functionally enriched for processes that are typically associated with tumors: for example, “cell division,” “cell cycle,” and “DNA repair”. Taken together, landscape-based gene signature analysis and discovery can recapitulate canonical cancer pathways, but also can identify a complementary set of gene signatures with distinct biological implications.

Specificity of Marker Genes.

It has been suggested that the so-called “incidentalome” of incidental findings is a threat that has yet to be addressed in either biological or clinical settings (23). The consequences of non-comprehensive views of biomarkers, such as prostate specific antigen, continue to cause needless harm and costs (24). By performing analyses in the context of a large database of biological samples, however, the inventors discovered that many genes are not specific to a single disease.

To illustrate this, the “carcinoma” marker gene localization scores was computed by comparing the 459 carcinoma samples in the database to the 270 other tumor samples. As the UMLS concepts are in a structured ontology, the marker gene scores for the 13 concepts subordinate to “carcinoma” (e.g., “adenocarcinoma,” “Adenosquamous carcinoma”) were computed. From the list of genes sorted by their carcinoma marker gene score p-value, all genes that had a better p-value in any of the 13 subordinate concepts were removed. This yielded a list of 5805 genes that had better p-values at the more general concept “carcinoma” than at any of the more specific subordinate carcinoma types. Functional enrichment analyses of the top 10, 20, 50, 100, and 150 genes in this list reveals processes such as “regulation of cell adhesion,” “response to growth factors,” and other morphogenesis and development terms. Furthermore, within the sorted list of carcinoma genes, genes previously implicated in carcinomas such as COL1A1 (25, 26) and ELF3 (27) were found in the top 5. As such, these genes that have previously been implicated in particular types of carcinomas may instead be part of a larger “carcinoma” process, rather than specific to breast or colorectal cancer.

This kind of quantification of phenotype specificity is relevant to the diagnostic accuracy of putative biomarkers and for developing suitably broad-spectrum or targeted therapeutics. As such, the gene-phenotype expression localization scores (and corresponding binomial p-values) for all 20252 genes on the Affymetrix HG-U133 Plus 2.0 for all 1,489 anatomy and disease concepts were computed. There are multiple perspectives of the data. First, there is a perspective where tissues are grouped together regardless of whether they are cancerous or not. In other words, this view states that because breast cancer is a type of breast tissue, the scores for “breast” should incorporate the cancerous tissue as well. The second view makes the opposite assumption and presents the scores for the genes such that, for example, the breast tissue scores were computed without including samples from breast cancer. The full matrices of gene scores can be publicly obtained from the downloads section of the Concordia website: http://concordia.csail.mit.edu.

Specificity of the Conventional Classification of Tissue and Disease.

Employing the classification accuracies of the conventional clinical categories as defined by the UMLS hierarchy allows one to systematically estimate the classification robustness of conventional clinical labels as compared to molecular pathophenotypes (42). The subtree of the ontology rooted at “inflammatory disease,” is a striking illustration of the faithful reflection of specificity as a function of depth in the tree. As conventional wisdom would dictate, concepts relating to broad phenotypic topics that span multiple tissue or disease categories have lower classification potential than specific concepts located deeper in the ontology that have a more conserved gene expression pattern. For instance, it was found that the classification accuracy of the more specific concept, “chronic arthropathy” (98%), is significantly higher than that of “inflammatory disorder” (78.9%). In general, the conventional clinical classification of tissue and disease mirrors the underlying gene expression signature. If, for example, the opposite effect were observed, such that concepts higher in the hierarchy had higher accuracies, the structure of clinical nomenclature would be put into question.

It is important to note that the ordering based on depth in the UMLS hierarchy is not global, but a local phenomenon. For example, “arthritis” splits into two subtrees in which the side rooted at “chronic arthropathy” has a high predictive value all the way down the subtree, whereas the other subtree has a wider variance in predictive accuracies. Furthermore, being deeper in the UMLS hierarchy does not necessarily mean that a concept is more specific; for instance, both the general term “inflammatory disorder of the digestive system” and the more specific concept “periodontitis” are four hops from “inflammatory disorder.” In general, deeper concepts in the hierarchy have both fewer samples associated with them and have higher accuracies. As the deeper concepts corresponding to gene expression samples generally have greater biological similarities, fewer samples can be sufficient to yield high accuracy. For example, the “deeper” concept “malignant neoplasm of breast” has a higher predictive power with 67 samples than the broader concept “primary malignant neoplasm” with 697 samples.

Tissue specific signal of tumor metastases. The clinical problem of distinguishing whether a cancerous lesion represents a primary tumor, or a metastasis from a distant malignancy, presents a test case for the ability of the methods described herein to localize a sample to the appropriate phenotypic group within the transcriptomic landscape. By combining the aforementioned sample- and gene-centric methods, new tumor metastasis tissue samples can be mapped onto the expression landscape, providing an unbiased measure of their phenotypic predisposition based on gene expression. It is commonly known by pathologists that tumor metastasis tissue biopsies viewed “under the microscope” resemble the tissue of the primary site rather than that of the tissue in the metastasized location. Nevertheless, the proper identification of the primary site of a metastasis can be critical in determining the appropriate clinical treatment plan (28). Indeed, using the methods described herein, metastatic tissue samples were found to localize in the vicinity of their tissue of origin in the transcriptomic landscape (FIGS. 5A-5B), even without the use of specially-tuned primary site detection methods (28, 29).

For instance, in an analysis of 29 metastasized breast cancer samples resected from lung, brain, and bone (GSE14107), the metastases more closely resemble breast tissue than their biopsy locations (FIG. 5A). Over-enriched UMLS concepts from Concordia for the metastasized samples include “White Adipose Tissue,” “Subcutaneous Fat,” “Subcutaneous Tissue,” “Lactiferous duct,” “Mammary lobe,” and “Glandular structure of breast.” When we restrict the analysis to use only the 164 genes in the breast gene set identified using our aforementioned FIRF based method, it was found that these metastasized breast samples lie within the context of other primary breast cancer samples in the database, which in turn are juxtaposed to normal breast tissue (FIG. 5B). Similarly, 15 of the 17 metastasized colorectal cancer samples that were removed from liver (GSE10961) were all labeled with “Rectum and sigmoid colon,” “Colonic Diseases, Functional,” and “Colon carcinoma” with a false positive rate below 0.05; the other two samples had a FPR of 0.06 for “Colon Carcinoma.” The top UMLS concepts for other metastatic samples obtained from GEO were also obtained (see Table S5 of Schmid P. R. et al. (2012) PNAS 109: 5594-5599).

The mislabeled metastases provide an unbiased measure of the degree of overlap between the biological signals of related tissues. In some embodiments, within the soft-tissue cluster (bottom left of FIG. 2B), in which the tissue specific signal can be dwarfed by the larger variances caused by the blood and brain tissue samples. Although the use of supervised learning approaches could mitigate these issues (29), they minimize the significant biological overlap of some of these samples, which may have implications for therapeutic selection (30). For example, due to the proximity of breast and ovarian tissue samples in the global transcriptomic landscape, distinctions between breast metastases in the ovary and primary ovarian carcinoma (GSE20565) could be smaller.

### Discussion

With the ever-growing amounts of transcriptomic data, it has become not only possible, but also imperative, to embrace the full transcriptomic continuum of tissue and disease. Employing a comprehensive, non-case vs. control approach and making use of the multi-dimensional nature of gene expression data, biological processes that are typically overshadowed in traditional analyses can be captured. Furthermore, the biologically and medically relevant concepts relating to a new expression sample can be capitulated through Concordia. Indeed, as the power of this macroscopic analysis increases with the amount of data, this embodiment of the methods described herein can more fully leverage large databases with biological data, and benefit further as more data are added. In this Example, exemplary sample- and gene-centric methods utilizing medically relevant concepts and gene expression data are presented herein. However, the nature of these methods based on a larger set of diverse data indicates that by changing the scope or domain of the labels and/or the underlying quantitative data, they can be applied to analyses in different contexts with relative ease. For instance, these methods can be used to create a transcriptomic landscape based on RNAseq expression data (31) annotated with concepts from RxNorm, a clinical drug vocabulary.

Systematic application of molecular pathology measurements can allow a shifting of the conventionally employed diagnostic classification boundaries to include intermediate pathotypes that cross the boundaries of the conventional medical classifications (32). These intermediate pathotypes are more closely coupled to the actual underlying pathology, thus revealing not only shared pathology but also opportunities for development of shared treatment (30, 33). Alternatively, it can be the case that the expression signatures of diseases provide clues to a disease network (34) other than what classical medical knowledge dictates, thus providing insights to previously unknown disease relationships.

It has been proposed that the future of personalized medicine, and the proper application of genomic and genetic data, requires an understanding of both who the patient is and the characteristics of the subpopulation to which the patient belongs (35). Clinical applications of one or more embodiments of the methods described herein, together with other genetic, environmental and phenotypic information, can more accurately and consistently annotate clinical samples and provide an impartial view of the landscape of clinico-pathological classification. As an enrichment statistic that only requires the usual standard of care in the labeling of samples is employed, the system and/or method described herein can be deployed in a clinical setting with minimal alteration of normal procedures. By shifting away from a dichotomous view and employing the global transcriptomic landscape, some of the key requirements of personalized medicine can be addressed and more effective treatment can be determined based on comparison of a subject's sample to a diverse set of other samples.

### Exemplary Methods

Normalizing the Gene Expression Samples.

The database is comprised of 3030 gene expression samples belonging to 192 series performed on the Affymetrix HG-U133 Plus 2.0 arrays that were obtained from NCBI's Gene Expression Omnibus (1) (GEO). The original CEL files were downloaded from GEO and MAS 5.0 normalized. Subsequently all probe specific values were converted to gene specific values using a trimmed mean. For the gene selection procedure, all of the expression values were log-normalized to be between −1 and 1 to ensure a normal distribution. For all of the other analyses, the expression values were additionally rank normalized.

UMLS Annotation.

Using the methods described in Ref. 36, the title, description, and source fields were extracted from each of the 3030 expression samples and they were annotated using the Java implementation of the National Library of Medicine's (NLM) MetaMap program, MMTx (37). A custom Unified Medical Language System (13) (UMLS) thesaurus containing concepts from the UMLS, MeSH, and SNOMED ontologies was generated using NLM's MetaMorphosys program. The automated annotations were manually verified and 672 UMLS concepts were kept. As these concepts only represented the most detailed level of annotation, they were mapped up the ontology such that a sample labeled with a specific concept also received labels corresponding to all of its ancestor concepts. Due to the domain of the data, the concepts were filtered to only those that are descendants of either “Disease” or “Anatomy,” resulting in 1489 concepts.

Transcriptomic landscape. The transcriptomic landscape is based on the first two principal components (PCs) of the PC projection of the 3030 centered and scaled gene expression samples. The phenotypic clusters portrayed by shaded regions were created by iteratively using the convex hull function (chull) in the R statistical language package. The hierarchic analysis of the landscape was performed by taking the 1065 phenotypically normal samples in the soft tissue cluster and recalculating the PCs. The convex hulls for the gastrointestinal and reproductive clusters were computed in the aforementioned fashion.

The tissue similarity network was generated by computing correlations of a representative sample of a tissue type to all other representatives of the other tissues. The representative was chosen to be the sample that was closest to the centroid in the set of samples for that phenotype. To contend with sampling bias, the correlations were computed 100 times; the centroid for each phenotype having been chosen from a random 75% subset of the samples for that phenotype. The network was then created based on the tissue-tissue relationships with an average correlation greater than 0.8 across all 100 subsampling runs. The colors of the nodes denote the general tissue class (blood, brain, gastrointestinal, reproductive, and other).

An input sample's coordinates are computed by centering and scaling its expression values by constants learned from the database, and then applying the loadings from the first two PCs.

Selection of Blood, Brain, and Soft Tissue Specific Genes.

Tissue specific genes were selected by performing permutation t-tests comparing, for example, the log-normalized expression values for the blood samples for a given gene to the log-normalized expression values of the samples associated with brain and soft tissue. Each permutation run comprised computing the t statistic for the actual labeling of the samples and comparing it to the t statistics produced when the labels were randomly permuted 200 times while keeping the sample size distribution constant. To counter the potential influence of sampling bias, this entire procedure was performed 100 times, each time using only a random 75% of the data for each tissue type. Genes with a false discovery rate corrected p-value of 0.05 or lower in all 100 runs were deemed significant. As there were genes with identical p-values, the genes were then sorted such that a gene with a larger difference in means between the phenotypes was ordered before those with a smaller difference. GO enrichment was performed on the top 50, 100, and 250 genes for each tissue type using FuncAssociate 2 (38). We report only the GO terms that had a resampling-based p-value less than 0.05.

Computing Phenotype-Specific Gene Signatures.

To determine the level of localization of the expression intensities for a given gene, a finite impulse response filter (11) (FIRF) was employed. For each gene g, phenotype p pair, all of the expression samples were sorted by their expression intensities for g. Using a “sliding window” of size equal to the number of samples corresponding to p, the fraction of samples in that window that are associated with p was computed. The value is 1 if all samples in the window are associated with p, and 0 if none of them are. This window is iteratively moved across the sorted list of samples to obtain a value for all positions. The marker gene score for a particular gene-phenotype pair is the maximum value that is achieved in any of the windows. A p-value is computed for each score using a binomial distribution.

To determine the appropriate cut-off for the number of genes to include in the gene set for phenotype p, the genes are first sorted according to their marker gene score from highest to lowest. The quality of the top n genes was then iteratively examined, e.g., by balancing their positive predictive capability with the amount of additional noise. Starting with the first two highest scoring genes, each sample s was iteratively removed and its correlation to all other samples was computed using only those two genes. A receiver operating characteristic (ROC) curve was generated for s, and the area under the curve (AUC) was used as a summary statistic. The ROC curve is generated by sorting all samples by their correlation to s, and incrementing the true-positive count when that sample is associated with p, and increment the false-positive count when that sample is not associated with p. Once all AUCs are computed for two genes, the next highest scoring gene was added, and all AUC values were computed. The mean “hit” AUC is defined as the average AUC obtained by all samples associated with p, and the mean “miss” AUC as the average AUC of all samples not associated with p. By taking the ratio of the mean “hit” AUC and mean “miss” AUC at each number of genes n, the relevant set of genes as all genes in the sorted list up was determined until the number of genes that maximizes this ratio.

To compare the performance of the FIRF to the traditional over- and under-expression based analyses relying on differences in the mean expression levels in the phenotypes being studied, a t-test was performed for each gene and the empirical p-value was computed based on 1000 random permutations of the phenotype labels. As many of the p-values were 0 (or the same), the list of genes was sorted by the z score of the actual t statistic as compared to the 1000 t statistics generated by the random permutations. GO enrichment was then performed using the Bioconductor GOstats (39) library in R.

Enrichment Score Calculation.

The database of gene expression samples was used to assess over-enrichment for particular disease- and tissue-specific signals. Given a new expression profile, for each concept represented in the database, a statistic that measures the strength of association between the sample and concept was calculated, as indicated by its similarity to the labeled database samples.

The statistic is calculated as follows. First, the database consisting of n curated expression samples {s₁, s₂, s₃, . . . , sₙ} is sorted (in decreasing order) according to each observation's Spearman correlation, p, with the new profile. Let s_{1′}, s_{2′}, s_{3′}, . . . , s_{n′} represent the samples ordered according to their correlation coefficients ρ_{s1′}, ρ_{s2′}, ρ_{s3′}, . . . , ρ_{s′}. For a given concept c in the set C, the set of all UMLS concepts in our database, let Sc be the set of all database samples associated with the concept. That is, s_{c}={sᵢ|sᵢ is associated with c}. An ordered list of xᵢ values is defined:

$${x}_{i} = ( \frac{1 + {ρ}_{si}^{′}}{2} ) / ( {\sum }_{{s}_{i}^{′} ∈ {S}_{c}} \frac{1 + {ρ}_{sj}^{′}}{2} )$$

when sample s_{i′} associated with concept c, and

xᵢ=−1/(n−|S_{c}|)

for all other samples that are not associated with concept c. Intuitively, when sᵢ is associated with the concept in question, the xᵢ value corresponds to the fraction of total correlation between the new sample and all database samples associated with the concept. All of the xᵢ values for the concept “hits” sum to 1, and all of the xᵢ values for the concept “misses” sum to −1.

Then a running sum of xᵢ is computed across all n database samples and take the maximum value achieved by this running sum as our enrichment score (ES) for the concept in question:

$$Enrichment {Score}_{c} = {max}_{1 \leq j \leq n} {\sum }_{1 \leq i \leq j} {x}_{i}$$

This sum across all n samples is zero. The concepts where there is strong positive deviation from 0 are the concepts whose associated samples are more highly correlated with the new profile than those samples that are not associated with the concept.

Performance Randomization Strategy and Quantifying Performance.

The area under the curve (AUC) and an empirical false-positive rate (FPR) were used to characterize the system's ability to recover signal rather than random sampling or permutation testing [as performed by another Kolmogorov-Smirnov statistic based method, Gene Set Enrichment Analysis (40)] for several reasons. If working with the null hypothesis that the sample's enrichment score (ES) for a given concept looks like the ES of a random permutation of the database samples (e.g., the ordering prescribed by the correlation scores between this sample and the rest of the database are the result of random shuffling), then the correlation structure among the database samples themselves would not be accounted for. Because the expression values of samples for a given concept (assuming the concept has some signal in gene expression space) will be highly coordinated, they will appear grouped together regardless of the phenotype of the new sample, resulting in a localized “bump” in the running enrichment score. This localized bump is often large enough to cause us to reject the null hypothesis, even when the new sample shouldn't be associated with the concept in question.

If instead it were to randomize the input and reject the null hypothesis that the new sample's concept-specific ES looks like the ES of a random point in gene expression space for this concept, such a sampling procedure may not be parameterized. Because in vivo gene expression programs contain highly correlated subprograms (41), there are large portions of gene expression space that are unavailable to a living cell (i.e., there are relationships among the gene's expression intensities that one never observes in nature). These “impossible” expression inputs should not be considered when generating the null distribution.

To overcome this sampling problem by using real human gene expression observations, the cross-validation strategy can be used. Rather than set a threshold learned from this data for accepting or rejecting a concept outright, the overall amount of signal present in the data can be determined for a given concept, via the receiver operating characteristic (ROC) plots, and report an expected false-positive rate for the concept at the ES observed for the new sample.

To quantify the ability of the method to recover UMLS concepts based on an input expression profile, a receiver operating characteristic (ROC) curve was generated and the area under the curve (AUC) was calculated as a summary statistic for each concept represented in the database. To compute the ROC curve for each concept c in the database, each sample s was iteratively left out, and sample s's enrichment score for c is computed using the remaining database samples. The running true- (TP) and false-positive counts (FP) were computed by walking down the list of samples sorted by their enrichment score for c. The TP is incremented if the i^{th} sample in the list is actually labeled with concept c. If the sample is not labeled with concept c, the FP is incremented. The true-(TPR) and false-positive rates (FPR) are obtained by dividing TP and FP respectively by the number of known positives and negatives at each position i. By plotting the TPR vs. FPR we obtain the ROC curve. The larger the area under the ROC curve (AUC), the greater the gene expression signal for that concept as the samples with the highest enrichment scores for the concept were truly labeled with that concept.

When using the method described in the Example to label a new sample, its ES was computed (with respect to the entire database) for each concept. The system's estimated FPR was reported for each concept at the sample's observed concept-specific enrichment score. These FPR values are derived from the running statistics used to generate the ROC plots: look up the new sample's score position in the list of sorted scores, and report the FPR at that position (if there is not an exact match, report the next-worst FPR).

### Example 2

### Application of Concordia Method to Stratify Various Kinds of Cell Samples, e.g., Stem Cell, Malignant and Normal Tissue Samples

Understanding the fundamental mechanisms of tumorigenesis remains one of the most pressing problems in modern biology. To this end, stem-like cells with tumor-initiating potential have become a central focus in cancer research. While the cancer stem cell hypothesis presents a model of self-renewal and partial differentiation, the relationship between tumor cells and normal stem cells remains unclear. In this Example, the inventors identified, in an unbiased fashion, mRNA transcription patterns associated with pluripotent stem cells. Using this profile, a quantitative measure of stem cell-like gene expression activity was derived. The Example shows how this 189 gene signature can stratify a variety of stem cell, malignant and normal tissue samples by their relative plasticity and state of differentiation within Concordia, a diverse gene expression database consisting of 3,209 Affymetrix HGU133+2.0 microarray assays. Further, the orthologous murine signature correctly orders a time course of differentiating embryonic mouse stem cells. This Example also demonstrates how this stem-like signature can serve as a proxy for tumor grade in a variety of solid tumors, including brain, breast, lung and colon. The findings indicate the core stemness gene expression signature represents a quantitative measure of stem cell-associated transcriptional activity. Broadly, the intensity of this signature correlates to the relative level of plasticity and differentiation across all of the human tissues analyzed. Further, the intensity of this signature being capable of differentiating histological grade for a variety of human malignancies indicates potential therapeutic and diagnostic implications.

There have been numerous investigations into the relationship between normal organogenesis programs and malignancy, particularly with respect to the stem cell properties of self-renewal and pluripotentiality [1-3]. At the molecular level, certain malignant tumors and developing tissues have been shown to exhibit shared transcription factor activity, regulation of chromatin structure, signaling characteristics and gene expression characteristics [4]. Likewise, enrichment patterns of well-characterized gene sets have been observed to be similar in stem cells and breast cancers, bladder cancers and poorly differentiated glioblastomas [5]. In addition, a variety of stem cell populations have been identified that are specific to individual tissues, yet share some of the same gene expression characteristics of embryonic stem (ES) cells [6]. However, multiple controversies continue to circulate around the role of particular genes in stem cells vs. differentiated tissues (e.g. N-cadherin [7]), and the extent to which the activation of various stem cell-like programs and pathways occurs across various tissues and diseases.

The cancer stem cell hypothesis asserts a model of tumorigenesis that may tie some of these observations together [8]. By implying a hierarchical organization of tumor growth that closely reflects normal tissue development, the hypothesis simultaneously accounts for the high degree of functional heterogeneity observed in solid tumors [9, 10], as well as the fact that only a small fraction of malignant cells retain tumor-initiating potential[8]. Under these assumptions, expression profiles derived from resected tumor samples (comprising both the cancer stem cells and their differentiated progeny) should broadly resemble those of the normal tissue of origin, with a degree of stem cell like activity also apparent.

Originally identified in hematopoietic cancers, leukemic stem cells were observed to express several markers (CD34+CD38−) in common with normal stem cells [11]. Subsequently, analogous models have been developed for a number of solid tumors, primarily through the identification of a small population (typically <5%) of tumor cells that were unique both in their expression of a set of specific surface markers as well as their ability to induce phenocopies of their original tumors in xenograft and transplant models [12-19].

Although the cancer stem cell model and the experimental approach to identifying cancer stem cell populations have been replicated across a variety of tissues, the molecular signatures derived from the proliferative cells have varied widely. As yet, the extent to which there exist any molecular fingerprints commonly attributable to multiple types of cancer stem cells remains unclear. While some have been observed to express a subset of the embryonic stem cell-associated genes (POU5F1, NANOG), the degree to which these trends may be broadly apparent is unknown [20].

The increasing volume of evidence supporting a pervasive connection between cancer and stem cells indicates significant therapeutic implications. As opposed to current therapies that are evaluated based on their ability to reduce the overall size of a tumor, regimens that target cancer stem cells may have more success in preventing long-term recurrence [8]. Molecular signatures that are capable of grading pluripotentiality and proliferative potential represent an important step in designing such regimens and guiding therapeutic procedures.

Indeed, gene expression signatures derived from breast cancer stem cells have been shown to separate patients with early-stage breast cancer into high-risk and low-risk groups [21]. Similarly, gene expression signatures have been used to identify cell-sorted acute myeloid leukemia (AML) samples enriched for leukemic stem cells (LSCS), and LSC expression signatures have been shown to correlate with patient survival[22, 23]. Diverse malignant tissue samples have been shown to exhibit a broadly similar trend within a large gene expression database, but no specific connection has been made in this context to stem cell-like activity [24]. However, identifying an unbiased transcriptional measure of “stemness” conserved across embryonic and adult stem cells, and relating that signature to malignancy, has remained a challenge [6, 25, 26]. Understanding the mechanisms of tumor proliferation and the relationship of those mechanisms to stem cell pluripotency may yield especially important insights into the origins and treatment of germ cell tumors, and embryonal carcinomas in particular, which have been previously demonstrated to express the hallmark ES regulators [27].

Presented herein is a comprehensive analysis of a diverse compilation of gene expression samples, using one embodiment of the methods described herein to reveal a robust multidimensional continuum from ES/induced pluripotent stem (iPS) cells to fully differentiated tissues. The findings indicate that, within this functional genomic landscape, cancers display a combination of stem cell-like programming and tissue-specific signatures. A shared molecular measure of pluripotentiality was derived in order to help bridge the gap between disparate tissue-specific cancer stem cell populations, reflecting their shared proliferative potential. In addition, this Example demonstrates that differentiation and pluripotentiality-centric view of gene expression correlates with classical grading systems for a variety of solid tumors, indicating that the expression landscape can form a quantitative axis with practical relevance to personalized medicine.

Identifying a Stem Cell Gene Set.

It was first sought to identify a set of genes whose expression profiles represent a tightly conserved core of transcriptional programming among stem cells, wherein this set of genes was termed as the stem cell gene set (SCGS). The SCGS was derived from a high-quality database called Concordia, representing a significant subset of the NCBI's Gene Expression Omnibus (GEO) [28]. Concordia was constructed using a combination of automated textual parsing, human curation and normalization methods, which is described in Exemplary Materials and Methods later below.

In order to identify a set of genes with highly specific stem cell expression intensities, Concordia was used to identify all of the stem cell samples in the dataset. A standard signal processing tool, a finite impulse response filter (FIR) [29], was then applied to identify those genes with the most highly-conserved expression intensities among the stem cell samples. That is, those genes with a range of expression intensities among the stem cell samples that was most distinct from the non-stem cell samples scored the highest (see, e.g., Exemplary Materials and Methods below).

In contrast to a standard t-test, this approach does not require defining a specific “control” phenotype against which is tested for separation. Moreover, the method described herein can identify genes with expression levels that are highly specific in the stem cell samples, allowing for the diverse population of non-stem cell samples to express these genes at simultaneously higher and lower levels (something for which a t-test cannot directly account). For example, the gene DBC1 exhibits a highly specific range of expression across the stem cell samples, and ranked highly (among the top 0.5% of all genes) in its ability to localize the stem cell samples by the described method. However, the non-stem cell samples demonstrate both higher and lower expression levels of this gene (see FIG. 7), causing a standard Student's t-test (treating all non-stem cell samples as the control group) to rank this gene at only the 24.6% strongest among all genes.

The ability of the SCGS to capture a nuanced measure of stem cell-like gene expression activity was verified by demonstrating the accurate clustering of a series of developing ES cell populations in mouse (see below). This analysis also shows the concordance between the SCGS transcriptional profile and cellular state of differentiation.

Previous studies have examined the expression patterns of literature-curated gene sets relating to ES-like activity among a variety of malignancies [5]. In contrast, a gene set in silico that reflects only those transcriptional signals with the greatest ability to localize the stem cell samples within the spectrum of human tissues and diseases was constructed.

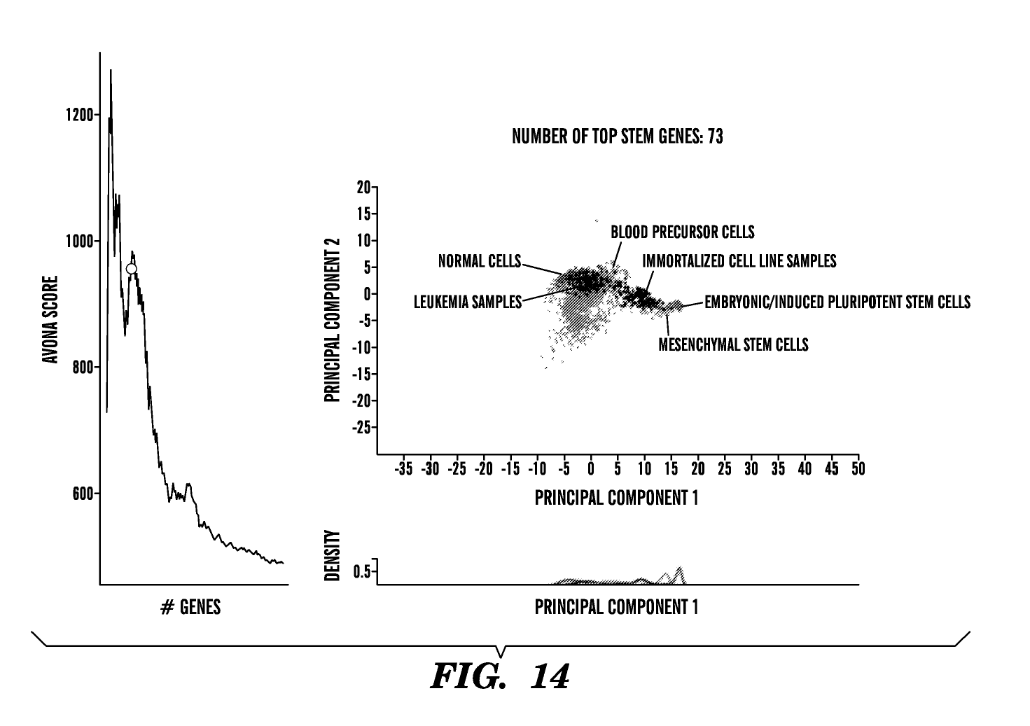

The 189 genes comprising the SCGS are shown in Appendix 5 (Tables s1 to s4). A variety of FIR thresholds were evaluated according to the ability of the gene sets to differentiate between stem cell samples and the other phenotypes in the dataset via an analysis of variance (ANOVA). The genes determined herein represent a set capable of simultaneously separating the pluripotent, multipotent, progenitor, malignant and normal samples, while also retaining tissue-specific features (e.g., clearly separating normal blood, neural and epithelial tissues). The effect of varying the number of top-ranking stem genes included in the SCGS is shown in FIG. 14.

Comparison to Previously Published Stem Gene Sets.

Several previous reports have been made to identify the genes responsible for maintaining pluripotency by analyzing the expression patterns of germ cell tumors. Sperger et al. performed differential expression analyses between control differentiated cells and embryonic stem cells and a variety of germ cell tumors to identify genes with higher expression in pluripotent stem cells [30]. The approach described herein differs, partly, in that the expression of only stem cells rather than cultured tumor cell lines was analyzed. Further, no stipulation was placed on differential expression with respect to a fixed control group, but rather focusing in on the genes with the greatest ability to characterize the stem cells within a broad spectrum of the human transcriptional landscape. Skotheim et al. and Almstrup et al. had also identified the genes that characterize an assortment of germ cell tumors [31, 32]. FIG. 8 shows the overlap of the SCGS with these previously identified stem gene sets.

Stem-Like Signature Stratifies a Diverse Expression Database by Pluripotentialhy and Malignancy.

Via principal component analysis (PCA), the transcriptional profile of the SCGS across the entire collection of normal tissues, cancers and stem cells assembled from GEO was examined. Performing PCA across only the SCGS genes (including all samples in the data set) allowed one to measure the extent to which the specific transcriptional activity observed in the stem cell population was apparent in each of the other phenotypes.

This analysis revealed a striking trend apparent in the first two principal components (PCs) of the gene set; PC1 captured a measure of cellular pluripotency, while PC2 reflected the broad transcriptional differences between hematopoietic, neural and epithelial tissues. These trends are demonstrated in FIGS. 9A-9D. Each panel highlights in color the PCA region occupied by a particular normal tissue population (red) and its associated malignancies (green), as well as any related precursor cells (orange), immortalized cell line samples (cyan), multipotent (blue) and pluripotent stem cells (magenta) (PCA was computed jointly across all samples; each cancer is highlighted individually for clarity). The pluripotent stem cells included in this analysis were a combination of both embryonic stem cells and induced pluripotent stem cells. The locations of all other samples in the data set are shaded gray to provide context.

The dominant characteristic of PC1 is its ability to separate the pluripotent stem cells from the normal tissue samples (e.g., the normal tissues shown in FIGS. 9A-9D—blood, breast, brain, colon, shaded red, consistently lie on the extreme left side of the plots, whereas the pluripotent stem cells, shaded magenta, lie on the extreme right). Moreover, PC1 apparently reflects a finer-grained continuum of cellular potency: the multipotent stem cells are clustered near the pluripotent stem cells, with the hematopoietic progenitors (the only progenitors in this dataset) slightly farther away (FIG. 9A).

Further, the analysis indicates that the hematopoietic, neural and epithelial cancers (shaded green in FIGS. 9A-9D) contained in the data all clustered directly between the stem cell populations and their associated normal non-malignant samples. This indicates that the SCGS captures a kernel of stem cell-like transcriptional activity that is concurrently apparent in a variety of malignancies. These findings build on previous observations that genes associated with stem cell-like activity demonstrate differential expression in a variety of epithelial cancers with respect to their normal tissue counterparts [6]. The analysis reveals that stem-like expression profiles are observable not only in epithelial cancers, but also in neural and hematopoietic malignancy as well.

The coordinates of an expression profile's projection into the first principal component of the gene space defined by the SCGS can be used as a relative measure of “stemness”, a stemness index.

The overall landscape of the human transcriptome appears to be organized by a combination of tissue, cell-type and disease-specific features [24]. Previous studies have suggested that the primary factors driving the organization of this landscape are largely attributable to hematopoietic and malignant programming [24]. The findings presented herein indicate that while there exists a strong tissue-specific signal, the “malignancy” signature is more specifically a reflection of the self-renewal and pluripotentiality common to both stem cell populations and heterogeneous tumors.

Human-Derived ES-Like Transcriptional Profile Correlates to Mouse Stem Cell Differentiation.

To verify that the SCGS-derived stemness index captures a quantitative transcriptional measure of differentiation, the stemness index was used to examine the expression dynamics of a set of developing mouse ES cells over time [GEO: GSE12550]. This data set consisted of a time course of differentiating mouse ES cells, with gene expression measured at four time points (ES cells, 4 days of differentiation, 8 days of differentiation and 14 days of differentiation).

Human SCGS gene ids were mapped to mouse via NCBI's HomoloGene[33]. Human genes that lacked a unique match in mouse were ignored. Expression intensities were processed in an identical manner to the human data (see Exemplary Materials and Methods below) and summarized by gene. Again, the dominant variance among the differentiating mouse cells was computed via PCA over the SCGS. Each mouse ES sample's stemness index (i.e., coordinates in the first principal basis) was likewise used as a summary value of SCGS gene expression activity.

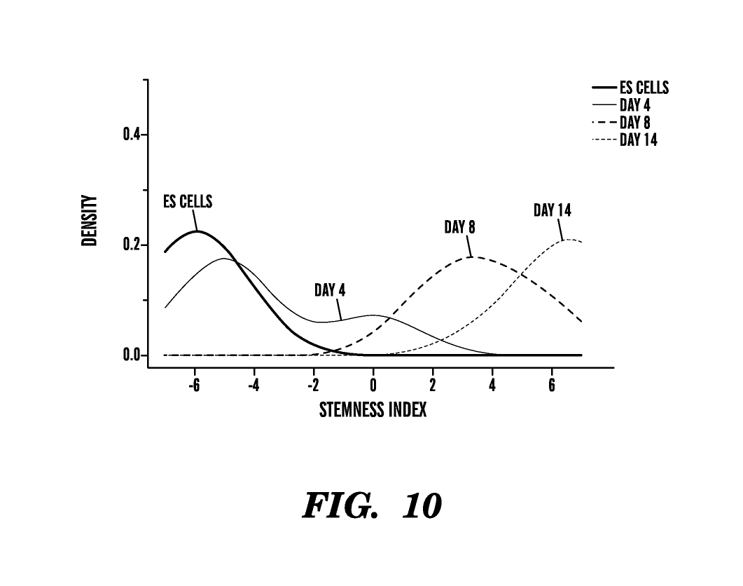

The dominant expression signal reflected in these genes accurately sorts the samples according to their time point, as shown in FIG. 10. This supports the hypothesis that the SCGS-derived stemness index reflects measurable changes in state of differentiation and pluripotentiality, and reflects that the functional genomic mechanisms associated with stem cell activity are at least partially conserved across species [34].

Stratifying Tumor Grade.

The stemness index that was derived from the SCGS was used to evaluate the transcriptional profiles of several graded tumor data sets. The goal was to evaluate whether the newly-found molecular marker for tissue-agnostic stem cell-like transcriptional activity was representative of poor clinical prognosis. The publicly-available data sets (see Exemplary Materials and Methods below) were included in the analysis. For each data set, the samples' stemness index (via PCA over the SCGS) was used to identify the dominant differences between the samples within the context of the stem cell genes (see Exemplary Materials and Methods below).

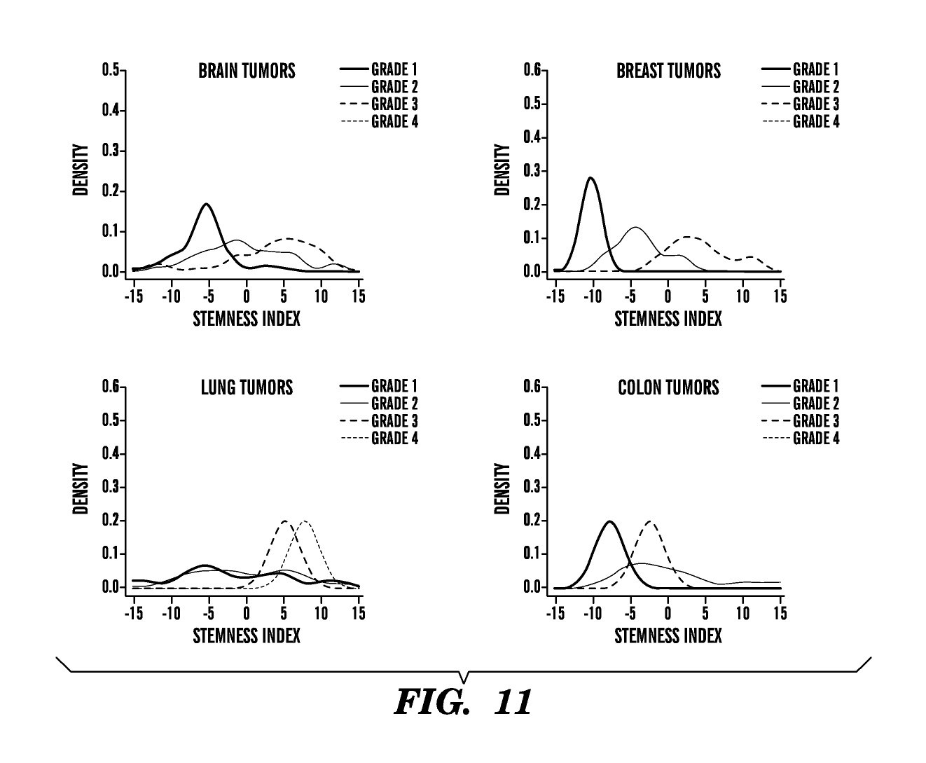

This analysis revealed that the stemness index correlates with tumor grade for a variety of primary tissues. FIG. 11 shows the distribution of stemness index values for the four tissue types' graded tumor samples. In each case, the transcriptional activity of the SCGS defines a clear separation between the high- and low-graded tumors, while also providing a molecular foundation based on stem-like expression for the clinical difficulty in classifying mid-grade tumors [35, 36]. Importantly, such measures should not be considered in isolation, but concert with standard histopathology, since an aggressive tumor containing a relatively large proportion of normal cells would likely have a low stemness score. As such, these methods may well serve as a “warning sign” when traditional pathology assigns a low grade, but RNA analysis suggests the tumor is about to turn aggressive.

Recent trends in chemotherapy design have focused not only on regulating cytotoxicity, but also on affecting the differentiation pathways that are apparently impaired in malignant cells. For example, Stegmaier et al. have demonstrated the ability of gefitinib to induce myeloid differentiation in both AML cell lines as well as patient-derived AML blast cells [37]. Indeed, the phenotypic transformation induced by gefitinib was shown to be observable in both cellular morphology and gene expression. In some embodiments, the ubiquitous stem cell-like expression patterns described in this Example, as well as those specifically tuned to individual tumor subclasses, can be used for screening compounds through the early stages of drug discovery. Understanding the transcriptional changes brought by these compounds within the context of pluripotentiality and differentiation can be of fundamental value in personalized oncology and therapy selection.

Functional Diversity of the Stem Cell Gene Set.

It was then sought to characterize the functional diversity of the genes comprising the SCGS. Hierarchical clustering of these genes' transcriptional activity in a population of pluripotent stem cells revealed four distinct coexpression modules. For each module, a set of over-enriched Gene Ontology (GO) biological processes was then identified [38].

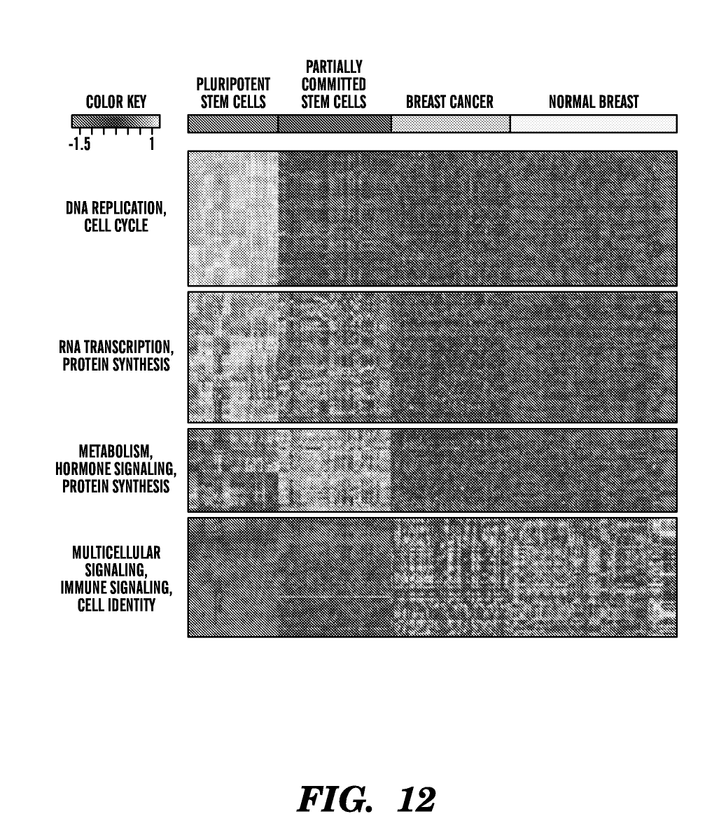

To illustrate the gene expression trends apparent within each gene cluster, FIG. 12 shows a heatmap of their profiles across pluripotent and partially committed stem cells, as well as malignant and normal breast samples. Genes active in DNA replication, cell cycle regulation and RNA transcription (see Appendix 5—Tables s5 and s6 for detailed annotations) are most highly expressed in the pluripotent stem cells, and less so, respectively, through increasing levels of cellular differentiation/decreasing pluripotentiality, consistent with prior studies of the dynamics of stem cell cycling and regeneration[25, 39]. Genes related to metabolism and hormone signaling (Appendix 5—Table s7) show peak expression intensity among the partially committed stem cells, while exhibiting low intensity among the fully differentiated tissue and tumor samples. Correspondingly, genes responsible for multicellular signaling and cellular identity (Appendix 5—Table s8) are most highly expressed in the fully differentiated tissue and malignant samples. Within each functional module, the tumor samples trend away from the respective normal tissue, reflecting stem cell-like transcriptional activity.

Accordingly, a comprehensive analysis of a diverse compilation of gene expression samples indicate conserved stem cell-like transcriptional activity across a wide variety of hematopoietic and solid cancers through a comprehensive molecular survey of malignancy, pluripotent stem cells and normal tissues. The findings agree with several recent developments in the cancer stem cell studies. In particular, the findings presented herein highlight transcriptional evidence that, despite individual tissue-specific characteristics, a wide range of cancers share a common set of transcriptional mechanisms with each other, as well as pluripotent and multipotent stem cells.

While a large volume of evidence indicates that only a small number of tumor cells are capable of self-renewal, controversy remains as to the exact origin of these cells. The hierarchical cancer stem cell hypothesis suggests that these cells arise from normal pluripotent or multipotent stem cells that have lost the ability to regulate their proliferative activity. Under this model, the phenotypic diversity observed in many tumors is viewed as the result of this defective stem cell population mismanaging the process of normal organogenesis. Alternatively, the stochastic model of tumorigenesis suggests that proliferative tumor cells arise from normal fully differentiated or committed progenitor cells that acquire the ability to self renew, and that tumor cell phenotype variation is the result of these mutated cells differentiating in a random fashion[40].

Regardless of the origin of proliferative tumor cells, the findings presented herein indicate that there is a high degree of stem cell-specific gene expression programming observable in heterogeneous tumor samples. The findings indicates the need for more detailed transcriptional assays comparing proliferative tumor cells to both ES/iPS cells and bulk heterogeneous tumor cells, as well as normal tissue cells. The data indicates that the gene expression patterns observed in heterogeneous tumor samples may be due to the effect of a small population of cancer stem cells in combination with a large number of partially differentiated cells. Without wishing to be bound by theory, while the partially differentiated mass of the tumor behaves transcriptionally similar to healthy tissue, the small population of proliferative tumor cells may push the observation of the aggregate mRNA back along the spectrum of stem cell-like activity identified herein.

The inventors have shown a specific transcriptional signal that is shared among a wide variety of solid and hematopoietic cancers. Moreover, when considered from a transcriptome-wide perspective, this signal is indicative of stem cell-like activity. The Example has shown how these gene expression patterns are most strongly associated with embryonic and induced pluripotent stem cells, and are successively less apparent in multipotent stem cells, malignancies, and fully differentiated tissues, respectively. In addition, the genes that comprise this signal also reveal a stratification of solid tumors that correlates strongly with classical grading systems.

### Exemplary Materials and Methods

Concordia, a Large Phenotypically Diverse Gene Expression Database.

The Concordia database contains 3209 Affymetrix HGU133+2.0 gene expression array samples (all from human tissue or cultured human cell lines) extracted from NCBI's Gene Expression Omnibus. A full description of the techniques used to assemble this database have been previously described [41], and the curated phenotype data are available for public download at the Concordia database web site [42], including all of the non-malignant, malignant and stem cell samples, less the external graded tumor sets that were used to verify the SCGS signal's relationship to solid tumor histology. The following two sections describe the Concordia database.

Using UMLS Annotation to Associate Each Sample with its Relevant Phenotypes.

A database was constructed representing a subset (3209 samples) of NCBI's Gene Expression Omnibus (GEO) [28, 33] that contained a combination of samples derived from normal tissues, immortalized cell lines, a variety of cancers, and an assortment of pluripotent and partially committed stem cells. In order to generate high-quality, systematic phenotype annotations for this dataset, the GEO text descriptions relating to each sample (including title, description, and source fields) were mapped into the Unified Medical Language System's (UMLS) [43] ontology of biological and medical concepts. This was done using a combination of natural language processing (NLP) software and hand validation to remove spurious associations.

NLP was performed by the Java implementation of the National Library of Medicine's (NLM) MetaMap program, MMTx [44]. A custom UMLS thesaurus was generated using NLM's MetaMorphosys program that contained the concepts and relationships from the UMLS, MeSH, and SNOMED ontologies.

These automated annotations were then verified by hand so as to remove false positives. Using custom-built software, these associations were propagated through the ontology's hierarchy, allowing us to identify all samples related to phenotypes of arbitrary specificity.

Normalizing the Gene Expression Samples.

The expression data for the samples in the dataset were obtained from their respective GEO CEL files, which were MAS 5.0 [45] normalized via R's BioConductor package [46, 47]. The resulting probe set intensities were averaged into 20,252 unique gene-centric values, and then rank normalized to improve cross data series comparability. All calculations were performed in the R statistical environment, employing the BioConductors suite.

Additional Expression Data.

In addition to the Concordia gene expression data, several additional GEO data sets were used to analyze the SCGS signal's relationship to histological tumor grade. These are: a series of graded glioma tumor samples [GEO: GSE4290]; a series of graded tumor samples from core needle biopsies of breast cancer patients, including a variety of ER+/− and PR+/− phenotypes [GEO: GSE23593]; a set of graded lung tumors including a variety of squamous and adenocarcinoma samples [GEO: GSE18842]; and a set of graded colon tumors [GEO: GSE17537].

Using FIR to Identify Genes that Characterize Pluripotent Stem Cells.

It was sought to associate with each gene a measure of how well conserved its expression intensity was over the stem cell samples. Rather than seeking a strict measure of constitutive over- or under-expression of the gene among the stem cell population, it was instead sought to identify individual genes that tightly cluster the stem cell population anywhere along the spectrum of expression intensities.

A signal-processing tool, the finite impulse response filter (FIR) [29] was employed. The input to this procedure is a list of all of the expression samples, sorted according to their intensity for a particular gene. The filter then applies a “sliding window” to the list and outputs, at each window position, the proportion of stem cell samples within the frame. The maximal value of this sliding window at any position in the list is then taken as that gene's score. A window equal in size to the total number of stem cell samples in the database was used, so the interpretation of the filter's maximal output can be determined. Genes with the highest scores are those with most specific stem cell expression intensities.

Binomial P-values (k=number of stem cell samples in a given window frame; n=window frame size; p=proportion of stem cell samples in the entire database) are reported along with these scores.

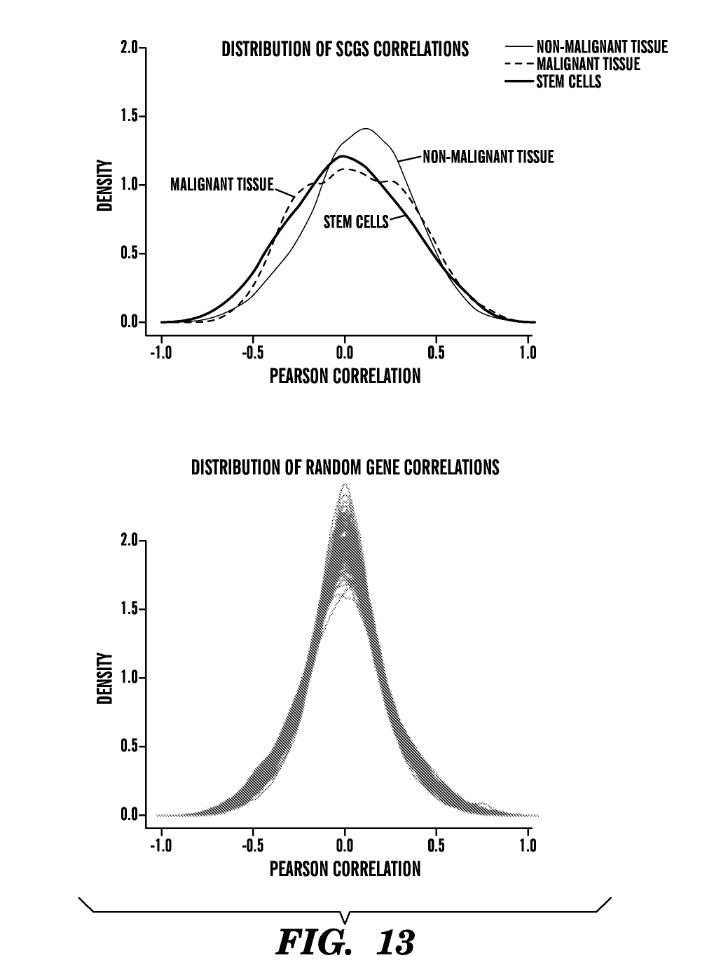

To ensure that the method was not simply selecting genes that are all highly correlated with each other across the entire database, the distribution of SCGS Pearson correlation coefficients was computed over the stem cell samples, malignant tissue samples and non-malignant tissue samples independently, and then those distributions to 1,000 random sets of genes equal in size were compared to the SCGS. Only the non-malignant tissue samples show a positive location shift (see FIG. 13).

Summarizing Expression Signals Across a Group of Genes Via PCA.

In order to capture a continuous measure of SCGS activity, principal component analysis [48] was applied. The basis vector associated with the largest eigenvalue of the gene-gene covariance matrix captures the dominant coordinated signal present within the gene set. By projecting each sample's determined expression intensity onto this basis, a summary value describing the sample's affinity was computed for a stem cell-like gene expression profile.

Measuring Tumor Grade Along the Continuum of Stem-Like Expression.

Four independent data series containing expression profiles were identified for graded tumors of various tissue types in GEO ([GEO: GSE4290], [GEO: GSE23593], [GEO: GSE17537], [GEO: GSE18842]) on Affymetrix HGU 133+2.0. Each series was pre-processed (MAS5.0 normalized, summarized) as previously described. Within each series, the SCGS summary values were computed, again, via PCA over this gene set, allowing us to associate a value with each sample indicating its relative stem-like expression activity.

SCGS Clustering and GO Enrichment.

The SCGS was clustered using the gplots package for R. Genes were individually quantile normalized to improve readability of the resulting figures. GO biological process enrichment calculations were performed on the individual clusters using the GOstats BioConductor library [38, 49].

Data Access.

All microarray samples included in these analyses are publicly available via the Gene Expression Omnibus. Accession ids for each sample are included in Appendix 5, and curated, machine-readable phenotype information for those samples is available at the Concordia database web site [42].

### Example 3

### Use of Concordia Method to Analyze Expression Signatures of iPSCs

Existing methods of phenotyping iPS-derived cells are not yet sufficiently reliable, affordable, and scalable to permit the creation of a high throughput screening assay for autism. Several high-throughput technologies have been developed that enable ones to evaluate the coordinated expression levels of tens of thousands of genes[95, 96], evaluate hundreds of thousands of single-nucleotide polymorphisms[97], and sequence individual genomes[98], all with relative ease at low cost. The data produced by these assays have provided the research and commercial communities the opportunity to define improved clinical prognostic indicators and develop a molecular understanding of the systemic underpinnings of a variety of diseases. The standard gene expression microarray is one of the most popular techniques for measuring the relative expression intensities of tens of thousands of genes simultaneously. Early acceptance of this “high-throughput” technique was limited based on several high-profile studies citing reproducibility problems [99, 100]. Subsequently, however, many of these inconsistencies were explained by differences in the cited array technologies and designs, post-processing normalization and statistical analyses [101-103]. Following this initial uncertainty, a number of studies have successfully demonstrated biological consistency among expression signatures from different high-throughput array technologies[104].

Several groups have studied the transcriptome (RNA) and genomic DNA variability of iPSC-derived models at various stages of differentiation. In some studies, gene expression characteristics of specific differentiation stages could be segregated into meaningful biological and clinical subgroups[17], though the small number of samples in these studies may limit the generalizability of their results. The simplest way to expand on these results is to project gene expression data from different clinical states and differentiation stages onto a more extended platform comprising diverse tissues and disease phenotypes[105]. Typical expression analyses compare expression level across two states (e.g., cases versus controls) or a limited number of phenotypic classes. Such comparative analyses impose subjective decisions about what constitutes an appropriate control population, limiting the analysis to a specific phenotype and again reducing generalizability. Therefore, presented herein is a more holistic approach to gene expression analysis based on a data-rich analysis environment, in which phenotypes can be characterized in the context of tissues and diseases. Schmid et al. introduce scalable methods (as shown in Example 1) that associate expression patterns with phenotypes in order to assign phenotype labels to new samples and identify phenotypically meaningful gene signatures[105]. This system, called Concordia, analyzes a specific phenotype in the context of data-rich transcriptomic space, avoiding the need for predefined control groups and presupposed relationships between phenotypes. Concordia has proved to be a replicable method of characterizing a cell's lineage and state of development. It has produced a comprehensive gene expression analysis that reveals a multidimensional continuum from ESC and iPSCs to fully differentiated tissues, and identified transcription patterns associated with pluripotent stem cells[106]. This method identified genes with expression levels that are highly specific to the stem cell samples as compared to non-stem cell samples. In particular, the stem cell gene 189 set (SCGS) was identified as representative of a tightly conserved core of transcriptional programming among stem cells. This gene set was capable of differentiating between the pluripotent, multipotent, progenitor, malignant and normal samples, retaining the tissue specific features. Based on SCGS, an index was defined to compare relative stem-ness (See Example 2). This index allowed the differentiation between various grades of tumors, indicating that there is a high degree of stem cell-specific gene expression which differs between heterogeneous cancers.

The inventors herein employ transcriptional analysis of iPSC-derived cell types. In some embodiments, a scalable measurement of the transcriptome can be used to differentiate among derived neurons from neurotypic and autistic patients. In some embodiments, a measurement of the transcriptome can be used to screen candidate drug compounds for preliminary signals of efficacy. This Example describes the use of the Concordia method to analyze data from publicly available studies of human primary neuronal, stem cell derived neuronal cultures and brain tissues (FIG. 15). The gene expression alterations result from the reprogramming of somatic tissue (fibroblasts) into pluripotent stem cells, which are then differentiated into neuronal cultures. These induced neurons are then compared to various regions of brain and primary neuronal cultures. The induced pluripotent state is also compared to embryonic cellular state. As is demonstrated in FIG. 15, the first two principal components (PCs) of the expression level of 17,596 genes across the database provide a representation of the phenotypic relationships and a specific signature characteristic to a differentiation stage.

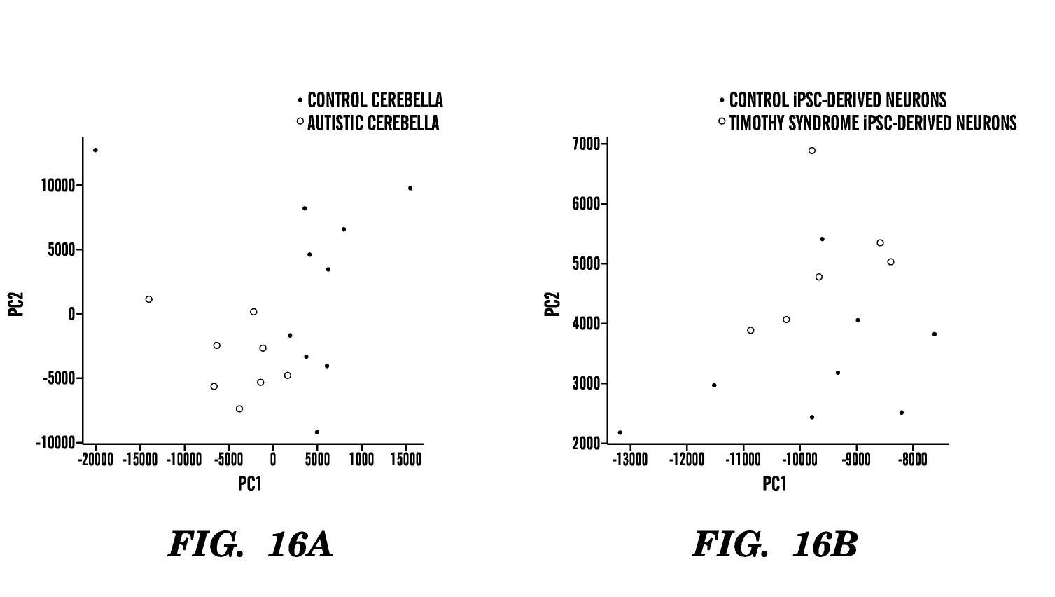

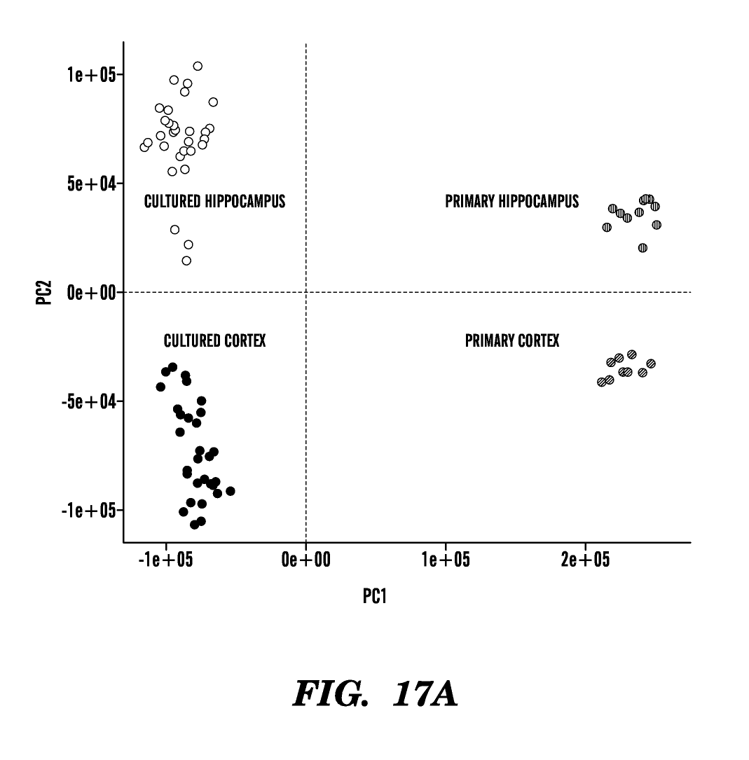

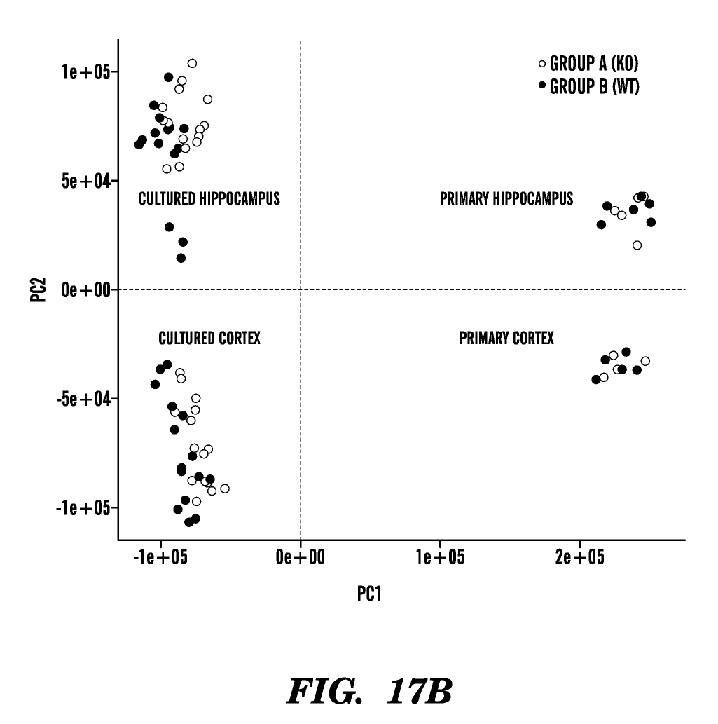

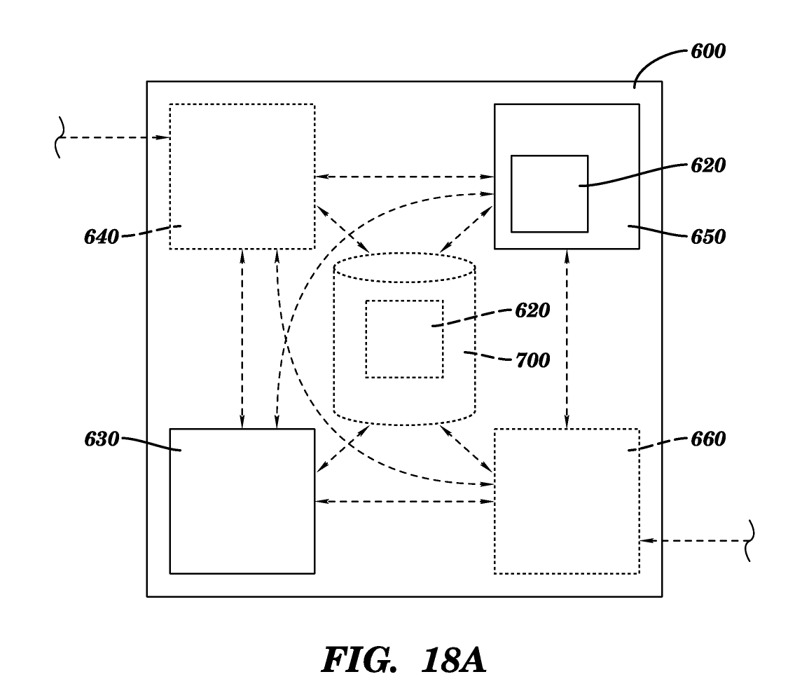

The use of this Concordia method based on publicly available experimental data from induced neurons derived from patients with monogenic neurodevelopmental disorder (Timothy Syndrome)[17] is also shown in FIG. 16B. This is the evidence that gene expression can be valid and stable readout even in the data generated from various laboratories with different reprogramming and differentiation strategies. The next step can be to test the gene expression map generated by projecting other relevant samples and to follow the trajectory change due to the therapeutic intervention. Based on these findings, insights into the biological processes that underlie differences between tissues and differentiation stages can be discovered beyond those that may be identified by traditional differential expression analyses identified. Identifying common pathways and mechanisms underlying disorders of neurodevelopment and neuronal differentiation such as ASD can yield new insights into molecular biology and facilitate the generation of relevant autism models. In some embodiments, the Concordia methods can be used to integrating information across various tissues to identify stable biomarkers for the dynamics of the nervous system in autism and provide useful end-points for future high-throughput screening using human iPSCs-derived models. By following the iPSC-derived neurons' expression profiles along the time course of brain development, the extent to which the transcriptional activity of iPSC-derived neurons resembles that of neurons in vivo can be assessed. In particular, a precise developmental or spatial region of the brain correlating to various iPSC-derived neurons can be identified. Furthermore, whether pluripotency, differentiation programs and pathways are consistent across various tissues and diseases can be examined. Moreover, the rescue of a disease-relevant phenotype can be examined as a correction of transcriptional program and the result of treatment can be compared to the untreated wild type end-point.

Based on the findings presented herein, it was discovered that (1) cell identity is manifest by transcriptional activity; (2) developing cells follow consistent trajectories during maturation; (3) similarity of tissue of origin and stage of maturity between cells can be measured in transcriptional space; and (4) applying the methods and/or systems described herein to iPSCs and cells derived by differentiation can be used for higher-throughput screening.

### REFERENCES FOR EXAMPLE 1

1. Barrett T et al. (2010) NCBI GEO: archive for functional genomics data sets—10 years on. NAR:1-6.
2. Tian Z et al. (2009) A practical platform for blood biomarker study by using global gene expression profiling of peripheral whole blood. PloS One 4:e5157.
3. Dudley J T, Tibshirani R, Deshpande T, Butte A J (2009) Disease signatures are robust across tissues and experiments. Molecular Systems Biology 5:1-8.
4. Golub T R et al. (1999) Molecular classification of cancer: class discovery and class prediction by gene expression monitoring. Science 286:531-537.
5. Rhodes D R et al. (2007) Oncomine 3.0: Genes, Pathways, and Networks in a Collection of 18,000 Cancer Gene Expression Profiles. NEO 9:166-180.
6. Liu X, Yu X, Zack D J, Zhu H, Qian J (2008) TiGER: A database for tissue-specific gene expression and regulation. BMC Bioinformatics 9.
7. Ogasawara 0 et al. (2006) BodyMap-Xs: anatomical breakdown of 17 million animal ESTs for cross-species comparison of gene expression. NAR 34:D629-D631.
8. Sirota M et al. (2011) Discovery and Preclinical Validation of Drug Indications Using Compendia of Public Gene Expression Data. Sci Transl Med 3:96ra77-96ra77.
9. Lamb J (2007) The Connectivity Map: a new tool for biomedical research. Nat Rev Cancer 7:54-60.
10. Ransohoff D F (2005) Bias as a threat to the validity of cancer molecular-marker research. Nat Rev Cancer 5:142-149.
11. McClellen J H, Schafer R W, Yoder M A (1998) DSP First: A Multimedia Approach (Prentice Hall).
12. Rhodes D R et al. (2004) Large-scale meta-analysis of cancer microarray data identifies common transcriptional profiles of neoplastic transformation and progression. PNAS 101:9309-9314.
13. Bodenreider 0 (2004) The Unified Medical Language System (UMLS): integrating biomedical terminology. NAR 32:D267-D270.
14. Lukk M et al. (2010) A global map of human gene expression. Nature Biotech 28:322-324.
15. Owzar K, Barry W T, Jung S-H, Sohn I, George S L (2008) Statistical challenges in preprocessing in microarray experiments in cancer. Clinical Cancer Research 14:5959-5966.
16. Michels K B et al. (2003) Type 2 Diabetes and Subsequent Incidence of Breast Cancer in the Nurses' Health Study. Diabetes Care 26:1752-1758.
17. Dhillon P K et al. (2011) Common polymorphisms in the adiponectin and its receptor genes, adiponectin levels and the risk of prostate cancer. Cancer Epidemiol Biomarkers Prev.
18. Kaklamani V et al. (2011) Polymorphisms of ADIPOQ and ADIPOR1 and prostate cancer risk. Metabolism 60:1234-1243.
19. Umar A et al. (2009) Identification of a putative protein profile associated with tamoxifen therapy resistance in breast cancer. Mol. Cell Proteomics 8:1278-1294.
20. Lee J-Y et al. (2011) Activation of peroxisome proliferator-activated receptor-Î±enhances fatty acid oxidation in human adipocytes. Biochemical and Biophysical Research Communications 407:818-822.
21. Shi Z, Derow C K, Zhang B (2010) Co-expression module analysis reveals biological processes, genomic gain, and regulatory mechanisms associated with breast cancer progression. BMC Syst Biol 4:74.
22. Golembesky A K et al. (2008) Peroxisome proliferator-activated receptor-alpha (PPARA) genetic polymorphisms and breast cancer risk: a Long Island ancillary study. Carcinogenesis 29:1944-1949.
23. Kohane I S, Masys D R, Altman R B (2006) The incidentalome: a threat to genomic medicine. JAMA 296:212-215.
24. Steenhuysen J (2011) PSA test for prostate cancer not recommended: panel. Reuters:1-2.
25. Zhao H et al. (2006) Gene expression profiling predicts survival in conventional renal cell carcinoma. PLoS Med. 3:e13.
26. Lyons T R et al. (2011) Postpartum mammary gland involution drives progression of ductal carcinoma in situ through collagen and COX-2. Nature Medicine 17:1109-1115.
27. Chang J et al. (2000) Over-expression of ERT(ESX/ESE-1/ELF3), an ets-related transcription factor, induces endogenous TGF-beta type II receptor expression and restores the TGF-beta signaling pathway in Hs578t human breast cancer cells. Oncogene 19:151-154.
28. Bridgewater J, van Laar R, van′t Veer L (2008) Gene expression profiling may improve diagnosis in patients with carcinoma of unknown primary British Journal of Cancer 98:1425-1430.
29. Schaner M E et al. (2003) Gene Expression Patterns in Ovarian Carcinomas. Molecular Biology of the Cell 14:4376-4386.
30. Dudley J T, Butte A J (2010) Biomarker and Drug Discovery for Gastroenterology Through Translational Bioinformatics. Gastroenterology 139:735-741.
31. Wang Z, Gerstein M, Snyder M (2009) RNA-Seq: a revolutionary tool for transcriptomics. Nat Rev Genet 10:57-63.
32. Loscalzo J, Kohane I S, Barabasi A-L (2007) Human disease classification in the postgenomic era: A complex systems approach to human pathobiology. Molecular Systems Biology 3.
33. Feldmann M (2002) Development of anti-TNF therapy for rheumatoid arthritis. Nat Rev Immunology 2:364-371.
34. Barabási A-L, Gulbahce N, Loscalzo J (2011) Network medicine: a network-based approach to human disease. Nat Rev Genet 12:56-68.
35. Kohane I S (2009) The twin questions of personalized medicine: who are you and whom do you most resemble? Genome Med 1:4.
36. Butte A J, Kohane I S (2006) Creation and implications of a phenome-genome network. Nature Biotech 24:55-62.
37. Aronson A R (2001) Effective mapping of biomedical text to the UMLS Metathesaurus: the MetaMap program. Proceedings of the AMIA Symposium.
38. Berriz G F, Beaver J E, Cenik C, Tasan M, Roth F P (2009) Next generation software for functional trend analysis. Bioinformatics 25:3043-3044.
39. Falcon S, Gentleman R (2007) Using GOstats to test gene lists for GO term association. Bioinformatics 23:257-258.
40. Subramanian A, et al. (2005) Gene set enrichment analysis: A knowledge-based approach for interpreting geneome-wide expression profiles. Proc. Natl. Acad. Sci 102:15278-15279.
41. Segal E, et al. (2003) Module networks: Identifying regulatory modules and their condition-specific regulators from gene expression data. Nat Genet 34:166-176.
42. Loscalzo J, Kohane I S, Barabási A-L (2007) Human disease classification in the postgenomic era: A complex systems approach to human pathobiology. Mol Syst Biol 3:124.
43. Barrett T, et al. (2010) NCBI GEO: Archive for functional genomics data sets-10 years on. NAR 39:D1005-D1010.

### REFERENCES FOR EXAMPLE 2

1. Rivera M N, Haber D A: Wilms' tumour: connecting tumorigenesis and organ development in the kidney. Nat Rev Cancer 2005, 5:699-712.
2. Scotting P J, Walker D A, Perilongo G: Childhood solid tumours: a developmental disorder. Nat Rev Cancer 2005, 5:481-488.
3. Stiewe T: The p53 family in differentiation and tumorigenesis. Nat Rev Cancer 2007, 7:165-168.
4. Naxerova K, Bult C J, Peaston A, Fancher K, Knowles B B, Kasif S, Kohane I S: Analysis of gene expression in a developmental context emphasizes distinct biological leitmotifs in human cancers. Genome Biol 2008, 9:R108.
5. Ben-Porath I, Thomson M W, Carey V J, Ge R, Bell G W, Regev A, Weinberg R A: An embryonic stem cell-like gene expression signature in poorly differentiated aggressive human tumors. Nat Genet 2008, 40:499-507.
6. Wong D J, Liu H, Ridky T W, Cassarino D, Segal E, Chang H Y: Module Map of Stem Cell Genes Guides Creation of Epithelial Cancer Stem Cells. Cell Stem Cell 2008, 2:333-344.
7. Li P, Zon L I: Resolving the controversy about N-cadherin and hematopoietic stem cells. Cell Stem Cell 2010, 6:199-202.
8. Visvader J E, Lindeman G J: Cancer stem cells in solid tumours: accumulating evidence and unresolved questions. Nat Rev Cancer 2008, 8:755-768.
9. Heppner G H, Miller B E: Tumor heterogeneity: biological implications and therapeutic consequences. Cancer and Metastasis Reviews 1983, 2:5-23-23.
10. Dontu G, Al-Hajj M, Abdallah W M, Clarke M F, Wicha M S: Stem cells in normal breast development and breast cancer. Cell Prolif. 2003, 36 Suppl 1:59-72.
11. Fialkow P J: Stem cell origin of human myeloid blood cell neoplasms. Verhandlungen der Deutschen Gesellschaft ftir Pathologie 1990, 74:43-7-47.
12. Singh S K, Clarke I D, Terasaki M, Bonn V E, Hawkins C, Squire J, Dirks P B: Identification of a cancer stem cell in human brain tumors. Cancer Res. 2003, 63:5821-5828.
13. Al-Hajj M, Wicha M S, Benito-Hernandez A, Morrison S J, Clarke M F: Prospective identification of tumorigenic breast cancer cells. Proc Natl Acad Sci USA 2003, 100:3983-3988.
14. Fang D, Nguyen T K, Leishear K, Finko R, Kulp A N, Hotz S, Van Belle P A, Xu X, Elder D E, Herlyn M: A tumorigenic subpopulation with stem cell properties in melanomas. Cancer Res. 2005, 65:9328-9337.
15. Bapat S A, Mali A M, Koppikar C B, Kurrey N K: Stem and progenitor-like cells contribute to the aggressive behavior of human epithelial ovarian cancer. Cancer Res. 2005, 65:3025-3029.
16. Collins A T, Berry P A, Hyde C, Stower M J, Maitland N J: Prospective identification of tumorigenic prostate cancer stem cells. Cancer Res. 2005, 65:10946-10951.
17. Gibbs C P, Kukekov V G, Reith J D, Tchigrinova O, Suslov O N, Scott E W, Ghivizzani S C, Ignatova T N, Steindler D A: Stem-like cells in bone sarcomas: implications for tumorigenesis. Neoplasia 2005, 7:967-976.
18. Ricci-Vitiani L, Lombardi D G, Pilozzi E, Biffoni M, Todaro M, Peschle C, De Maria R: Identification and expansion of human colon-cancer-initiating cells. Nature 2007, 445:111-115.
19. Lobo N A, Shimono Y, Qian D, Clarke M F: The biology of cancer stem cells. Annu. Rev. Cell Dev. Biol. 2007, 23:675-699.
20. Yu J, Vodyanik M A, Smuga-Otto K, Antosiewicz-Bourget J, Frane J L, Tian S, Nie J, Jonsdottir G A, Ruotti V, Stewart R, Slukvin I I, Thomson J A: Induced Pluripotent Stem Cell Lines Derived from Human Somatic Cells. Science 2007, 318:1917-1920.
21. Liu R, Wang X, Chen G Y, Dalerba P, Gurney A, Hoey T, Sherlock G, Lewicki J, Shedden K, Clarke M F: The prognostic role of a gene signature from tumorigenic breast-cancer cells. N. Engl. J. Med. 2007, 356:217-226.
22. Gentles A J, Plevritis S K, Majeti R, Alizadeh A A: Association of a leukemic stem cell gene expression signature with clinical outcomes in acute myeloid leukemia. JAMA 2010, 304:2706-2715.
23. Eppert K, Takenaka K, Lechman E R, Waldron L, Nilsson B, van Galen P, Metzeler K H, Poeppl A, Ling V, Beyene J, Canty A J, Danska J S, Bohlander S K, Buske C, Minden M D, Golub T R, Jurisica I, Ebert B L, Dick J E: Stem cell gene expression programs influence clinical outcome in human leukemia. Nat. Med. 2011, 17:1086-1093.
24. Lukk M, Kapushesky M, Nikkilä J, Parkinson H, Goncalves A, Huber W, Ukkonen E, Brazma A: A global map of human gene expression. Nat. Biotechnol. 2010, 28:322-324.
25. Ramalho-Santos M, Yoon S, Matsuzaki Y, Mulligan R C, Melton D A: “Stemness”: transcriptional profiling of embryonic and adult stem cells. Science 2002, 298:597-600.
26. Fortunel N O, Otu H H, Ng H-H, Chen J, Mu X, Chevassut T, Li X, Joseph M, Bailey C, Hatzfeld J A, Hatzfeld A, Usta F, Vega V B, Long P M, Libermann T A, Lim B: Comment on “‘Stemness’: transcriptional profiling of embryonic and adult stem cells” and “a stem cell molecular signature”. Science 2003, 302:393; author reply 393.
27. Gillis A J M, Stoop H, Biermann K, van Gurp R J H L M, Swartzman E, Cribbes S, Ferlinz A, Shannon M, Oosterhuis J W, Looij enga LHJ: Expression and interdependencies of pluripotency factors LIN28, OCT3/4, NANOG and SOX2 in human testicular germ cells and tumours of the testis. Int. J. Androl. 2011, 34:e160-74.
28. Barrett T, Troup D B, Wilhite S E, Ledoux P, Evangelista C, Kim I F, Tomashevsky M, Marshall K A, Phillippy K H, Sherman P M, Muertter R N, Holko M, Ayanbule 0, Yefanov A, Soboleva A: NCBI GEO: archive for functional genomics data sets—10 years on. Nucleic Acids Research 2011, 39:D1005-10.
29. McClellan J H, Schafer R W, Yoder M A: DSP first: a multimedia approach. Digital signal processing first 1998:xx, 523 p.
30. Sperger J M, Chen X, Draper J S, Antosiewicz J E, Chon C H, Jones S B, Brooks J D, Andrews P W, Brown P O, Thomson J A: Gene expression patterns in human embryonic stem cells and human pluripotent germ cell tumors. Proc Natl Acad Sci USA 2003, 100:13350-13355.
31. Skotheim R I, Lind G E, Monni O, Nesland J M, Abeler V M, Fossa S D, Duale N, Brunborg G, Kallioniemi 0, Andrews P W, Lothe R A: Differentiation of human embryonal carcinomas in vitro and in vivo reveals expression profiles relevant to normal development. Cancer Res. 2005, 65:5588-5598.
32. Almstrup K, Hoei-Hansen C E, Wirkner U, Blake J, Schwager C, Ansorge W, Nielsen J E, Skakkebaek N E, Rajpert-De Meyts E, Leffers H: Embryonic stem cell-like features of testicular carcinoma in situ revealed by genome-wide gene expression profiling. Cancer Res. 2004, 64:4736-4743.
33. Sayers E W, Barrett T, Benson D A, Bolton E, Bryant S H, Canese K, Chetvernin V, Church D M, DiCuccio M, Federhen S, Feolo M, Fingerman I M, Geer L Y, Helmberg W, Kapustin Y, Landsman D, Lipman D J, Lu Z, Madden T L, Madej T, Maglott D R, Marchler-Bauer A, Miller V, Mizrachi I, Ostell J, Panchenko A, Phan L, Pruitt K D, Schuler G D, Sequeira E, et al.: Database resources of the National Center for Biotechnology Information. Nucleic Acids Research 2011, 39:D38-51.
34. Cai J, Xie D, Fan Z, Chipperfield H, Marden J, Wong W H, Zhong S: Modeling co-expression across species for complex traits: insights to the difference of human and mouse embryonic stem cells. PLoS Comp Biol 2010, 6:e1000707.
35. Tonn J C, Westphal M: Neuro-oncology of CNS tumors. Springer Verlag; 2006.
36. Fuller G N, Mircean C, Tabus I, Taylor E, Sawaya R, Bruner J M, Shmulevich I, Zhang W: Molecular voting for glioma classification reflecting heterogeneity in the continuum of cancer progression. Oncol. Rep. 2005, 14:651-656.
37. Stegmaier K, Corsello S M, Ross K N, Wong J S, Deangelo D J, Golub T R: Gefitinib induces myeloid differentiation of acute myeloid leukemia. Blood 2005, 106:2841-2848.
38. Ashburner M, Ball C A, Blake J A, Botstein D, Butler H, Cherry J M, Davis A P, Dolinski K, Dwight S S, Eppig J T, Harris M A, Hill D P, Issel-Tarver L, Kasarskis A, Lewis S, Matese J C, Richardson J E, Ringwald M, Rubin G M, Sherlock G: Gene ontology: tool for the unification of biology. The Gene Ontology Consortium. Nat Genet 2000, 25:25-29.
39. Takizawa H, Regoes R R, Boddupalli C S, Bonhoeffer S, Manz M G: Dynamic variation in cycling of hematopoietic stem cells in steady state and inflammation. J. Exp. Med. 2011, 208:273-284.
40. Gupta P B, Fillmore C M, Jiang G, Shapira S D, Tao K, Kuperwasser C, Lander E S: Stochastic state transitions give rise to phenotypic equilibrium in populations of cancer cells. Cell 2011, 146:633-644.
41. Schmid P R, Palmer N P, Kohane I S, Berger B: Making sense out of massive data by going beyond differential expression. PNAS 2012, 109:5594-5599.
42. Concordia [http://concordia.csail.mit.edu].
43. Bodenreider 0: The Unified Medical Language System (UMLS): integrating biomedical terminology. Nucleic Acids Research 2004, 32:D267-70.
44. Osborne J D, Lin S, Zhu L, Kibbe W A: Mining biomedical data using MetaMap Transfer (MMtx) and the Unified Medical Language System (UMLS). Methods in Molecular Biology 2007, 408:153-69-169.
45. Affymetrix: Affymetrix Microarray Suite User Guide. Santa Clara, Calif.
46. R Development Core Team: R: A Language and Environment for Statistical Computing. Vienna, Austria: 2007.
47. Gentleman R C, Carey V J, Bates D M, Bolstad B, Dettling M, Dudoit S, Ellis B, Gautier L, Ge Y, Gentry J, Hornik K, Hothorn T, Huber W, Iacus S, Irizarry R, Leisch F, Li C, Maechler M, Rossini A J, Sawitzki G, Smith C, Smyth G, Tierney L, Yang J Y H, Zhang J: Bioconductor: open software development for computational biology and bioinformatics. Genome Biol 2004, 5:R80.
48. Kohane I S, Butte A J, Kho A: Microarrays for an Integrative Genomics. Cambridge, Mass., USA: MIT Press; 2002.
49. Falcon S, Gentleman R: Using GOstats to test gene lists for GO term association. Bioinformatics 2007, 23:257-258.

All patents and other publications identified in the specification and examples are expressly incorporated herein by reference for all purposes. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

### APPENDIX 1

| | | |
|---|---|---|
| GO ID | GO Term | P Value |

GO Enrichment for the top 250 differentially expressed brain genes.

| | | |
|---|---|---|
| GO: 0045110 | intermediate filament bundle assembly | 0.044 |
| GO: 0005883 | neurofilament | 0.001 |
| GO: 0060052 | neurofilament cytoskeleton organization | 0.013 |
| GO: 0007269 | neurotransmitter secretion | 0.02 |
| GO: 0001505 | regulation of neurotransmitter levels | 0 |
| GO: 0006836 | neurotransmitter transport | 0 |
| GO: 0008021 | synaptic vesicle | 0.013 |
| GO: 0043197 | dendritic spine | 0.032 |
| GO: 0044309 | neuron spine | 0.032 |
| GO: 0033267 | axon part | 0 |
| GO: 0030424 | axon | 0 |
| GO: 0007409 | axonogenesis | 0 |
| GO: 0043005 | neuron projection | 0 |
| GO: 0008509 | anion transmembrane transporter activity | 0.035 |
| GO: 0048812 | neuron projection morphogenesis | 0 |
| GO: 0007417 | central nervous system development | 0 |
| GO: 0048858 | cell projection morphogenesis | 0 |
| GO: 0044456 | synapse part | 0 |
| GO: 0045202 | synapse | 0 |
| GO: 0044463 | cell projection part | 0 |
| GO: 0032990 | cell part morphogenesis | 0.003 |
| GO: 0007268 | synaptic transmission | 0 |
| GO: 0022891 | substrate-specific transmembrane transporter activity | 0.018 |
| GO: 0022857 | transmembrane transporter activity | 0.04 |
| GO: 0005215 | transporter activity | 0.007 |
| GO: 0045211 | postsynaptic membrane | 0.019 |
| GO: 0042995 | cell projection | 0 |
| GO: 0030054 | cell junction | 0 |
| GO: 0007399 | nervous system development | 0 |
| GO: 0048731 | system development | 0 |
| GO: 0022838 | substrate-specific channel activity | 0.036 |
| GO: 0051234 | establishment of localization | 0.02 |
| GO: 0007267 | cell-cell signaling | 0.021 |
| GO: 0006810 | transport | 0.04 |
| GO: 0015075 | ion transmembrane transporter activity | 0.013 |
| GO: 0007154 | cell communication | 0.02 |
| GO: 0006811 | ion transport | 0.017 |
| GO: 0044459 | plasma membrane part | 0.003 |
| GO: 0048856 | anatomical structure development | 0.033 |
| GO: 0042105 | alpha-beta T cell receptor complex | 0 |
| GO: 0045730 | respiratory burst | 0.008 |
| GO: 0050857 | positive regulation of antigen receptor-mediated signaling pathway | 0.041 |
| GO: 0005833 | hemoglobin complex | 0 |
| GO: 0005344 | oxygen transporter activity | 0.001 |
| GO: 0042101 | T cell receptor complex | 0.002 |
| GO: 0050854 | regulation of antigen receptor-mediated signaling pathway | 0.005 |
| GO: 0031640 | killing of cells of another organism | 0.004 |
| GO: 0045058 | T cell selection | 0.035 |
| GO: 0003823 | antigen binding | 0 |
| GO: 0001906 | cell killing | 0.036 |
| GO: 0050830 | defense response to Gram-positive bacterium | 0 |
| GO: 0009620 | response to fungus | 0.009 |
| GO: 0006968 | cellular defense response | 0 |
| GO: 0001608 | nucleotide receptor activity, G-protein coupled | 0.045 |
| GO: 0045028 | purinergic nucleotide receptor activity, G-protein coupled | 0.045 |
| GO: 0004715 | non-membrane spanning protein tyrosine kinase activity | 0.036 |
| GO: 0042742 | defense response to bacterium | 0 |
| GO: 0031225 | anchored to membrane | 0.014 |
| GO: 0006935 | chemotaxis | 0 |
| GO: 0042330 | taxis | 0 |
| GO: 0050870 | positive regulation of T cell activation | 0.015 |
| GO: 0009617 | response to bacterium | 0 |
| GO: 0042110 | T cell activation | 0 |
| GO: 0006955 | immune response | 0 |
| GO: 0002376 | immune system process | 0 |
| GO: 0050863 | regulation of T cell activation | 0.004 |
| GO: 0040011 | locomotion | 0 |
| GO: 0046649 | lymphocyte activation | 0 |
| GO: 0007626 | locomotory behavior | 0 |
| GO: 0006952 | defense response | 0 |
| GO: 0050867 | positive regulation of cell activation | 0.014 |
| GO: 0045321 | leukocyte activation | 0 |
| GO: 0051707 | response to other organism | 0 |
| GO: 0009897 | external side of plasma membrane | 0.044 |
| GO: 0002684 | positive regulation of immune system process | 0 |
| GO: 0001775 | cell activation | 0 |
| GO: 0051249 | regulation of lymphocyte activation | 0.01 |
| GO: 0050865 | regulation of cell activation | 0.002 |
| GO: 0002694 | regulation of leukocyte activation | 0.008 |
| GO: 0006954 | inflammatory response | 0 |
| GO: 0002682 | regulation of immune system process | 0 |
| GO: 0007610 | behavior | 0.002 |
| GO: 0009607 | response to biotic stimulus | 0 |
| GO: 0030246 | carbohydrate binding | 0.038 |
| GO: 0009611 | response to wounding | 0 |
| GO: 0009605 | response to external stimulus | 0.001 |
| GO: 0005887 | integral to plasma membrane | 0 |
| GO: 0031226 | intrinsic to plasma membrane | 0 |
| GO: 0051704 | multi-organism process | 0.003 |
| GO: 0004872 | receptor activity | 0 |
| GO: 0004871 | signal transducer activity | 0 |
| GO: 0060089 | molecular transducer activity | 0 |
| GO: 0006950 | response to stress | 0 |
| GO: 0050896 | response to stimulus | 0 |
| GO: 0005886 | plasma membrane | 0 |
| GO: 0044459 | plasma membrane part | 0 |
| GO: 0007166 | cell surface receptor linked signaling pathway | 0 |
| GO: 0004888 | transmembrane receptor activity | 0.012 |
| GO: 0023033 | signaling pathway | 0 |
| GO: 0023052 | signaling | 0.003 |
| GO: 0016020 | membrane | 0 |
| GO: 0044425 | membrane part | 0 |
| GO: 0031224 | intrinsic to membrane | 0.002 |
| GO: 0016021 | integral to membrane | 0.012 |

C) GO Enrichment for the top 250 differentially expressed soft tissue genes.

| | | |
|---|---|---|
| GO: 0005584 | collagen type I | 0.017 |
| GO: 0005583 | fibrillar collagen | 0 |
| GO: 0032964 | collagen biosynthetic process | 0 |
| GO: 0001527 | microfibril | 0 |
| GO: 0043205 | fibril | 0.005 |
| GO: 0030057 | desmosome | 0 |
| GO: 0048407 | platelet-derived growth factor binding | 0 |
| GO: 0030199 | collagen fibril organization | 0 |
| GO: 0005520 | insulin-like growth factor binding | 0 |
| GO: 0005581 | collagen | 0 |
| GO: 0032963 | collagen metabolic process | 0 |
| GO: 0044259 | multicellular organismal macromolecule metabolic process | 0 |
| GO: 0044236 | multicellular organismal metabolic process | 0.001 |
| GO: 0044420 | extracellular matrix part | 0 |
| GO: 0005201 | extracellular matrix structural constituent | 0 |
| GO: 0030198 | extracellular matrix organization | 0 |
| GO: 0005604 | basement membrane | 0 |
| GO: 0043588 | skin development | 0.001 |
| GO: 0005200 | structural constituent of cytoskeleton | 0.001 |
| GO: 0010035 | response to inorganic substance | 0.033 |
| GO: 0001649 | osteoblast differentiation | 0.039 |
| GO: 0009612 | response to mechanical stimulus | 0 |
| GO: 0043062 | extracellular structure organization | 0 |
| GO: 0006956 | complement activation | 0.001 |
| GO: 0070161 | anchoring junction | 0.018 |
| GO: 0002541 | activation of plasma proteins involved in acute inflammatory | 0.002 |
| | response | |
| GO: 0009987 | cellular process | 0.013 |
| GO: 0005911 | cell-cell junction | 0.036 |
| GO: 0016043 | cellular component organization | 0.048 |
| GO: 0031960 | response to corticosteroid stimulus | 0 |
| GO: 0031012 | extracellular matrix | 0 |
| GO: 0005578 | proteinaceous extracellular matrix | 0 |
| GO: 0016337 | cell-cell adhesion | 0.008 |
| GO: 0019838 | growth factor binding | 0 |
| GO: 0030154 | cell differentiation | 0 |
| GO: 0008201 | heparin binding | 0 |
| GO: 0051384 | response to glucocorticoid stimulus | 0 |
| GO: 0001525 | angiogenesis | 0.017 |
| GO: 0008544 | epidermis development | 0 |
| GO: 0005539 | glycosaminoglycan binding | 0 |
| GO: 0005198 | structural molecule activity | 0 |
| GO: 0006959 | humoral immune response | 0.041 |
| GO: 0001871 | pattern binding | 0 |
| GO: 0030247 | polysaccharide binding | 0 |
| GO: 0030855 | epithelial cell differentiation | 0.004 |
| GO: 0048869 | cellular developmental process | 0.017 |
| GO: 0044421 | extracellular region part | 0 |
| GO: 0009628 | response to abiotic stimulus | 0.049 |
| GO: 0005576 | extracellular region | 0 |
| GO: 0005615 | extracellular space | 0 |
| GO: 0048545 | response to steroid hormone stimulus | 0 |
| GO: 0050896 | response to stimulus | 0.05 |
| GO: 0007584 | response to nutrient | 0.028 |
| GO: 0009888 | tissue development | 0 |
| GO: 0007155 | cell adhesion | 0 |
| GO: 0022610 | biological adhesion | 0 |
| GO: 0009725 | response to hormone stimulus | 0 |
| GO: 0009719 | response to endogenous stimulus | 0.008 |
| GO: 0010033 | response to organic substance | 0 |
| GO: 0009605 | response to external stimulus | 0.02 |
| GO: 0048856 | anatomical structure development | 0 |
| GO: 0042221 | response to chemical stimulus | 0 |
| GO: 0032502 | developmental process | 0 |
| GO: 0006950 | response to stress | 0.023 |

### APPENDIX 2

The 74 genes that comprise the breast cancer gene set

| | |
|---|---|
| Breast | ANKRD30A, hCG_25653, VTCN1, TBC1D9, TRPS1, SCUBE2, STC2, CCL28, |
| Tissue | KRT14, ROPN1, OXTR, SFRP1, FIGF, NFIB, ELF5, INHBB, IRX2, KRT6C, |
| | CYP4Z1, PROL1, DSG3, KRT5, IRX3, LYPD3, IRX5, PLIN, EGR2, MGP, |
| | TSHZ2, IRX1, FABP4, GABRP, MIA, SEMA3C, SAV1, TFAP2B, SERPINB5, |
| | SFN, SLC39A6, PI15, CTSO, DSC3, CX3CL1, TFAP2C, KCNMB1, DUSP4, |
| | XBP1, ANO1, ADIPOQ, AZGP1, KLK5, LEP, SCGB2A2, FXYD3, ADAMTS5, |
| | SAA2, AMIGO2, GATA3, TNN, TRIM29, RERG, GLYATL2, ALB, RPS4P13, |
| | TAT, MUCL1, FOXA1, KRT7, MUC15, PPL, SCGB3A1, FMO2, C1orf226, |
| | RPL3P7, ITGB6, KIT, PER2, LTF, C4orf7, PLAT, CIDEC, RLBP1L1, |
| | CD300LG, GRP, PLEKHG4, NTN4, SERPINA3, ZNF750, MMPI, AMOTL2, |
| | C4orf32, S100A2, AGR3, KRT6B, CITED4, TM4SF1, C10orf81, EGR3, |
| | FGF10, GRHL1, ARHGDIB, SRPX, NA, MAB21L1, KIAA1881, FMO1, GHR, |
| | EFCAB4A, C1orf116, TP63, TMC5, MYLK, AGR2, COL8A2, CPB1, |
| | CRABP2, RPL3, TAGLN, NA, ACTA2, MAPT, CREB3L4, CITED1, CRNDE, |
| | COL6A6, SCGB1D2, BNIPL, RBBP8, RPS8, SFRP2, FAT2, THRSP, NA, |
| | MPZL1, VPS8, RPL13A, CNN1, RPS10, SCN2A, ESR1, TGFBR3, IL6ST, |
| | KRT17, KLHL13, C9orf152, MEIS3P1, WFDC2, SLC16A4, SLC34A2, |
| | TM4SF18, PTPRZ1, RPS3, FOXI1, TFF3, STARD4, FAM46B, LGR6, MB, |
| | RPL10A, CRISPLD1, PIP, PTHLH, TUSC5, C16orf61 |
| Breast | ANKRD30A, EFHD1, SCGB2A2, hCG_25653, TRPS1, PIP, CYP4Z2P, |
| Cancer | TBC1D9, PRLR, GATA3, COX6C, TFAP2B, AZGP1, SERPINA3, FLJ45983, |
| Tissue | XBP1, SPDEF, CYP4Z1, NA, NME3, MAGED2, PLIN, MUCL1, SCUBE2, |
| | TFAP2A, NATI, DCAF10, MB, SYCP2, CCDC74B, RPS6KA3, FOXA1, |
| | RNF128, MAPT, MGP, CREB3L4, IRX5, ARSG, RABEP1, TPRG1, ENPP1, |
| | WWP1, RET, CUX1, RMND5B, FSIP1, TBX3, ESR1, ABCC11, TFAP2C, AR, |
| | SLC39A6, ACOT4, PM20D2, PIK3R3, METRN, ACADSB, C6orf211, |
| | LRRC15, ODC1, ADIPOQ, HSD17B11, COL10A1, CPB1, TMEM25, THRSP, |
| | CCDC82, HDAC11, RBM7, TTC39A, KDM4B, ERP44, PBX1, PPARA |

### APPENDIX 3

The genes that comprise the breast cancer gene set are functionally
enriched for processes related to breast-specific development, and
carbohydrate and lipid metabolism

| | |
|---|---|
| Breast | organ development, developmental process, multicellular organismal |
| Tissue | development, tissue development, anatomical structure development, |
| | multicellular organismal process, system development, gland morphogenesis, |
| | epithelium development, tissue morphogenesis, prostate gland morphogenesis, |
| | morphogenesis of an epithelium, organ morphogenesis, morphogenesis of a |
| | branching structure, response to hormone stimulus, morphogenesis of a |
| | branching epithelium, tube morphogenesis, reproductive structure |
| | development, fat cell differentiation, urogenital system development, |
| | epidermis development, prostate glandular acinus development, response to |
| | endogenous stimulus, prostate gland development, anatomical structure |
| | morphogenesis, gland development, prostate gland epithelium morphogenesis, |
| | response to estrogen stimulus, epithelial cell differentiation, response to |
| | estradiol stimulus, epithelial tube morphogenesis, rhythmic process, response |
| | to organic substance, axis elongation, regulation of Notch signaling pathway, |
| | negative regulation of peptidase activity, development of primary sexual |
| | characteristics, segmentation, regulation of multicellular organismal process, |
| | response to steroid hormone stimulus, kidney morphogenesis, developmental |
| | process involved in reproduction, tube development, positive regulation of |
| | Notch signaling pathway, NADPH oxidation, specification of loop of Henle |
| | identity, proximal/distal pattern formation involved in metanephric nephron |
| | development, developmental growth involved in morphogenesis, regulation of |
| | multicellular organismal development, regulation of organ morphogenesis, sex |
| | differentiation, negative regulation of cell morphogenesis involved in |
| | differentiation, proximal/distal pattern formation, peptidyl-tyrosine |
| | phosphorylation, reproductive process, development of primary female sexual |
| | characteristics, development of primary male sexual characteristics, |
| | anatomical structure formation involved in morphogenesis, reproduction, |
| | peptidyl-tyrosine modification, response to chemical stimulus, epithelial cell |
| | proliferation, morphogenesis of embryonic epithelium, regulation of |
| | morphogenesis of a branching structure, female sex differentiation, regulation |
| | of peptidyl-tyrosine phosphorylation, negative regulation of hydrolase activity, |
| | male sex differentiation, regulation of system process, translational |
| | termination, positive regulation of cell communication, pattern specification |
| | process, positive regulation of signaling, osteoblast differentiation, female |
| | genitalia morphogenesis, mammary gland bud morphogenesis, cellular |
| | response to X-ray, proximal/distal pattern formation involved in nephron |
| | development, specification of nephron tubule identity, pattern specification |
| | involved in metanephros development, regulation of planar cell polarity |
| | pathway involved in axis elongation, negative regulation of planar cell polarity |
| | pathway involved in axis elongation, positive regulation of response to |
| | stimulus, regulation of endopeptidase activity, growth, regulation of |
| | ossification, negative regulation of endopeptidase activity, positive regulation |
| | of growth, establishment of planar polarity, regulation of digestive system |
| | process, metanephric nephron development, regulation of developmental |
| | process, cellular component disassembly at cellular level, regulation of |
| | peptidase activity, response to nutrient levels, branching morphogenesis of a |
| | tube, cellular component disassembly, pancreas development, digestive tract |
| | morphogenesis, establishment of tissue polarity, morphogenesis of an |
| | epithelial bud, nephron epithelium morphogenesis, translational elongation, |
| | cellular protein complex disassembly, protein complex disassembly, positive |
| | regulation of signal transduction, cell differentiation, male gonad |
| | development, cellular process involved in reproduction, keratinocyte |
| | proliferation, planar cell polarity pathway involved in axis elongation, |
| | convergent extension involved in axis elongation, pattern specification |
| | involved in kidney development, renal system pattern specification, loop of |
| | Henle development, negative regulation of non-canonical Wnt receptor |
| | signaling pathway, tube formation, gonad development, epithelial cell |
| | development, ossification, cell development, somatic stem cell maintenance, |
| | nephron morphogenesis, digestive tract development, response to extracellular |
| | stimulus, ovulation cycle process, regulation of embryonic development, |
| | cellular macromolecular complex disassembly, response to X-ray, |
| | morphogenesis of an epithelial fold, regulation of cell proliferation, |
| | macromolecular complex disassembly, negative regulation of protein kinase |
| | activity, metanephros development, mammary gland epithelium development, |
| | cellular developmental process, cell proliferation, nephron epithelium |
| | development, cellular component movement, female genitalia development, |
| | regulation of Wnt receptor signaling pathway, planar cell polarity pathway, |
| | regulation of biological quality, endocrine pancreas development, ovulation |
| | cycle, renal system development, morphogenesis of a polarized epithelium, |
| | branching involved in salivary gland morphogenesis, negative regulation of |
| | kinase activity, digestive system process, digestive system development, |
| | embryo development, regulation of response to external stimulus, cellular |
| | response to radiation, positive regulation of endopeptidase activity, response |
| | to prostaglandin E stimulus, prostate glandular acinus morphogenesis, prostate |
| | epithelial cord arborization involved in prostate glandular acinus |
| | morphogenesis, Wnt receptor signaling pathway involved in somitogenesis, |
| | regulation of non-canonical Wnt receptor signaling pathway, negative |
| | regulation of transferase activity, mesenchymal cell differentiation, response |
| | to peptide hormone stimulus, endocrine system development, mammary gland |
| | duct morphogenesis, kidney epithelium development, negative regulation of |
| | MAP kinase activity, cell adhesion, biological adhesion, brown fat cell |
| | differentiation, regionalization, mammary gland development, glandular |
| | epithelial cell differentiation, toxin metabolic process, limb bud formation, |
| | regulation of branching involved in prostate gland morphogenesis, nephron |
| | tubule formation, regulation of establishment of planar polarity involved in |
| | neural tube closure, planar cell polarity pathway involved in neural tube |
| | closure, regulation of osteoblast differentiation, positive regulation of |
| | developmental process, developmental growth, regulation of anatomical |
| | structure morphogenesis, positive regulation of response to external stimulus, |
| | viral genome expression, viral transcription, response to nutrient, negative |
| | regulation of molecular function, embryonic morphogenesis, mesenchyme |
| | development, salivary gland morphogenesis, negative regulation of epithelial |
| | to mesenchymal transition, response to prostaglandin stimulus, regulation of |
| | branching involved in salivary gland morphogenesis, nephron tubule |
| | morphogenesis, establishment of planar polarity involved in neural tube |
| | closure, regulation of MAP kinase activity, cell migration, regulation of cell |
| | differentiation, digestion, positive regulation of gene-specific transcription, |
| | response to cytokine stimulus, negative regulation of cell differentiation, |
| | appendage morphogenesis, limb morphogenesis, positive regulation of cell |
| | growth, negative regulation of programmed cell death, regulation of |
| | gastrulation, otic vesicle formation, white fat cell differentiation, lung |
| | epithelial cell differentiation, prostatic bud formation, renal tubule |
| | morphogenesis, otic vesicle development, otic vesicle morphogenesis, salivary |
| | gland development, stem cell maintenance, positive regulation of canonical |
| | Wnt receptor signaling pathway, positive regulation of gene-specific |
| | transcription from RNA polymerase II promoter, embryonic epithelial tube |
| | formation, secondary metabolic process, appendage development, limb |
| | development, regulation of reproductive process, response to external |
| | stimulus, epithelial tube formation, negative regulation of cell death, cardiac |
| | ventricle morphogenesis, cartilage development, establishment of planar |
| | polarity of embryonic epithelium, negative regulation of JUN kinase activity, |
| | lung cell differentiation, lateral sprouting from an epithelium, response to |
| | interleukin-6, positive regulation of cell size, positive regulation of peptidyl- |
| | tyrosine phosphorylation, negative regulation of catalytic activity, regulation |
| | of developmental growth, stem cell development, cellular response to abiotic |
| | stimulus, nephron development, regulation of cellular component movement, |
| | regulation of protein serine/threonine kinase activity, cardiovascular system |
| | development, circulatory system development, negative regulation of protein |
| | serine/threonine kinase activity, gene-specific transcription from RNA |
| | polymerase II promoter, mammary gland morphogenesis, response to |
| | interleukin-1, cell motility, localization of cell, Notch signaling pathway, |
| | myeloid cell differentiation, regulation of gluconeogenesis, hemidesmosome |
| | assembly, genitalia morphogenesis, response to mercury ion, negative |
| | regulation of peptidyl-tyrosine phosphorylation, induction of positive |
| | chemotaxis, epithelial cell differentiation involved in prostate gland |
| | development, epidermal cell differentiation, negative regulation of cell |
| | proliferation, regulation of fat cell differentiation, blood vessel development, |
| | kidney development, respiratory system development, osteoblast development, |
| | trabecula formation, branch elongation of an epithelium, trabecula |
| | morphogenesis, negative regulation of hormone secretion, female gonad |
| | development, response to ionizing radiation, bone morphogenesis, response to |
| | metal ion, transmembrane receptor protein serine/threonine kinase signaling |
| | pathway, regulation of programmed cell death, exocrine system development, |
| | regulation of fibroblast proliferation, columnar/cuboidal epithelial cell |
| | differentiation, branching involved in prostate gland morphogenesis, blood |
| | vessel morphogenesis, negative regulation of secretion, chondrocyte |
| | differentiation, cardiac ventricle development, cell-substrate junction |
| | assembly, fibroblast proliferation, vasculature development, response to |
| | insulin stimulus, cell growth, mesenchymal cell development, regulation of |
| | transcription, DNA-dependent, regulation of cell death, cell-cell adhesion, |
| | positive regulation of Wnt receptor signaling pathway, skeletal system |
| | morphogenesis, metanephros morphogenesis, segment specification, epithelial |
| | cell migration, tail morphogenesis, convergent extension, Wnt receptor |
| | signaling pathway, planar cell polarity pathway, cellular response to ionizing |
| | radiation, nephron tubule development, epithelium migration, regulation of |
| | establishment of planar polarity, somitogenesis, regulation of cell migration, |
| | negative regulation of apoptosis, cardiac chamber morphogenesis, cell-cell |
| | signaling, negative regulation of cellular component movement, outflow tract |
| | morphogenesis, positive regulation of tyrosine phosphorylation of Stat3 |
| | protein, positive regulation of fat cell differentiation, smooth muscle tissue |
| | development, renal tubule development, cellular response to oxygen levels, |
| | cellular response to hypoxia, regulation of cell motility, negative regulation of |
| | developmental process, tube closure, locomotion, blastocyst hatching, |
| | epidermal cell fate specification, negative regulation of tumor necrosis factor- |
| | mediated signaling pathway, rhombomere formation, rhombomere 3 |
| | formation, rhombomere 5 morphogenesis, rhombomere 5 formation, |
| | hepatocyte growth factor production, regulation of hepatocyte growth factor |
| | production, leptin-mediated signaling pathway, negative regulation of |
| | heterotypic cell-cell adhesion, response to luteinizing hormone stimulus, |
| | hatching, cellular response to drug, canonical Wnt receptor signaling pathway |
| | involved in regulation of type B pancreatic cell proliferation, stromal- |
| | epithelial cell signaling involved in prostate gland development, fibroblast |
| | apoptosis, negative regulation of DNA repair, hepatocyte growth factor |
| | biosynthetic process, regulation of hepatocyte growth factor biosynthetic |
| | process, negative regulation of hepatocyte growth factor biosynthetic process, |
| | urothelial cell proliferation, regulation of urothelial cell proliferation, positive |
| | regulation of urothelial cell proliferation, leukocyte adhesive activation, |
| | regulation of calcium-independent cell-cell adhesion, positive regulation of |
| | calcium-independent cell-cell adhesion, lung pattern specification process, |
| | bronchiole morphogenesis, cell-cell signaling involved in lung development, |
| | mesenchymal-epithelial cell signaling involved in lung development, |
| | mammary gland bud elongation, nipple sheath formation, submandibular |
| | salivary gland formation, regulation of branching involved in salivary gland |
| | morphogenesis by extracellular matrix-epithelial cell signaling, prostate gland |
| | stromal morphogenesis, semicircular canal formation, semicircular canal |
| | fusion, lung proximal/distal axis specification, regulation of interleukin-6- |
| | mediated signaling pathway, negative regulation of interleukin-6-mediated |
| | signaling pathway, interleukin-27-mediated signaling pathway, positive |
| | regulation of fat cell proliferation, positive regulation of white fat cell |
| | proliferation, response to platinum ion, response to interleukin-9, response to |
| | interleukin-11, hair follicle cell proliferation, regulation of hair follicle cell |
| | proliferation, positive regulation of hair follicle cell proliferation, organism |
| | emergence from protective structure, response to BMP stimulus, cellular |
| | response to BMP stimulus, axis elongation involved in somitogenesis, |
| | convergent extension involved in somitogenesis, regulation of stem cell |
| | division, regulation of canonical Wnt receptor signaling pathway involved in |
| | controlling type B pancreatic cell proliferation, negative regulation of |
| | canonical Wnt receptor signaling pathway involved in controlling type B |
| | pancreatic cell proliferation, regulation of fibroblast apoptosis, negative |
| | regulation of fibroblast apoptosis, positive regulation of fibroblast apoptosis, |
| | regulation of DNA biosynthetic process, negative regulation of DNA |
| | biosynthetic process, regulation of cell size, positive regulation of |
| | inflammatory response, somite development |
| Breast | tube morphogenesis, tube development, epithelial tube morphogenesis, |
| Cancer | branching morphogenesis of a tube, negative regulation of cellular |
| Tissue | carbohydrate metabolic process, negative regulation of carbohydrate metabolic |
| | process, regulation of transcription from RNA polymerase II promoter, |
| | morphogenesis of a branching structure, development of primary male sexual |
| | characteristics, regulation of multicellular organismal development, regulation |
| | of developmental process, male sex differentiation, branching involved in |
| | mammary gland duct morphogenesis, system development, morphogenesis of |
| | an epithelium, male genitalia development, anatomical structure development, |
| | regulation of survival gene product expression, organ development, positive |
| | regulation of estrogen receptor signaling pathway, morphogenesis of a |
| | branching epithelium, estrogen receptor signaling pathway, transcription from |
| | RNA polymerase II promoter, mammary gland duct morphogenesis, response |
| | to hormone stimulus, sex differentiation, positive regulation of steroid |
| | hormone receptor signaling pathway, male genitalia morphogenesis, prostate |
| | gland epithelium morphogenesis, gland development, prostate gland |
| | morphogenesis, tissue morphogenesis, genitalia development, negative |
| | regulation of receptor biosynthetic process, negative regulation of protein |
| | autophosphorylation, mammary gland branching involved in pregnancy, |
| | regulation of cell differentiation, skeletal system development, response to |
| | endogenous stimulus, multicellular organismal development, gland |
| | morphogenesis, developmental process involved in reproduction, cell |
| | differentiation, mammary gland morphogenesis, regulation of bone |
| | mineralization, negative regulation of survival gene product expression, |
| | urogenital system development, lipid metabolic process, cellular |
| | developmental process, mammary gland development, regulation of estrogen |
| | receptor signaling pathway, organ morphogenesis, developmental process, |
| | regulation of biomineral tissue development, regulation of ossification, |
| | development of primary sexual characteristics, prostate gland development, |
| | tissue development, prostate gland growth, mammary gland epithelium |
| | development, regulation of cellular macromolecule biosynthetic process, |
| | regulation of glucose metabolic process, epithelium development, genitalia |
| | morphogenesis, prostate glandular acinus development, epithelial cell |
| | differentiation involved in prostate gland development, regulation of |
| | multicellular organismal process, anatomical structure morphogenesis, |
| | sequestering of triglyceride, regulation of macromolecule biosynthetic |
| | process, regulation of carbohydrate metabolic process, regulation of cellular |
| | carbohydrate metabolic process, regulation of nitrogen compound metabolic |
| | process, negative regulation of macrophage derived foam cell differentiation, |
| | regulation of receptor biosynthetic process, mammary gland alveolus |
| | development, mammary gland lobule development, ossification, regulation of |
| | anatomical structure morphogenesis, bone mineralization, maternal process |
| | involved in female pregnancy, regulation of primary metabolic process, |
| | steroid hormone mediated signaling pathway, regulation of transcription, |
| | DNA-dependent, regulation of transcription from RNA polymerase II |
| | promoter by nuclear hormone receptor, lipid catabolic process, regulation of |
| | protein autophosphorylation, regulation of cellular metabolic process, |
| | regulation of transcription, positive regulation of transcription from RNA |
| | polymerase II promoter, receptor biosynthetic process, negative regulation of |
| | fat cell differentiation, regulation of nucleobase, nucleoside, nucleotide and |
| | nucleic acid metabolic process, regulation of cellular biosynthetic process, |
| | regulation of RNA metabolic process, regulation of gene-specific transcription |
| | from RNA polymerase II promoter, positive regulation of transcription, DNA- |
| | dependent, gene-specific transcription from RNA polymerase II promoter, |
| | regulation of biosynthetic process, regulation of lipid metabolic process, |
| | positive regulation of RNA metabolic process, response to insulin stimulus, |
| | male gonad development, regulation of metabolic process, positive regulation |
| | of gene expression, anti-apoptosis, negative regulation of cellular |
| | macromolecule biosynthetic process, biomineral tissue development, positive |
| | regulation of gene-specific transcription from RNA polymerase II promoter, |
| | response to organic substance, neuron maturation, nervous system |
| | development, embryonic morphogenesis, neuron differentiation, cell |
| | maturation, negative regulation of cell differentiation, posterior midgut |
| | development, negative regulation of tumor necrosis factor-mediated signaling |
| | pathway, male somatic sex determination, anterior neuropore closure, |
| | neuropore closure, saturated monocarboxylic acid metabolic process, |
| | unsaturated monocarboxylic acid metabolic process, negative regulation of |
| | heterotypic cell-cell adhesion, cellular response to drug, prostate induction, |
| | activation of prostate induction by androgen receptor signaling pathway, |
| | prostate gland stromal morphogenesis, regulation of glycolysis by positive |
| | regulation of transcription from an RNA polymerase II promoter, regulation of |
| | cellular ketone metabolic process by positive regulation of transcription from |
| | an RNA polymerase II promoter, regulation of lipid transport by positive |
| | regulation of transcription from an RNA polymerase II promoter, regulation of |
| | DNA biosynthetic process, negative regulation of DNA biosynthetic process, |
| | androgen metabolic process, negative regulation of macromolecule |
| | biosynthetic process, regulation of organ morphogenesis, positive regulation |
| | of fatty acid metabolic process, regulation of macromolecule metabolic |
| | process, regulation of steroid hormone receptor signaling pathway, brown fat |
| | cell differentiation, response to steroid hormone stimulus, negative regulation |
| | of cellular biosynthetic process, multicellular organismal process, |
| | transcription, regulation of macrophage derived foam cell differentiation, |
| | steroid hormone receptor signaling pathway, regulation of gene-specific |
| | transcription, negative regulation of biosynthetic process, morphogenesis of |
| | embryonic epithelium, transcription, DNA-dependent, generation of neurons, |
| | RNA biosynthetic process, fat cell differentiation, negative regulation of blood |
| | pressure, macrophage derived foam cell differentiation, foam cell |
| | differentiation, regulation of morphogenesis of a branching structure, |
| | reproductive process, reproduction, positive regulation of transcription, |
| | regulation of carbohydrate biosynthetic process, regulation of cell |
| | development, reproductive structure development, androgen catabolic process, |
| | regulation of tumor necrosis factor-mediated signaling pathway, somatic sex |
| | determination, inorganic diphosphate transport, slow-twitch skeletal muscle |
| | fiber contraction, luteinizing hormone secretion, positive regulation of |
| | myeloid cell apoptosis, adiponectin-mediated signaling pathway, negative |
| | regulation of glycogen biosynthetic process, negative regulation of glycolysis, |
| | positive regulation of retinoic acid receptor signaling pathway, lateral |
| | sprouting involved in mammary gland duct morphogenesis, epithelial- |
| | mesenchymal signaling involved in prostate gland development, regulation of |
| | glycolysis by regulation of transcription from an RNA polymerase II |
| | promoter, regulation of cellular ketone metabolic process by regulation of |
| | transcription from an RNA polymerase II promoter, regulation of lipid |
| | transport by regulation of transcription from an RNA polymerase II promoter, |
| | neurogenesis, lung development, hormone-mediated signaling pathway, |
| | regulation of glucose import, regulation of gene expression, regulation of |
| | neuron differentiation, transmembrane receptor protein tyrosine kinase |
| | signaling pathway, positive regulation of axonogenesis, respiratory tube |
| | development, intracellular receptor mediated signaling pathway, negative |
| | regulation of developmental process, positive regulation of gene-specific |
| | transcription, cell development, regulation of generation of precursor |
| | metabolites and energy |

### APPENDIX 4

| | Dataset | |
|---|---|---|
| Tissue | Effect | P Value |
| Spleen | −0.22 | 0 |
| Esophagus | −0.2 | 0 |
| Salivary Glands | −0.2 | 0 |
| Cerebellum | −0.18 | 0 |
| Prostate | −0.17 | 0 |
| Lymph Node | −0.17 | 0 |
| Myometrium | −0.14 | 0 |
| Tongue | −0.14 | 0 |
| Liver and/or Biliary | −0.14 | 0 |
| Structure | | |
| Kidney | −0.13 | 0 |
| Skeletal Muscle | −0.12 | 0 |
| Spinal Cord | −0.11 | 0 |
| Stomach | −0.11 | 0 |
| Endometrium | −0.11 | 0 |
| Spinal Nerve Structure | −0.1 | 0 |
| Heart | −0.1 | 0 |
| Brain | −0.08 | 0 |
| Adrenal Gland | −0.08 | 0 |
| Lung | −0.06 | 0 |
| Colon | −0.05 | 0 |
| Penis | −0.05 | 0.06 |
| Gingiva | −0.05 | 0 |
| Skin | −0.04 | 0 |
| Ovary | −0.04 | 0 |
| Hippocampus | −0.03 | 0 |
| Breast | −0.02 | 0 |
| Intestine | −0.02 | 0 |
| Bone Marrow | −0.01 | 0 |
| Stem Cells | 0 | 0 |
| Thyroid | 0 | 0.46 |
| Uterus | 0.04 | 0.98 |
| Blood | 0.06 | 0.34 |
| Epithelial | 0.07 | 0 |
| Bone | 0.09 | 0 |

### APPENDIX 5

### Including Table S1-Table S8

Table s1 to s4: genes in the SCGS, organized by the functional module to which they belong. Tables s5 to s8: GO enrichment statistics for each functional module in the SCGS. A complete listing of all of the GEO sample identifiers for the microarray data comprising the database used in the analysis

TABLE s1
SCGS genes in the DNA replication/cell cycle module.
The FIR score, percentile, and Bonferroni-corrected p-value
(see Methods) are reported for each gene in the set.

| | | | Binomial p- | |
|---|---|---|---|---|
| Gene Name | Gene ID | Score | value | Percentile |
| DNMT3B | 1789 | 0.508379888 | 2.94E−61 | 0.00296267 |
| MCM6 | 4175 | 0.51396648 | 1.62E−62 | 0.002666403 |
| CDC25A | 993 | 0.525139665 | 4.62E−65 | 0.002024491 |
| PFAS | 5198 | 0.525139665 | 4.62E−65 | 0.002024491 |
| MCM4 | 4173 | 0.452513966 | 3.30E−49 | 0.008641122 |
| XRCC5 | 7520 | 0.480446927 | 4.11E−55 | 0.005184673 |
| HAUS6 | 54801 | 0.458100559 | 2.28E−50 | 0.007406676 |
| TET1 | 80312 | 0.458100559 | 2.28E−50 | 0.007406676 |
| IGF2BP1 | 10642 | 0.541899441 | 5.95E−69 | 0.001580091 |
| PLAA | 9373 | 0.469273743 | 1.01E−52 | 0.006270986 |
| DEPDC1B | 55789 | 0.458100559 | 2.28E−50 | 0.007406676 |
| TEX10 | 54881 | 0.458100559 | 2.28E−50 | 0.007406676 |
| CCDC99 | 54908 | 0.558659218 | 6.26E−73 | 0.001234446 |
| MSH2 | 4436 | 0.480446927 | 4.11E−55 | 0.005184673 |
| BUB1B | 701 | 0.480446927 | 4.11E−55 | 0.005184673 |
| MSH6 | 2956 | 0.463687151 | 1.53E−51 | 0.007011653 |
| DLGAP5 | 9787 | 0.491620112 | 1.53E−57 | 0.004147738 |
| SKIV2L2 | 23517 | 0.469273743 | 1.01E−52 | 0.006270986 |
| CENPE | 1062 | 0.474860335 | 6.52E−54 | 0.005629074 |
| CHEK2 | 11200 | 0.525139665 | 4.62E−65 | 0.002024491 |
| SOHLH2 | 54937 | 0.603351955 | 5.68E−84 | 0.000345645 |
| CCNB1 | 891 | 0.458100559 | 2.28E−50 | 0.007406676 |
| RRAS2 | 22800 | 0.581005587 | 2.26E−78 | 0.000641912 |
| PRIM1 | 5557 | 0.474860335 | 6.52E−54 | 0.005629074 |
| PAICS | 10606 | 0.469273743 | 1.01E−52 | 0.006270986 |
| CCNA2 | 890 | 0.497206704 | 9.02E−59 | 0.003703338 |
| CPSF3 | 51692 | 0.474860335 | 6.52E−54 | 0.005629074 |
| NUSAP1 | 51203 | 0.469273743 | 1.01E−52 | 0.006270986 |
| LIN28B | 389421 | 0.502793296 | 5.21E−60 | 0.00320956 |
| IPO5 | 3843 | 0.525139665 | 4.62E−65 | 0.002024491 |
| KIF11 | 3832 | 0.48603352 | 2.54E−56 | 0.004690895 |
| BMPR1A | 657 | 0.452513966 | 3.30E−49 | 0.008641122 |
| NDC80 | 10403 | 0.491620112 | 1.53E−57 | 0.004147738 |
| BCAT1 | 586 | 0.519553073 | 8.75E−64 | 0.002419514 |
| CCNG1 | 900 | 0.508379888 | 2.94E−61 | 0.00296267 |
| ZNF788 | 388507 | 0.469273743 | 1.01E−52 | 0.006270986 |
| ASCC3 | 10973 | 0.452513966 | 3.30E−49 | 0.008641122 |
| FANCB | 2187 | 0.458100559 | 2.28E−50 | 0.007406676 |
| MCM10 | 55388 | 0.525139665 | 4.62E−65 | 0.002024491 |
| HMGA2 | 8091 | 0.469273743 | 1.01E−52 | 0.006270986 |
| SKP2 | 6502 | 0.469273743 | 1.01E−52 | 0.006270986 |
| TRIM24 | 8805 | 0.541899441 | 5.95E−69 | 0.001580091 |
| ORC1 | 4998 | 0.480446927 | 4.11E−55 | 0.005184673 |
| HDAC2 | 3066 | 0.458100559 | 2.28E−50 | 0.007406676 |
| HESX1 | 8820 | 0.480446927 | 4.11E−55 | 0.005184673 |
| C1orf135 | 79000 | 0.51396648 | 1.62E−62 | 0.002666403 |
| INHBE | 83729 | 0.497206704 | 9.02E−59 | 0.003703338 |
| MIS18A | 54069 | 0.463687151 | 1.53E−51 | 0.007011653 |
| DCUN1D5 | 84259 | 0.463687151 | 1.53E−51 | 0.007011653 |
| POLE2 | 5427 | 0.48603352 | 2.54E−56 | 0.004690895 |
| MRPL3 | 11222 | 0.469273743 | 1.01E−52 | 0.006270986 |
| CENPH | 64946 | 0.463687151 | 1.53E−51 | 0.007011653 |
| MYCN | 4613 | 0.458100559 | 2.28E−50 | 0.007406676 |
| HAUS1 | 115106 | 0.474860335 | 6.52E−54 | 0.005629074 |
| GDF3 | 9573 | 0.458100559 | 2.28E−50 | 0.007406676 |

TABLE s2
SCGS genes in the RNA transcription/protein synthesis module.
The FIR score, percentile, and Bonferroni-corrected p-value
(see Methods) are reported for each gene in the set.

| | | | Binomial p- | |
|---|---|---|---|---|
| Gene Name | Gene ID | Score | value | Percentile |
| TBCE | 6905 | 0.491620112 | 1.53E−57 | 0.004147738 |
| RIOK2 | 55781 | 0.597765363 | 1.48E−82 | 0.000395023 |
| BCKDHB | 594 | 0.458100559 | 2.28E−50 | 0.007406676 |
| RAD1 | 5810 | 0.458100559 | 2.28E−50 | 0.007406676 |
| NREP | 9315 | 0.458100559 | 2.28E−50 | 0.007406676 |
| ADH5 | 128 | 0.648044693 | 1.16E−95 | 0.000197511 |
| PLRG1 | 5356 | 0.519553073 | 8.75E−64 | 0.002419514 |
| ROR1 | 4919 | 0.670391061 | 9.24E−102 | 4.94E−05 |
| RAB3B | 5865 | 0.553072626 | 1.36E−71 | 0.001431957 |
| LOC285431 | 285431 | 0.491620112 | 1.53E−57 | 0.004147738 |
| DBC1 | 1620 | 0.48603352 | 2.54E−56 | 0.004690895 |
| KIF23 | 9493 | 0.452513966 | 3.30E−49 | 0.008641122 |
| DIAPH3 | 81624 | 0.502793296 | 5.21E−60 | 0.00320956 |
| GNL2 | 29889 | 0.491620112 | 1.53E−57 | 0.004147738 |
| FGF2 | 2247 | 0.681564246 | 7.10E−105 | 0 |
| TARDBP | 23435 | 0.458100559 | 2.28E−50 | 0.007406676 |
| NMNAT2 | 23057 | 0.452513966 | 3.30E−49 | 0.008641122 |
| ZNF167 | 55888 | 0.491620112 | 1.53E−57 | 0.004147738 |
| KIF20A | 10112 | 0.463687151 | 1.53E−51 | 0.007011653 |
| CENPI | 2491 | 0.480446927 | 4.11E−55 | 0.005184673 |
| DDX1 | 1653 | 0.469273743 | 1.01E−52 | 0.006270986 |
| XXYLT1 | 152002 | 0.525139665 | 4.62E−65 | 0.002024491 |
| GPR176 | 11245 | 0.664804469 | 3.21E−100 | 9.88E−05 |
| FBXO22 | 26263 | 0.469273743 | 1.01E−52 | 0.006270986 |
| BBS9 | 27241 | 0.51396648 | 1.62E−62 | 0.002666403 |
| C14orf166 | 51637 | 0.541899441 | 5.95E−69 | 0.001580091 |
| BOD1 | 91272 | 0.519553073 | 8.75E−64 | 0.002419514 |
| CDC123 | 8872 | 0.469273743 | 1.01E−52 | 0.006270986 |
| SNRPD3 | 6634 | 0.502793296 | 5.21E−60 | 0.00320956 |
| FAM118B | 79607 | 0.56424581 | 2.82E−74 | 0.000987557 |
| DPH3 | 285381 | 0.474860335 | 6.52E−54 | 0.005629074 |
| EIF2B3 | 8891 | 0.469273743 | 1.01E−52 | 0.006270986 |
| KDELC1 | 79070 | 0.586592179 | 9.33E−80 | 0.000543156 |
| RPF2 | 84154 | 0.458100559 | 2.28E−50 | 0.007406676 |
| APLP1 | 333 | 0.474860335 | 6.52E−54 | 0.005629074 |
| DACT1 | 51339 | 0.536312849 | 1.20E−67 | 0.001777602 |
| PDHB | 5162 | 0.586592179 | 9.33E−80 | 0.000543156 |
| C14orf119 | 55017 | 0.575418994 | 5.37E−77 | 0.000790045 |
| DTD1 | 92675 | 0.469273743 | 1.01E−52 | 0.006270986 |
| SAMM50 | 25813 | 0.497206704 | 9.02E−59 | 0.003703338 |
| CCL26 | 10344 | 0.491620112 | 1.53E−57 | 0.004147738 |
| C4orf52 | 389203 | 0.458100559 | 2.28E−50 | 0.007406676 |
| CCDC90B | 60492 | 0.458100559 | 2.28E−50 | 0.007406676 |
| MED20 | 9477 | 0.56424581 | 2.82E−74 | 0.000987557 |
| UTP6 | 55813 | 0.469273743 | 1.01E−52 | 0.006270986 |
| RARS2 | 57038 | 0.458100559 | 2.28E−50 | 0.007406676 |
| KIAA0020 | 9933 | 0.474860335 | 6.52E−54 | 0.005629074 |
| ARMCX2 | 9823 | 0.569832402 | 1.25E−75 | 0.000839423 |
| RARS | 5917 | 0.491620112 | 1.53E−57 | 0.004147738 |
| MTHFD2 | 10797 | 0.469273743 | 1.01E−52 | 0.006270986 |
| DHX15 | 1665 | 0.452513966 | 3.30E−49 | 0.008641122 |
| HTR7 | 3363 | 0.558659218 | 6.26E−73 | 0.001234446 |
| HIST1H4C | 8364 | 0.48603352 | 2.54E−56 | 0.004690895 |

TABLE s3
SCGS genes in the metabolism/hormone signaling/protein synthesis
module. The FIR score, percentile, and Bonferroni-corrected p-
value (see Methods) are reported for each gene in the set.

| | | | Binomial | |
|---|---|---|---|---|
| Gene Name | Gene ID | Score | p-value | Percentile |
| MTHFD1L | 25902 | 0.541899441 | 5.95E−69 | 0.001580091 |
| ARMC9 | 80210 | 0.569832402 | 1.25E−75 | 0.000839423 |
| XPOT | 11260 | 0.51396648 | 1.62E−62 | 0.002666403 |
| IARS | 3376 | 0.497206704 | 9.02E−59 | 0.003703338 |
| HDX | 139324 | 0.56424581 | 2.82E−74 | 0.000987557 |
| ACTRT3 | 84517 | 0.530726257 | 2.39E−66 | 0.001925736 |
| ERCC2 | 2068 | 0.458100559 | 2.28E−50 | 0.007406676 |
| TBC1D16 | 125058 | 0.452513966 | 3.30E−49 | 0.008641122 |
| GARS | 2617 | 0.497206704 | 9.02E−59 | 0.003703338 |
| KIF7 | 374654 | 0.61452514 | 7.83E−87 | 0.000296267 |
| UBE2K | 3093 | 0.508379888 | 2.94E−61 | 0.00296267 |
| SLC25A3 | 5250 | 0.48603352 | 2.54E−56 | 0.004690895 |
| ICMT | 23463 | 0.530726257 | 2.39E−66 | 0.001925736 |
| UGGT2 | 55757 | 0.48603352 | 2.54E−56 | 0.004690895 |
| ATP11C | 286410 | 0.48603352 | 2.54E−56 | 0.004690895 |
| SLC24A1 | 9187 | 0.497206704 | 9.02E−59 | 0.003703338 |
| EIF2AK4 | 440275 | 0.474860335 | 6.52E−54 | 0.005629074 |
| GPX8 | 493869 | 0.491620112 | 1.53E−57 | 0.004147738 |
| ALX1 | 8092 | 0.51396648 | 1.62E−62 | 0.002666403 |
| OSTC | 58505 | 0.525139665 | 4.62E−65 | 0.002024491 |
| TRPC4 | 7223 | 0.458100559 | 2.28E−50 | 0.007406676 |
| HAS2 | 3037 | 0.51396648 | 1.62E−62 | 0.002666403 |
| FZD2 | 2535 | 0.452513966 | 3.30E−49 | 0.008641122 |
| TRNT1 | 51095 | 0.519553073 | 8.75E−64 | 0.002419514 |
| MMADHC | 27249 | 0.536312849 | 1.20E−67 | 0.001777602 |
| SNX8 | 29886 | 0.502793296 | 5.21E−60 | 0.00320956 |
| CDH6 | 1004 | 0.458100559 | 2.28E−50 | 0.007406676 |
| HAT1 | 8520 | 0.458100559 | 2.28E−50 | 0.007406676 |
| SEC11A | 23478 | 0.519553073 | 8.75E−64 | 0.002419514 |
| DIMT1 | 27292 | 0.452513966 | 3.30E−49 | 0.008641122 |
| TM2D2 | 83877 | 0.452513966 | 3.30E−49 | 0.008641122 |
| FST | 10468 | 0.536312849 | 1.20E−67 | 0.001777602 |
| GBE1 | 2632 | 0.480446927 | 4.11E−55 | 0.005184673 |

TABLE s4
SCGS genes in the multicellular signaling/immune signaling/cell
identity module. The FIR score, percentile, and Bonferroni-corrected
p-value (see Methods) are reported for each gene in the set.

| | | | Binomial | |
|---|---|---|---|---|
| Gene Name | Gene ID | Score | p-value | Percentile |
| NA | 80047 | 0.452513966 | 3.30E−49 | 0.008641122 |
| MLL3 | 58508 | 0.508379888 | 2.94E−61 | 0.00296267 |
| MXI1 | 4601 | 0.480446927 | 4.11E−55 | 0.005184673 |
| FKSG49 | 400949 | 0.569832402 | 1.25E−75 | 0.000839423 |
| FAM185BP | 641808 | 0.48603352 | 2.54E−56 | 0.004690895 |
| ARRB2 | 409 | 0.56424581 | 2.82E−74 | 0.000987557 |
| SMARCC2 | 6601 | 0.497206704 | 9.02E−59 | 0.003703338 |
| WASH3P | 374666 | 0.491620112 | 1.53E−57 | 0.004147738 |
| PILRB | 29990 | 0.463687151 | 1.53E−51 | 0.007011653 |
| CTSH | 1512 | 0.48603352 | 2.54E−56 | 0.004690895 |
| SAT1 | 6303 | 0.553072626 | 1.36E−71 | 0.001431957 |
| JUNB | 3726 | 0.452513966 | 3.30E−49 | 0.008641122 |
| CD53 | 963 | 0.508379888 | 2.94E−61 | 0.00296267 |
| PECAM1 | 5175 | 0.597765363 | 1.48E−82 | 0.000395023 |
| IL10RA | 3587 | 0.502793296 | 5.21E−60 | 0.00320956 |
| RCSD1 | 92241 | 0.452513966 | 3.30E−49 | 0.008641122 |
| ARHGDIB | 397 | 0.452513966 | 3.30E−49 | 0.008641122 |
| GIMAP5 | 55340 | 0.581005587 | 2.26E−78 | 0.000641912 |
| GIMAP6 | 474344 | 0.474860335 | 6.52E−54 | 0.005629074 |
| HLA-DMB | 3109 | 0.597765363 | 1.48E−82 | 0.000395023 |
| PTPRC | 5788 | 0.502793296 | 5.21E−60 | 0.00320956 |
| C10orf128 | 170371 | 0.502793296 | 5.21E−60 | 0.00320956 |
| CMBL | 134147 | 0.474860335 | 6.52E−54 | 0.005629074 |
| HLA-DRB5 | 3127 | 0.558659218 | 6.26E−73 | 0.001234446 |
| HLA-DPA1 | 3113 | 0.558659218 | 6.26E−73 | 0.001234446 |
| ABCG1 | 9619 | 0.642458101 | 3.65E−94 | 0.000246889 |
| GIMAP7 | 168537 | 0.480446927 | 4.11E−55 | 0.005184673 |
| HLA-DQA1 | 3117 | 0.502793296 | 5.21E−60 | 0.00320956 |
| TSHZ2 | 128553 | 0.463687151 | 1.53E−51 | 0.007011653 |
| RGCC | 28984 | 0.502793296 | 5.21E−60 | 0.00320956 |
| CCR1 | 1230 | 0.502793296 | 5.21E−60 | 0.00320956 |
| NPR3 | 4883 | 0.458100559 | 2.28E−50 | 0.007406676 |
| RSAD2 | 91543 | 0.491620112 | 1.53E−57 | 0.004147738 |
| GIMAP1 | 170575 | 0.474860335 | 6.52E−54 | 0.005629074 |
| TNFSF10 | 8743 | 0.497206704 | 9.02E−59 | 0.003703338 |
| AFTPH | 54812 | 0.581005587 | 2.26E−78 | 0.000641912 |
| NA | 643187 | 0.458100559 | 2.28E−50 | 0.007406676 |
| MALAT1 | 378938 | 0.497206704 | 9.02E−59 | 0.003703338 |
| UBXN2A | 165324 | 0.463687151 | 1.53E−51 | 0.007011653 |
| PDE4C | 5143 | 0.56424581 | 2.82E−74 | 0.000987557 |
| GIMAP8 | 155038 | 0.474860335 | 6.52E−54 | 0.005629074 |
| FYB | 2533 | 0.547486034 | 2.87E−70 | 0.001530713 |
| MS4A7 | 58475 | 0.525139665 | 4.62E−65 | 0.002024491 |
| C5orf56 | 441108 | 0.458100559 | 2.28E−50 | 0.007406676 |
| LOC400931 | 400931 | 0.474860335 | 6.52E−54 | 0.005629074 |
| MLLT6 | 4302 | 0.664804469 | 3.21E−100 | 9.88E−05 |
| CTSS | 1520 | 0.48603352 | 2.54E−56 | 0.004690895 |
| ZBTB20 | 26137 | 0.458100559 | 2.28E−50 | 0.007406676 |

TABLE s5
GO terms associated with the DNA replication/cell
cycle expression module.

| GO ID | p-value | Term |
|---|---|---|
| GO:0000280 | 7.52E−14 | nuclear division |
| GO:0007067 | 7.52E−14 | mitosis |
| GO:0048285 | 1.22E−13 | organelle fission |
| GO:0000087 | 1.28E−13 | M phase of mitotic cell cycle |
| GO:0022403 | 3.70E−13 | cell cycle phase |
| GO:0000279 | 1.26E−12 | M phase |
| GO:0000278 | 1.92E−12 | mitotic cell cycle |
| GO:0022402 | 2.78E−12 | cell cycle process |
| GO:0051301 | 3.40E−12 | cell division |
| GO:0007049 | 3.88E−12 | cell cycle |
| GO:0000070 | 6.02E−09 | mitotic sister chromatid segregation |
| GO:0000819 | 7.13E−09 | sister chromatid segregation |
| GO:0000226 | 2.29E−08 | microtubule cytoskeleton organization |
| GO:0006996 | 4.19E−08 | organelle organization |
| GO:0007059 | 6.75E−08 | chromosome segregation |
| GO:0007051 | 7.94E−08 | spindle organization |
| GO:0051276 | 8.06E−08 | chromosome organization |
| GO:0000075 | 1.92E−07 | cell cycle checkpoint |
| GO:0051656 | 3.08E−07 | establishment of organelle localization |
| GO:0050000 | 4.99E−07 | chromosome localization |
| GO:0051303 | 4.99E−07 | establishment of chromosome localization |
| GO:0051726 | 9.53E−07 | regulation of cell cycle |
| GO:0007017 | 1.09E−06 | microtubule-based process |
| GO:0007093 | 1.63E−06 | mitotic cell cycle checkpoint |
| GO:0051640 | 1.78E−06 | organelle localization |
| GO:0006259 | 1.81E−06 | DNA metabolic process |
| GO:0008608 | 3.22E−06 | attachment of spindle microtubules to |
| | | kinetochore |
| GO:0051313 | 3.22E−06 | attachment of spindle microtubules to |
| | | chromosome |
| GO:0007346 | 4.21E−06 | regulation of mitotic cell cycle |
| GO:0040001 | 4.82E−06 | establishment of mitotic spindle |
| | | localization |
| GO:0006261 | 9.11E−06 | DNA-dependent DNA replication |
| GO:0007080 | 9.42E−06 | mitotic metaphase plate congression |
| GO:0051293 | 9.42E−06 | establishment of spindle localization |
| GO:0051653 | 9.42E−06 | spindle localization |
| GO:0007079 | 1.53E−05 | mitotic chromosome movement towards |
| | | spindle pole |
| GO:0051984 | 1.53E−05 | positive regulation of chromosome |
| | | segregation |
| GO:0051987 | 1.53E−05 | positive regulation of attachment of |
| | | spindle microtubules to kinetochore |
| GO:0051329 | 1.58E−05 | interphase of mitotic cell cycle |
| GO:0051310 | 1.62E−05 | metaphase plate congression |
| GO:0051325 | 2.26E−05 | interphase |
| GO:0034453 | 2.57E−05 | microtubule anchoring |
| GO:0010564 | 3.29E−05 | regulation of cell cycle process |
| GO:0010638 | 3.35E−05 | positive regulation of organelle |
| | | organization |
| GO:0006260 | 3.41E−05 | DNA replication |
| GO:0006189 | 4.59E−05 | ‘de novo’ IMP biosynthetic |
| | | process |
| GO:0045842 | 4.59E−05 | positive regulation of mitotic |
| | | metaphase/anaphase transition |
| GO:0051305 | 4.59E−05 | chromosome movement towards spindle pole |
| GO:0051988 | 4.59E−05 | regulation of attachment of spindle |
| | | microtubules to kinetochore |
| GO:0042770 | 5.20E−05 | DNA damage response, signal transduction |
| GO:0070925 | 6.40E−05 | organelle assembly |
| GO:0007052 | 7.38E−05 | mitotic spindle organization |
| GO:0000077 | 8.44E−05 | DNA damage checkpoint |
| GO:0045840 | 8.53E−05 | positive regulation of mitosis |
| GO:0051225 | 8.53E−05 | spindle assembly |
| GO:0051785 | 8.53E−05 | positive regulation of nuclear division |
| GO:0006188 | 9.16E−05 | IMP biosynthetic process |
| GO:0046040 | 9.16E−05 | IMP metabolic process |
| GO:0031570 | 0.000102493 | DNA integrity checkpoint |
| GO:0006270 | 0.000126262 | DNA-dependent DNA replication initiation |
| GO:0045787 | 0.000138788 | positive regulation of cell cycle |
| GO:0007095 | 0.000152304 | mitotic cell cycle G2/M transition DNA |
| | | damage checkpoint |
| GO:0034501 | 0.000152304 | protein localization to kinetochore |
| GO:0043570 | 0.000152304 | maintenance of DNA repeat elements |
| GO:0051096 | 0.000152304 | positive regulation of helicase activity |
| GO:0071780 | 0.000152304 | mitotic cell cycle G2/M transition |
| | | checkpoint |
| GO:0007010 | 0.000158535 | cytoskeleton organization |
| GO:0006974 | 0.000162218 | response to DNA damage stimulus |
| GO:0002566 | 0.000227877 | somatic diversification of immune |
| | | receptors via somatic mutation |
| GO:0016446 | 0.000227877 | somatic hypermutation of immunoglobulin |
| | | genes |
| GO:0051383 | 0.000227877 | kinetochore organization |
| GO:0000086 | 0.000242661 | G2/M transition of mitotic cell cycle |
| GO:0031123 | 0.000242661 | RNA 3′-end processing |
| GO:0000132 | 0.00031822 | establishment of mitotic spindle |
| | | orientation |
| GO:0051095 | 0.00031822 | regulation of helicase activity |
| GO:0051294 | 0.00031822 | establishment of spindle orientation |
| GO:0051297 | 0.00052015 | centrosome organization |
| GO:0008340 | 0.000542761 | determination of adult lifespan |
| GO:0010389 | 0.000542761 | regulation of G2/M transition of mitotic |
| | | cell cycle |
| GO:0045910 | 0.000542761 | negative regulation of DNA recombination |
| GO:0031023 | 0.000559652 | microtubule organizing center organization |
| GO:0090068 | 0.000644305 | positive regulation of cell cycle process |
| GO:0016043 | 0.000661968 | cellular component organization |
| GO:0090304 | 0.000751504 | nucleic acid metabolic process |
| GO:0051716 | 0.000765834 | cellular response to stimulus |
| GO:0006268 | 0.000825026 | DNA unwinding involved in replication |
| GO:0051983 | 0.000987526 | regulation of chromosome segregation |
| GO:0010259 | 0.001164124 | multicellular organismal aging |
| GO:0031058 | 0.001164124 | positive regulation of histone modification |
| GO:0071174 | 0.001164124 | mitotic cell cycle spindle checkpoint |
| GO:0006139 | 0.001184437 | nucleobase, nucleoside, nucleotide and |
| | | nucleic acid metabolic process |
| GO:0033554 | 0.001264272 | cellular response to stress |
| GO:0071103 | 0.001274869 | DNA conformation change |
| GO:0034641 | 0.001471331 | cellular nitrogen compound metabolic |
| | | process |
| GO:0007088 | 0.001545082 | regulation of mitosis |
| GO:0051783 | 0.001545082 | regulation of nuclear division |
| GO:0032507 | 0.001787196 | maintenance of protein location in cell |
| GO:0009127 | 0.00200931 | purine nucleoside monophosphate |
| | | biosynthetic process |
| GO:0009168 | 0.00200931 | purine ribonucleoside monophosphate |
| | | biosynthetic process |
| GO:0031577 | 0.00200931 | spindle checkpoint |
| GO:0000082 | 0.002145096 | G1/S transition of mitotic cell cycle |
| GO:0051130 | 0.002169458 | positive regulation of cellular component |
| | | organization |
| GO:0045185 | 0.002241011 | maintenance of protein location |
| GO:0032392 | 0.002254764 | DNA geometric change |
| GO:0032508 | 0.002254764 | DNA duplex unwinding |
| GO:0006807 | 0.002269381 | nitrogen compound metabolic process |
| GO:0051651 | 0.002440746 | maintenance of location in cell |
| GO:0033043 | 0.002513612 | regulation of organelle organization |
| GO:0016458 | 0.002651184 | gene silencing |
| GO:0006298 | 0.002785911 | mismatch repair |
| GO:0031572 | 0.002785911 | G2/M transition DNA damage checkpoint |
| GO:0009126 | 0.003071393 | purine nucleoside monophosphate metabolic |
| | | process |
| GO:0009167 | 0.003071393 | purine ribonucleoside monophosphate |
| | | metabolic process |
| GO:0031056 | 0.003071393 | regulation of histone modification |
| GO:0031124 | 0.003071393 | mRNA 3′-end processing |
| GO:0000710 | 0.003955576 | meiotic mismatch repair |
| GO:0003272 | 0.003955576 | endocardial cushion formation |
| GO:0007100 | 0.003955576 | mitotic centrosome separation |
| GO:0010610 | 0.003955576 | regulation of mRNA stability involved in |
| | | response to stress |
| GO:0021998 | 0.003955576 | neural plate mediolateral regionalization |
| GO:0033129 | 0.003955576 | positive regulation of histone |
| | | phosphorylation |
| GO:0043146 | 0.003955576 | spindle stabilization |
| GO:0043148 | 0.003955576 | mitotic spindle stabilization |
| GO:0046680 | 0.003955576 | response to DDT |
| GO:0048338 | 0.003955576 | mesoderm structural organization |
| GO:0048352 | 0.003955576 | paraxial mesoderm structural organization |
| GO:0060623 | 0.003955576 | regulation of chromosome condensation |
| GO:0071281 | 0.003955576 | cellular response to iron ion |
| GO:0071283 | 0.003955576 | cellular response to iron(III) ion |
| GO:0002204 | 0.004006215 | somatic recombination of immunoglobulin |
| | | genes involved in immune response |
| GO:0002208 | 0.004006215 | somatic diversification of immunoglobulins |
| | | involved in immune response |
| GO:0007091 | 0.004006215 | mitotic metaphase/anaphase transition |
| GO:0009156 | 0.004006215 | ribonucleoside monophosphate biosynthetic |
| | | process |
| GO:0030010 | 0.004006215 | establishment of cell polarity |
| GO:0030071 | 0.004006215 | regulation of mitotic metaphase/anaphase |
| | | transition |
| GO:0031576 | 0.004006215 | G2/M transition checkpoint |
| GO:0045190 | 0.004006215 | isotype switching |
| GO:0010605 | 0.004216709 | negative regulation of macromolecule |
| | | metabolic process |
| GO:0008283 | 0.004296653 | cell proliferation |
| GO:0002381 | 0.004343602 | immunoglobulin production involved in |
| | | immunoglobulin mediated immune response |
| GO:0006342 | 0.004693708 | chromatin silencing |
| GO:0030261 | 0.004693708 | chromosome condensation |
| GO:0051129 | 0.004995788 | negative regulation of cellular component |
| | | organization |
| GO:0009161 | 0.005431668 | ribonucleoside monophosphate metabolic |
| | | process |
| GO:0016447 | 0.005431668 | somatic recombination of immunoglobulin |
| | | gene segments |
| GO:0000018 | 0.005819321 | regulation of DNA recombination |
| GO:0045814 | 0.005819321 | negative regulation of gene expression, |
| | | epigenetic |
| GO:0040029 | 0.005896798 | regulation of gene expression, epigenetic |
| GO:0006281 | 0.006387647 | DNA repair |
| GO:0009892 | 0.006597795 | negative regulation of metabolic process |
| GO:0010639 | 0.006626223 | negative regulation of organelle |
| | | organization |
| GO:0016445 | 0.006631468 | somatic diversification of immunoglobulins |
| GO:0008630 | 0.007492078 | DNA damage response, signal transduction |
| | | resulting in induction of apoptosis |
| GO:0000236 | 0.007895805 | mitotic prometaphase |
| GO:0003203 | 0.007895805 | endocardial cushion morphogenesis |
| GO:0009082 | 0.007895805 | branched chain family amino acid |
| | | biosynthetic process |
| GO:0010041 | 0.007895805 | response to iron(III) ion |
| GO:0010424 | 0.007895805 | DNA methylation on cytosine within a CG |
| | | sequence |
| GO:0032776 | 0.007895805 | DNA methylation on cytosine |
| GO:0033127 | 0.007895805 | regulation of histone phosphorylation |
| GO:0048369 | 0.007895805 | lateral mesoderm morphogenesis |
| GO:0048370 | 0.007895805 | lateral mesoderm formation |
| GO:0048371 | 0.007895805 | lateral mesodermal cell differentiation |
| GO:0048372 | 0.007895805 | lateral mesodermal cell fate commitment |
| GO:0048377 | 0.007895805 | lateral mesodermal cell fate specification |
| GO:0048378 | 0.007895805 | regulation of lateral mesodermal cell fate |
| | | specification |
| GO:0048382 | 0.007895805 | mesendoderm development |
| GO:0051571 | 0.007895805 | positive regulation of histone H3-K4 |
| | | methylation |
| GO:0060897 | 0.007895805 | neural plate regionalization |
| GO:0070562 | 0.007895805 | regulation of vitamin D receptor signaling |
| | | pathway |
| GO:0090307 | 0.007895805 | spindle assembly involved in mitosis |
| GO:0032269 | 0.008382756 | negative regulation of cellular protein |
| | | metabolic process |
| GO:0002562 | 0.008872146 | somatic diversification of immune |
| | | receptors via germline recombination |
| | | within a single locus |
| GO:0016444 | 0.008872146 | somatic cell DNA recombination |
| GO:0048477 | 0.008872146 | oogenesis |
| GO:0051235 | 0.009127171 | maintenance of location |
| GO:0050767 | 0.009727988 | regulation of neurogenesis |
| GO:0002200 | 0.009850495 | somatic diversification of immune receptors |
| GO:0048863 | 0.010356874 | stem cell differentiation |
| GO:0051248 | 0.010368518 | negative regulation of protein metabolic |
| | | process |
| GO:0006344 | 0.011820745 | maintenance of chromatin silencing |
| GO:0010586 | 0.011820745 | miRNA metabolic process |
| GO:0010587 | 0.011820745 | miRNA catabolic process |
| GO:0031442 | 0.011820745 | positive regulation of mRNA 3′-end |
| | | processing |
| GO:0046499 | 0.011820745 | S-adenosylmethioninamine metabolic |
| | | process |
| GO:0048368 | 0.011820745 | lateral mesoderm development |
| GO:0050685 | 0.011820745 | positive regulation of mRNA processing |
| GO:0051299 | 0.011820745 | centrosome separation |
| GO:0051573 | 0.011820745 | negative regulation of histone H3-K9 |
| | | methylation |
| GO:0060896 | 0.011820745 | neural plate pattern specification |
| GO:0060914 | 0.011820745 | heart formation |
| GO:0070507 | 0.011943695 | regulation of microtubule cytoskeleton |
| | | organization |
| GO:0031324 | 0.012021243 | negative regulation of cellular metabolic |
| | | process |
| GO:0006310 | 0.012383973 | DNA recombination |
| GO:0033044 | 0.012494885 | regulation of chromosome organization |
| GO:0051960 | 0.013012966 | regulation of nervous system development |
| GO:0051053 | 0.013630083 | negative regulation of DNA metabolic |
| | | process |
| GO:0002377 | 0.015413557 | immunoglobulin production |
| GO:0000089 | 0.015730456 | mitotic metaphase |
| GO:0000281 | 0.015730456 | cytokinesis after mitosis |
| GO:0001880 | 0.015730456 | Mullerian duct regression |
| GO:0006269 | 0.015730456 | DNA replication, synthesis of RNA primer |
| GO:0006346 | 0.015730456 | methylation-dependent chromatin silencing |
| GO:0031062 | 0.015730456 | positive regulation of histone methylation |
| GO:0031440 | 0.015730456 | regulation of mRNA 3′-end processing |
| GO:0042661 | 0.015730456 | regulation of mesodermal cell fate |
| | | specification |
| GO:0045347 | 0.015730456 | negative regulation of MHC class II |
| | | biosynthetic process |
| GO:0051570 | 0.015730456 | regulation of histone H3-K9 methylation |
| GO:0060218 | 0.015730456 | hemopoietic stem cell differentiation |
| GO:0060236 | 0.015730456 | regulation of mitotic spindle organization |
| GO:0070561 | 0.015730456 | vitamin D receptor signaling pathway |
| GO:0072132 | 0.015730456 | mesenchyme morphogenesis |
| GO:0032886 | 0.016029199 | regulation of microtubule-based process |
| GO:0051495 | 0.017291676 | positive regulation of cytoskeleton |
| | | organization |
| GO:0040007 | 0.017363157 | growth |
| GO:0042493 | 0.017388016 | response to drug |
| GO:0031400 | 0.01786688 | negative regulation of protein modification |
| | | process |
| GO:0008629 | 0.017938333 | induction of apoptosis by intracellular |
| | | signals |
| GO:0060284 | 0.019513871 | regulation of cell development |
| GO:0009628 | 0.01952189 | response to abiotic stimulus |
| GO:0003197 | 0.019624993 | endocardial cushion development |
| GO:0007501 | 0.019624993 | mesodermal cell fate specification |
| GO:0010870 | 0.019624993 | positive regulation of receptor biosynthetic |
| | | process |
| GO:0030916 | 0.019624993 | otic vesicle formation |
| GO:0031061 | 0.019624993 | negative regulation of histone methylation |
| GO:0031573 | 0.019624993 | intra-S DNA damage checkpoint |
| GO:0051382 | 0.019624993 | kinetochore assembly |
| GO:0051569 | 0.019624993 | regulation of histone H3-K4 methylation |
| GO:0070934 | 0.019624993 | CRD-mediated mRNA stabilization |
| GO:0071305 | 0.019624993 | cellular response to vitamin D |
| GO:0071398 | 0.019624993 | cellular response to fatty acid |
| GO:0071453 | 0.019624993 | cellular response to oxygen levels |
| GO:0071456 | 0.019624993 | cellular response to hypoxia |
| GO:0071599 | 0.019624993 | otic vesicle development |
| GO:0071600 | 0.019624993 | otic vesicle morphogenesis |
| GO:0090224 | 0.019624993 | regulation of spindle organization |
| GO:0007163 | 0.019938926 | establishment or maintenance of cell |
| | | polarity |
| GO:0014070 | 0.021040728 | response to organic cyclic substance |
| GO:0009987 | 0.022113253 | cellular process |
| GO:0044260 | 0.022685343 | cellular macromolecule metabolic process |
| GO:0032268 | 0.022850588 | regulation of cellular protein metabolic |
| | | process |
| GO:0006398 | 0.023504417 | histone mRNA 3′-end processing |
| GO:0031054 | 0.023504417 | pre-microRNA processing |
| GO:0033762 | 0.023504417 | response to glucagon stimulus |
| GO:0046498 | 0.023504417 | S-adenosylhomocysteine metabolic process |
| GO:0051567 | 0.023504417 | histone H3-K9 methylation |
| GO:0060033 | 0.023504417 | anatomical structure regression |
| GO:0000079 | 0.024205165 | regulation of cyclin-dependent protein |
| | | kinase activity |
| GO:0009411 | 0.024205165 | response to UV |
| GO:0031323 | 0.024229028 | regulation of cellular metabolic process |
| GO:0016570 | 0.025724865 | histone modification |
| GO:0002440 | 0.026466249 | production of molecular mediator of immune |
| | | response |
| GO:0006302 | 0.026466249 | double-strand break repair |
| GO:0031145 | 0.026466249 | anaphase-promoting complex-dependent |
| | | proteasomal ubiquitin-dependent protein |
| | | catabolic process |
| GO:0016569 | 0.026555857 | covalent chromatin modification |
| GO:0016310 | 0.026882049 | phosphorylation |
| GO:0034661 | 0.027368783 | ncRNA catabolic process |
| GO:0051323 | 0.027368783 | metaphase |
| GO:0060391 | 0.027368783 | positive regulation of SMAD protein nuclear |
| | | translocation |
| GO:0071396 | 0.027368783 | cellular response to lipid |
| GO:0007292 | 0.028019516 | female gamete generation |
| GO:0032270 | 0.028347257 | positive regulation of cellular protein |
| | | metabolic process |
| GO:0030900 | 0.029134926 | forebrain development |
| GO:0010212 | 0.029608727 | response to ionizing radiation |
| GO:0051439 | 0.029608727 | regulation of ubiquitin-protein ligase |
| | | activity involved in mitotic cell cycle |
| GO:0032880 | 0.030472794 | regulation of protein localization |
| GO:0044237 | 0.03110202 | cellular metabolic process |
| GO:0009113 | 0.031218149 | purine base biosynthetic process |
| GO:0010224 | 0.031218149 | response to UV-B |
| GO:0017085 | 0.031218149 | response to insecticide |
| GO:0019047 | 0.031218149 | provirus integration |
| GO:0030069 | 0.031218149 | lysogeny |
| GO:0031060 | 0.031218149 | regulation of histone methylation |
| GO:0034508 | 0.031218149 | centromere complex assembly |
| GO:0048340 | 0.031218149 | paraxial mesoderm morphogenesis |
| GO:0048532 | 0.031218149 | anatomical structure arrangement |
| GO:0048853 | 0.031218149 | forebrain morphogenesis |
| GO:0055015 | 0.031218149 | ventricular cardiac muscle cell development |
| GO:0060045 | 0.031218149 | positive regulation of cardiac muscle cell |
| | | proliferation |
| GO:0060390 | 0.031218149 | regulation of SMAD protein nuclear |
| | | translocation |
| GO:0071407 | 0.031218149 | cellular response to organic cyclic substance |
| GO:0016064 | 0.031233241 | immunoglobulin mediated immune response |
| GO:0019724 | 0.032058539 | B cell mediated immunity |
| GO:0007420 | 0.032187216 | brain development |
| GO:0051247 | 0.033532315 | positive regulation of protein metabolic |
| | | process |
| GO:0009950 | 0.035052572 | dorsal/ventral axis specification |
| GO:0010453 | 0.035052572 | regulation of cell fate commitment |
| GO:0010470 | 0.035052572 | regulation of gastrulation |
| GO:0016572 | 0.035052572 | histone phosphorylation |
| GO:0031503 | 0.035052572 | protein complex localization |
| GO:0033205 | 0.035052572 | cell cycle cytokinesis |
| GO:0042659 | 0.035052572 | regulation of cell fate specification |
| GO:0010243 | 0.036312306 | response to organic nitrogen |
| GO:0051641 | 0.037096512 | cellular localization |
| GO:0045786 | 0.037642407 | negative regulation of cell cycle |
| GO:0051246 | 0.038616306 | regulation of protein metabolic process |
| GO:0001710 | 0.03887211 | mesodermal cell fate commitment |
| GO:0006301 | 0.03887211 | postreplication repair |
| GO:0006303 | 0.03887211 | double-strand break repair via |
| | | nonhomologous end joining |
| GO:0006349 | 0.03887211 | regulation of gene expression by genetic |
| | | imprinting |
| GO:0006378 | 0.03887211 | mRNA polyadenylation |
| GO:0010869 | 0.03887211 | regulation of receptor biosynthetic process |
| GO:0031057 | 0.03887211 | negative regulation of histone modification |
| GO:0043584 | 0.03887211 | nose development |
| GO:0045346 | 0.03887211 | regulation of MHC class II biosynthetic |
| | | process |
| GO:0071241 | 0.03887211 | cellular response to inorganic substance |
| GO:0071248 | 0.03887211 | cellular response to metal ion |
| GO:0071514 | 0.03887211 | genetic imprinting |
| GO:0046661 | 0.041686743 | male sex differentiation |
| GO:0051438 | 0.041686743 | regulation of ubiquitin-protein ligase |
| | | activity |
| GO:0048015 | 0.042610059 | phosphoinositide-mediated signaling |
| GO:0006379 | 0.042676819 | mRNA cleavage |
| GO:0045342 | 0.042676819 | MHC class II biosynthetic process |
| GO:0048333 | 0.042676819 | mesodermal cell differentiation |
| GO:0055012 | 0.042676819 | ventricular cardiac muscle cell |
| | | differentiation |
| GO:0051128 | 0.043302372 | regulation of cellular component |
| | | organization |
| GO:0051340 | 0.044479666 | regulation of ligase activity |
| GO:0048519 | 0.045547242 | negative regulation of biological process |
| GO:0034645 | 0.045691844 | cellular macromolecule biosynthetic process |
| GO:0007281 | 0.046379426 | germ cell development |
| GO:0031099 | 0.046379426 | regeneration |
| GO:0001556 | 0.046466754 | oocyte maturation |
| GO:0002021 | 0.046466754 | response to dietary excess |
| GO:0007076 | 0.046466754 | mitotic chromosome condensation |
| GO:0007094 | 0.046466754 | mitotic cell cycle spindle assembly |
| | | checkpoint |
| GO:0009083 | 0.046466754 | branched chain family amino acid catabolic |
| | | process |
| GO:0010714 | 0.046466754 | positive regulation of collagen metabolic |
| | | process |
| GO:0032967 | 0.046466754 | positive regulation of collagen biosynthetic |
| | | process |
| GO:0046112 | 0.046466754 | nucleobase biosynthetic process |
| GO:0051568 | 0.046466754 | histone H3-K4 methylation |
| GO:0051094 | 0.046704657 | positive regulation of developmental process |
| GO:0006950 | 0.047411532 | response to stress |

TABLE s6
GO terms associated with the RNA transcription/protein
synthesis expression module.

| GO ID | p-value | Term |
|---|---|---|
| GO:0006420 | 2.84E−05 | arginyl-tRNA aminoacylation |
| GO:0018198 | 0.000197338 | peptidyl-cysteine modification |
| GO:0009108 | 0.001505193 | coenzyme biosynthetic process |
| GO:0008380 | 0.002033993 | RNA splicing |
| GO:0006397 | 0.002458656 | mRNA processing |
| GO:0022613 | 0.002766281 | ribonucleoprotein complex biogenesis |
| GO:0007192 | 0.003118819 | activation of adenylate cyclase activity by |
| | | serotonin receptor signaling pathway |
| GO:0017014 | 0.003118819 | protein amino acid nitrosylation |
| GO:0018119 | 0.003118819 | peptidyl-cysteine S-nitrosylation |
| GO:0042660 | 0.003118819 | positive regulation of cell fate specification |
| GO:0046294 | 0.003118819 | formaldehyde catabolic process |
| GO:0048936 | 0.003118819 | peripheral nervous system neuron |
| | | axonogenesis |
| GO:0044281 | 0.003169195 | small molecule metabolic process |
| GO:0051188 | 0.004581947 | cofactor biosynthetic process |
| GO:0006520 | 0.005315717 | cellular amino acid metabolic process |
| GO:0016071 | 0.005476853 | mRNA metabolic process |
| GO:0000022 | 0.006228148 | mitotic spindle elongation |
| GO:0000189 | 0.006228148 | nuclear translocation of MAPK |
| GO:0019478 | 0.006228148 | D-amino acid catabolic process |
| GO:0042699 | 0.006228148 | follicle-stimulating hormone signaling |
| | | pathway |
| GO:0046185 | 0.006228148 | aldehyde catabolic process |
| GO:0046292 | 0.006228148 | formaldehyde metabolic process |
| GO:0051231 | 0.006228148 | spindle elongation |
| GO:0060128 | 0.006228148 | adrenocorticotropin hormone secreting cell |
| | | differentiation |
| GO:0060591 | 0.006228148 | chondroblast differentiation |
| GO:0009987 | 0.006259244 | cellular process |
| GO:0006396 | 0.00728534 | RNA processing |
| GO:0006446 | 0.007904176 | regulation of translational initiation |
| GO:0017157 | 0.008264316 | regulation of exocytosis |
| GO:0006418 | 0.008631734 | tRNA aminoacylation for protein translation |
| GO:0043038 | 0.008631734 | amino acid activation |
| GO:0043039 | 0.008631734 | tRNA aminoacylation |
| GO:0019752 | 0.009318116 | carboxylic acid metabolic process |
| GO:0043436 | 0.009318116 | oxoacid metabolic process |
| GO:0014889 | 0.009328015 | muscle atrophy |
| GO:0017182 | 0.009328015 | peptidyl-diphthamide metabolic process |
| GO:0017183 | 0.009328015 | peptidyl-diphthamide biosynthetic process |
| | | from peptidyl-histidine |
| GO:0018125 | 0.009328015 | peptidyl-cysteine methylation |
| GO:0046416 | 0.009328015 | D-amino acid metabolic process |
| GO:0060129 | 0.009328015 | thyroid-stimulating hormone-secreting cell |
| | | differentiation |
| GO:0070935 | 0.009328015 | 3′-UTR-mediated mRNA stabilization |
| GO:0044282 | 0.009730879 | small molecule catabolic process |
| GO:0006082 | 0.009845979 | organic acid metabolic process |
| GO:0042180 | 0.010395066 | cellular ketone metabolic process |
| GO:0006732 | 0.012350571 | coenzyme metabolic process |
| GO:0048511 | 0.012350571 | rhythmic process |
| GO:0007008 | 0.012418447 | outer mitochondrial membrane organization |
| GO:0043922 | 0.012418447 | negative regulation by host of viral |
| | | transcription |
| GO:0048935 | 0.012418447 | peripheral nervous system neuron |
| | | development |
| GO:0051409 | 0.012418447 | response to nitrosative stress |
| GO:0070096 | 0.012418447 | mitochondrial outer membrane translocase |
| | | complex assembly |
| GO:0006413 | 0.014514097 | translational initiation |
| GO:0044106 | 0.014817902 | cellular amine metabolic process |
| GO:0021534 | 0.015499473 | cell proliferation in hindbrain |
| GO:0021924 | 0.015499473 | cell proliferation in the external granule |
| | | layer |
| GO:0021930 | 0.015499473 | granule cell precursor proliferation |
| GO:0032057 | 0.015499473 | negative regulation of translational initiation |
| | | in response to stress |
| GO:0048934 | 0.015499473 | peripheral nervous system neuron |
| | | differentiation |
| GO:0006067 | 0.018571121 | ethanol metabolic process |
| GO:0006069 | 0.018571121 | ethanol oxidation |
| GO:0007210 | 0.018571121 | serotonin receptor signaling pathway |
| GO:0032055 | 0.018571121 | negative regulation of translation in |
| | | response to stress |
| GO:0032897 | 0.018571121 | negative regulation of viral transcription |
| GO:0034308 | 0.018571121 | monohydric alcohol metabolic process |
| GO:0060644 | 0.018571121 | mammary gland epithelial cell |
| | | differentiation |
| GO:0009063 | 0.019515168 | cellular amino acid catabolic process |
| GO:0043921 | 0.021633418 | modulation by host of viral transcription |
| GO:0046668 | 0.021633418 | regulation of retinal cell programmed cell |
| | | death |
| GO:0051775 | 0.021633418 | response to redox state |
| GO:0052312 | 0.021633418 | modulation of transcription in other |
| | | organism involved in symbiotic interaction |
| GO:0052472 | 0.021633418 | modulation by host of symbiont |
| | | transcription |
| GO:0022618 | 0.022249871 | ribonucleoprotein complex assembly |
| GO:0010001 | 0.022814877 | glial cell differentiation |
| GO:0051301 | 0.023268534 | cell division |
| GO:0006519 | 0.02370024 | cellular amino acid and derivative metabolic |
| | | process |
| GO:0009396 | 0.024686392 | folic acid and derivative biosynthetic |
| | | process |
| GO:0009435 | 0.024686392 | NAD biosynthetic process |
| GO:0018202 | 0.024686392 | peptidyl-histidine modification |
| GO:0043558 | 0.024686392 | regulation of translational initiation in |
| | | response to stress |
| GO:0046653 | 0.024686392 | tetrahydrofolate metabolic process |
| GO:0046666 | 0.024686392 | retinal cell programmed cell death |
| GO:0060045 | 0.024686392 | positive regulation of cardiac muscle cell |
| | | proliferation |
| GO:0009310 | 0.025133766 | amine catabolic process |
| GO:0042698 | 0.025728003 | ovulation cycle |
| GO:0051186 | 0.026128322 | cofactor metabolic process |
| GO:0034622 | 0.026162461 | cellular macromolecular complex assembly |
| GO:0002042 | 0.027730071 | cell migration involved in sprouting |
| | | angiogenesis |
| GO:0010453 | 0.027730071 | regulation of cell fate commitment |
| GO:0019359 | 0.027730071 | nicotinamide nucleotide biosynthetic |
| | | process |
| GO:0021936 | 0.027730071 | regulation of granule cell precursor |
| | | proliferation |
| GO:0021940 | 0.027730071 | positive regulation of granule cell precursor |
| | | proliferation |
| GO:0030815 | 0.027730071 | negative regulation of cAMP metabolic |
| | | process |
| GO:0030818 | 0.027730071 | negative regulation of cAMP biosynthetic |
| | | process |
| GO:0042659 | 0.027730071 | regulation of cell fate specification |
| GO:0043555 | 0.027730071 | regulation of translation in response to |
| | | stress |
| GO:0007188 | 0.028161812 | G-protein signaling, coupled to cAMP |
| | | nucleotide second messenger |
| GO:0042063 | 0.03068472 | gliogenesis |
| GO:0030800 | 0.030764483 | negative regulation of cyclic nucleotide |
| | | metabolic process |
| GO:0030803 | 0.030764483 | negative regulation of cyclic nucleotide |
| | | biosynthetic process |
| GO:0030809 | 0.030764483 | negative regulation of nucleotide |
| | | biosynthetic process |
| GO:0043537 | 0.030764483 | negative regulation of blood vessel |
| | | endothelial cell migration |
| GO:0006412 | 0.03284547 | translation |
| GO:0007128 | 0.033789655 | meiotic prophase I |
| GO:0021984 | 0.033789655 | adenohypophysis development |
| GO:0032855 | 0.033789655 | positive regulation of Rac GTPase activity |
| GO:0051324 | 0.033789655 | prophase |
| GO:0051851 | 0.033789655 | modification by host of symbiont |
| | | morphology or physiology |
| GO:0034660 | 0.03423083 | ncRNA metabolic process |
| GO:0045761 | 0.034630745 | regulation of adenylate cyclase activity |
| GO:0009308 | 0.035832323 | amine metabolic process |
| GO:0000377 | 0.035987987 | RNA splicing, via transesterification |
| | | reactions with bulged adenosine as |
| | | nucleophile |
| GO:0000398 | 0.035987987 | nuclear mRNA splicing, via spliceosome |
| GO:0031279 | 0.035987987 | regulation of cyclase activity |
| GO:0051339 | 0.036674296 | regulation of lyase activity |
| GO:0006086 | 0.036805614 | acetyl-CoA biosynthetic process from |
| | | pyruvate |
| GO:0009083 | 0.036805614 | branched chain family amino acid catabolic |
| | | process |
| GO:0010510 | 0.036805614 | regulation of acetyl-CoA biosynthetic |
| | | process from pyruvate |
| GO:0045980 | 0.036805614 | negative regulation of nucleotide metabolic |
| | | process |
| GO:0051046 | 0.03692867 | regulation of secretion |
| GO:0019933 | 0.038062107 | cAMP-mediated signaling |
| GO:0010608 | 0.038117727 | posttranscriptional regulation of gene |
| | | expression |
| GO:0018193 | 0.038921335 | peptidyl-amino acid modification |
| GO:0043536 | 0.039812388 | positive regulation of blood vessel |
| | | endothelial cell migration |
| GO:0045947 | 0.039812388 | negative regulation of translational initiation |
| GO:0046782 | 0.039812388 | regulation of viral transcription |
| GO:0055021 | 0.039812388 | regulation of cardiac muscle tissue growth |
| GO:0055024 | 0.039812388 | regulation of cardiac muscle tissue |
| | | development |
| GO:0060043 | 0.039812388 | regulation of cardiac muscle cell |
| | | proliferation |
| GO:0044237 | 0.040070335 | cellular metabolic process |
| GO:0000375 | 0.042344467 | RNA splicing, via transesterification |
| | | reactions |
| GO:0006085 | 0.042810004 | acetyl-CoA biosynthetic process |
| GO:0006700 | 0.042810004 | C21-steroid hormone biosynthetic process |
| GO:0006760 | 0.042810004 | folic acid and derivative metabolic process |
| GO:0051193 | 0.042810004 | regulation of cofactor metabolic process |
| GO:0051196 | 0.042810004 | regulation of coenzyme metabolic process |
| GO:0034621 | 0.043195956 | cellular macromolecular complex subunit |
| | | organization |
| GO:0030817 | 0.045295615 | regulation of cAMP biosynthetic process |
| GO:0014003 | 0.04579849 | oligodendrocyte development |
| GO:0017158 | 0.04579849 | regulation of calcium ion-dependent |
| | | exocytosis |
| GO:0019080 | 0.04579849 | viral genome expression |
| GO:0019083 | 0.04579849 | viral transcription |
| GO:0019363 | 0.04579849 | pyridine nucleotide biosynthetic process |
| GO:0060420 | 0.04579849 | regulation of heart growth |
| GO:0006171 | 0.046799216 | cAMP biosynthetic process |
| GO:0030814 | 0.046799216 | regulation of cAMP metabolic process |
| GO:0051726 | 0.047999309 | regulation of cell cycle |
| GO:0007018 | 0.048321133 | microtubule-based movement |
| GO:0050709 | 0.048777871 | negative regulation of protein secretion |
| GO:0051702 | 0.048777871 | interaction with symbiont |
| GO:0006399 | 0.049088873 | tRNA metabolic process |
| GO:0007187 | 0.04986109 | G-protein signaling, coupled to cyclic |
| | | nucleotide second messenger |

TABLE s7
GO terms associated with the metabolism/hormone
signaling expression module.

| GO ID | p-value | Term |
|---|---|---|
| GO:0034660 | 0.001322169 | ncRNA metabolic process |
| GO:0006399 | 0.001776558 | tRNA metabolic process |
| GO:0042278 | 0.002085852 | purine nucleoside metabolic process |
| GO:0046128 | 0.002085852 | purine ribonucleoside metabolic process |
| GO:0006409 | 0.002129925 | tRNA export from nucleus |
| GO:0009642 | 0.002129925 | response to light intensity |
| GO:0015957 | 0.002129925 | bis(5′-nucleosidyl) oligophosphate |
| | | biosynthetic process |
| GO:0015960 | 0.002129925 | diadenosine polyphosphate biosynthetic |
| | | process |
| GO:0015965 | 0.002129925 | diadenosine tetraphosphate metabolic |
| | | process |
| GO:0015966 | 0.002129925 | diadenosine tetraphosphate biosynthetic |
| | | process |
| GO:0032289 | 0.002129925 | myelin formation in the central nervous |
| | | system |
| GO:0051031 | 0.002129925 | tRNA transport |
| GO:0001942 | 0.003573516 | hair follicle development |
| GO:0022404 | 0.003573516 | molting cycle process |
| GO:0022405 | 0.003573516 | hair cycle process |
| GO:0006418 | 0.00409276 | tRNA aminoacylation for protein translation |
| GO:0042303 | 0.00409276 | molting cycle |
| GO:0042633 | 0.00409276 | hair cycle |
| GO:0043038 | 0.00409276 | amino acid activation |
| GO:0043039 | 0.00409276 | tRNA aminoacylation |
| GO:0006348 | 0.004255476 | chromatin silencing at telomere |
| GO:0006426 | 0.004255476 | glycyl-tRNA aminoacylation |
| GO:0006428 | 0.004255476 | isoleucyl-tRNA aminoacylation |
| GO:0006481 | 0.004255476 | C-terminal protein amino acid methylation |
| GO:0015942 | 0.004255476 | formate metabolic process |
| GO:0018410 | 0.004255476 | peptide or protein carboxyl-terminal |
| | | blocking |
| GO:0042780 | 0.004255476 | tRNA 3′-end processing |
| GO:0009119 | 0.004836233 | ribonucleoside metabolic process |
| GO:0055086 | 0.005692612 | nucleobase, nucleoside and nucleotide |
| | | metabolic process |
| GO:0006475 | 0.00637666 | internal protein amino acid acetylation |
| GO:0015956 | 0.00637666 | bis(5′-nucleosidyl) oligophosphate |
| | | metabolic process |
| GO:0015959 | 0.00637666 | diadenosine polyphosphate metabolic process |
| GO:0022010 | 0.00637666 | myelination in the central nervous system |
| GO:0032291 | 0.00637666 | ensheathment of axons in the central nervous |
| | | system |
| GO:0035315 | 0.00637666 | hair cell differentiation |
| GO:0043628 | 0.00637666 | ncRNA 3′-end processing |
| GO:0046499 | 0.00637666 | S-adenosylmethioninamine metabolic |
| | | process |
| GO:0051798 | 0.00637666 | positive regulation of hair follicle |
| | | development |
| GO:0009116 | 0.007645128 | nucleoside metabolic process |
| GO:0007199 | 0.008493487 | G-protein signaling, coupled to cGMP |
| | | nucleotide second messenger |
| GO:0032276 | 0.008493487 | regulation of gonadotropin secretion |
| GO:0032277 | 0.008493487 | negative regulation of gonadotropin |
| | | secretion |
| GO:0040016 | 0.008493487 | embryonic cleavage |
| GO:0046880 | 0.008493487 | regulation of follicle-stimulating hormone |
| | | secretion |
| GO:0046882 | 0.008493487 | negative regulation of follicle-stimulating |
| | | hormone secretion |
| GO:0051797 | 0.008493487 | regulation of hair follicle development |
| GO:0060218 | 0.008493487 | hemopoietic stem cell differentiation |
| GO:0035264 | 0.009928836 | multicellular organism growth |
| GO:0032288 | 0.010605965 | myelin assembly |
| GO:0032926 | 0.010605965 | negative regulation of activin receptor |
| | | signaling pathway |
| GO:0042634 | 0.010605965 | regulation of hair cycle |
| GO:0006283 | 0.012714102 | transcription-coupled nucleotide-excision |
| | | repair |
| GO:0032274 | 0.012714102 | gonadotropin secretion |
| GO:0046498 | 0.012714102 | S-adenosylhomocysteine metabolic process |
| GO:0046884 | 0.012714102 | follicle-stimulating hormone secretion |
| GO:0070509 | 0.012714102 | calcium ion import |
| GO:0070588 | 0.012714102 | calcium ion transmembrane transport |
| GO:0000154 | 0.014817908 | rRNA modification |
| GO:0030825 | 0.014817908 | positive regulation of cGMP metabolic |
| | | process |
| GO:0033683 | 0.014817908 | nucleotide-excision repair, DNA incision |
| GO:0044237 | 0.016838242 | cellular metabolic process |
| GO:0006465 | 0.01691739 | signal peptide processing |
| GO:0009396 | 0.01691739 | folic acid and derivative biosynthetic |
| | | process |
| GO:0043249 | 0.01691739 | erythrocyte maturation |
| GO:0043558 | 0.01691739 | regulation of translational initiation in |
| | | response to stress |
| GO:0045684 | 0.01691739 | positive regulation of epidermis |
| | | development |
| GO:0046653 | 0.01691739 | tetrahydrofolate metabolic process |
| GO:0044281 | 0.017394375 | small molecule metabolic process |
| GO:0009163 | 0.019012558 | nucleoside biosynthetic process |
| GO:0019934 | 0.019012558 | cGMP-mediated signaling |
| GO:0042451 | 0.019012558 | purine nucleoside biosynthetic process |
| GO:0042455 | 0.019012558 | ribonucleoside biosynthetic process |
| GO:0043555 | 0.019012558 | regulation of translation in response to |
| | | stress |
| GO:0044060 | 0.019012558 | regulation of endocrine process |
| GO:0046129 | 0.019012558 | purine ribonucleoside biosynthetic process |
| GO:0009650 | 0.021103419 | UV protection |
| GO:0018196 | 0.021103419 | peptidyl-asparagine modification |
| GO:0018279 | 0.021103419 | protein amino acid N-linked glycosylation |
| | | via asparagine |
| GO:0048820 | 0.021103419 | hair follicle maturation |
| GO:0030823 | 0.023189983 | regulation of cGMP metabolic process |
| GO:0060986 | 0.023189983 | endocrine hormone secretion |
| GO:0007164 | 0.025272258 | establishment of tissue polarity |
| GO:0006486 | 0.026347976 | protein amino acid glycosylation |
| GO:0043413 | 0.026347976 | macromolecule glycosylation |
| GO:0070085 | 0.026347976 | glycosylation |
| GO:0032925 | 0.027350252 | regulation of activin receptor signaling |
| | | pathway |
| GO:0048821 | 0.027350252 | erythrocyte development |
| GO:0044249 | 0.027781463 | cellular biosynthetic process |
| GO:0044260 | 0.028257369 | cellular macromolecule metabolic process |
| GO:0006760 | 0.029423975 | folic acid and derivative metabolic process |
| GO:0034645 | 0.030926132 | cellular macromolecule biosynthetic process |
| GO:0001502 | 0.031493433 | cartilage condensation |
| GO:0014003 | 0.031493433 | oligodendrocyte development |
| GO:0006730 | 0.032794344 | one-carbon metabolic process |
| GO:0046483 | 0.032943656 | heterocycle metabolic process |
| GO:0006725 | 0.033244252 | cellular aromatic compound metabolic |
| | | process |
| GO:0032924 | 0.033558636 | activin receptor signaling pathway |
| GO:0009058 | 0.034305782 | biosynthetic process |
| GO:0009416 | 0.03460864 | response to light stimulus |
| GO:0002244 | 0.035619593 | hemopoietic progenitor cell differentiation |
| GO:0043616 | 0.035619593 | keratinocyte proliferation |
| GO:0071695 | 0.035619593 | anatomical structure maturation |
| GO:0009059 | 0.035896956 | macromolecule biosynthetic process |
| GO:0008152 | 0.036403368 | metabolic process |
| GO:0010558 | 0.036475033 | negative regulation of macromolecule |
| | | biosynthetic process |
| GO:0031069 | 0.037676311 | hair follicle morphogenesis |
| GO:0006519 | 0.038301916 | cellular amino acid and derivative metabolic |
| | | process |
| GO:0031327 | 0.040019133 | negative regulation of cellular |
| | | biosynthetic process |
| GO:0030968 | 0.041777065 | endoplasmic reticulum unfolded protein |
| | | response |
| GO:0034620 | 0.041777065 | cellular response to unfolded protein |
| GO:0043009 | 0.041931225 | chordate embryonic development |
| GO:0009890 | 0.042699542 | negative regulation of biosynthetic process |
| GO:0009792 | 0.043082223 | embryo development ending in birth or egg |
| | | hatching |
| GO:0000718 | 0.043821118 | nucleotide-excision repair, DNA damage |
| | | removal |
| GO:0007223 | 0.043821118 | Wnt receptor signaling pathway, calcium |
| | | modulating pathway |
| GO:0045682 | 0.043821118 | regulation of epidermis development |
| GO:0046068 | 0.043821118 | cGMP metabolic process |
| GO:0009987 | 0.045108181 | cellular process |
| GO:0009101 | 0.045768921 | glycoprotein biosynthetic process |
| GO:0042558 | 0.045860967 | pteridine and derivative metabolic process |
| GO:0006412 | 0.049386928 | translation |
| GO:0045055 | 0.049928082 | regulated secretory pathway |
| GO:0048730 | 0.049928082 | epidermis morphogenesis |

TABLE s8
GO terms associated with the signaling/cellular
identity expression module.

| GO ID | p-value | Term |
|---|---|---|
| GO:0006955 | 1.69E−08 | immune response |
| GO:0002376 | 2.37E−08 | immune system process |
| GO:0002504 | 4.25E−06 | antigen processing and presentation of |
| | | peptide or polysaccharide antigen via |
| | | MHC class II |
| GO:0001910 | 2.04E−05 | regulation of leukocyte mediated |
| | | cytotoxicity |
| GO:0001911 | 3.22E−05 | negative regulation of leukocyte mediated |
| | | cytotoxicity |
| GO:0031341 | 3.34E−05 | regulation of cell killing |
| GO:0031342 | 5.36E−05 | negative regulation of cell killing |
| GO:0042492 | 5.36E−05 | gamma-delta T cell differentiation |
| GO:0045586 | 5.36E−05 | regulation of gamma-delta T cell |
| | | differentiation |
| GO:0045588 | 5.36E−05 | positive regulation of gamma-delta T cell |
| | | differentiation |
| GO:0046643 | 5.36E−05 | regulation of gamma-delta T cell activation |
| GO:0046645 | 5.36E−05 | positive regulation of gamma-delta T cell |
| | | activation |
| GO:0001909 | 6.18E−05 | leukocyte mediated cytotoxicity |
| GO:0002704 | 0.00011219 | negative regulation of leukocyte mediated |
| | | immunity |
| GO:0002707 | 0.00011219 | negative regulation of lymphocyte |
| | | mediated immunity |
| GO:0002925 | 0.00011219 | positive regulation of humoral immune |
| | | response mediated by circulating |
| | | immunoglobulin |
| GO:0033687 | 0.00011219 | osteoblast proliferation |
| GO:0046629 | 0.00011219 | gamma-delta T cell activation |
| GO:0002922 | 0.000149366 | positive regulation of humoral immune |
| | | response |
| GO:0002923 | 0.000149366 | regulation of humoral immune response |
| | | mediated by circulating immunoglobulin |
| GO:0002706 | 0.000215899 | regulation of lymphocyte mediated |
| | | immunity |
| GO:0019882 | 0.000271484 | antigen processing and presentation |
| GO:0002714 | 0.000292106 | positive regulation of B cell mediated |
| | | immunity |
| GO:0002891 | 0.000292106 | positive regulation of immunoglobulin |
| | | mediated immune response |
| GO:0001906 | 0.000302434 | cell killing |
| GO:0002703 | 0.00035299 | regulation of leukocyte mediated immunity |
| GO:0002920 | 0.000413044 | regulation of humoral immune response |
| GO:0065007 | 0.000531015 | biological regulation |
| GO:0050789 | 0.000672523 | regulation of biological process |
| GO:0002715 | 0.000715957 | regulation of natural killer cell mediated |
| | | immunity |
| GO:0042269 | 0.000715957 | regulation of natural killer cell mediated |
| | | cytotoxicity |
| GO:0001912 | 0.00080427 | positive regulation of leukocyte mediated |
| | | cytotoxicity |
| GO:0002698 | 0.00080427 | negative regulation of immune effector |
| | | process |
| GO:0050794 | 0.000941615 | regulation of cellular process |
| GO:0050896 | 0.001113031 | response to stimulus |
| GO:0031343 | 0.001207177 | positive regulation of cell killing |
| GO:0046635 | 0.001207177 | positive regulation of alpha-beta T cell |
| | | activation |
| GO:0002683 | 0.001214137 | negative regulation of immune system |
| | | process |
| GO:0002712 | 0.001438112 | regulation of B cell mediated immunity |
| GO:0002889 | 0.001438112 | regulation of immunoglobulin mediated |
| | | immune response |
| GO:0002252 | 0.001521832 | immune effector process |
| GO:0002228 | 0.001560873 | natural killer cell mediated immunity |
| GO:0042267 | 0.001560873 | natural killer cell mediated cytotoxicity |
| GO:0002697 | 0.001840539 | regulation of immune effector process |
| GO:0002824 | 0.001958061 | positive regulation of adaptive immune |
| | | response based on somatic recombination |
| | | of immune receptors built from |
| | | immunoglobulin superfamily domains |
| GO:0050777 | 0.001958061 | negative regulation of immune response |
| GO:0002449 | 0.00205033 | lymphocyte mediated immunity |
| GO:0002821 | 0.002100019 | positive regulation of adaptive immune |
| | | response |
| GO:0045582 | 0.002100019 | positive regulation of T cell differentiation |
| GO:0002705 | 0.002246722 | positive regulation of leukocyte mediated |
| | | immunity |
| GO:0002708 | 0.002246722 | positive regulation of lymphocyte mediated |
| | | immunity |
| GO:0002158 | 0.002358132 | osteoclast proliferation |
| GO:0002361 | 0.002358132 | CD4-positive, CD25-positive, alpha-beta |
| | | regulatory T cell differentiation |
| GO:0002370 | 0.002358132 | natural killer cell cytokine production |
| GO:0002727 | 0.002358132 | regulation of natural killer cell cytokine |
| | | production |
| GO:0002729 | 0.002358132 | positive regulation of natural killer cell |
| | | cytokine production |
| GO:0009720 | 0.002358132 | detection of hormone stimulus |
| GO:0009726 | 0.002358132 | detection of endogenous stimulus |
| GO:0032829 | 0.002358132 | regulation of CD4-positive, CD25-positive, |
| | | alpha-beta regulatory T cell differentiation |
| GO:0032831 | 0.002358132 | positive regulation of CD4-positive, CD25- |
| | | positive, alpha-beta regulatory T cell |
| | | differentiation |
| GO:0034436 | 0.002358132 | glycoprotein transport |
| GO:0045838 | 0.002358132 | positive regulation of membrane potential |
| GO:0050904 | 0.002358132 | diapedesis |
| GO:0060448 | 0.002358132 | dichotomous subdivision of terminal units |
| | | involved in lung branching |
| GO:0045621 | 0.002398149 | positive regulation of lymphocyte |
| | | differentiation |
| GO:0046634 | 0.002398149 | regulation of alpha-beta T cell activation |
| GO:0002455 | 0.003404688 | humoral immune response mediated by |
| | | circulating immunoglobulin |
| GO:0007204 | 0.003545142 | elevation of cytosolic calcium ion |
| | | concentration |
| GO:0002443 | 0.003699526 | leukocyte mediated immunity |
| GO:0065008 | 0.004027722 | regulation of biological quality |
| GO:0002700 | 0.004167465 | regulation of production of molecular |
| | | mediator of immune response |
| GO:0051480 | 0.004272108 | cytosolic calcium ion homeostasis |
| GO:0001915 | 0.004710882 | negative regulation of T cell mediated |
| | | cytotoxicity |
| GO:0002716 | 0.004710882 | negative regulation of natural killer cell |
| | | mediated immunity |
| GO:0034314 | 0.004710882 | Arp2/3 complex-mediated actin nucleation |
| GO:0045591 | 0.004710882 | positive regulation of regulatory T cell |
| | | differentiation |
| GO:0045953 | 0.004710882 | negative regulation of natural killer cell |
| | | mediated cytotoxicity |
| GO:0050855 | 0.004710882 | regulation of B cell receptor signaling |
| | | pathway |
| GO:0051607 | 0.004786756 | defense response to virus |
| GO:0002699 | 0.005221786 | positive regulation of immune effector |
| | | process |
| GO:0060402 | 0.005221786 | calcium ion transport into cytosol |
| GO:0046631 | 0.005445889 | alpha-beta T cell activation |
| GO:0060401 | 0.005674356 | cytosolic calcium ion transport |
| GO:0045580 | 0.005907169 | regulation of T cell differentiation |
| GO:0002822 | 0.006385745 | regulation of adaptive immune response |
| | | based on somatic recombination of |
| | | immune receptors built from |
| | | immunoglobulin superfamily domains |
| GO:0032879 | 0.006415683 | regulation of localization |
| GO:0002819 | 0.006631468 | regulation of adaptive immune response |
| GO:0002032 | 0.007058262 | desensitization of G-protein coupled |
| | | receptor protein signaling pathway by |
| | | arrestin |
| GO:0002378 | 0.007058262 | immunoglobulin biosynthetic process |
| GO:0045542 | 0.007058262 | positive regulation of cholesterol |
| | | biosynthetic process |
| GO:0045589 | 0.007058262 | regulation of regulatory T cell |
| | | differentiation |
| GO:0045896 | 0.007058262 | regulation of transcription, mitotic |
| GO:0045897 | 0.007058262 | positive regulation of transcription, mitotic |
| GO:0046021 | 0.007058262 | regulation of transcription from RNA |
| | | polymerase II promoter, mitotic |
| GO:0046022 | 0.007058262 | positive regulation of transcription from |
| | | RNA polymerase II promoter, mitotic |
| GO:0006917 | 0.00726145 | induction of apoptosis |
| GO:0012502 | 0.007337971 | induction of programmed cell death |
| GO:0045619 | 0.007923631 | regulation of lymphocyte differentiation |
| GO:0048878 | 0.008359535 | chemical homeostasis |
| GO:0045088 | 0.009319878 | regulation of innate immune response |
| GO:0002710 | 0.009400284 | negative regulation of T cell mediated |
| | | immunity |
| GO:0033688 | 0.009400284 | regulation of osteoblast proliferation |
| GO:0034113 | 0.009400284 | heterotypic cell-cell adhesion |
| GO:0090205 | 0.009400284 | positive regulation of cholesterol metabolic |
| | | process |
| GO:0002440 | 0.009906968 | production of molecular mediator of |
| | | immune response |
| GO:0002521 | 0.010351705 | leukocyte differentiation |
| GO:0006874 | 0.010942755 | cellular calcium ion homeostasis |
| GO:2000021 | 0.011129305 | regulation of ion homeostasis |
| GO:0045010 | 0.011736959 | actin nucleation |
| GO:0045019 | 0.011736959 | negative regulation of nitric oxide |
| | | biosynthetic process |
| GO:0045066 | 0.011736959 | regulatory T cell differentiation |
| GO:0050857 | 0.011736959 | positive regulation of antigen receptor- |
| | | mediated signaling pathway |
| GO:0016064 | 0.011764243 | immunoglobulin mediated immune |
| | | response |
| GO:0055074 | 0.012023642 | calcium ion homeostasis |
| GO:0019724 | 0.012087588 | B cell mediated immunity |
| GO:0006875 | 0.012668084 | cellular metal ion homeostasis |
| GO:0050870 | 0.013762313 | positive regulation of T cell activation |
| GO:0001916 | 0.0140683 | positive regulation of T cell mediated |
| | | cytotoxicity |
| GO:0007171 | 0.0140683 | activation of transmembrane receptor |
| | | protein tyrosine kinase activity |
| GO:0010887 | 0.0140683 | negative regulation of cholesterol storage |
| GO:0031953 | 0.0140683 | negative regulation of protein amino acid |
| | | autophosphorylation |
| GO:0032366 | 0.0140683 | intracellular sterol transport |
| GO:0032367 | 0.0140683 | intracellular cholesterol transport |
| GO:0045059 | 0.0140683 | positive thymic T cell selection |
| GO:0048304 | 0.0140683 | positive regulation of isotype switching to |
| | | IgG isotypes |
| GO:0055091 | 0.0140683 | phospholipid homeostasis |
| GO:0060136 | 0.0140683 | embryonic process involved in female |
| | | pregnancy |
| GO:0055065 | 0.014365205 | metal ion homeostasis |
| GO:0002573 | 0.015170568 | myeloid leukocyte differentiation |
| GO:0010740 | 0.015260172 | positive regulation of intracellular protein |
| | | kinase cascade |
| GO:0006959 | 0.015531987 | humoral immune response |
| GO:0001914 | 0.016394319 | regulation of T cell mediated cytotoxicity |
| GO:0002031 | 0.016394319 | G-protein coupled receptor internalization |
| GO:0006198 | 0.016394319 | cAMP catabolic process |
| GO:0032689 | 0.016394319 | negative regulation of interferon-gamma |
| | | production |
| GO:0045060 | 0.016394319 | negative thymic T cell selection |
| GO:0045824 | 0.016394319 | negative regulation of innate immune |
| | | response |
| GO:0060600 | 0.016394319 | dichotomous subdivision of an epithelial |
| | | terminal unit |
| GO:0035556 | 0.01664198 | intracellular signal transduction |
| GO:0019221 | 0.017777681 | cytokine-mediated signaling pathway |
| GO:0023036 | 0.017777681 | initiation of signal transduction |
| GO:0023038 | 0.017777681 | signal initiation by diffusible mediator |
| GO:0023049 | 0.017777681 | signal initiation by protein/peptide mediator |
| GO:0043410 | 0.017777681 | positive regulation of MAPKKK cascade |
| GO:0010872 | 0.018715026 | regulation of cholesterol esterification |
| GO:0032365 | 0.018715026 | intracellular lipid transport |
| GO:0043011 | 0.018715026 | myeloid dendritic cell differentiation |
| GO:0043368 | 0.018715026 | positive T cell selection |
| GO:0043383 | 0.018715026 | negative T cell selection |
| GO:0046641 | 0.018715026 | positive regulation of alpha-beta T cell |
| | | proliferation |
| GO:0048302 | 0.018715026 | regulation of isotype switching to IgG |
| | | isotypes |
| GO:0030005 | 0.018740757 | cellular di-, tri-valent inorganic cation |
| | | homeostasis |
| GO:0006952 | 0.019140405 | defense response |
| GO:0050776 | 0.01936046 | regulation of immune response |
| GO:0030217 | 0.020972695 | T cell differentiation |
| GO:0002820 | 0.021030435 | negative regulation of adaptive immune |
| | | response |
| GO:0002823 | 0.021030435 | negative regulation of adaptive immune |
| | | response based on somatic recombination |
| | | of immune receptors built from |
| | | immunoglobulin superfamily domains |
| GO:0009214 | 0.021030435 | cyclic nucleotide catabolic process |
| GO:0010893 | 0.021030435 | positive regulation of steroid biosynthetic |
| | | process |
| GO:0042987 | 0.021030435 | amyloid precursor protein catabolic |
| | | process |
| GO:0043372 | 0.021030435 | positive regulation of CD4-positive, alpha |
| | | beta T cell differentiation |
| GO:0045540 | 0.021030435 | regulation of cholesterol biosynthetic |
| | | process |
| GO:0045830 | 0.021030435 | positive regulation of isotype switching |
| GO:0046902 | 0.021030435 | regulation of mitochondrial membrane |
| | | permeability |
| GO:0048291 | 0.021030435 | isotype switching to IgG isotypes |
| GO:0045597 | 0.021730044 | positive regulation of cell differentiation |
| GO:0055066 | 0.021730044 | di-, tri-valent inorganic cation homeostasis |
| GO:0043065 | 0.021732802 | positive regulation of apoptosis |
| GO:0043068 | 0.022200664 | positive regulation of programmed cell |
| | | death |
| GO:0007165 | 0.022734777 | signal transduction |
| GO:0010942 | 0.022994253 | positive regulation of cell death |
| GO:0001913 | 0.023340555 | T cell mediated cytotoxicity |
| GO:0030146 | 0.023340555 | diuresis |
| GO:0033700 | 0.023340555 | phospholipid efflux |
| GO:0034374 | 0.023340555 | low-density lipoprotein particle remodeling |
| GO:0045911 | 0.023340555 | positive regulation of DNA recombination |
| GO:0030003 | 0.024489935 | cellular cation homeostasis |
| GO:0051251 | 0.024830961 | positive regulation of lymphocyte activation |
| GO:0001773 | 0.0256454 | myeloid dendritic cell activation |
| GO:0002029 | 0.0256454 | desensitization of G-protein coupled |
| | | receptor protein signaling pathway |
| GO:0002720 | 0.0256454 | positive regulation of cytokine production |
| | | involved in immune response |
| GO:0010634 | 0.0256454 | positive regulation of epithelial cell |
| | | migration |
| GO:0022401 | 0.0256454 | negative adaptation of signaling pathway |
| GO:0023058 | 0.0256454 | adaptation of signaling pathway |
| GO:0031648 | 0.0256454 | protein destabilization |
| GO:0031952 | 0.0256454 | regulation of protein amino acid |
| | | autophosphorylation |
| GO:0034433 | 0.0256454 | steroid esterification |
| GO:0034434 | 0.0256454 | sterol esterification |
| GO:0034435 | 0.0256454 | cholesterol esterification |
| GO:0045061 | 0.0256454 | thymic T cell selection |
| GO:0045123 | 0.0256454 | cellular extravasation |
| GO:0050732 | 0.0256454 | negative regulation of peptidyl-tyrosine |
| | | phosphorylation |
| GO:0050853 | 0.0256454 | B cell receptor signaling pathway |
| GO:0046907 | 0.026085117 | intracellular transport |
| GO:0009967 | 0.026679788 | positive regulation of signal transduction |
| GO:0051235 | 0.027090738 | maintenance of location |
| GO:0023056 | 0.027940783 | positive regulation of signaling process |
| GO:0001960 | 0.027944981 | negative regulation of cytokine-mediated |
| | | signaling pathway |
| GO:0002711 | 0.027944981 | positive regulation of T cell mediated |
| | | immunity |
| GO:0003091 | 0.027944981 | renal water homeostasis |
| GO:0009125 | 0.027944981 | nucleoside monophosphate catabolic |
| | | process |
| GO:0010885 | 0.027944981 | regulation of cholesterol storage |
| GO:0046640 | 0.027944981 | regulation of alpha-beta T cell proliferation |
| GO:0046697 | 0.027944981 | decidualization |
| GO:0090181 | 0.027944981 | regulation of cholesterol metabolic process |
| GO:0002460 | 0.02943091 | adaptive immune response based on |
| | | somatic recombination of immune |
| | | receptors built from immunoglobulin |
| | | superfamily domains |
| GO:0002696 | 0.02990841 | positive regulation of leukocyte activation |
| GO:0007187 | 0.02990841 | G-protein signaling, coupled to cyclic |
| | | nucleotide second messenger |
| GO:0001829 | 0.030239309 | trophectodermal cell differentiation |
| GO:0006607 | 0.030239309 | NLS-bearing substrate import into nucleus |
| GO:0010745 | 0.030239309 | negative regulation of macrophage derived |
| | | foam cell differentiation |
| GO:0010878 | 0.030239309 | cholesterol storage |
| GO:0043370 | 0.030239309 | regulation of CD4-positive, alpha beta T |
| | | cell differentiation |
| GO:0045191 | 0.030239309 | regulation of isotype switching |
| GO:0045577 | 0.030239309 | regulation of B cell differentiation |
| GO:0050891 | 0.030239309 | multicellular organismal water |
| | | homeostasis |
| GO:0002250 | 0.030389025 | adaptive immune response |
| GO:0050863 | 0.030872742 | regulation of T cell activation |
| GO:0048585 | 0.03234233 | negative regulation of response to stimulus |
| GO:0050867 | 0.03234233 | positive regulation of cell activation |
| GO:0002717 | 0.032528396 | positive regulation of natural killer cell |
| | | mediated immunity |
| GO:0010631 | 0.032528396 | epithelial cell migration |
| GO:0010632 | 0.032528396 | regulation of epithelial cell migration |
| GO:0010888 | 0.032528396 | negative regulation of lipid storage |
| GO:0034375 | 0.032528396 | high-density lipoprotein particle remodeling |
| GO:0042147 | 0.032528396 | retrograde transport, endosome to Golgi |
| GO:0042994 | 0.032528396 | cytoplasmic sequestering of transcription |
| | | factor |
| GO:0045954 | 0.032528396 | positive regulation of natural killer cell |
| | | mediated cytotoxicity |
| GO:0050854 | 0.032528396 | regulation of antigen receptor-mediated |
| | | signaling pathway |
| GO:0050995 | 0.032528396 | negative regulation of lipid catabolic |
| | | process |
| GO:0060716 | 0.032528396 | labyrinthine layer blood vessel |
| | | development |
| GO:0090132 | 0.032528396 | epithelium migration |
| GO:0055080 | 0.032742446 | cation homeostasis |
| GO:0046058 | 0.032838285 | cAMP metabolic process |
| GO:0001893 | 0.034812254 | maternal placenta development |
| GO:0002702 | 0.034812254 | positive regulation of production of |
| | | molecular mediator of immune response |
| GO:0032091 | 0.034812254 | negative regulation of protein binding |
| GO:0046633 | 0.034812254 | alpha-beta T cell proliferation |
| GO:0070661 | 0.034852141 | leukocyte proliferation |
| GO:0019216 | 0.036393627 | regulation of lipid metabolic process |
| GO:0051649 | 0.036897528 | establishment of localization in cell |
| GO:0002709 | 0.037090894 | regulation of T cell mediated immunity |
| GO:0042982 | 0.037090894 | amyloid precursor protein metabolic |
| | | process |
| GO:0046676 | 0.037090894 | negative regulation of insulin secretion |
| GO:0051208 | 0.037090894 | sequestering of calcium ion |
| GO:0090130 | 0.037090894 | tissue migration |
| GO:0030097 | 0.03765206 | hemopoiesis |
| GO:0030098 | 0.03796129 | lymphocyte differentiation |
| GO:0045595 | 0.038541331 | regulation of cell differentiation |
| GO:0032844 | 0.039020736 | regulation of homeostatic process |
| GO:0043691 | 0.039364327 | reverse cholesterol transport |
| GO:0045058 | 0.039364327 | T cell selection |
| GO:0045940 | 0.039364327 | positive regulation of steroid metabolic |
| | | process |
| GO:0090278 | 0.039364327 | negative regulation of peptide hormone |
| | | secretion |
| GO:0006606 | 0.039554713 | protein import into nucleus |
| GO:0019935 | 0.0406311 | cyclic-nucleotide-mediated signaling |
| GO:0042592 | 0.040906208 | homeostatic process |
| GO:0010627 | 0.041021136 | regulation of intracellular protein kinase |
| | | cascade |
| GO:0051170 | 0.041173479 | nuclear import |
| GO:0002792 | 0.041632566 | negative regulation of peptide secretion |
| GO:0006516 | 0.041632566 | glycoprotein catabolic process |
| GO:0030104 | 0.041632566 | water homeostasis |
| GO:0030838 | 0.041632566 | positive regulation of actin filament |
| | | polymerization |
| GO:0046638 | 0.041632566 | positive regulation of alpha-beta T cell |
| | | differentiation |
| GO:0051220 | 0.041632566 | cytoplasmic sequestering of protein |
| GO:0051412 | 0.041632566 | response to corticosterone stimulus |
| GO:0060441 | 0.041632566 | epithelial tube branching involved in lung |
| | | morphogenesis |
| GO:0019222 | 0.042224827 | regulation of metabolic process |
| GO:0031400 | 0.042817175 | negative regulation of protein modification |
| | | process |
| GO:0048534 | 0.043888965 | hemopoietic or lymphoid organ |
| | | development |
| GO:0001825 | 0.043895621 | blastocyst formation |
| GO:0002718 | 0.043895621 | regulation of cytokine production involved |
| | | in immune response |
| GO:0042992 | 0.043895621 | negative regulation of transcription factor |
| | | import into nucleus |
| GO:0043029 | 0.043895621 | T cell homeostasis |
| GO:0060674 | 0.043895621 | placenta blood vessel development |
| GO:0009187 | 0.044485396 | cyclic nucleotide metabolic process |
| GO:0043367 | 0.046153505 | CD4-positive, alpha beta T cell |
| | | differentiation |
| GO:0006810 | 0.04615684 | transport |
| GO:0007243 | 0.046177765 | intracellular protein kinase cascade |
| GO:0023014 | 0.046177765 | signal transmission via phosphorylation |
| | | event |
| GO:0051094 | 0.046521539 | positive regulation of developmental |
| | | process |
| GO:0042308 | 0.048406228 | negative regulation of protein import into |
| | | nucleus |
| GO:0045744 | 0.048406228 | negative regulation of G-protein coupled |
| | | receptor protein signaling pathway |
| GO:0015031 | 0.048818151 | protein transport |
| GO:0034504 | 0.049050825 | protein localization in nucleus |
| GO:0051707 | 0.049921612 | response to other organism |

### GEO Samples Included in the Concordia Database

GSM175794, GSM170979, GSM175795, GSM46884, GSM175796, GSM175797, GSM170978, GSM175790, GSM175791, GSM46888, GSM175792, GSM117730, GSM203686, GSM402327, GSM175793, GSM175798, GSM353935, GSM175799, GSM159011, GSM352110, GSM353933, GSM203696, GSM318104, GSM402317, GSM117720, GSM203699, GSM46878, GSM159001, GSM117710, GSM402307, GSM353915, GSM159031, GSM152689, GSM318124, GSM117700, GSM152681, GSM379868, GSM117701, GSM46898, GSM352123, GSM353925, GSM159021, GSM152699, GSM318114, GSM379858, GSM363401, GSM260997, GSM194307, GSM363406, GSM363403, GSM117770, GSM117772, GSM187610, GSM261007, GSM187611, GSM350298, GSM318144, GSM187616, GSM194309, GSM187617, GSM194308, GSM187618, GSM187619, GSM187612, GSM187613, GSM187614, GSM152669, GSM187615, GSM194313, GSM194314, GSM194311, GSM353905, GSM194312, GSM199397, GSM117763, GSM194310, GSM76489, GSM117761, GSM261017, GSM117756, GSM187621, GSM67186, GSM187622, GSM117755, GSM152670, GSM187620, GSM318134, GSM350288, GSM187629, GSM152679, GSM187627, GSM187628, GSM187625, GSM187626, GSM187623, GSM187624, GSM175777, GSM175776, GSM260977, GSM175779, GSM175778, GSM76499, GSM117751, GSM175775, GSM187630, GSM337197, GSM152649, GSM337199, GSM337198, GSM385721, GSM363411, GSM175789, GSM363412, GSM175788, GSM260987, GSM175787, GSM325807, GSM175782, GSM175781, GSM117741, GSM175780, GSM175786, GSM363415, GSM175785, GSM175784, GSM175783, GSM280370, GSM152659, GSM361954, GSM391367, GSM211122, GSM280847, GSM371106, GSM148611, GSM148610, GSM211132, GSM325817, GSM85486, GSM325812, GSM361964, GSM391357, GSM280837, GSM325827, GSM148605, GSM211142, GSM148606, GSM148607, GSM148608, GSM148609, GSM85496, GSM260967, GSM279060, GSM279061, GSM279062, GSM279063, GSM279064, GSM279065, GSM211102, GSM46824, GSM348321, GSM325837, GSM46828, GSM211112, GSM151998, GSM151999, GSM151996, GSM151997, GSM151994, GSM151995, GSM151992, GSM151993, GSM151990, GSM46818, GSM151991, GSM46817, GSM85476, GSM238798, GSM201248, GSM238799, GSM201249, GSM201246, GSM201247, GSM201244, GSM201245, GSM270842, GSM270843, GSM270844, GSM270840, GSM261088, GSM231885, GSM270841, GSM231886, GSM46848, GSM151980, GSM261092, GSM151982, GSM261091, GSM151981, GSM151984, GSM201254, GSM151983, GSM201253, GSM151986, GSM201252, GSM151985, GSM201251, GSM151988, GSM201250, GSM151987, GSM151989, GSM201259, GSM231899, GSM201255, GSM201256, GSM201257, GSM201258, GSM270834, GSM261096, GSM261099, GSM231896, GSM231897, GSM46838, GSM270839, GSM270838, GSM151971, GSM270837, GSM151970, GSM270836, GSM270835, GSM151975, GSM201263, GSM151974, GSM201262, GSM151973, GSM201265, GSM151972, GSM201264, GSM301697, GSM151979, GSM151978, GSM151977, GSM201261, GSM46833, GSM151976, GSM201260, GSM151969, GSM151966, GSM151965, GSM151968, GSM46868, GSM151967, GSM151962, GSM201232, GSM201231, GSM151964, GSM201230, GSM151963, GSM201233, GSM201234, GSM201235, GSM201236, GSM201237, GSM385383, GSM201238, GSM201239, GSM231876, GSM231874, GSM46858, GSM238795, GSM238794, GSM238797, GSM238796, GSM238791, GSM201241, GSM238790, GSM201240, GSM46850, GSM238793, GSM201243, GSM238792, GSM279753, GSM173679, GSM325787, GSM53033, GSM386413, GSM60985, GSM173684, GSM317736, GSM279743, GSM173685, GSM173682, GSM173683, GSM306190, GSM173680, GSM173681, GSM211092, GSM317739, GSM80602, GSM80601, GSM80600, GSM173688, GSM270809, GSM173689, GSM173686, GSM173687, GSM60972, GSM386403, GSM316693, GSM238875, GSM238877, GSM238870, GSM211082, GSM238873, GSM280897, GSM279774, GSM238874, GSM238871, GSM238872, GSM351404, GSM238867, GSM238865, GSM238864, GSM316683, GSM238868, GSM211072, GSM238860, GSM238861, GSM199307, GSM238862, GSM279763, GSM238863, GSM66937, GSM325797, GSM360316, GSM238854, GSM238856, GSM238855, GSM238858, GSM238857, GSM316673, GSM80632, GSM80633, GSM80634, GSM80635, GSM80630, GSM80631, GSM340514, GSM372286, GSM238851, GSM280877, GSM372289, GSM372288, GSM372287, GSM238848, GSM401152, GSM238846, GSM238847, GSM372292, GSM238844, GSM401156, GSM372293, GSM238845, GSM372290, GSM238842, GSM372291, GSM238843, GSM80629, GSM386453, GSM80626, GSM80625, GSM360329, GSM80628, GSM80627, GSM80645, GSM80646, GSM80643, GSM75017, GSM80644, GSM80641, GSM340504, GSM80642, GSM80640, GSM372295, GSM372294, GSM280887, GSM372297, GSM238841, GSM372296, GSM279784, GSM238840, GSM372299, GSM372298, GSM401162, GSM238835, GSM238837, GSM238838, GSM401165, GSM279794, GSM238834, GSM386443, GSM80639, GSM238839, GSM80638, GSM80637, GSM80636, GSM80610, GSM176306, GSM80611, GSM203716, GSM80612, GSM176304, GSM80613, GSM176305, GSM176302, GSM176303, GSM352580, GSM176300, GSM176301, GSM238822, GSM280857, GSM238823, GSM238820, GSM401132, GSM238821, GSM238826, GSM238827, GSM238824, GSM238825, GSM80604, GSM80603, GSM60960, GSM80606, GSM80605, GSM386433, GSM80608, GSM80607, GSM80609, GSM176319, GSM179951, GSM80620, GSM179950, GSM80623, GSM176315, GSM80624, GSM176316, GSM80621, GSM176317, GSM203706, GSM80622, GSM176318, GSM176312, GSM176313, GSM176310, GSM238810, GSM280867, GSM238811, GSM238812, GSM238813, GSM401142, GSM238815, GSM238816, GSM80617, GSM386423, GSM238817, GSM80616, GSM238818, GSM80615, GSM238819, GSM80614, GSM80619, GSM80618, GSM152759, GSM152757, GSM187702, GSM350248, GSM238807, GSM152755, GSM238806, GSM80669, GSM238809, GSM238808, GSM238803, GSM238802, GSM238805, GSM238804, GSM401112, GSM238801, GSM238800, GSM80671, GSM203732, GSM80670, GSM176321, GSM176320, GSM117680, GSM176323, GSM203736, GSM176322, GSM175840, GSM176325, GSM175841, GSM176324, GSM80679, GSM175842, GSM176327, GSM80678, GSM175843, GSM176326, GSM80677, GSM175844, GSM176329, GSM80676, GSM175845, GSM176328, GSM80675, GSM175846, GSM80674, GSM175847, GSM179940, GSM80673, GSM175848, GSM199357, GSM80672, GSM175849, GSM175839, GSM152749, GSM350258, GSM345187, GSM401122, GSM80680, GSM176332, GSM176331, GSM80682, GSM176330, GSM80681, GSM176336, GSM175830, GSM176335, GSM176334, GSM176333, GSM203726, GSM80688, GSM175833, GSM179930, GSM80687, GSM301707, GSM175834, GSM117690, GSM176339, GSM175831, GSM176338, GSM80689, GSM175832, GSM176337, GSM80684, GSM175837, GSM80683, GSM175838, GSM199367, GSM80686, GSM175835, GSM80685, GSM175836, GSM80649, GSM80647, GSM80648, GSM187722, GSM281019, GSM350268, GSM175860, GSM176345, GSM175861, GSM176344, GSM175862, GSM117660, GSM176347, GSM203756, GSM175863, GSM176346, GSM176341, GSM176340, GSM176343, GSM176342, GSM80653, GSM175868, GSM80652, GSM175869, GSM80651, GSM340534, GSM80650, GSM152739, GSM80657, GSM53093, GSM175864, GSM199377, GSM80656, GSM175865, GSM80655, GSM175866, GSM80654, GSM175867, GSM179920, GSM80658, GSM80659, GSM281009, GSM187712, GSM176360, GSM401102, GSM176361, GSM350278, GSM175851, GSM176358, GSM175852, GSM176357, GSM203746, GSM176356, GSM175850, GSM117670, GSM176355, GSM176354, GSM176353, GSM80660, GSM176352, GSM179918, GSM80662, GSM368398, GSM175859, GSM152729, GSM80661, GSM53083, GSM340524, GSM80664, GSM175857, GSM80663, GSM175858, GSM80666, GSM175855, GSM80665, GSM175856, GSM80668, GSM175853, GSM179910, GSM80667, GSM175854, GSM176359, GSM199387, GSM317794, GSM316663, GSM176370, GSM176372, GSM176371, GSM351424, GSM175806, GSM350208, GSM175807, GSM175808, GSM175809, GSM179900, GSM175801, GSM389778, GSM175800, GSM175803, GSM122548, GSM152719, GSM175802, GSM175805, GSM53073, GSM175804, GSM176362, GSM176363, GSM203776, GSM176364, GSM345147, GSM176365, GSM199317, GSM176366, GSM176367, GSM306160, GSM176368, GSM176369, GSM176383, GSM176382, GSM176381, GSM316653, GSM350218, GSM351414, GSM95519, GSM389788, GSM95522, GSM95523, GSM95524, GSM53063, GSM95525, GSM152709, GSM176375, GSM199327, GSM176376, GSM95520, GSM345137, GSM176373, GSM203766, GSM95521, GSM176374, GSM176392, GSM345177, GSM170983, GSM176391, GSM170980, GSM176390, GSM95509, GSM95508, GSM350228, GSM175828, GSM175829, GSM95513, GSM80696, GSM175825, GSM95514, GSM80697, GSM53053, GSM175824, GSM170597, GSM199337, GSM95511, GSM80694, GSM175827, GSM170596, GSM122528, GSM95512, GSM80695, GSM175826, GSM170595, GSM95517, GSM175821, GSM95518, GSM175820, GSM95515, GSM80698, GSM175823, GSM95516, GSM80699, GSM175822, GSM306180, GSM170590, GSM176388, GSM176389, GSM80692, GSM170594, GSM176384, GSM95510, GSM80693, GSM170593, GSM176385, GSM80690, GSM170592, GSM176386, GSM80691, GSM170591, GSM176387, GSM203796, GSM170992, GSM345167, GSM350238, GSM175819, GSM53043, GSM53046, GSM175817, GSM175818, GSM95500, GSM175816, GSM95501, GSM175815, GSM95502, GSM175814, GSM199347, GSM95503, GSM175813, GSM95504, GSM175812, GSM170589, GSM95505, GSM175811, GSM170588, GSM95506, GSM175810, GSM95507, GSM306170, GSM345157, GSM203786, GSM176396, GSM385060, GSM73686, GSM76579, GSM345117, GSM337033, GSM158711, GSM385070, GSM345127, GSM76587, GSM76585, GSM340494, GSM96276, GSM337023, GSM76559, GSM361371, GSM60588, GSM176297, GSM176296, GSM337013, GSM361381, GSM158731, GSM114096, GSM76569, GSM335834, GSM345107, GSM176287, GSM155701, GSM176294, GSM176295, GSM176292, GSM176293, GSM176290, GSM176291, GSM337003, GSM158721, GSM175890, GSM175892, GSM175891, GSM175894, GSM175893, GSM175896, GSM175895, GSM89091, GSM60562, GSM175898, GSM175897, GSM175899, GSM385020, GSM306210, GSM155711, GSM361351, GSM385010, GSM152769, GSM390943, GSM270789, GSM337073, GSM89081, GSM155721, GSM361361, GSM385030, GSM306220, GSM387979, GSM152779, GSM337063, GSM175872, GSM76595, GSM175871, GSM89071, GSM175874, GSM89072, GSM175873, GSM60548, GSM175870, GSM101100, GSM175879, GSM101101, GSM385040, GSM101102, GSM101103, GSM175876, GSM101104, GSM389824, GSM361331, GSM175875, GSM101105, GSM175878, GSM101106, GSM175877, GSM152789, GSM390158, GSM337053, GSM281029, GSM387969, GSM76590, GSM89060, GSM175885, GSM89061, GSM175884, GSM175883, GSM175882, GSM175881, GSM175880, GSM60538, GSM361341, GSM385050, GSM306200, GSM175889, GSM175888, GSM175887, GSM389813, GSM175886, GSM270799, GSM387959, GSM152799, GSM337043, GSM281039, GSM143900, GSM378170, GSM387949, GSM88971, GSM51690, GSM261312, GSM46948, GSM46941, GSM395790, GSM387939, GSM361321, GSM88981, GSM46938, GSM261302, GSM51680, GSM46936, GSM395780, GSM387929, GSM88991, GSM88997, GSM46928, GSM310839, GSM310838, GSM261332, GSM280009, GSM38103, GSM38104, GSM38100, GSM387919, GSM94603, GSM94604, GSM46918, GSM94605, GSM261322, GSM134589, GSM134588, GSM134587, GSM134586, GSM134584, GSM187595, GSM187596, GSM187593, GSM93568, GSM187594, GSM187599, GSM187597, GSM187598, GSM287293, GSM387909, GSM134591, GSM403597, GSM401092, GSM73656, GSM88949, GSM46975, GSM46976, GSM280028, GSM46973, GSM173691, GSM173690, GSM328997, GSM46960, GSM46961, GSM88955, GSM73666, GSM46968, GSM88951, GSM187586, GSM187587, GSM187588, GSM187589, GSM187584, GSM187585, GSM187590, GSM187592, GSM187591, GSM73676, GSM88961, GSM46958, GSM88962, GSM175903, GSM175904, GSM175901, GSM175902, GSM372348, GSM175900, GSM199417, GSM175909, GSM175908, GSM350308, GSM175907, GSM175906, GSM175905, GSM372358, GSM184639, GSM199427, GSM401062, GSM184636, GSM184637, GSM101095, GSM184638, GSM350318, GSM101096, GSM101097, GSM101098, GSM101099, GSM336033, GSM336983, GSM401076, GSM184640, GSM184641, GSM184644, GSM184645, GSM184642, GSM184643, GSM184648, GSM401072, GSM184649, GSM184646, GSM184647, GSM101998, GSM199407, GSM336043, GSM250001, GSM143898, GSM184650, GSM184651, GSM184652, GSM184653, GSM184654, GSM184655, GSM184656, GSM184657, GSM184658, GSM401082, GSM184659, GSM80900, GSM365142, GSM310849, GSM176409, GSM80901, GSM365143, GSM80902, GSM365140, GSM176407, GSM80903, GSM365141, GSM176408, GSM80904, GSM310845, GSM238951, GSM189790, GSM310846, GSM176406, GSM310847, GSM310848, GSM310844, GSM339558, GSM339559, GSM339566, GSM277701, GSM339565, GSM339568, GSM238949, GSM339567, GSM339562, GSM339561, GSM339564, GSM184665, GSM339563, GSM184664, GSM238943, GSM184663, GSM189782, GSM365139, GSM238944, GSM184662, GSM189783, GSM365138, GSM339560, GSM238941, GSM184661, GSM189784, GSM365137, GSM238942, GSM184660, GSM189785, GSM365136, GSM238947, GSM189786, GSM365135, GSM238948, GSM189787, GSM365134, GSM238945, GSM189788, GSM365133, GSM238946, GSM189789, GSM80913, GSM365151, GSM336993, GSM176418, GSM365152, GSM176419, GSM80911, GSM365153, GSM80912, GSM365154, GSM310858, GSM176414, GSM189781, GSM310859, GSM176415, GSM189780, GSM176416, GSM365150, GSM310857, GSM176417, GSM176410, GSM176411, GSM310852, GSM176412, GSM310853, GSM176413, GSM46908, GSM310850, GSM310851, GSM339569, GSM387575, GSM189779, GSM277711, GSM365149, GSM189773, GSM365148, GSM189774, GSM189771, GSM189772, GSM365145, GSM189777, GSM365144, GSM189778, GSM365147, GSM189775, GSM365146, GSM189776, GSM365160, GSM176427, GSM365161, GSM176428, GSM176425, GSM189770, GSM176426, GSM365162, GSM176429, GSM387565, GSM310860, GSM176420, GSM310861, GSM310862, GSM176423, GSM176424, GSM176421, GSM176422, GSM189768, GSM189769, GSM365158, GSM189764, GSM365157, GSM189765, GSM365156, GSM189766, GSM365155, GSM189767, GSM189760, GSM189761, GSM238963, GSM189762, GSM365159, GSM189763, GSM176436, GSM176437, GSM176438, GSM176439, GSM176430, GSM176431, GSM94599, GSM176432, GSM94598, GSM176433, GSM176434, GSM176435, GSM339557, GSM189759, GSM189757, GSM189758, GSM189755, GSM189756, GSM189753, GSM189754, GSM238952, GSM189751, GSM238953, GSM189752, GSM238955, GSM187600, GSM345097, GSM125006, GSM187606, GSM187605, GSM187608, GSM187607, GSM187602, GSM187601, GSM187604, GSM187603, GSM242672, GSM175989, GSM242673, GSM158791, GSM176446, GSM100898, GSM175985, GSM150220, GSM176228, GSM176440, GSM187609, GSM176227, GSM242674, GSM175987, GSM150222, GSM76509, GSM242675, GSM175988, GSM169531, GSM150221, GSM176229, GSM176441, GSM175981, GSM150224, GSM176224, GSM175982, GSM150223, GSM176223, GSM175983, GSM150226, GSM176226, GSM175984, GSM150225, GSM176225, GSM176220, GSM176448, GSM150227, GSM176447, GSM176222, GSM175980, GSM176221, GSM176449, GSM345087, GSM176240, GSM176456, GSM175978, GSM176455, GSM175979, GSM176454, GSM175976, GSM176453, GSM175977, GSM176452, GSM175974, GSM176239, GSM176451, GSM175975, GSM176238, GSM176450, GSM176237, GSM175973, GSM176236, GSM176235, GSM176234, GSM176233, GSM176232, GSM100888, GSM176231, GSM176230, GSM391616, GSM365113, GSM365114, GSM125026, GSM365115, GSM365116, GSM365117, GSM365118, GSM345077, GSM365119, GSM277721, GSM176206, GSM176205, GSM175965, GSM176208, GSM363399, GSM175966, GSM176207, GSM363398, GSM175967, GSM176466, GSM176209, GSM363396, GSM363395, GSM306240, GSM365121, GSM365120, GSM365124, GSM365125, GSM365122, GSM125016, GSM391626, GSM365123, GSM67153, GSM365128, GSM365129, GSM365126, GSM365127, GSM351339, GSM277731, GSM169530, GSM80567, GSM277094, GSM175954, GSM176219, GSM80566, GSM277095, GSM175955, GSM176218, GSM80569, GSM277092, GSM175952, GSM176217, GSM80568, GSM277093, GSM175953, GSM176216, GSM80563, GSM277098, GSM175958, GSM169525, GSM80562, GSM277099, GSM175959, GSM169524, GSM80565, GSM277096, GSM175956, GSM169527, GSM80564, GSM277097, GSM175957, GSM169526, GSM169529, GSM176211, GSM306230, GSM169528, GSM176210, GSM80561, GSM365132, GSM277090, GSM175950, GSM176215, GSM365131, GSM277091, GSM175951, GSM176214, GSM365130, GSM176213, GSM176212, GSM350348, GSM151324, GSM363383, GSM175949, GSM158741, GSM176271, GSM176270, GSM176273, GSM176272, GSM176267, GSM176268, GSM372301, GSM175940, GSM176269, GSM372300, GSM336013, GSM80571, GSM176263, GSM80572, GSM176264, GSM176265, GSM80570, GSM176266, GSM80575, GSM175946, GSM80576, GSM372306, GSM175945, GSM80573, GSM76549, GSM175948, GSM80574, GSM372308, GSM175947, GSM80579, GSM372303, GSM363379, GSM175942, GSM372302, GSM175941, GSM80577, GSM372305, GSM363377, GSM175944, GSM80578, GSM372304, GSM175943, GSM388709, GSM363390, GSM151314, GSM350358, GSM363392, GSM363394, GSM175938, GSM175939, GSM158751, GSM391606, GSM176280, GSM336023, GSM176278, GSM176279, GSM80580, GSM60601, GSM176276, GSM80581, GSM176277, GSM80582, GSM176274, GSM80583, GSM176275, GSM80584, GSM175937, GSM80585, GSM76539, GSM363385, GSM175936, GSM158761, GSM80586, GSM372318, GSM175935, GSM80587, GSM363387, GSM175934, GSM80588, GSM175933, GSM80589, GSM363389, GSM175932, GSM175931, GSM175930, GSM350328, GSM175927, GSM175928, GSM175929, GSM151344, GSM176251, GSM89101, GSM176250, GSM80593, GSM176241, GSM80594, GSM176242, GSM80591, GSM176243, GSM80592, GSM176244, GSM176245, GSM80590, GSM176246, GSM176247, GSM176248, GSM76529, GSM175920, GSM176249, GSM80599, GSM242653, GSM175922, GSM242652, GSM175921, GSM80597, GSM242651, GSM175924, GSM80598, GSM372328, GSM242650, GSM175923, GSM80595, GSM175926, GSM158771, GSM80596, GSM175925, GSM175918, GSM175919, GSM175916, GSM175917, GSM151334, GSM350338, GSM96266, GSM176262, GSM176261, GSM176260, GSM176254, GSM176255, GSM176252, GSM176253, GSM242668, GSM176258, GSM242667, GSM176259, GSM176256, GSM242669, GSM176257, GSM372338, GSM175911, GSM175910, GSM242666, GSM76519, GSM175915, GSM175914, GSM175913, GSM175912, GSM158781, GSM377475, GSM113822, GSM158811, GSM85219, GSM85217, GSM85218, GSM371383, GSM85215, GSM85216, GSM199167, GSM350139, GSM125066, GSM148493, GSM113812, GSM148491, GSM148495, GSM148496, GSM158801, GSM357635, GSM371373, GSM199157, GSM125076, GSM148488, GSM335978, GSM148485, GSM125036, GSM148487, GSM199197, GSM350155, GSM350156, GSM199187, GSM350158, GSM102578, GSM350151, GSM350152, GSM350153, GSM350154, GSM125046, GSM335988, GSM159162, GSM371393, GSM350150, GSM350146, GSM102568, GSM350147, GSM199177, GSM350144, GSM350145, GSM350142, GSM249991, GSM350143, GSM350140, GSM350141, GSM350148, GSM125056, GSM350149, GSM277695, GSM158851, GSM277696, GSM114526, GSM176182, GSM176183, GSM176184, GSM114525, GSM176185, GSM176180, GSM176181, GSM176179, GSM51710, GSM176176, GSM176175, GSM176178, GSM176177, GSM249981, GSM151304, GSM158841, GSM114535, GSM176173, GSM176174, GSM176171, GSM176172, GSM261292, GSM176170, GSM387809, GSM114534, GSM261282, GSM176169, GSM51700, GSM176168, GSM176167, GSM176166, GSM176165, GSM176164, GSM277691, GSM249971, GSM113802, GSM114506, GSM158831, GSM114504, GSM114505, GSM125086, GSM261272, GSM387819, GSM249961, GSM85227, GSM85226, GSM85228, GSM158821, GSM85221, GSM85220, GSM85223, GSM85222, GSM85225, GSM114515, GSM85224, GSM114516, GSM125096, GSM176186, GSM387829, GSM261262, GSM249950, GSM402152, GSM335522, GSM150209, GSM386291, GSM249940, GSM312934, GSM161820, GSM102512, GSM80800, GSM287323, GSM261252, GSM387839, GSM361610, GSM102518, GSM371309, GSM371306, GSM371305, GSM371308, GSM371307, GSM371302, GSM327292, GSM371301, GSM371304, GSM371303, GSM249930, GSM150201, GSM150208, GSM161810, GSM335512, GSM161811, GSM287333, GSM161812, GSM161813, GSM361620, GSM312924, GSM102508, GSM387849, GSM102507, GSM261242, GSM327282, GSM150210, GSM161819, GSM249920, GSM161818, GSM161815, GSM161814, GSM161817, GSM161816, GSM312911, GSM312912, GSM155672, GSM312910, GSM155671, GSM287343, GSM387859, GSM261232, GSM312913, GSM312914, GSM361242, GSM161806, GSM161805, GSM161804, GSM161803, GSM249910, GSM161809, GSM155681, GSM161808, GSM161807, GSM312900, GSM312901, GSM287353, GSM312906, GSM312907, GSM312908, GSM387869, GSM312909, GSM261222, GSM312902, GSM312903, GSM312904, GSM312905, GSM155691, GSM249900, GSM183234, GSM261212, GSM387879, GSM102553, GSM102555, GSM102556, GSM155651, GSM102558, GSM183230, GSM386245, GSM335572, GSM387889, GSM155668, GSM155669, GSM261202, GSM155665, GSM155666, GSM155667, GSM183240, GSM102548, GSM155661, GSM155670, GSM391596, GSM386255, GSM335562, GSM152009, GSM102538, GSM152006, GSM152005, GSM152008, GSM152007, GSM287303, GSM152002, GSM152001, GSM152004, GSM152003, GSM387899, GSM152000, GSM335552, GSM386225, GSM335938, GSM171597, GSM199027, GSM286700, GSM152017, GSM102528, GSM152016, GSM152015, GSM287313, GSM152014, GSM183220, GSM260703, GSM152013, GSM312944, GSM260702, GSM152012, GSM152011, GSM152010, GSM335532, GSM335542, GSM386235, GSM377465, GSM335942, GSM335941, GSM335940, GSM199037, GSM327202, GSM80868, GSM80867, GSM80869, GSM80874, GSM80870, GSM80871, GSM80872, GSM80873, GSM333446, GSM199047, GSM151294, GSM327212, GSM198042, GSM80887, GSM80888, GSM80885, GSM80886, GSM80883, GSM80884, GSM80881, GSM80882, GSM333436, GSM317934, GSM317933, GSM151284, GSM199057, GSM198052, GSM80845, GSM198053, GSM198050, GSM327222, GSM198051, GSM198049, GSM198048, GSM80851, GSM198047, GSM198046, GSM80853, GSM198045, GSM198044, GSM198043, GSM151274, GSM199067, GSM80861, GSM80865, GSM80866, GSM80864, GSM333456, GSM287383, GSM93939, GSM80823, GSM93938, GSM80824, GSM80825, GSM80826, GSM199077, GSM337202, GSM199087, GSM337203, GSM279998, GSM337200, GSM337201, GSM80831, GSM93944, GSM93943, GSM93941, GSM287373, GSM93946, GSM350413, GSM93948, GSM337205, GSM337204, GSM337207, GSM74882, GSM337206, GSM337209, GSM337208, GSM337210, GSM337211, GSM337212, GSM337213, GSM337214, GSM199097, GSM93954, GSM80844, GSM80843, GSM80842, GSM80841, GSM93950, GSM287363, GSM93952, GSM80801, GSM80802, GSM80803, GSM80804, GSM350423, GSM80805, GSM80806, GSM80807, GSM80808, GSM80809, GSM337219, GSM337218, GSM337217, GSM337216, GSM337215, GSM337224, GSM337225, GSM337222, GSM337223, GSM337220, GSM337221, GSM80811, GSM286660, GSM80810, GSM80814, GSM80815, GSM80812, GSM93927, GSM80813, GSM80818, GSM287393, GSM80819, GSM80816, GSM80817, GSM337227, GSM371403, GSM337226, GSM350433, GSM337229, GSM337228, GSM337233, GSM337234, GSM337235, GSM337236, GSM337230, GSM337231, GSM337232, GSM80822, GSM80821, GSM80820, GSM286650, GSM176128, GSM176129, GSM38094, GSM158891, GSM337241, GSM176120, GSM337240, GSM176121, GSM337243, GSM176122, GSM337242, GSM176123, GSM337245, GSM176124, GSM337244, GSM176125, GSM76640, GSM337247, GSM272315, GSM176126, GSM337246, GSM176127, GSM337237, GSM337238, GSM350443, GSM337239, GSM176130, GSM125106, GSM286690, GSM286670, GSM176139, GSM337250, GSM75563, GSM337254, GSM176133, GSM337253, GSM176134, GSM337252, GSM176131, GSM337251, GSM176132, GSM378160, GSM337258, GSM176137, GSM76630, GSM337257, GSM176138, GSM337256, GSM176135, GSM337255, GSM176136, GSM337248, GSM48672, GSM350453, GSM337249, GSM176141, GSM176140, GSM286680, GSM337260, GSM158871, GSM75553, GSM119369, GSM176146, GSM176147, GSM337269, GSM176148, GSM176149, GSM176142, GSM89001, GSM176143, GSM176144, GSM176145, GSM176150, GSM74892, GSM242033, GSM176152, GSM242032, GSM176151, GSM350463, GSM337259, GSM158861, GSM277681, GSM158881, GSM119379, GSM176159, GSM337279, GSM176157, GSM176158, GSM176155, GSM199107, GSM176156, GSM89011, GSM176153, GSM176154, GSM176163, GSM350473, GSM176162, GSM176161, GSM176160, GSM175998, GSM175999, GSM175996, GSM175994, GSM277678, GSM175995, GSM175992, GSM175993, GSM175990, GSM175991, GSM38054, GSM89021, GSM76600, GSM179780, GSM337289, GSM350168, GSM359509, GSM199117, GSM50703, GSM139018, GSM139017, GSM139019, GSM151264, GSM179790, GSM89031, GSM242031, GSM38064, GSM337299, GSM38068, GSM350178, GSM119359, GSM119354, GSM199127, GSM179784, GSM179786, GSM89041, GSM139002, GSM176103, GSM139003, GSM176102, GSM139004, GSM176105, GSM139005, GSM176104, GSM80891, GSM80890, GSM76620, GSM176101, GSM176100, GSM38074, GSM199137, GSM80899, GSM176107, GSM80898, GSM350188, GSM176106, GSM80897, GSM176109, GSM176108, GSM80889, GSM103559, GSM89046, GSM150196, GSM150197, GSM150198, GSM150199, GSM139015, GSM176116, GSM139016, GSM176115, GSM139013, GSM176114, GSM89051, GSM139014, GSM176113, GSM139011, GSM176112, GSM139012, GSM176111, GSM76610, GSM176110, GSM139010, GSM350198, GSM38084, GSM199147, GSM176119, GSM176118, GSM176117, GSM139009, GSM139008, GSM139007, GSM125116, GSM139006, GSM194087, GSM194088, GSM194089, GSM203643, GSM194083, GSM194084, GSM96897, GSM194085, GSM203646, GSM96898, GSM158911, GSM194086, GSM343815, GSM159051, GSM187752, GSM281300, GSM231907, GSM231906, GSM194091, GSM194090, GSM102458, GSM194093, GSM194092, GSM102455, GSM387029, GSM312875, GSM102450, GSM102451, GSM203656, GSM158901, GSM194096, GSM194097, GSM194094, GSM194095, GSM261192, GSM343825, GSM231916, GSM159041, GSM187762, GSM261184, GSM249890, GSM281310, GSM102447, GSM199297, GSM102449, GSM102448, GSM387019, GSM312862, GSM158931, GSM203666, GSM159071, GSM211450, GSM158463, GSM158464, GSM187732, GSM377358, GSM231926, GSM349749, GSM211449, GSM249880, GSM387009, GSM176098, GSM176099, GSM312894, GSM102478, GSM312896, GSM312897, GSM312898, GSM312899, GSM211446, GSM281320, GSM211447, GSM199287, GSM211448, GSM194075, GSM158921, GSM159061, GSM194078, GSM194079, GSM203676, GSM402247, GSM194076, GSM194077, GSM176097, GSM187742, GSM176096, GSM176095, GSM343805, GSM176094, GSM176093, GSM176092, GSM231936, GSM176091, GSM349739, GSM176090, GSM249870, GSM176089, GSM176087, GSM318094, GSM176088, GSM402257, GSM194082, GSM281330, GSM102468, GSM194081, GSM194080, GSM199277, GSM170833, GSM187792, GSM176080, GSM176081, GSM176082, GSM231946, GSM176083, GSM176084, GSM176085, GSM176086, GSM159091, GSM158951, GSM152569, GSM402267, GSM102498, GSM272305, GSM249860, GSM176077, GSM318084, GSM176076, GSM176079, GSM176078, GSM261151, GSM261152, GSM85506, GSM170835, GSM176070, GSM176071, GSM176074, GSM176075, GSM176072, GSM231956, GSM176073, GSM231950, GSM388192, GSM158941, GSM231952, GSM159081, GSM152579, GSM102488, GSM402277, GSM176068, GSM85513, GSM261146, GSM176067, GSM85514, GSM261143, GSM176066, GSM85515, GSM249850, GSM176065, GSM85516, GSM318074, GSM170823, GSM85517, GSM261142, GSM85518, GSM85519, GSM176069, GSM176061, GSM170850, GSM176062, GSM231966, GSM176063, GSM359583, GSM176064, GSM170855, GSM353428, GSM261182, GSM170853, GSM187772, GSM343837, GSM176060, GSM203626, GSM152589, GSM158971, GSM388182, GSM402287, GSM158981, GSM335602, GSM261172, GSM170858, GSM176059, GSM176058, GSM261174, GSM170857, GSM176055, GSM176054, GSM249840, GSM176057, GSM176056, GSM176052, GSM231976, GSM176053, GSM359593, GSM176050, GSM249820, GSM152594, GSM176051, GSM343847, GSM170841, GSM187782, GSM170844, GSM170843, GSM152599, GSM203636, GSM158961, GSM203641, GSM323169, GSM402297, GSM323168, GSM176049, GSM176048, GSM261162, GSM170848, GSM176047, GSM171011, GSM170849, GSM176046, GSM249830, GSM171012, GSM176045, GSM176044, GSM176043, GSM261113, GSM211032, GSM261112, GSM329007, GSM261117, GSM261116, GSM137954, GSM287463, GSM387731, GSM386393, GSM335622, GSM155968, GSM367219, GSM155969, GSM315621, GSM280907, GSM231986, GSM249810, GSM211042, GSM261102, GSM315622, GSM183301, GSM315623, GSM183300, GSM315624, GSM315625, GSM183302, GSM329017, GSM137964, GSM387741, GSM117629, GSM261109, GSM335612, GSM117632, GSM249800, GSM312816, GSM277128, GSM277129, GSM277126, GSM277127, GSM277125, GSM261134, GSM211052, GSM261132, GSM287443, GSM335642, GSM261138, GSM261137, GSM137934, GSM137931, GSM38376, GSM155989, GSM335652, GSM155988, GSM277132, GSM277131, GSM277130, GSM280927, GSM277137, GSM277138, GSM277139, GSM211062, GSM277133, GSM261122, GSM277134, GSM277135, GSM277136, GSM387721, GSM137945, GSM335632, GSM137944, GSM287453, GSM261127, GSM117649, GSM38386, GSM373559, GSM280917, GSM137994, GSM277109, GSM287423, GSM277108, GSM277103, GSM277102, GSM277101, GSM277100, GSM277107, GSM277106, GSM277105, GSM277104, GSM201302, GSM377338, GSM201301, GSM201300, GSM155920, GSM277110, GSM280947, GSM201304, GSM201303, GSM155923, GSM155922, GSM155921, GSM38356, GSM155928, GSM155927, GSM287433, GSM155919, GSM387789, GSM158465, GSM158466, GSM158467, GSM158468, GSM312826, GSM158469, GSM353885, GSM377348, GSM158471, GSM280937, GSM158470, GSM158473, GSM158472, GSM158475, GSM158474, GSM335662, GSM38366, GSM287403, GSM102438, GSM353895, GSM280967, GSM155948, GSM155947, GSM287413, GSM137984, GSM102428, GSM312849, GSM211022, GSM211012, GSM280957, GSM101301, GSM38346, GSM117610, GSM80725, GSM272192, GSM80724, GSM272193, GSM80727, GSM327342, GSM272190, GSM80726, GSM335582, GSM272191, GSM80729, GSM386311, GSM80728, GSM280979, GSM138034, GSM272295, GSM183260, GSM80730, GSM239824, GSM80731, GSM239825, GSM80732, GSM272185, GSM239826, GSM80733, GSM80734, GSM272183, GSM80738, GSM335592, GSM80737, GSM386301, GSM272180, GSM80736, GSM272181, GSM80735, GSM327352, GSM272182, GSM117587, GSM80739, GSM337309, GSM280989, GSM138044, GSM80740, GSM272177, GSM80741, GSM286730, GSM272176, GSM183250, GSM272172, GSM80742, GSM272175, GSM80743, GSM272174, GSM327322, GSM183290, GSM386331, GSM272170, GSM53113, GSM272171, GSM80749, GSM80748, GSM280999, GSM138054, GSM272169, GSM134694, GSM272164, GSM272163, GSM272162, GSM272275, GSM272161, GSM286720, GSM272168, GSM80750, GSM80751, GSM272165, GSM386321, GSM183280, GSM80759, GSM327332, GSM80758, GSM53103, GSM80757, GSM272160, GSM134690, GSM134691, GSM134692, GSM134693, GSM272159, GSM134688, GSM272158, GSM134687, GSM134689, GSM272151, GSM272150, GSM272152, GSM272155, GSM272154, GSM183270, GSM272285, GSM272157, GSM80761, GSM387799, GSM286710, GSM272156, GSM337339, GSM201279, GSM401293, GSM201278, GSM201277, GSM316703, GSM53133, GSM137924, GSM201286, GSM201287, GSM201284, GSM201285, GSM201282, GSM201283, GSM201280, GSM201281, GSM119685, GSM119684, GSM119683, GSM119682, GSM179801, GSM201267, GSM119688, GSM179800, GSM201266, GSM119687, GSM201269, GSM337349, GSM119686, GSM201268, GSM119681, GSM53123, GSM119680, GSM316713, GSM137912, GSM137910, GSM80701, GSM80700, GSM138004, GSM201273, GSM138003, GSM201274, GSM119679, GSM138002, GSM201275, GSM201276, GSM137916, GSM201270, GSM137914, GSM201271, GSM201272, GSM179810, GSM201299, GSM337319, GSM80706, GSM53153, GSM117577, GSM80707, GSM80708, GSM316723, GSM80709, GSM80702, GSM80703, GSM80704, GSM80705, GSM80710, GSM80712, GSM80711, GSM347925, GSM347924, GSM137904, GSM347923, GSM347922, GSM347921, GSM138014, GSM201289, GSM201288, GSM124996, GSM179820, GSM337329, GSM80719, GSM80717, GSM80718, GSM53143, GSM80715, GSM352629, GSM179827, GSM80716, GSM80713, GSM80714, GSM80723, GSM272194, GSM80722, GSM272195, GSM80721, GSM272196, GSM80720, GSM272197, GSM347916, GSM272198, GSM272199, GSM347918, GSM347917, GSM162960, GSM201290, GSM162961, GSM201291, GSM162962, GSM201292, GSM201293, GSM201294, GSM201295, GSM201296, GSM138024, GSM201297, GSM201298, GSM119649, GSM176025, GSM162954, GSM119648, GSM176026, GSM359603, GSM162957, GSM119647, GSM176027, GSM272215, GSM170867, GSM162956, GSM119646, GSM176028, GSM176021, GSM176022, GSM176023, GSM199217, GSM176024, GSM53173, GSM158991, GSM176029, GSM53170, GSM378838, GSM378837, GSM378836, GSM378831, GSM119651, GSM378830, GSM170862, GSM119652, GSM179830, GSM176031, GSM119650, GSM176030, GSM378835, GSM170865, GSM162958, GSM119655, GSM378834, GSM170866, GSM162959, GSM119656, GSM378833, GSM119653, GSM378832, GSM119654, GSM119636, GSM176038, GSM119635, GSM176039, GSM272225, GSM119638, GSM176036, GSM162943, GSM119637, GSM176037, GSM162942, GSM176034, GSM162941, GSM119639, GSM176035, GSM162940, GSM176032, GSM176033, GSM53163, GSM199227, GSM378826, GSM378825, GSM95473, GSM378828, GSM378827, GSM95475, GSM95474, GSM378829, GSM95477, GSM53167, GSM95476, GSM95479, GSM370399, GSM176042, GSM95478, GSM176041, GSM378820, GSM119640, GSM176040, GSM179840, GSM119641, GSM378822, GSM119642, GSM378821, GSM119643, GSM378824, GSM119644, GSM378823, GSM119645, GSM176000, GSM176001, GSM162931, GSM176002, GSM162930, GSM176003, GSM162933, GSM176004, GSM162932, GSM176005, GSM162935, GSM119669, GSM176006, GSM162934, GSM119668, GSM176007, GSM95480, GSM176008, GSM176009, GSM95488, GSM95487, GSM119670, GSM95486, GSM378819, GSM95485, GSM378818, GSM95484, GSM378817, GSM95483, GSM378816, GSM95482, GSM378815, GSM95481, GSM378814, GSM378813, GSM162936, GSM119677, GSM378812, GSM337359, GSM162937, GSM119678, GSM378811, GSM162938, GSM119675, GSM162939, GSM159101, GSM119673, GSM119674, GSM119671, GSM95489, GSM119672, GSM179850, GSM176012, GSM176013, GSM199207, GSM176010, GSM179870, GSM176011, GSM272205, GSM119658, GSM176016, GSM272204, GSM119657, GSM176017, GSM176014, GSM272202, GSM119659, GSM176015, GSM272201, GSM95490, GSM176018, GSM95491, GSM176019, GSM53183, GSM281280, GSM95497, GSM95496, GSM281290, GSM95499, GSM95498, GSM95493, GSM95492, GSM95495, GSM45796, GSM95494, GSM119664, GSM162928, GSM119665, GSM337369, GSM159111, GSM119666, GSM119667, GSM119660, GSM176020, GSM179860, GSM119661, GSM162929, GSM119662, GSM119663, GSM272143, GSM301693, GSM272144, GSM272145, GSM152619, GSM80771, GSM272146, GSM199257, GSM80778, GSM80777, GSM272140, GSM80776, GSM272255, GSM272141, GSM272142, GSM272147, GSM179880, GSM272148, GSM272149, GSM159122, GSM327302, GSM301687, GSM80783, GSM272134, GSM80782, GSM272135, GSM80785, GSM80784, GSM152609, GSM80787, GSM80786, GSM301680, GSM80789, GSM199267, GSM80788, GSM350078, GSM272265, GSM162902, GSM272138, GSM272139, GSM179890, GSM80781, GSM272136, GSM80780, GSM272137, GSM162906, GSM162905, GSM162904, GSM159132, GSM399579, GSM80779, GSM327312, GSM301677, GSM80799, GSM80798, GSM80797, GSM80796, GSM80795, GSM199237, GSM80794, GSM80793, GSM80792, GSM80791, GSM80790, GSM119628, GSM119629, GSM272235, GSM249790, GSM119626, GSM119627, GSM119624, GSM119625, GSM119634, GSM119633, GSM119632, GSM119631, GSM119630, GSM159142, GSM152639, GSM238763, GSM301667, GSM272245, GSM199247, GSM152629, GSM119617, GSM119618, GSM119619, GSM119615, GSM119616, GSM119621, GSM119620, GSM119623, GSM119622, GSM159152, GSM301657, GSM152624, GSM97793, GSM97794, GSM97795, GSM97796, GSM97797, GSM97798, GSM97799, GSM97800, GSM97801, GSM97802, GSM97803, GSM97804, GSM97805, GSM97806, GSM97807, GSM97808, GSM97809, GSM97810, GSM97811, GSM97812, GSM97813, GSM97814, GSM97815, GSM97816, GSM97817, GSM97818, GSM97819, GSM97820, GSM97821, GSM97822, GSM97823, GSM97824, GSM97825, GSM97826, GSM97827, GSM97828, GSM97829, GSM97830, GSM97831, GSM97832, GSM97833, GSM97834, GSM97835, GSM97836, GSM97837, GSM97838, GSM97839, GSM97840, GSM97841, GSM97842, GSM97843, GSM97844, GSM97845, GSM97846, GSM97847, GSM97848, GSM97849, GSM97850, GSM97851, GSM97852, GSM97853, GSM97854, GSM97855, GSM97856, GSM97857, GSM97858, GSM97859, GSM97860, GSM97861, GSM97862, GSM97863, GSM97864, GSM97865, GSM97866, GSM97867, GSM97868, GSM97869, GSM97870, GSM97871, GSM97872, GSM97873, GSM97874, GSM97875, GSM97876, GSM97877, GSM97878, GSM97879, GSM97880, GSM97881, GSM97882, GSM97883, GSM97884, GSM97885, GSM97886, GSM97887, GSM97888, GSM97889, GSM97890, GSM97891, GSM97892, GSM97893, GSM97894, GSM97895, GSM97896, GSM97897, GSM97898, GSM97899, GSM97900, GSM97901, GSM97902, GSM97903, GSM97904, GSM97905, GSM97906, GSM97907, GSM97908, GSM97909, GSM97910, GSM97911, GSM97912, GSM97913, GSM97914, GSM97915, GSM97916, GSM97917, GSM97918, GSM97919, GSM97920, GSM97921, GSM97922, GSM97923, GSM97924, GSM97925, GSM97926, GSM97927, GSM97928, GSM97929, GSM97930, GSM97931, GSM97932, GSM97933, GSM97934, GSM97935, GSM97936, GSM97937, GSM97938, GSM97939, GSM97940, GSM97941, GSM97942, GSM97943, GSM97944, GSM97945, GSM97946, GSM97947, GSM97948, GSM97949, GSM97950, GSM97951, GSM97952, GSM97953, GSM97954, GSM97955, GSM97956, GSM97957, GSM97958, GSM97959, GSM97960, GSM97961, GSM97962, GSM97963, GSM97964, GSM97965, GSM97966, GSM97967, GSM97968, GSM97969, GSM97970, GSM97971, GSM97972

1. A method of identifying a physiological state of a target cell comprising:
providing a normalized expression atlas reflecting a plurality of reference loci, said plurality of reference loci corresponding to a set of reference phenotypes associated with reference samples, wherein each of the reference loci is determined based on a compendium of covariance measurements determined between different biochemical expression measurements across the reference samples;
in a specifically-programmed computer, projecting onto the normalized expression atlas an expression vector reflecting at least a subset of biochemical expression measurements determined from a target cell to be identified, thereby locating the locus corresponding to the target cell on the normalized expression atlas;
in the specifically-programmed computer, determining deviation of the locus corresponding to the target cell from the reference loci corresponding to at least one selected reference phenotype, wherein the magnitude of the deviation indicates degree of similarity between the physiological state of the target cell and said at least one selected reference phenotype, thereby identifying the physiological state of the target cell relative to said at least one selected reference phenotype.

2.-108. (canceled)
